(19) United States
(12) Patent Application Publication
(10) Pub. No.: US 2016/0086222 A1
(43) Pub. Date: Mar. 24, 2016

(54) METHOD AND SYSTEM TO REMIND USERS OF TARGETED OFFERS IN SIMILAR CATEGORIES

(71) Applicant: Truaxis, Inc., San Carlos, CA (US)

(72) Inventor: Kaushal Kurapati, Cupertino, CA (US)

(21) Appl. No.: 14/955,862

(22) Filed: Dec. 1, 2015

Related U.S. Application Data
(63) Continuation-in-part of application No. 14/637,150, filed on Mar. 3, 2015.
Application No. 14/637,150 is a continuation-in-part of application No. 14/631,091, filed on Feb. 25, 2015.
Application No. 14/631,091 is a continuation-in-part of application No. 13/904,624, filed on May 29, 2013.
Application No. 13/904,624 is a continuation-in-part of application No. 13/247,657, filed on Sep. 28, 2011.
Application No. 13/247,657 is a continuation-in-part of application No. 13/180,511, filed on Jul. 11, 2011.
Application No. 13/180,511 is a continuation-in-part of application No. 13/082,591, filed on Apr. 8, 2011, now Pat. No. 8,600,857.
Application No. 13/082,591 is a continuation-in-part of application No. 12/501,572, filed on Jul. 13, 2009.
(60) Provisional application No. 62/036,921, filed on Aug. 13, 2014.
(60) Provisional application No. 61/652,662, filed on May 29, 2012.
(60) Provisional application No. 61/783,477, filed on Mar. 14, 2013.
(60) Provisional application No. 61/427,138, filed on Dec. 24, 2010.
(60) Provisional application No. 61/388,680, filed on Oct. 1, 2010.
(60) Provisional application No. 61/146,120, filed on Jan. 21, 2009.

(51) Int. Cl. G06Q 30/02

(52) U.S. Cl. CPC G06Q 30/0255

(57) ABSTRACT

Disclosed herein is a method for providing an offer which includes selecting at least one offer for presentation by applying at least one rule dictated by a merchant to a set of offers, applying at least one rule dictated by a financial institution to the offers, and applying a filter to identify offers with the highest likelihood of being accepted by the user. The selected offer is then presented to the user. An authorization request from a merchant for a user transaction is received by a remote computer and analyzed to determine one or more categories or sub-categories of the merchant or item in the transaction. The system then determines whether the selected offer is for a merchant or item in a related but different category from the one for which the authorization request was received, and if it is, the system reminds the user of the selected offer.

### CROSS-REFERENCE TO RELATED APPLICATIONS

This application is a continuation-in-part of U.S. patent application Ser. No. 14/637,150 (Docket No. BILL-0013-U01-N), filed on Mar. 3, 2015.

U.S. patent application Ser. No. 14/637,150 (Docket No. BILL-0013-U01-N) is a continuation-in-part of, and claims the benefit of the filing date of U.S. patent application Ser. No. 14/631,091 (Docket No. BILL-0010-U01-N), filed on Feb. 25, 2015 and hereby incorporated by reference, which claims the benefit of the following provisional application, which is hereby incorporated by reference in its entirety: U.S. Pat. Appl. 62/036,921, filed Aug. 13, 2014 (Docket No. BILL-0008-P01)

U.S. patent application Ser. No. 14/631,091 (Docket No. BILL-0010-U01-N) is a continuation-in-part of, and claims the benefit of the filing date of U.S. patent application Ser. No. 13/904,624 (Docket No. BILL-0007-U06), filed on May 29, 2013 and hereby incorporated by reference, which claims the benefit of the following provisional applications, each of which is hereby incorporated by reference in its entirety: U.S. Provisional Application No. 61/652,662, filed May 29, 2012 (Docket No. BILL-0006-P01); and U.S. Provisional Application No. 61/783,477, filed Mar. 14, 2013 (Docket No. BILL-0007-P01).

U.S. patent application Ser. No. 13/904,624 (Docket No. BILL-0007-U06) is a continuation-in-part of, and claims the benefit of the filing date of U.S. patent application Ser. No. 13/247,657 (Docket No. BILL-0005-U01), filed on Sep. 28, 2011.

U.S. patent application Ser. No. 13/247,657 (Docket No. BILL-0005-U01) is a continuation-in-part of, and claims the benefit of the filing date of U.S. patent application Ser. No. 13/180,511 (Docket No. BILL-0004-U01), filed on Jul. 11, 2011, which claims the benefit of the filing date of Provisional Application 61/427,138 (Docket No. BILL-0003-P01), filed on Dec. 24, 2010.

U.S. patent application Ser. No. 13/180,511 (Docket No. BILL-0004-U01) is a continuation-in-part of U.S. patent application Ser. No. 13/082,591 (Docket No. BILL-0002-U01), filed on Apr. 8, 2011, which claims the benefit of the filing date of Provisional Appl. 61/388,680 (Docket No. BILL-0002-P01), filed on Oct. 1, 2010.

U.S. patent application Ser. No. 13/082,591 (Docket No. BILL-0002-U01) is a continuation-in-part of U.S. patent application Ser. No. 12/501,572 (Docket No. BILL-0001-U01), filed on Jul. 13, 2009, which claims the benefit of the filing date of Provisional Appl. 61/146,120 (Docket No. BILL-0001-P01), filed on Jan. 21, 2009.

Each of the above applications is incorporated by reference in its entirety.

### BACKGROUND

1. Field

The present disclosure is generally related to an in-statement rewards platform.

2. Description of the Related Art

While consumer comparison shopping for products is known, an unbiased way of comparison shopping for competing services is unavailable. Often a consumer may only be aware of some of the information related to a service provider's services, options, terms, conditions, costs, and the like. Also, the consumer may not be aware of how the service options change based on their particular usage characteristics. Thus, there remains a need for a consumer comparison shopping method that obtains actual or predicted service usage data from the consumer and service provider information in order to present the consumer with relevant alternative service offering options.

### SUMMARY

In embodiments, methods and systems may help track consumer behavior and incentives. One embodiment is a method for tracking financial transactions. The method includes step of gathering transaction data from a plurality of user accounts by at least one computer, each user account a financial institution account at a financial institution and analyzing the transaction data for each user by the at least one computer for at least one criterion. The method also includes a step of providing a first savings opportunity to a first plurality of users whose transaction data meet the at least one criterion, the first savings opportunity provided in association with an online statement of the user's financial account, tracking a redemption of the savings opportunity by the first plurality of users whose transaction data met the at least one criterion, and tracking purchasing behavior for a period of time for the first plurality of users whose transaction data met the at least one criterion before and after the savings opportunity was provided.

In some of these embodiments, the transaction data comprises at least one of a merchant name, a merchant location, a transaction amount, a date of a transaction, a time of a transaction, a merchant category, a product category and a number of transactions. In some embodiments, there is a further step of tracking purchasing behavior of a second plurality of users whose transaction data met the at least one criterion, said second plurality of users not undertaking the savings opportunity. In some embodiments, there is a further step of tracking purchasing behavior of a second plurality of users whose transaction data met the at least one criterion, said second plurality of users provided with a second savings opportunity, said second savings opportunity different from said first savings opportunity. In some embodiments, there is a further step of gathering demographic data concerning each of the plurality of users, the demographic data including at least one of gender, age, ethnicity, an income level, an educational level, a shopping habit and a personal interest.

In some embodiments, the at least one criterion is selected from the group consisting of a previous purchase of an item, an amount of one or more purchases of an item, a number of transactions, a frequency of transactions and a transaction category. In some embodiments, there is a further step of comparing tracking information about purchasing behavior of the first plurality of users and a second plurality of users whose transaction data met the at least one criterion but who were not provided the savings opportunity for a category of product or service related to a category of the savings opportunity indication. Some embodiments of the method also compare tracking information about the purchasing behavior of a second plurality of users whose transaction data met the at least one criterion and who were not provided the savings opportunity and a third plurality of users whose transaction data met the at least one criterion and who were provided with a second savings opportunity different from the first savings opportunity. In other embodiments of the method, there is a further step of revising at least one of the first savings opportunity and the at least one criterion based on at least one of the tracked purchasing behavior, the spending lift and the redemption lift.

In embodiments, systems and methods may track the behavior of more than one group of consumers receiving different incentives. Another embodiment is a method for tracking financial transactions. The method includes steps of gathering transaction data from a plurality of user accounts by at least one computer, each user account a financial institution account at a financial institution, analyzing the transaction data for each user by the at least one computer for at least one criterion for a savings opportunity indication, and providing a first savings opportunity to a first plurality of users whose transaction data meet the at least one criterion. The method also includes steps of providing a second savings opportunity to a second plurality of users whose transaction data meet the at least one criterion, tracking a redemption of the savings opportunity by the first plurality of users and the second plurality of users, and tracking purchasing behavior of the first plurality of users and the second plurality of users for a period of time before and after the savings opportunity was provided.

In some of these embodiments, there is a further step of comparing spending on a good or a service in a category of the first and second savings opportunity by the first plurality of users and the second plurality of users. In some embodiments, there is a further step of tracking purchasing behavior of a third plurality of users whose transaction data met the at least one criterion, said third plurality of users not being provided the savings opportunity. In some of these embodiments, there is a further step comprising presenting the first savings opportunity or the second savings opportunity to a user in association with an on-line statement of the user's financial institution account. In some embodiments, there is a further step of presenting the user with an opportunity to view detailed billing records of the user's transactions with a merchant associated with the first savings opportunity or the second savings opportunity. In some embodiments, there is a further step of revising at least one of the first savings opportunity, the second savings opportunity and the at least one criterion based on at least one of the tracked purchasing behavior, the spending lift and the redemption lift. In some embodiments, there is a further step of storing data related to the transaction data, demographics of the first and second pluralities of users and a propensity of the first and second users to accept a savings opportunity, spending lift or redemption lift.

In another embodiment, a method of tracking financial transactions may include three separate groups of consumers. This embodiment is a method for tracking financial transactions. The method includes step of gathering transaction data from a plurality of user financial accounts by at least one computer, each user account a financial institution account at a financial institution, analyzing the transaction data for each user by the at least one computer for at least one criterion for a savings opportunity indication, and providing a first savings opportunity to a first plurality of users whose transaction data meet the at least one criterion. The method also includes steps of providing a second savings opportunity to a second plurality of users whose transaction data meet the at least one criterion, tracking a redemption of the savings opportunity by the first plurality of users and the second plurality of users, tracking purchasing behavior of the first plurality of users and the second plurality of users for a time period before and after the savings opportunity was provided, and tracking purchasing behavior in a same time period for a third plurality of users whose transaction data met the at least one criterion and for whom a savings opportunity was not provided.

In some of these embodiments, the first savings opportunity differs from the second savings opportunity in at least one of: an amount of spending required to realize the first or second opportunity; a number of transactions required to realize the first or second opportunity; and a time period in which to realize the first or second opportunity. In some embodiments, the third plurality of users is selected based on a previous purchasing behavior of at least one of: not accepting savings opportunities; opting out of receiving opportunities or offers; and not enrolling in a program or plan to receive offers. In some embodiments, the purchasing behavior is tracked for differences among the pluralities of users in at least one of: average total spending; average purchase amount; and number of transactions.

In embodiments, methods and systems may comprise gathering transaction data from a user's financial account, analyzing the transaction data for a savings opportunity indication, matching a savings opportunity from a database of savings opportunities to the user based on the savings opportunity indication, and displaying the savings opportunity in association with a statement of a user's financial account. Further, a past response may be gathered to a savings opportunity indication and analyzing it, wherein the savings opportunity is based on both the analyzed transaction data and past response data. The statement may be an online statement, an online graphical user interface associated with the user's financial account, an online bill pay area, a dialog box associated with the user's financial account, an ATM receipt, a teller receipt, a mobile statement, a paper statement, and the like. The step of analyzing may comprise extracting at least one of a merchant name, a merchant category, a merchant location, a store number, a transaction amount, a transaction frequency, a zip code, a store category, a transaction description, and a total spending amount. The step of analyzing may comprise analyzing the transaction data for a savings opportunity indication relating to a merchant. The step of analyzing may comprise analyzing the transaction data for a savings opportunity indication relating to a market segment. The step of displaying the savings opportunity may comprise displaying the savings opportunity within a field of the statement where prior transaction data may be presented. The savings opportunity may be presented interweaved within the presented prior transaction data. The step of displaying the savings opportunity may comprise displaying the savings opportunity within a field of the statement not where prior transaction data may be presented. The user's financial account may be a credit card account, a bank account, a checking account, a savings account, a personal finance program account, a loan account, and the like. The step of analyzing may comprise anonymizing the transaction data.

The savings opportunity may comprise an offer to perform a bill analysis. Further, generating and displaying a link may be provided in a graphical user interface to the user's financial account, to a transaction assessment user interface to compare the transaction to a plurality of alternative offers. The savings opportunity may be a coupon. The coupon may be a barcode presented on a mobile device. The coupon may be a printed coupon presented in a statement. The coupon may be an online redemption coupon code. The savings opportunity may be an automatic discount on a subsequent transaction. The savings opportunity may be a credit on a subsequent transaction. When the user makes the subsequent transaction, the user may receive the credit. The savings opportunity may be a pre-paid offer. The pre-paid offer may be charged immediately to the user's financial account. The pre-paid offer may be redeemed via an online coupon code, an in-store coupon, a mobile phone coupon, and the like. The savings opportunity may be a merchant loyalty program. The merchant loyalty program may be implemented through the use of a transaction card associated with the financial account. The merchant loyalty program may be implemented by providing the user with a printed coupon, a bar code coupon presented on a mobile device, a credit on a merchant loyalty card, and the like. Wherein analyzing the transaction data may comprise analyzing market segment information. The step of matching may be limited to savings opportunities near a user's identified location. The user's location may be identified manually by the user. The user's location may be identified automatically from a mobile device implementing the method.

In embodiments, methods and systems may comprise following a secure user login procedure, presenting a graphical user interface where a user's financial transaction data are presented, wherein the financial transaction data were obtained from a financial institution that maintains a financial account on behalf of the user, and presenting a savings opportunity, in proximity to the financial transaction data, wherein the savings opportunity relates to the financial transaction data. The sales offer may be presented in an interweaved fashion amongst more than one financial transaction of the financial transaction data. The financial account may be a credit card account, a bank account, a checking account, a savings account, a personal finance program account, a loan account, and the like. A past response may be gathered to a savings opportunity and analyzing it, wherein the current savings opportunity may be based on both the financial transaction data and past response data. The savings opportunity may relate to an aspect of the financial transaction data chosen from a merchant name, a merchant category, a merchant location, a store number, a transaction amount, a transaction frequency, a zip code, a store category, a transaction description, a total spending amount, and the like. Further, the financial transaction data may be anonymized. The step of presenting may be limited to savings opportunities near a user's identified location. The user's location may be identified manually by the user. The user's location may be identified automatically from a mobile device implementing the method. The savings opportunity may comprise an offer to perform a bill analysis. Further, generating and displaying a link may be provided in a graphical user interface to the user's financial account, to a transaction assessment user interface to compare the transaction to a plurality of alternative offers. The savings opportunity may be a coupon. The coupon may be a barcode presented on a mobile device. The coupon may be a printed coupon presented in a statement. The coupon may be an online redemption coupon code. The savings opportunity may be an automatic discount on a subsequent transaction. The savings opportunity may be a credit on a subsequent transaction. When the user makes the subsequent transaction, the user may receive the credit. The savings opportunity may be a pre-paid offer. The pre-paid offer may be charged immediately to the user's financial account. The pre-paid offer may be redeemed via an online coupon code, an in-store coupon, a mobile phone coupon, and the like. The savings opportunity may be a merchant loyalty program.

In embodiments, methods and systems may comprise presenting an opportunity to assess alternative offerings related to a financial transaction from a user's financial account, wherein the financial transaction is related to a presently selected offering, in response to the selection of the opportunity, gathering transaction data relating to the presented selected offering and analyzing the transaction data, wherein the step of analyzing involves normalizing the transaction data such that a comparison to other offers can be assessed, collecting offer data relating to an alternative offering and normalizing the offer data such that a comparison with the normalized transaction data can be assessed, comparing the normalized transaction data with the normalized offer data to assess if the alternative offering presents an improvement to the user in comparison to the presently selected offering, and presenting the alternative offering to the user if the alternative offering presents an improvement. Presenting may be done in a statement. The statement may be an online statement, an online graphical user interface associated with the user's financial account, an online bill pay area, a dialog box associated with the user's financial account, an ATM receipt, a teller receipt, a mobile statement, a paper statement, and the like. The financial transaction may be presented in a bill for payment in an online bill pay area. The improvement may be related to at least one of a cost, a coverage, a quality, and a rating. The user financial account is may be a credit card account, a bank account, a checking account, a savings account, a personal finance program account, a loan account, and the like. Analyzing the transaction data may involve extracting a merchant name, a merchant category, a merchant location, a transaction amount, a transaction frequency, a zip code, a store name, a store category, a store number a transaction description, a purchase frequency, a total spending amount, and the like. Further, the transaction data may be anonymized.

In embodiments, methods and systems may comprise presenting, in a user financial account graphical user interface, an opportunity to assess alternative offerings related to a transaction that is presented within the account graphical user interface, wherein the transaction is related to a presently selected offering, and in response to the selection of the opportunity, redirecting the user to an alternative offering graphical user interface adapted to present the user with alternative offerings. The bill's details may be analyzed and normalized for comparison with an alternative offering that has been normalized, and if the alternative offering presents an improvement in comparison to the presently selected offering, the alternative offering may be presented in the alternative offering graphical user interface. The bill details may include a merchant name, a merchant category, a merchant location, a transaction amount, a transaction frequency, a zip code, a store name, a store category, a store number a transaction description, a purchase frequency, a total spending amount, and the like. The improvement may be related to a cost, a coverage, a quality, a rating, and the like. The financial account may be a credit card account, a bank account, a checking account, a savings account, a personal finance program account, a loan account, and the like. Further, the transaction may be anonymized. The opportunity to assess alternative offerings may relate to a plurality of transactions.

In embodiments, methods and systems may comprise gathering transaction data relating to a user's bill wherein the bill is related to a presently selected offering, analyzing the transaction data, wherein the step of analyzing involves normalizing the transaction data such that a comparison to other offers can be assessed, collecting offer usage data relating to an alternative offering and normalizing the offer usage data such that a comparison with the transaction data can be assessed, comparing the normalized transaction data with the normalized offer usage data to assess if the alternative offering presents an advantage to the user in comparison to the presently selected offering, and in response to an assessment indicating that the alternative offering presents an improvement to the user, presenting, in a user financial account statement, an indication that an alternative offering related to the bill is available. The statement may be an online statement, an online graphical user interface associated with the user's financial account, an online bill pay area, a dialog box associated with the user's financial account, an ATM receipt, a teller receipt, a mobile statement, a paper statement, and the like. The improvement may be related to a cost, a coverage, a quality, a rating, and the like. The financial account may be a credit card account, a bank account, a checking account, a savings account, a personal finance program account, a loan account, and the like. Analyzing the transaction data may comprise anonymizing the transaction data.

In embodiments, methods and systems may comprise presenting a statement of a user's financial transaction data, where the financial transaction data were obtained from a financial institution that maintains a financial account on behalf of the user, and presenting a map of a geographic area and indicating where, within the geographic area, a savings opportunity is presented, wherein the savings opportunity relates to the financial transaction data. The map may be presented in proximity to the financial transaction data. The map may be presented in a separate window from the financial transaction data. The statement may be an online statement, an online graphical user interface associated with the user's financial account, an online bill pay area, a dialog box associated with the user's financial account, an ATM receipt, a teller receipt, a mobile statement, a paper statement, and the like. The financial account may be a credit card account, a bank account, a checking account, a savings account, a personal finance program account, a loan account, and the like. Further, the financial transaction data may be anonymized. The geographic area may relate to a user's identified location. The user's location may be identified manually by the user. The user's location may be identified automatically from a mobile device implementing the method. The savings opportunity may comprise an offer to perform a bill analysis. Further, generating and displaying a link may be provided in a graphical user interface to the user's financial account, to a transaction assessment user interface to compare the transaction to a plurality of alternative offers. The savings opportunity may be a coupon. The coupon may be a barcode presented on a mobile device. The coupon may be a printed coupon presented in a statement. The coupon may be an online redemption coupon code. The savings opportunity may be an automatic discount on a subsequent transaction. The savings opportunity may be a credit on a subsequent transaction. When the user makes the subsequent transaction, the user may receive the credit. The savings opportunity may be a pre-paid offer. The pre-paid offer may be charged immediately to the user's financial account. The pre-paid offer may be redeemed via an online coupon code, an in-store coupon, a mobile phone coupon, and the like. The savings opportunity may be a merchant loyalty program.

In embodiments, methods and systems may comprise gathering transaction data from a user for a merchant from a user's financial account, where the user's financial account is a financial institution account that is maintained on behalf of the user; analyzing the transaction data to determine if an aspect of the transaction data meet a criteria set by the merchant; if the transaction data meet the criteria, matching a savings opportunity from the merchant to the user based on the analyzed transaction data; and enabling the user to redeem the savings opportunity during a subsequent transaction with the merchant. The criteria may comprise a total spending amount with the merchant, a number of transactions with the merchant, a number of transactions within a category, total spending during a period of time, a particular transaction, a particular set of transactions, a transaction at a particular merchant location, and the like. The financial account may be a bank account, a checking account, a savings account, a credit account, a personal finance program account, a loan account, and the like. Enabling may comprise automatic redemption upon presentation of a transaction card associated with the user's financial account. Enabling may comprise providing the user with a printed coupon, a bar code coupon presented on a mobile device, a credit on a merchant loyalty card, and the like. Analyzing may comprise anonymizing the financial transaction data. Analyzing may comprise extracting a merchant name, a merchant category, a merchant location, a transaction amount, a transaction frequency, a zip code, a store name, a store category, a store number, a transaction description, a purchase frequency, a total spending amount, and the like.

In embodiments, methods and systems may comprise gathering transaction data from a user for a merchant from a user's financial account, wherein the user's financial account is a financial institution account that is maintained on behalf of the user; analyzing the transaction data; matching a savings opportunity from the merchant to the user based on the analyzed transaction data; and enabling the user to redeem the savings opportunity during a subsequent transaction with the merchant. The financial account may be a bank account, a checking account, a savings account, a credit account, a personal finance program account, a loan account, and the like. Enabling may comprise automatic redemption upon presentation of a transaction card associated with the user's financial account. Enabling may comprise providing the user with at least one of a printed coupon, a bar code coupon presented on a mobile device, and a credit on a merchant loyalty card. Analyzing may comprise anonymizing the financial transaction data. Analyzing may comprise extracting a merchant name, a merchant category, a merchant location, a transaction amount, a transaction frequency, a zip code, a store name, a store category, a store number, a transaction description, a purchase frequency, a total spending amount, and the like.

In embodiments, methods and systems may comprise presenting a merchant bill assessment graphical user interface where an indication of a savings opportunity is presented, and in response to a placement of a savings opportunity in a graphical user interface associated with a user's financial account, wherein the savings opportunity was related to one or more transactions processed through the user's financial account, tracking interaction with the savings opportunity and reporting the tracking to a merchant through the merchant bill assessment graphical user interface. The reporting may comprise reporting on a total spending amount with the merchant, a number of transactions with the merchant, a number of transactions within a category, total spending during a period of time, a particular transaction, a particular set of transactions, a transaction at a particular merchant location, and the like.

In embodiments, methods and systems may comprise an executable script such that when embedded in a graphical user interface of a user's financial account will automatically provide the user, through the graphical user interface, a savings opportunity interface, wherein savings opportunities relating to user financial transactions will be presented. The executable program may be implemented in the JavaScript programming language.

In embodiments, methods and systems may comprise embedding an executable script in a graphical user interface of a user's financial account, executing the executable script when the user accesses the user financial account; and using the executable script to: (1) gather transaction data from the user financial account and anonymize the transaction data before transmitting the anonymized transaction data to a server for analysis; (2) instruct a decision engine in communication with the server to select a savings opportunity to match to the user based on the anonymized transaction data analyzed by the server; (3) receive an indication of the matched savings opportunity from the decision engine; and (4) display the savings opportunity in the user financial account graphical user interface. Analyzing may comprise extracting a merchant name, a merchant category, a merchant location, a transaction amount, a transaction frequency, a zip code, a store name, a store category, a store number, a transaction description, a purchase frequency, a total spending amount, and the like. Further, the executable script may be used to instruct the decision engine to consult a rules database in making the match. The rules database may comprise criteria that the transaction data should meet before a match is made. The criteria may comprise a total spending amount with the merchant, a number of transactions with the merchant, a number of transactions within a category, total spending during a period of time, a particular transaction, a particular set of transactions, a transaction at a particular merchant location, and the like. The financial account may be a bank account, a checking account, a savings account, a credit account, a personal finance program account, a loan account, and the like.

In embodiments, methods and systems may comprise: providing an executable script such that when embedded in a graphical user interface of a user's financial account will automatically provide a merchant with anonymized information relating to transactions made by the user from the user's financial account; and in response to receipt of the anonymized information, enabling the merchant to present a savings opportunity to the user, which will appear in the graphical user interface. The executable program may be implemented in the JavaScript programming language. The user may select to which merchants the executable program can transmit the anonymized information. A user financial account host may select to which merchants the executable program can transmit the anonymized information.

In embodiments, methods and systems may comprise embedding a first executable script in a graphical user interface of a user's financial account, executing the first executable script when the user accesses the user financial account, and using the first executable script to: (1) gather transaction data from the user financial account and anonymize the transaction data before transmitting the anonymized transaction data to a first server for analysis and (2) specify the address of a second executable script, wherein the second executable script accesses the analyzed transaction data and performs a function with the analyzed transaction data. The executable script may be implemented in the JavaScript programming language.

In embodiments, methods and systems may comprise embedding an executable script in a graphical user interface of a user's financial account, executing the executable script when the user accesses the user financial account, and using the executable script to: (1) gather transaction data from the user financial account and anonymize the transaction data before transmitting the anonymized transaction data to a server for analysis; and (2) transmit the transaction data to a third party application to be leveraged. The third party application may be a fraud detection application. The third party application may be a transaction analytics application. The third party application may be a marketing application. The third party application may be a social networking application. The executable script may be implemented in the JavaScript programming language.

In an aspect of the disclosure, a method for a conditional purchase may include receiving a conditional purchase offer for a good or service, wherein the conditional purchase offer specifies at least one of a desired discount and an offer price, comparing the conditional purchase offer with at least one of an inventory and a pricing information to determine if the conditional purchase offer is acceptable, if the conditional purchase offer is acceptable, optionally binding the customer to purchase the good or service, wherein binding comprises automatically charging a financial account of the user for the good or service, and if the conditional purchase offer is not acceptable, allowing the user to modify at least one of the discount and offer price.

A system and method for platform-driven savings opportunity matching includes gathering transaction data from a user's financial account, wherein the user's financial account is a financial institution account that is maintained on behalf of the user and analyzing the transaction data for a psychographic inference. A savings opportunity from a database of savings opportunities is matched to the user based on the psychographic inference. The savings opportunity is displayed in association with a statement of the user's financial account. The psychographic inference may relate to at least one of a credit rating, a gender, an age group, a life event, an income level, and a demographic.

A system and method for financial institution- and merchant-driven savings opportunity matching includes gathering transaction data from a user's financial account, wherein the user's financial account is a financial institution account that is maintained on behalf of the user and analyzing the transaction data for a savings opportunity indication. A filter may be applied to a database of savings opportunities prior to matching one to the user based on the savings opportunity indication. The savings opportunity may be displayed in association with a statement of a user's financial account. The filter may relate to a host of the user's financial account. The filter may be a blacklist of at least one of a merchant, a merchant type, a transaction type, a time period, and a savings opportunity type. The filter may relate to a merchant offering a savings opportunity. The filter may relate to a past spend with the merchant, a past spend in a category, a past purchase frequency, a transaction, and a change in purchase pattern.

A system and method for user-driven savings opportunity matching includes gathering transaction data from a user's financial account, wherein the user's financial account is a financial institution account that is maintained on behalf of the user and analyzing the transaction data for a savings opportunity indication. A savings opportunity from a database of savings opportunities may be matched to the user based on the savings opportunity indication. The savings opportunity may be displayed in association with a statement of a user's financial account, and the user is allowed to interact with the savings opportunity. The interaction data may be used to drive a subsequent match of a savings opportunity. The interaction data may be a past response to a savings opportunity. The system and method may further include decreasing the number of matches made if the response is negative. The system and method may further include increasing the number of matches made if the response is positive. The system and method may further include changing the type of savings opportunity matched if the response is negative. The interaction data may be a like or dislike of the savings opportunity. The interaction data may be an expansion of a savings opportunity headline to reveal additional details. The interaction data may be a sharing of the savings opportunity with at least one of a second user and a social network.

A system and method for providing rewards through a user financial instrument includes gathering transaction data from a user's financial account, wherein the user's financial account is a financial institution account that is maintained on behalf of the user and analyzing the transaction data to determine a reward level. The savings opportunity from the merchant may be matched to the user based on the reward level. The user is enabled to redeem the savings opportunity during a subsequent transaction with the merchant. The system and method may further include allowing the merchant to set a criterion for determining the reward level. The criterion may relate to an amount spent with the merchant. The criterion may relate to a number of visits to the merchant. As the reward level improves, the matched savings opportunity may improve.

A system and method for providing a future reward through a user financial instrument includes gathering transaction data from a user's financial account, wherein the user's financial account is a financial institution account that is maintained on behalf of the user and analyzing the transaction data to determine a future savings opportunity accessible to the user after completion of a goal. Systems and methods track progress towards completing the goal. The user is enabled to obtain the future savings opportunity when the goal is completed. The system and method may further include allowing the merchant to set the goal. The goal may relate to an amount spent with the merchant. The goal may relate to a number of visits to the merchant.

A system and method for providing socially enabled rewards through a user financial instrument includes gathering transaction data from a user's financial account and analyzing the transaction data for a savings opportunity indication. A savings opportunity from a database of savings opportunities is matched to the user based on the savings opportunity indication, wherein the savings opportunity can be shared with other users or a social network. The savings opportunity is displayed in association with a statement of a user's financial account and the user is allowed to share the savings opportunity, wherein sharing causes a shared savings opportunity to be generated. A second user, one who received the shared savings opportunity, can redeem the shared savings opportunity. The sharing and redemption of the shared savings opportunity is tracked, such as to improve targeting users who are influential based on the number of redemptions of the shared savings opportunity. The system and method may further include allowing a merchant to modify the savings opportunity priori to generating the shared savings opportunity.

A system and method for providing a geo-enhanced savings opportunity in association with a financial account includes gathering transaction data from a user's financial account and analyzing the transaction data for a savings opportunity indication. A savings opportunity from a database of savings opportunities is matched to the user based on the savings opportunity indication. The savings opportunity is displayed in association with a statement of a user's financial account. A response to the savings opportunity is tracked in order to receive an indication of whether or not the savings opportunity has been accepted. If it was not accepted, an additional incentive to accept the savings opportunity may be made when the user is in a geographic location set by a merchant offering the savings opportunity. The incentive may be at least one of an additional % discount, an additional monetary discount, an additional savings opportunity, the opportunity to share the savings opportunity, and a related opportunity.

A system and method for providing a savings opportunity matched to a spend pattern in association with a financial account includes gathering transaction data from a user's financial account and analyzing the transaction data for a spend pattern. A savings opportunity from a database of savings opportunities is matched to the user based on the spend pattern. The savings opportunity is displayed in association with a statement of a user's financial account. The system and method may further include gathering a past response to a savings opportunity and analyzing it, wherein the savings opportunity is based on both the spend pattern and past response data.

Methods and systems for a conditional purchase may include gathering transaction data from a user's financial account, wherein the user's financial account is a financial institution account that is maintained on behalf of the user and analyzing the transaction data for a savings opportunity indication. A savings opportunity is matched from a database of savings opportunities to the user based on the savings opportunity indication. The user may provide a conditional purchase offer for a good or service identified by the savings opportunity, wherein the conditional purchase offer specifies at least one of a desired discount and an offer price. The conditional purchase offer is compared with at least one of an inventory and a pricing information to determine if the conditional purchase offer is acceptable. If the conditional purchase offer is acceptable, the customer may be bound to purchase the good or service, wherein binding comprises automatically charging a financial account of the user for the good or service. If the conditional purchase offer is not acceptable, the user may modify at least one of the discount and offer price of the conditional purchase offer to try to gain acceptance again.

A system and method for matching a savings opportunity using census data includes gathering transaction data from a user's financial account and analyzing the transaction data for a savings opportunity indication. Third party census data related to a geographic location of the user may be used in addition to the savings opportunity indication to match a savings opportunity from a database of savings opportunities to the user. The savings opportunity is displayed in association with a statement of the user's financial account. The system and method may further include gathering a past response to a savings opportunity indication and analyzing it, wherein the savings opportunity is based on both the analyzed transaction data and past response data.

A system and method for matching a savings opportunity using third party data includes gathering transaction data from a user's financial account and analyzing the transaction data for a savings opportunity indication. Third party data regarding the savings opportunity may be used in addition to the savings opportunity indication to match a savings opportunity from a database of savings opportunities to the user. The savings opportunity is displayed in association with a statement of the user's financial account. The third party data may relate to an aspect of the merchant. The third party data may relate to an aspect of a product or service offered by the merchant.

In an embodiment, a method for identifying group members may include identifying demographic characteristics of members of a group via market research, identifying purchasing behaviors of the members of the group via market research, correlating the identified demographic characteristics with the identified purchasing behaviors to identify merchants whom the members of the group tend to patronize, gathering transaction data from a financial account of a user at a financial institution for processing transactions between the user and a plurality of merchants and providers, clustering users using their transaction data with the identified merchants to from a plurality of clusters, analyzing the characteristics of each cluster and identifying at least one cluster that has the identified demographic characteristics, and presenting to the user in an online statement of the user's account a savings opportunity from a merchant seeking to contact members of the group when the characteristics suggest that the user belongs to the at least one cluster. The demographic characteristics of the members of the group may include at least one of gender; ethnicity; age or birthdate; family income; personal income; educational level; shopping preference; and a personal interest. The market research may include an organized effort to contact individual members of the group to gather information concerning at least one of: economic data; habits and practices of individual members of the group. Identifying merchants may include identifying sellers, retailers, manufacturers, establishments, on-line services for connecting buyers and sellers, on-line services using primarily mobile devices to connect buyers and sellers, and providers of goods and services patronized by members of the group. The identified merchants may include at least one of sellers, retailers, manufacturers, establishments, providers of goods and services, and completed transactions with selected merchants or providers. Analyzing may include analyzing transaction data for at least one of: an amount spent in a time period; an amount spent in a product or service category; one or more transactions with a particular merchant or provider of a good or a service; and an average amount spent per time periods over several time periods. The method may further include eliminating from the step of presenting, savings opportunities from merchants not patronized by the members of the group. The savings opportunity may be an invitation to an alternative provider of a good or a service previously purchased by the user and further comprising accepting a response from the user to the presentation of the savings opportunity by redirecting the user to information about the alternative provider. The method may further include identifying the purchasing behaviors of the members of the group from third party sources and verifying the purchasing behaviors of the members of the group via market research. The method may further include identifying merchants patronized by the members of the group from third party sources and verifying the purchasing behaviors of the members of the group via the analyzed transaction data.

In an embodiment, a method for identifying group members may include identifying demographic characteristics of members of a group via market research, identifying purchasing behaviors of the members of the group via market research, correlating the identified demographic characteristics with the identified purchasing behaviors to identify merchandise categories typically purchased by the members of the group, gathering transaction data from a financial account of a user at a financial institution for processing transactions between the user and a plurality of merchants and providers, clustering users using their transaction data in the identified merchant categories, analyzing the characteristics of each cluster and identify at least one cluster with the identified demographic characteristics and presenting to the user in an online statement of the user's account a savings opportunity from a merchant seeking to contact members of the group when the characteristics suggest that the user belong to the cluster. At least one of the merchandise categories may be selected from the group consisting of restaurants, jewelry, airline travel, travel-related merchandise, clothing, high-end apparel, entertainment, furniture, appliances, general merchandise, mass-market discount merchandise, housing, automobiles, education, continuing education and online-purchased merchandise and services. The identified purchasing behaviors of the members may include a list of merchants or providers patronized by the members of the group. Identifying purchasing behaviors of the members of the group may include identifying merchants, retailers, manufacturers, establishments and providers of goods and services patronized by members of the group, and further comprising categorizing the identified merchants, retailers, manufacturers, establishments and providers into a plurality of merchandise categories. The savings opportunity may be an invitation to an alternative provider of a good or a service in a merchandise category previously purchased by the user and further comprising accepting a response from the user to the presentation of the savings opportunity by redirecting the user to information about the alternative provider in the merchandise category. The method may further include presenting the user with an opportunity to view detailed billing records from a current provider to the user in the merchandise category, the detailed billing records including information additional to the transaction data. The method may further include correlating the identified demographic characteristics with the identified purchasing behavior to identify merchandise categories not typically purchased by the members of the group.

In an aspect, a method for identifying group members may include identifying demographic characteristics of members of a group via market research, identifying purchasing behaviors of the members of the group via market research, correlating the identified demographic characteristics with the identified purchasing behaviors to identify purchasing behaviors of the members of the group, defining criteria to identify a member of the group via a purchasing behavior of the member, gathering transaction data from a financial account of a user at a financial institution for processing transactions of the user with a plurality of merchants and providers, analyzing the transaction data of the user to determine whether the transaction data of the user meet two or more of the criteria for the user to be an individual member of the group, and, presenting to the user in an online statement of the financial account of the user a savings opportunity from a merchant seeking to contact members of the group having the identified purchasing behaviors when the user meets the two or more of the criteria for the user to be an individual member of the group. At least two purchasing behaviors may be selected from the group consisting of: at least one merchandise category; an amount spent in a time period; an amount spent in a product or service category; one or more transactions with a particular merchant or provider of a good or a service; purchases made online; purchases made from a mobile device; transactions conducted outside a person's zip code or statistical area; and an average amount spent per time periods over several time periods. The method may further include identifying purchasing behaviors not practiced by the members of the group and in the step of analyzing, eliminating the user if the transaction data of the user reveal a purchasing behavior inconsistent with membership in the group. The merchant may participate in a merchandise category selected from the group consisting of a niche apparel category, an online retailer category, an educational category, a continuing education category and a travel category. The merchant seeking to contact members of the group may be identified in the step of identifying purchasing behaviors of the members of the group. The method may further include comparing a list of the members of the group from the step of correlating with a list of users identified by the step of analyzing and modifying the criteria to identify a member of the group.

In an aspect, a method for identifying a member of a group with particular demographic characteristics may include identifying purchasing behaviors of members of a group with particular demographic characteristics via market research, gathering transaction data from a financial account of a user at a financial institution for processing transactions of the user with the multiple of merchants, using the market research to set prior probabilities that a user is a member of the group in a Bayesian belief network, analyzing the transaction data of the user via a Bayesian belief network to determine whether the transaction data of the user indicates that the user is an individual member of the group with the particular demographic characteristics, and presenting to the user at least one of an offer and a savings opportunity from a merchant seeking to contact members of the group with the particular demographic characteristics. The particular demographic characteristics include gender, race, ethnicity, an age range, family income, personal income, and educational level. Gathering transaction data from the financial account of the user includes a past spend history. Gathering transaction data from the financial account of the user includes avoiding any personally identifiable information. The user is a particular credit card holder.

In an aspect, a method for identifying a member of a group with particular demographic characteristics may include identifying purchasing behaviors of members of a group with particular demographic characteristics via survey data from each of a multiple of merchants, gathering transaction data from a financial account of a user at a financial institution for processing transactions of the user with the multiple of merchants, analyzing the transaction data of the user via a Bayesian belief network and the survey data from each of the multiple of merchants to determine whether the transaction data of the user indicates that the user is an individual member of the group with the particular demographic characteristics, and presenting to the user a savings opportunity from a merchant seeking to contact members of the group with the particular demographic characteristics. Gathering transaction data from the financial account of the user includes avoiding any personally identifiable information. The user is a particular credit card holder.

In an aspect, a method for identifying a member of a group with particular demographic characteristics may include identifying purchasing behaviors of members of a group with particular demographic characteristics via survey data from each of a multiple of merchants, gathering transaction data without personally identifiable information from a financial account of a user at a financial institution for processing transactions of the user with the multiple of merchants, analyzing the transaction data of the user via a Bayesian belief network and the survey data from each of the multiple of merchants to determine whether the transaction data of the user indicates that the user is an individual member of the group with the particular demographic characteristics, and presenting to the user, via an online statement of the financial account of the user, a savings opportunity from a merchant seeking to contact members of the group with the particular demographic characteristics. Analyzing the transaction data includes a Markov process. Analyzing the transaction data includes iterating probabilities until a predetermined stabilization occurs.

Today, when the term “personalized offers” is used in the rewards space, what is typically meant is selecting one or more merchant-defined rewards, offers, or incentives from an inventory of such and giving it to a given user based on the spending characteristics of the user. If both “User 1” and “User 2” get “Offer 1”, the parameters of the offer, reward, or incentive, such as, without limitation, minimum spending threshold, discount amount, and duration or length of the campaign, are typically all be the same. This is not true personalization, and this approach tends to be inefficient at driving incremental spending when compared to control groups, as some users may require less or more discount to act, some users ordinarily would spend over, or perhaps far below, the spending threshold associated with the offer, and some users respond to short offer periods while others require a longer time to make decisions. A need exists for a system and method of personalizing offers that targets appropriate offers for particular users.

Among other things, the methods and systems disclosed herein allow a host of a platform for providing offers to dynamically change offer parameters such as discount amount, campaign length or duration, and minimum spending threshold, depending on which user receives the offer and based on information about particular users.

In an aspect, a method of targeting users with an offer may include selecting at least one reward, offer, or incentive to present to a user by: applying at least one rule dictated by a merchant to a set of offers to be provided to the user, applying at least one rule dictated by a financial institution to the set of offers, and applying a filter to identify offers with a highest likelihood of being accepted by the user, and adjusting at least one parameter of the at least one offer prior to presentation to the user based on at least one characteristic of the user. The at least one parameter may be at least one of a minimum spending threshold, a discount amount, and a duration of a campaign, and a category of offer. The filter to identify offers with the highest likelihood of being accepted may be based on a predictive model of user purchase behavior developed using at least one of: data on one or more past user responses to one or more savings opportunities, public data relevant to the user, inferred data about the user, preferences selected from the group consisting of merchant category preferences, transaction category preferences, product category preferences, and merchant preferences, a geographic location, a seasonal variety, a spending level, and a change from an historic spending pattern. Adjusting the at least one parameter may include calculating a spending trajectory based on a historical spending pattern and adjusting the at least one parameter in accordance with the spending trajectory. Adjusting the at least one parameter may be done in accordance with at least one segmentation criterion applied to the user. Adjusting may be completed in a time span selected from the group consisting of: less than about 10 sec, less than about 5 sec, less than about 1 second, or substantially instantaneously. Adjusting may be done in accordance with one or more inputs selected from the group consisting of: a spend trajectory, a user propensity model, user profile information or segmentation criteria, and a campaign goal. A rule may be applied to determine which of the one or more inputs are used in adjusting. A weight may be applied to each of the selected one or more inputs in adjusting.

In an aspect, a method of targeting users with an offer may include selecting at least one offer to present to a user by: applying at least one rule dictated by a merchant to a set of offers to be provided to a user, applying at least one rule dictated by a financial institution to the set of offers, and applying a filter to identify offers with the highest likelihood of being accepted by the user, and adjusting at least one of a minimum spending threshold, a discount amount, a duration of the campaign, and a category of the at least one offer prior to presentation to the user based on at least one characteristic of the user. The filter to identify offers with a highest likelihood of being accepted may be based on a predictive model of user purchase behavior developed using at least one of: data on one or more past user responses to one or more savings opportunities, public data relevant to the user, inferred data about the user, preferences selected from the group consisting of merchant category preferences, transaction category preferences, product category preferences, and merchant preferences, a geographic location, a seasonal variety, a spending level, and a change from an historic spending pattern. Adjusting the parameter may include calculating a spending trajectory based on a historic spending pattern and adjusting the at least one minimum spending threshold, discount amount, duration of the campaign, and category of offer and adjusting the parameter in accordance with the spending trajectory. Adjusting the parameter may be done in accordance with at least one segmentation criterion applied to the user. Adjusting may be completed in a time span selected from the group consisting of: less than about 10 sec, less than about 5 sec, less than about 1 second, or substantially instantaneously. Adjusting may be done in accordance with at least one input selected from the group consisting of: a spend trajectory, a user propensity model, user profile information or segmentation criteria, and a campaign goal. A rule may be applied to determine which of the inputs are used in adjusting. A weight may be applied to each of the selected inputs in adjusting.

In an aspect, a method of dynamically personalizing an offer may include selecting at least one offer to present to a user, and adjusting at least one parameter of the at least one offer prior to presentation to the user, wherein adjusting is done in accordance with at least one input selected from the group consisting of: a spending trajectory, a user propensity model, user profile information, a segmentation criterion, and a campaign goal. The filter to identify offers with the highest likelihood of being accepted may be based on a predictive model of user purchase behavior developed using at least one of: data on one or more past user responses to one or more savings opportunities, public data relevant to the user, inferred data about the user, preferences selected from the group consisting of merchant category preferences, transaction category preferences, product category preferences, and merchant preferences, a geographic location, a seasonal variety, a spending level, and a change from an historic spending pattern. Adjusting may be completed in a time span selected from the group consisting of: less than about 10 sec, less than about 5 sec, less than about 1 second, or substantially instantaneously. A rule may be applied to determine which of the inputs are used in adjusting. A weight may be applied to each of the selected inputs in adjusting.

In an aspect, a computer-implemented method for providing a savings opportunity may include receiving an authorization request from a merchant for a user transaction by a first remote computer, accessing, at the first remote computer, a user profile including a preferred currency for transactions, analyzing, at the first remote computer, the authorization request to determine if the currency being used is different from the preferred currency for a savings opportunity indication, transmitting the savings opportunity indication to a second remote computer, matching, at the second remote computer, a savings opportunity from a database of savings opportunities to the user based on the savings opportunity indication, and notifying at least one of the user and the merchant, by the second remote computer, of the savings opportunity. The savings opportunity is for use during the current transaction or for a future transaction, and may be automatically applied to the current transaction. The method may further include filtering the savings opportunities in the database by one or more merchant-indicated conditions. The merchant-indicated condition may be at least one of a location of the merchant/payment, a type of merchant, an amount of the payment, a good or service purchased, a date of the transaction, and a time of the transaction. The method may further include receiving an indication from the user by at least one of the first and second remote computers for sharing the matched savings opportunity with at least one additional user, wherein sharing causes at least one of the first and second remote computers to generate a shared savings opportunity. The method may further include receiving an indication to redeem the shared savings opportunity; and tracking the sharing and redemption of the shared savings opportunity. The method may further include presenting an indication to redeem the shared savings opportunity to the at least one additional user, and tracking the sharing and redemption of the shared savings opportunity. The indication to redeem the shared savings opportunity may be presented on a mobile device.

In one embodiment, a computer-implemented method for providing a savings opportunity is disclosed. The method includes steps of receiving an authorization request from a merchant for a user transaction by a first remote computer, detecting a geographical location of a mobile device of the user and accessing, at the first remote computer, a user profile including a preferred currency for transactions. The method also includes analyzing, at the first remote computer, the authorization request to determine if the currency being used is different from the preferred currency for a savings opportunity indication, transmitting the savings opportunity indication to a second remote computer, matching, at the second remote computer, a savings opportunity from a database of savings opportunities to the user based on the savings opportunity indication and transmitting the matched savings opportunity to at least one of the user and the merchant via a physical device in close proximity to the at least one of the user and the merchant.

In embodiments, the geographical location of the mobile device of the user is determined via a GPS system or a telecommunications network. In an embodiment, the method includes matching the geographical location of the mobile device of the user with a location of the merchant. The method may also include denying the transaction if the geographical location of the mobile device of the user does not match a location of the merchant. The method may include filtering the savings opportunities in the database by a merchant-indicated condition. The merchant-indicated condition may be at least one of a location of the merchant/payment, a type of merchant, an amount of the payment, a good or service purchased, a date of the transaction, and a time of the transaction. The method may also include a step of transmitting a message from the user to at least one additional user in a different location from the user to share the matched savings opportunity, wherein sharing causes at least one of the first and second remote computers to generate a shared savings opportunity. In embodiments, the method may also include transmitting an indication to redeem the shared savings opportunity by the at least one additional user; and tracking the sharing and redemption of the shared savings opportunity. The method may also include receiving an indication to redeem the shared savings opportunity; and tracking the sharing and redemption of the shared savings opportunity. In an embodiment, the method may also include transmitting a response to the savings opportunity by a physical action of the user via the mobile device of the user. In some embodiments, the savings opportunity indication depends on the geographical location of the mobile device of the user. The matched savings opportunity is at least one of printed on a receipt, displayed on a merchant user interface, and displayed on a mobile device user interface.

In another embodiment, a computer-implemented method is disclosed. The method includes steps of receiving an authorization request from a merchant for a user transaction by a first remote computer, detecting a geographical location of a mobile device of the user and accessing, at the first remote computer, a user profile including a preferred currency for transactions. The method also includes steps of analyzing, at the first remote computer, the authorization request to determine if the currency being used is different from the preferred currency for a savings opportunity indication, transmitting the savings opportunity indication to a second remote computer, matching, at the second remote computer, a savings opportunity from a database of savings opportunities to the user based on the savings opportunity indication and transmitting the matched savings opportunity to the first remote computer for transmittal to at least one of the user and the merchant along with an authorization of the transaction.

In embodiments, the geographical location of the mobile device of the user is determined via a GPS system or a telecommunications network. The method may also include matching the geographical location of the mobile device of the user with a location of the merchant. The method may also include receiving a response to the matched savings opportunity from the user via a physical action of the user with the mobile device of the user. In embodiments, the method may also include filtering the savings opportunities in the database by one or more merchant-indicated conditions. The merchant-indicated condition may be at least one of a location of the merchant/payment, a type of merchant, an amount of the payment, a good or service purchased, a date of the transaction, and a time of the transaction. The method may also include receiving an indication from the user by at least one of the first and second remote computers for sharing the matched savings opportunity with at least one additional user, wherein sharing causes at least one of the first and second remote computers to generate a shared savings opportunity. In embodiments, the method includes detecting a geographical location of the at least one additional user. The geographical location of the at least one additional user is determined via a GPS system or a telecommunications network. In some embodiments, the shared savings opportunity indication depends on the geographical location of the mobile device of the user. The matched savings opportunity is at least one of printed on a receipt, displayed on a merchant user interface, and displayed on a mobile device user interface.

In an aspect, a computer-implemented method for providing a savings opportunity may include receiving an authorization request from a merchant for a user transaction by a first remote computer, accessing, at the first remote computer, a user profile including a preferred currency for transactions, analyzing, at the first remote computer, the authorization request to determine if the currency being used is different from the preferred currency for a savings opportunity indication, transmitting the savings opportunity indication to a second remote computer, matching, at the second remote computer, a savings opportunity from a database of savings opportunities to the user based on the savings opportunity indication, and returning the matched savings opportunity to the first remote computer for transmittal to at least one of the user and the merchant along with an authorization of the transaction. The savings opportunity is for use during the current transaction or for a future transaction, and may be automatically applied to the current transaction. The method may further include filtering the savings opportunities in the database by one or more merchant-indicated conditions. The merchant-indicated condition may be at least one of a location of the merchant/payment, a type of merchant, an amount of the payment, a good or service purchased, a date of the transaction, and a time of the transaction. The method may further include receiving an indication from the user by at least one of the first and second remote computers for sharing the matched savings opportunity with at least one additional user, wherein sharing causes at least one of the first and second remote computers to generate a shared savings opportunity. The method may further include receiving an indication to redeem the shared savings opportunity; and tracking the sharing and redemption of the shared savings opportunity. The method may further include presenting an indication to redeem the shared savings opportunity to the at least one additional user, and tracking the sharing and redemption of the shared savings opportunity. The indication to redeem the shared savings opportunity may be presented on a mobile device.

In an aspect, a computer-implemented method for providing an offer may include selecting at least one offer to present to a user by applying at least one rule dictated by a merchant to a set of offers to be provided to the user, applying at least one rule dictated by a financial institution to the set of offers, and applying a filter to identify offers with the highest likelihood of being accepted by the user. Then, the selected offer may be presented to the user. An authorization request from a merchant for a user transaction may be received by a remote computer and analyzed to determine one or more categories or sub-categories of the merchant or item in the transaction. Then, the system may determine if the selected offer is for a merchant or item in a related but different category from the one for which the authorization request was received. The system generates a reminder for the user of the selected offer if the selected offer is for a merchant or item in a related but different category from the one for which the authorization request was received and then transmits the reminder to the user. Presentation to the user may be done in a mobile notification. The method may further include accepting a like or dislike interaction for the selected offer from the user, and sharing the selected offer with at least one user of a social network when a like interaction is accepted, wherein sharing causes the remote computer to generate a shared offer. The method may further include receiving an indication to redeem the shared offer and tracking the sharing and redemption of the shared offer.

In an aspect, a method may include providing an executable script embedded in a graphical user interface of a user's financial account, using the executable script to gather transaction data from a user's financial account, wherein the user's financial account is a financial institution account that is maintained on behalf of the user, and analyzing the transaction data for transactions by the user. Based on the transaction data, selecting at least one offer to present to a user by applying at least one rule dictated by a merchant to a set of offers to be provided to the user, applying at least one rule dictated by a financial institution to the set of offers, and applying a filter to identify offers with the highest likelihood of being accepted by the user given the transaction data. Then, the selected offer may be presented to the user. An authorization request from a merchant for a user transaction may be received by a remote computer and analyzed to determine one or more categories or sub-categories of the merchant or item in the transaction. Then, the system may determine if the selected offer is for a merchant or item in a related but different category from the one for which the authorization request was received. The system generates a reminder for the user of the selected offer if the selected offer is for a merchant or item in a related but different category from the one for which the authorization request was received and then transmits the reminder to the user. The step of analyzing may include extracting at least one of a merchant name, a merchant category, a merchant location, a store number, a transaction amount, a transaction frequency, a zip code, a store category, a transaction description, and a total spending amount or analyzing the transaction data for transactions by the user relating to a merchant, a market segment, or a category. The user's financial account may be at least one of a credit card account, a bank account, a checking account, a savings account, a personal finance program account, and a loan account. The step of analyzing may include anonymizing the transaction data. Presentation to the user may be done in a mobile notification. The method may further include accepting a like or dislike interaction for the selected offer from the user, and sharing the selected offer with at least one user of a social network when a like interaction is accepted, wherein sharing causes the remote computer to generate a shared offer. The method may further include receiving an indication to redeem the shared offer and tracking the sharing and redemption of the shared offer.

In an aspect, a computer-implemented method for providing an offer may include receiving an authorization request by a remote computer from a first merchant for a user transaction for an item selected for purchase by a user, analyzing, using a programmed processor of the remote computer, the authorization request to determine a category of the merchant or a category of the item for which authorization is requested, searching in a remote database for at least one offer previously sent to the user from a provider in a related but different category from the category of goods or services of the item for which authorization is requested, searching in a remote database for at least one offer previously sent to the user from a provider in a related but different category from the category of the merchant from which the authorization is requested, generating a reminder to transmit to the user of the offer previously sent to the user for the merchant or item in the related but different category from the one for which the authorization request was received, and transmitting the reminder for presentation to the user. Presentation to the user may be done via a mobile notification. The offer previously sent to the user may be selected by: applying at least one rule dictated by at least one of the first merchant and a second merchant to a set of offers to be provided to the user, applying at least one rule dictated by a financial institution to the set of offers, and applying a filter to identify offers with the highest likelihood of being accepted by the user. The merchant may be the provider. The category of the merchant may include both a geographic location of the merchant and a type of product available from the merchant. The method may further include accepting a like or dislike interaction for the selected offer from the user, and sharing the selected offer with at least one user of a social network when a like interaction is accepted, wherein sharing causes the remote computer to generate a shared offer. The method may further include receiving an indication to redeem the shared offer and tracking the sharing and redemption of the shared offer.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a block diagram of a consumer service comparison shopping system.

FIG. 2 depicts a flow diagram for comparing alternative service offerings.

FIG. 3 depicts an alternative service offering model.

FIG. 4 depicts a flow diagram for comparing alternative credit card offerings.

FIG. 5 depicts a flow diagram for comparing alternative credit card offerings according to a value of rewards.

FIG. 6 depicts a flow diagram for comparing insurance policies.

FIG. 7 depicts a flow diagram for comparing alternative service offerings and performing a billing error analysis.

FIG. 8 depicts a flow diagram for determining a personalized true cost of service offerings.

FIG. 9 depicts a flow diagram of a process for normalizing user data.

FIG. 10 depicts a flow diagram of a process for generating a normalized service usage model.

FIG. 11 depicts a flow diagram of a method for comparing alternative wireless service offerings.

FIG. 12 depicts a flow diagram of a method for comparing savings account offerings.

FIG. 13 depicts a flow diagram of a method for comparing internet, television, and telephone service offerings.

FIG. 14 depicts a screenshot of a user account.

FIG. 15 depicts a wireless plan log in window.

FIG. 16 depicts a data import report window.

FIG. 17 depicts an alternative service plan recommendation window.

FIG. 18 depicts a screenshot of a user account.

FIG. 19 depicts a data entry window for a gasoline savings application of the system.

FIG. 20 depicts a map showing results of the gasoline savings application.

FIG. 21 depicts a screenshot of a user BillPay window.

FIG. 22 depicts a wireless plan log in window.

FIG. 23 depicts a data import report window.

FIG. 24 depicts a screenshot of a user account.

FIG. 25 depicts a deal purchase window.

FIG. 26 depicts a receipt for deal purchase.

FIG. 27 depicts a block diagram of the system.

FIG. 28 depicts a block diagram of a merchant categorization system.

FIG. 28A depicts a block diagram of a merchant categorization system.

FIG. 28B depicts an example merchant database.

FIG. 28C depicts an example merchant radix tree.

FIG. 28D depicts an example location database.

FIG. 28E depicts an example location radix tree.

FIG. 28F depicts an example of multilevel classification.

FIG. 29 depicts a method of the system.

FIG. 30 depicts example rewards redemptions.

FIG. 31 depicts an integrated bill analysis, with ‘like/dislike’ button.

FIG. 32 depicts an embodiment technology stack.

FIG. 33 depicts a welcome and login for an embodiment bank dashboard.

FIG. 34 depicts administration settings for an embodiment bank dashboard.

FIG. 35 depicts rewards controls for an embodiment bank dashboard.

FIG. 36 depicts user interface settings for an embodiment bank dashboard.

FIG. 37 depicts payment controls for an embodiment bank dashboard.

FIG. 38 depicts financial institution management for an embodiment bank dashboard.

FIG. 39 depicts an approve-deny window for financial institution management for an embodiment bank dashboard.

FIG. 40 depicts a reporting window in an embodiment bank dashboard.

FIG. 41 depicts a reporting window in an embodiment bank dashboard.

FIG. 42 depicts a reporting window in an embodiment bank dashboard

FIG. 43 depicts a customer service user lookup in an embodiment bank dashboard.

FIG. 44 depicts customer service contact for an embodiment bank dashboard.

FIG. 45 depicts a campaign window for creating a reward in an embodiment merchant dashboard.

FIG. 46 depicts a campaign window for targeting a reward in an embodiment merchant dashboard.

FIG. 47 depicts campaign performance in an embodiment merchant dashboard.

FIG. 48 depicts a reporting window in an embodiment merchant dashboard.

FIG. 49 depicts a reporting window in an embodiment merchant dashboard.

FIG. 50 depicts a reporting window in an embodiment merchant dashboard.

FIG. 51 depicts a reporting window with sales performance in an embodiment merchant dashboard.

FIG. 52 depicts a statement rewards embodiment.

FIG. 53 depicts a statement rewards embodiment.

FIG. 54 depicts a statement rewards embodiment.

FIG. 55 depicts a statement rewards embodiment.

FIG. 56 depicts a statement rewards embodiment.

FIG. 57 depicts a statement rewards embodiment.

FIG. 58 depicts a statement rewards embodiment.

FIG. 59 depicts a statement rewards embodiment.

FIG. 60 depicts a statement rewards embodiment.

FIGS. 61A-61D depict a mobile statement rewards embodiment.

FIGS. 62A-62B depict a mobile statement rewards embodiment.

FIGS. 63A-63B depict a mobile statement rewards embodiment.

FIG. 64 depicts a mobile statement rewards embodiment.

FIG. 65 depicts a predicted merchant's window.

FIG. 66 depicts a merchant level spending chart.

FIG. 67 depicts a geographic proximity spending chart.

FIG. 67A depicts an effectiveness graph.

FIGS. 67B and 67C depict flowcharts for methods of measuring effectiveness of user incentives or savings opportunities for groups of consumers.

FIG. 68 depicts a data driven personalized services platform.

FIG. 69 depicts an example of cross selling.

FIG. 70 depicts an example process for collecting financial transactional data from multiple sources.

FIG. 70A depicts an example process for collecting financial transactional data from multiple sources.

FIG. 71 depicts a method for processing large amounts of transactional data.

FIG. 71A depicts a method for processing large amounts of transactional data.

FIG. 72 depicts an example process for selecting a highest propensity customer offer.

FIG. 72B depicts customer models

FIG. 72C depicts evaluating purchase propensity

FIG. 73 depicts a demonstrative example of collecting financial transactional data

FIG. 74 depicts a demonstrative example of a variable extraction process

FIG. 75 depicts a demonstrative example of selecting the highest propensity offer for a specific customer.

FIG. 76 depicts a method of using market research to assist in identifying members of a demographic group using transaction data.

FIG. 77 depicts another method for using market research to assist in identifying members of a demographic group that merchants wish to contact.

FIG. 78 depicts a method for using market research and purchasing behavior to identify members of a demographic group merchants wish to contact;

FIG. 79 depicts a method for using market research and purchasing behavior to identify members of a demographic group merchants wish to contact via a Bayesian Belief Network;

FIG. 80 is a simplified Bayesian network to infer gender from transactions and external survey data; and

FIG. 81 is a sample Bayesian network to infer gender from transactions and external survey data.

FIG. 82 depicts a method of targeting users with a reward, offer, or incentive.

FIG. 83 depicts a method of targeting users with a reward, offer, or incentive.

FIG. 84 depicts a method of targeting users with a reward, offer, or incentive.

FIG. 85 depicts a method of providing offers for foreign transactions.

FIG. 86 depicts a method of providing offers for related categories.

### DETAILED DESCRIPTION

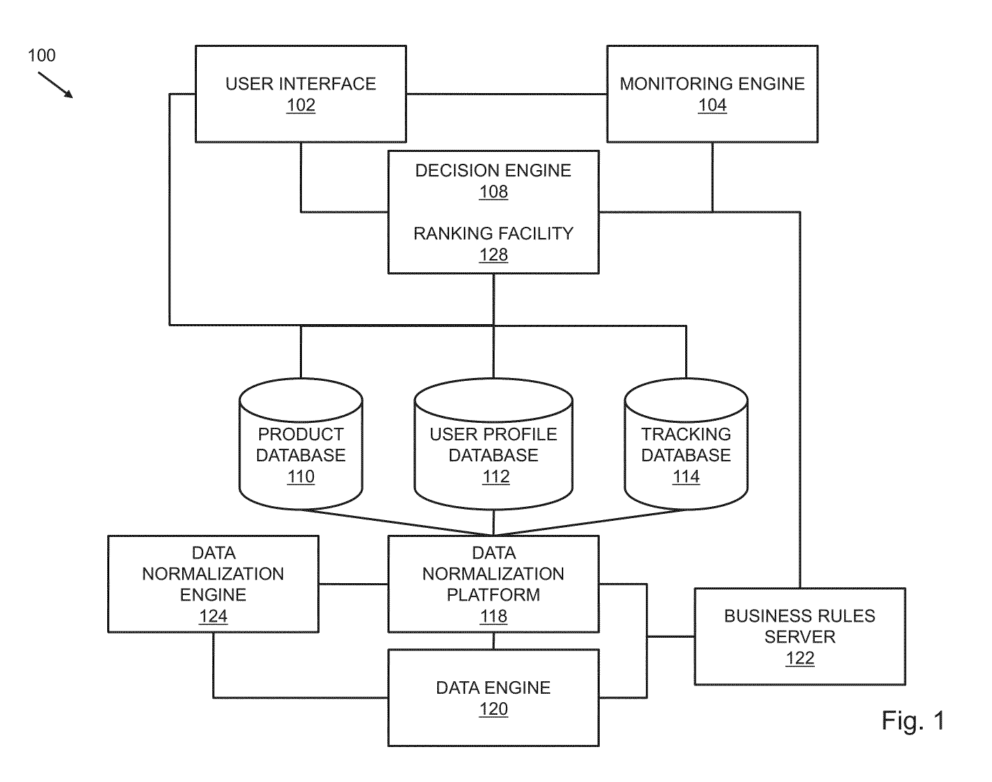

Referring to FIG. 1, an embodiment of a consumer service comparison shopping system 100 is depicted. Through the user interface 102, a user may access the decision engine 108 and monitoring engine 104. In an embodiment, the user interface 102 may be embodied in a website. The user may enter service usage data and preference data into a user profile database 112. For example, the data may include a geographical location, a current service provider, a current service cost, a current service usage, a predicted future service usage, preferences for future service, and other pertinent information. In an alternative embodiment, the data may be gathered automatically from the user's service provider by a data engine 120, such as by logging in to a user's service account after obtaining authorization from the user for release of such information. The data normalization platform 118 may normalize data obtained from the user and stored in the user profile database 112, data obtained about the user's service usage using the data engine 120, as well as alternative service offering data stored in a product database 110. A data normalization engine 124 may perform the normalization step. The decision engine 108 may utilize the usage and preference data from the consumer along with the business rules server 122 to determine how the user's needs, based on a previous or predicted future usage, and preferences match with alternate service offerings offered by various service providers. The decision engine 108 may organize the usage data based on the business rules server 122, and then determines how well each service offering fits the user based on one or more factors, such as total cost, per unit cost, service quality, and the like. The user may then be given the option to select an alternative service offering based on the recommendation by the decision engine 108. The user may be given the option to proceed to acceptance of terms and conditions as well as payment for services. In an embodiment, the monitoring engine 104 may repeat the process of obtaining and normalizing alternative service offering data and comparing it to the user's needs and preferences to determine on an updated basis which alternative service offering best fits the user's needs and preferences. The tracking criteria and output of the monitoring engine 104 may be stored in the tracking database 114. For example, the monitoring engine 104 may repeat the process when a new service offering becomes available, when a user's service usage changes, when a user moves to a new geographic location, when a user indicates a desire to do so, and the like. The user may be alerted when the process is repeated.

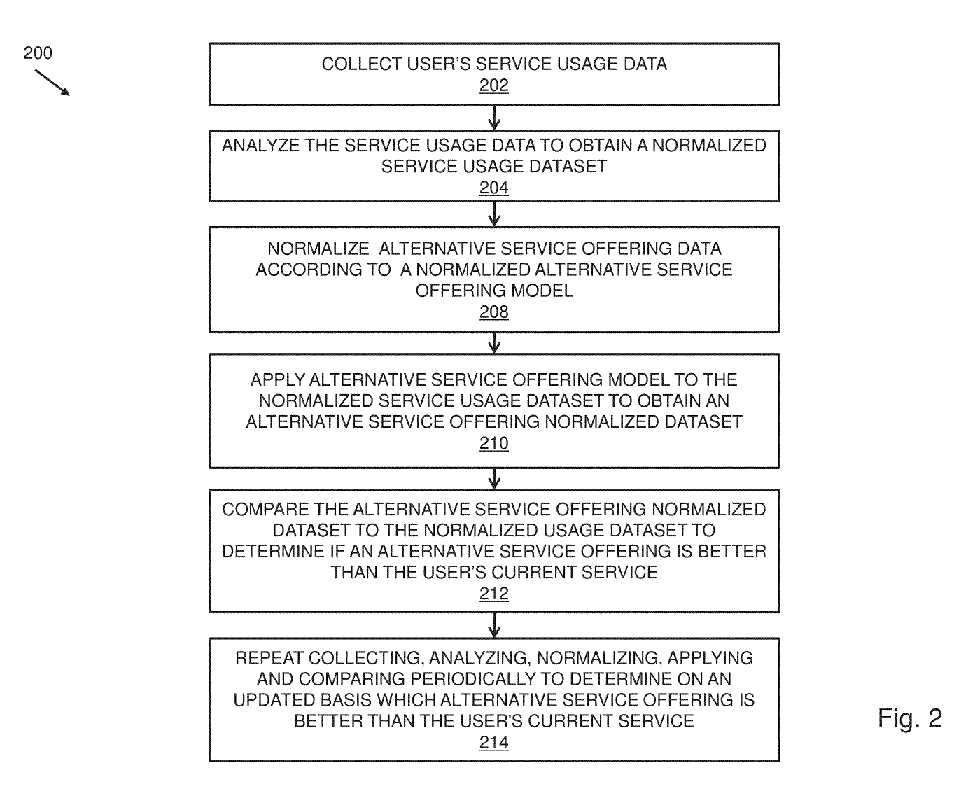

Referring now to FIG. 2, a method of comparing service plans based on a user's service usage data may include the steps of collecting service usage data for a user's current service using a computer implemented facility 202, analyzing the service usage data to obtain a normalized service usage dataset 204, optionally, normalizing data related to a plurality of alternative service offerings according to a normalized alternative service offering model 208, applying the normalized alternative service offering model to the normalized service usage dataset to produce a plurality of alternative service offering normalized datasets, wherein the dataset comprises at least the cost for the alternative service offering 210, comparing the alternative service offering normalized datasets to the normalized usage dataset to determine if an alternative service offering is better than the user's current service 212, and optionally, repeating said collecting, analyzing, normalizing, applying and comparing periodically to determine on an updated basis which alternative service offering is better than the user's current service 214. It should be understood that the methods and systems described herein may be applicable to any service plan, policy, or offering engaged in by a user. For example, the service offering may relate to wireless telephony, wireless data, internet service, hotel services, restaurant services, rental car services, loans, insurance services, auto loans, home loans, student loans, life insurance, home insurance, casualty insurance, auto insurance, motorcycle insurance, disability insurance, financial services, a credit card, a checking account, a savings account, a brokerage account, an insurance policy, utility service, personal finance management, residential fuel, automotive fuel, a gym membership, a security service, television programming, VoIP, long distance calling, international calling, utilities, termite services, pest services, moving services, identity theft protection services, travel services, software applications, and the like. For example, in the case where the service offering is travel services, the system 100 may obtain information about a user's previous travel, such as what hotels they have stayed at and what level of service is offered by the hotel, what level of service the user purchases for flights, what type of car the user has rented, if the user pre-purchases tour packages, and the like. When the user requests that the system determine a new travel offering, the system may search for accommodations based on at least one aspect of the user's previous travel. The user's previous travel may be analyzed to obtain a normalized travel service usage dataset which may be compared to an alternative service offering normalized dataset to determine a travel service offering for the user.

In an embodiment, collecting service usage data for a user's current service using a computer implemented facility 202 may comprise the service usage data being input manually by the user to the computer implemented facility. For example, using the user interface 102, a wireless service user may indicate their service usage data, such as how much they spend a month, how many anytime minutes they use, how many wireless lines they have, if they send text, video, or MMS messages, how frequently they message, their geographic locations of use, and the like. The service usage data may be for a current use, past use, or a predicted future use. The service usage data may relate to more than one service plan. In an embodiment, the service usage data may relate to a single service usage parameter. In an alternative embodiment, the service usage data may be obtained automatically, such as with a secure retrieval application. For example, the user may give permission for the data engine 120 to log into the user's service account and obtain the service usage data. In an embodiment, the service usage data are obtained from usage records or billing records, either current or historical. In some embodiments, the data engine 120 obtains a copy of a bill and processes it to obtain the service usage data. The service usage data may relate to more than one service plan. In an alternative embodiment, the service usage data are obtained from an application. For example, the application may be an online banking application, personal financial management software, a bill payment application, a check writing application, a logging application, a mobile phone usage logging application, a computer usage logging application, a browsing application, a search application, and the like. The service usage data may consist of average usage data over a specified period of time in the past. The service usage data may be obtained independent of a user's billing data.

In an embodiment, analyzing the service usage data to obtain a normalized service usage dataset 204 may comprise processing historical usage data to obtain an average normalized usage dataset. Alternatively, processing a single time period's usage data may be done to obtain a normalized usage dataset for that time period. Normalizing usage data may be done by sorting the data according to service-related data types used to define a data model. In an embodiment, the data are sorted according the same data types used in the normalized alternative service offering model to facilitate applying the normalized alternative service offering model to the usage data.

In an embodiment, normalizing data related to a plurality of alternative service offerings may be done according to a normalized alternative service offering model. The data engine 120 is programmed to extract data related to alternative service offerings from multiple sources, some of which may be human-generated. For example, the data engine 120 may be programmed to know the location of rate plan data on a wireless carrier's website. The data related to the plurality of alternative service offerings may be obtained from a data vendor, a human-assisted normalization system, public information sources, direct connections to service providers, and the like. The data then are normalized according to an alternative service offering model. Normalizing data related to the plurality of alternative service offerings may include defining a plurality of service usage-related data types, such as number of peak minutes available, number of nights and weekend minutes available, and the like, collecting parameters related to a service usage using the computer implemented facility, such as how many minutes were used during a particular time period, and normalizing the service parameters according to the defined service usage-related data types to generate a normalized alternative service offering model. The data engine 120 may sort all of the data it collects for each plan and its potential add-on's according to the normalized alternative service offering model. As the data are collected from various sources, it is integrated according to the normalized alternative service offering model. Normalization occurs via at least one of two methods, semantic normalization, syntactic normalization, and the like. In semantic normalization, a string of characters or set of words, phrases, number, and the like may be determined to mean something specific in the data model. Semantic normalization may be done by human encoding, where humans decide the semantic meaning, or may be done in an automated fashion. For example, the normalized alternative service offering model may have only a field for afternoon rates, but a provider's rate plan segments the day according to chunks of hours, such as from 1 pm-4 pm, and the like. The data normalization platform 118 may examine the data from the service provider and determine that the 1 pm-4 pm time period rate should be described as an afternoon rate in the normalized alternative service offering model. The assignment of the provider's rate time period to a particular field of the normalized alternative service offering model may only need to be done once in order for the data normalization platform 118 to know how to interpret the data every time it pulls data automatically, such as for updating, from the service provider. In syntactic normalization, the data normalization platform 118 possesses certain information to convert certain patterns to others. For example, the data normalization platform 118 can extract the 1 pm to 2 pm time period and assign it to Hour A, extract the 2 pm to 3 pm time period and assign it to Hour B, extract the 3 pm to 4 pm time period and assign it to Hour C, and so on. In an embodiment, the data may be enhanced or validated prior to normalization.

In an embodiment, a canonical model for the user data may be defined manually. Then, an agent, or data engine, may be defined or taught so it knows how to map data from a given source into the canonical model. The data engine may be automated from then on. The data engine is taught by a human how to read the data, then convert that into a global concept, such as a model of a cell phone bill. Then the data engine may be instructed to run on a specific item, such as a bill from VERIZON, to pull data and map the data to a canonical model.

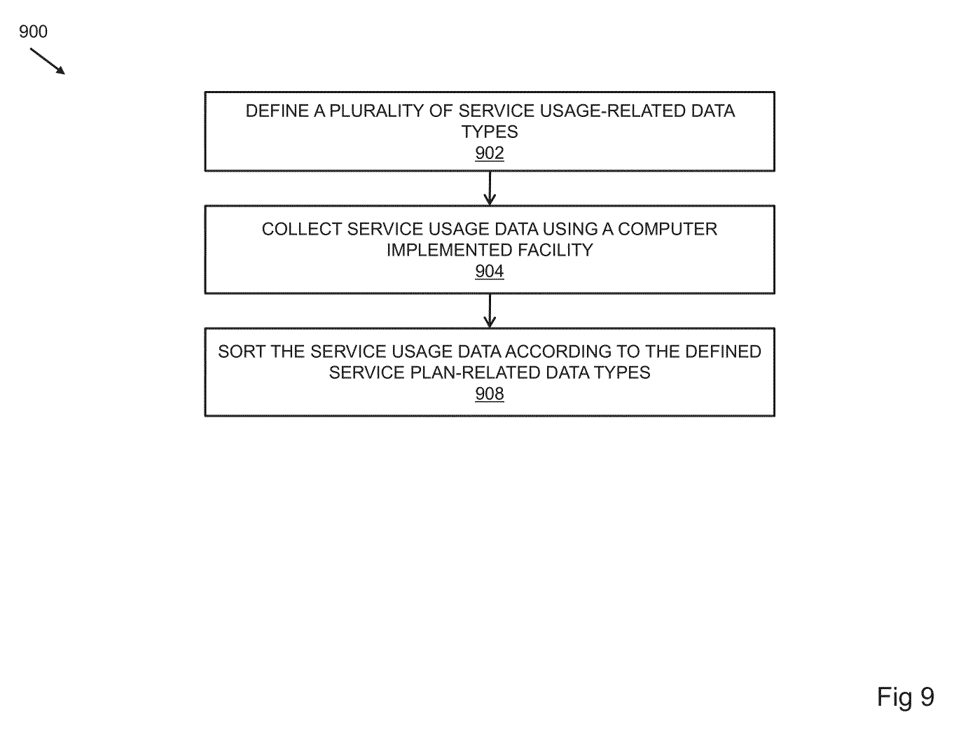

Referring to FIG. 9, a process for normalizing user data may include defining a plurality of service usage-related data types 902, collecting service usage data using a computer implemented facility 904, and sorting the service usage data according to the defined service plan-related data types 908.

In an embodiment, the business rules server 122 may enhance and/or validate the normalized data, either the normalized service usage dataset or the normalized alternative service offering dataset, and/or the normalized alternative service offering model. Rules may be applied to the datasets or model, such as rules regarding a given vertical, rules based on facts about a rate plan, add-on's, phones or devices, their relative importance in determining the best plan or an aggregate score, information about the user, information about similar users, and the like. The business rules server 122 may verify that the datasets and/or model fit known facts and heuristics stored in the business rules server 122.

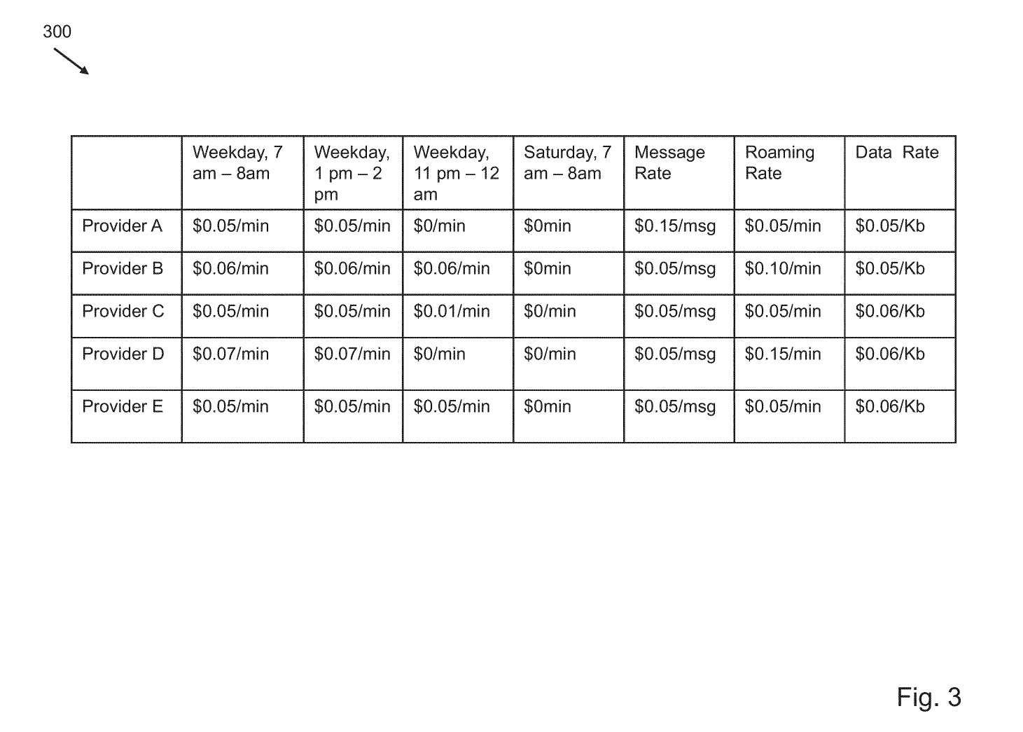

In an embodiment, producing a plurality of alternative service offering normalized datasets may comprise applying the normalized alternative service offering model to the normalized service usage dataset. In some embodiments, the alternative service offering normalized datasets comprise at least the cost for the alternative service offering. The normalized alternative service offering model is applied to the normalized service usage dataset in order to determine what the cost of a particular alternative service offering would be given the user's service usage. For example, the normalized alternative service offering model may be envisioned as a matrix 300. For example, in FIG. 3, an embodiment of a model in the form of a matrix is shown. In this example and without limitation, the model is for wireless plans and comprises a Weekday, 7 am-8 am rate, a Weekday, 1 pm-2 pm, a Weekday, 11 pm-12 am rate, a Saturday 7 am-8 am rate, a messaging rate, a roaming rate, and a data rate. A person of skill in the art will understand that the model may include any defined data types, such as data by the hour, by ranges of time, by day, by weekend, and the like. Data may be acquired from each provider with regard to what their rates are during the defined time periods. For example, Provider A's Weekday, 7 am-8 am rate is $0.05/min while Provider D's is $0.07/min. The message rate for Provider A is $0.15/msg while Provider D's is $0.05/msg.

In an embodiment, determining if an alternative service offering is better than the user's current service may comprise comparing the alternative service offering normalized datasets to the normalized usage dataset. Applying the model to the usage data may comprise the decision engine 108 multiplying the number of minutes or messages used during the time period by the rate during the time period. If the data normalization platform 118 determined that 100 calls were made during the Weekday 7 am-8 am time period and the user sent and/or received 100 text messages, the cost for the Current Provider A, if only these two data types were considered, would be $20 while Provider D would be $12. The decision engine 108 may determine that given the user's service usage, the service offering from Provider D may be a better fit to the user given the lower cost. In an alternative embodiment, the data engine 120 may have pulled additional information, such as the opportunity to purchase an unlimited message plan, and placed it in the matrix 300. Therefore, when the model is applied to the service usage data, the decision engine 108 may perform an optimization with respect to messaging, calculating if it is cheaper to go with the pay-as-you-go plan or getting unlimited messaging. Continuing with the above example, if Current Provider A offered a flat rate for messaging of $5 per month while Provider D only offered the pay-per-message rate structure, the decision engine 108 optimization may result in Current Provider A offering the service offering with the better fit to the user given the lower cost of Current Provider A's service ($10) versus Provider D's service ($12). In this case, the user may be advised to not change their service provider but perhaps ask the provider to add on the flat message rate feature.

Cost may be only one component in determining if an alternative service offering is better than the user's current service. User preference, signal strength, terms and conditions, and the like may all be components of determining if an alternative service offering is better than the user's current service. In an embodiment, the decision engine 108 may perform a personalized impact analysis. The decision engine 108 may compute an aggregate score for each alternative service offering normalized dataset. For example, when the service offering is a wireless service, the aggregate score may include a normalization of the alternative service offering savings and signal strength. In an example, the data engine 120 may extract usage information then map the usage onto a wireless plan. In embodiments, the wireless plan may also have optional add-ons and Terms & Conditions added into the calculation for aggregate score. For any given service, the decision engine 108 may be able to select the best possible option from a range of service plans. Then, the decision engine 108 may be able to select optimal add-on's to achieve the lowest impact, or the best aggregate score. In embodiments, the user may be able to specify what criteria to include in the aggregate score calculation. In the case of wireless plans, wireless coverage or signal strength may also be a component of the aggregate score. Individual scores attributed to components of the service may be added together, often in a non-trivial formula, to weight them and come up with an aggregate score. For example, a score may be assigned to terms and conditions, a score may be assigned to signal strength, a score may be assigned to savings over a current service plan, and the like. Users may be able to set the weighting, such as with a slider or manually. Alternatively, certain assumptions may be made in providing an automatic weighting. Assumptions may be provided and stored on the business rules server 122.

The aggregate score may include cost and at least one other element. The other element may be selected from the group consisting of total cost, per unit cost, savings, and service quality. The instruction may further include collecting data points about the service offering and calculating the aggregate score based on those data points. The data points may be identified in the terms and conditions of the service offering. The data points may be in declarations related to the service offering.

In an embodiment, once an aggregate score is calculated, the alternative service plans may be ranked, such as according to aggregate score, according to savings, according to signal strength, according to a combination of the above, and the like, in order to compare the various alternative service plans. In some embodiments, the aggregate score may be plotted according to the overall cost of the service plan. In some embodiments, comparing service plans includes ranking the alternative service offerings according to total costs, per unit costs, and service quality or signal strength.

In an embodiment, after comparing service plans, the user may have the option to purchase a service plan or contact a current service provider in order to modify their current service.

In an embodiment, at any point during the process of collecting 202, analyzing 204, normalizing 208, applying 210 and comparing 212, an advertisement may be presented to the user, wherein the advertisement is selected based on an alternative service offering.

In an embodiment, the system 100 may repeat 214 the steps of collecting 202, analyzing 204, normalizing 208, applying 210 and comparing 212 periodically to determine on an updated basis which alternative service offering is better than the user's current service. The user may be alerted when an alternative service offering that is better than the user's current service is available, such as by email, phone, SMS, MMS, and the like. The repetition interval may be set by the user or may be a pre-determined system 100 interval. The user may also be alerted that the repetition 214 is occurring.

In an embodiment, the user may be a business entity.

In an embodiment, when the service offering is a wireless service offering, the service usage data and data related to the alternative service offering may relate to at least one of plan definitions, add-on's, carrier coverage networks, cost, included minutes, plan capacity, additional line cost, anytime minutes, mobile-to-mobile minutes, minutes overage, nights & weekends minutes, nights start, nights end, roaming minutes, peak/off-peak minutes, data/downloads/applications charges, data overages, data megabytes used/unused, most frequently called numbers, most frequently called locations, networks/carriers called, calls per day, time of day usage, day of week usage, day of month usage, overages, unused services, carrier charges, messaging, messaging overage, activation fees, early termination fees, payment preferences, carrier, current hardware, compatible hardware, hardware availability, coverage area, signal strength, included services, caller ID block, call waiting, call forwarding, caller ID, voicemail, visual voicemail, 3-way calling, insurance, at least one wireless service related item. and the like. Any of the aforementioned service usage data types may be used to calculate an aggregate score, in comparing service offerings, in ranking service offerings, and the like.

In an embodiment, when the service offering is a credit card service, the service usage data and data related to the alternative service offering may relate to at least one of monthly spending, spending categories, credit rating, current credit card, years of use of credit card, current balance, monthly pay-off amount, current APR, pay off every month, carry a balance, sign-up bonus, bonus rewards, base earning rate, maximum earning rate, earning limit, total value of rewards, earned program promotions, spend program promotions, net asset promotions, annual fee, late fee, balance transfer fee, cash advance fee, purchases APR, introductory APR, regular APR, penalty APR, balance transfer APR, cash advance APR, typical redemptions, redemption options, rewards type, credit card network, credit card issuer, features and benefits, at least one credit card related item and the like. For example, typical redemptions may include domestic airfare, international airfare, car rentals, cash rebates, charitable donations, consumer electronics, cruises, hotel stays, restaurants, shopping, and the like. The redemption may relate to an item of value, a service, and a class of services. The class of services may be one of first class, business class, coach class, and premium class.

A user may weigh the availability of domestic airfare redemption options higher than the option of receiving a cash rebate, and the weighting may be used to rank credit card offerings accordingly. In another example, the rewards type may be at least one of cash, points, certificates, vouchers, discounts, and miles. In another example, the features and benefits may include at least one of instant approval, no annual fee, secured card, no fraud liability, 24 hr. customer service, airport lounge access, auto rental insurance, concierge service, emergency replacement, extended warranty, online account management, photo security, price protection, purchase protection, return protection, roadside assistance, travel insurance, and the like. Any of the aforementioned credit card data types may be used to calculate an aggregate score, in comparing credit card offerings, in ranking credit card offerings, and the like.

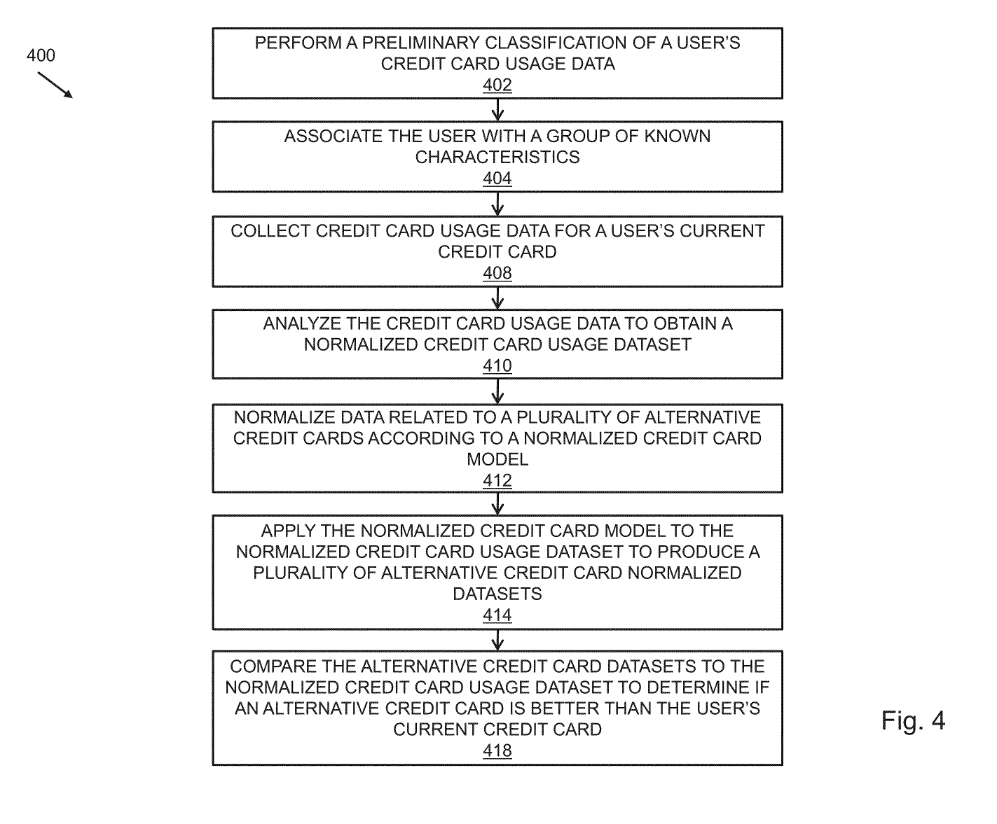

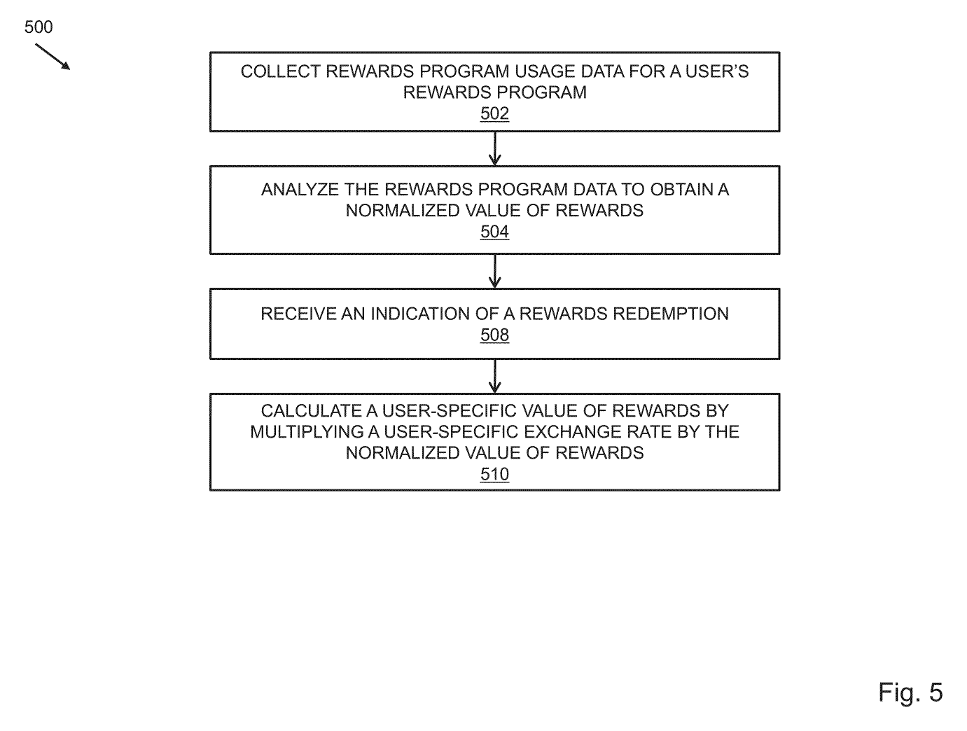

Referring now to FIG. 4, in embodiments, the service offering may be a credit card offering. When the service offering is a credit card offering, a preliminary classification of a user's credit card usage data 402 may be performed to associate the user with a group of known characteristics 404. For example, the group may be those that pay their credit cards off every month, those that carry a balance, and the like. In an example, if the user pays off their balance every month, the credit card usage data collected in subsequent steps may include monthly spending, credit rating, categories of spending, current credit card, number of years holding current credit card, and the like. In another example, if the user does not pay off their balance every month, the credit card usage data collected may be monthly spending, credit rating, categories of spending, current credit card, number of years holding current credit card, existing balance, interest rate, late payments, monthly payment, and the like. After associating the user with a group of known characteristics 404, credit card usage data may be collected for a user's current credit card 408 using a computer implemented facility according to the preliminary classification. The credit card usage data may be analyzed to obtain a normalized credit card usage dataset 410. Analyzing may include processing historical usage data to obtain an average normalized usage dataset, processing a single time period's usage data to obtain a normalized usage dataset for that time period, and the like. Data related to a plurality of alternative credit cards may be normalized according to a normalized credit card model 412. Normalizing data related to the plurality of alternative credit cards may include defining a plurality of credit card usage-related data types, collecting parameters related to a credit card usage using the computer implemented facility, and normalizing the credit card parameters according to the defined credit card usage-related data types to generate a normalized alternative credit card model. Then, the normalized credit card model may be applied to the normalized credit card usage dataset to produce a plurality of alternative credit card normalized datasets 414. A comparison of the alternative credit card datasets with the normalized credit card usage dataset may reveal if an alternative credit card is better than the user's current credit card 418. Comparing may include ranking the alternative credit cards according to an aggregate score calculated for the alternative credit card normalized dataset, an aspect of the alternative credit card normalized dataset, and the like. In an embodiment of comparing, the aggregate score may be plotted against the cost for the alternative credit card. The aspect may be the total card cost, a value of rewards, an additional earnings over the user's current credit card, a savings over the user's current credit card, at least one of an introductory purchase APR, an introductory rate period, a purchase APR, an annual fee, a balance transfer fee, and a credit level required, at least one of a reward type, a rewards sign-up bonus, a base earning rate, a maximum earning rate, and an earnings limit, and the like. As described previously, an aggregate score for each of the plurality of alternative credit card normalized datasets may be calculated, where the score may be used for ranking. As described previously, users may specify which components of the dataset or terms & conditions to include in the calculation for the aggregate score and with what weighting to include them. Credit card data, both usage and alternative credit cards, may be obtained from public information sources, direct connections to credit card providers, automatically, input manually by the user to a computer implemented facility for a current card usage or predicted future credit card usage, chosen by a user from among a sampling of standard credit card profiles, for multiple credit cards, and the like. In some embodiments, credit card usage data may be obtained by the data engine 120 in a computer readable format, such as in a billing record. The billing record may be for a current bill only, may be historical billing data, may be a paper bill, an electronic bill, and the like. Once the user may have compared various credit card offerings, they may be provided the option of applying for a selected credit card, contact a current credit card provider in order to modify their current credit card terms and conditions, and the like.

In an embodiment, at any point during the process of performing 402, associating 404, collecting 408, analyzing 410, normalizing 412, applying 414 and comparing 418, an advertisement may be presented to the user, wherein the advertisement is selected based on an alternative service offering.

In an embodiment, the system 100 may repeat the steps of performing 402, associating 404, collecting 408, analyzing 410, normalizing 412, applying 414 and comparing 418 periodically to determine on an updated basis which alternative service offering is better than the user's current service. The user may be alerted when an alternative service offering that is better than the user's current service is available, such as by email, phone, SMS, MMS, and the like. The repetition interval may be set by the user or may be a pre-determined system 100 interval. The user may also be alerted that the repetition is occurring.

In an embodiment, the user may be a business entity.

In an embodiment, the credit card usage data and data related to the alternative credit card may relate to at least one of monthly spending, spending categories, credit rating, current credit card, years of use of credit card, current balance, monthly pay-off amount, current APR, pay off every month, carry a balance, sign-up bonus, bonus rewards, base earning rate, maximum earning rate, earning limit, total value of rewards, earned program promotions, spend program promotions, net asset promotions, annual fee, late fee, balance transfer fee, cash advance fee, purchases APR, introductory APR, regular APR, penalty APR, balance transfer APR, cash advance APR, typical redemptions, redemption options, rewards type, credit card network, credit card issuer, features and benefits, and the like. For example, typical redemptions may be for domestic airfare, international airfare, car rentals, cash, charitable donations, consumer electronics, cruises, hotel stays, restaurants, and shopping. The rewards type may be one of cash, points, and/or miles. The features and benefits may include at least one of instant approval, no annual fee, secured card, no fraud liability, 24 hr. customer service, airport lounge access, auto rental insurance, concierge service, emergency replacement, extended warranty, online account management, photo security, price protection, purchase protection, return protection, roadside assistance, travel insurance, and the like.

In an alternative embodiment, credit card usage data may be analyzed to obtain a value of rewards. For example, credit card usage data for a user's current credit card may be collected 502, such as by using a computer implemented facility. Then the data may be analyzed to obtain a value of rewards 504. An indication of a rewards redemption may be received 508. A user-specific value of rewards may be calculated by multiplying a user-specific exchange rate by the normalized value of rewards 510. In addition to the rewards program data described herein, information related to calculating a value of rewards may also be collected 502. Analyzing 504 may include processing historical usage data to obtain an average value of rewards, processing a single time period's usage data to obtain a value of rewards for that time period, and the like. The exchange rate may relate to the currency system of the user's country or a different country. The system 1000 may automatically compare the value of rewards in different currencies because the system 100 may be able to convert the value of a reward point to a dollar in a personalized way. The personalized exchange rate for you may depend on what the user wants to redeem the points for. For example, redemption outside the user's country might have much more value than redemption inside the user's country. In the example, a user might get as much as 4 cents per point as compared to 0.5 cents per point depending on what, and where, the user redeems the points. Certain currencies, for example, may be more valuable to one user when compared to another user.

In an embodiment, the system 100 may repeat the steps of collecting 502, analyzing 504, receiving 508, and calculating 510 periodically to determine on an updated basis a user-specific value of rewards. The user may be alerted when a reward of a different or particular value is available, such as by email, phone, SMS, MMS, and the like. The repetition interval may be set by the user or may be a pre-determined system 100 interval. The user may also be alerted that the repetition is occurring.

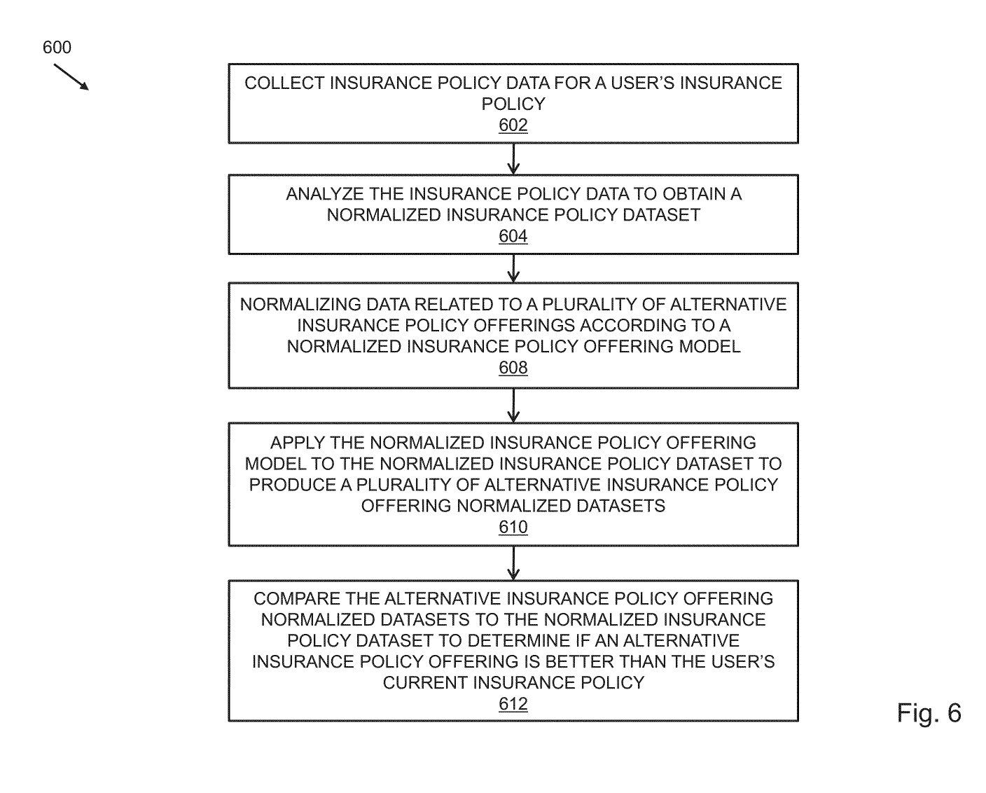

Referring to FIG. 6, when the service offering relates to an insurance policy, data for a user's current insurance policy may be collected using a computer implemented facility 602. The insurance policy may be at least one of life insurance, auto insurance, health insurance, disability insurance, home insurance, and renter's insurance. Then, the insurance policy data may be analyzed to obtain a normalized insurance policy dataset 604. Analyzing may include processing historical insurance policy data to obtain a normalized insurance policy dataset that represents an average dataset, or processing a single time period's insurance policy data to obtain a normalized insurance policy dataset for that time period. Data related to a plurality of alternative insurance policy offerings may be normalized according to a normalized insurance policy offering model 608. Normalizing data related to the plurality of insurance policy offerings may include defining a plurality of insurance policy-related data types, collecting parameters related to an insurance policy using the computer implemented facility, and normalizing the insurance policy parameters according to the defined insurance policy-related data types to generate a normalized alternative insurance policy offering model. The normalized insurance policy offering model may be applied to the normalized insurance policy dataset to produce a plurality of alternative insurance policy offering normalized datasets 610. Then, the alternative insurance policy offering normalized datasets may be compared with the normalized insurance policy dataset to determine if an alternative insurance policy offering is better than the user's current insurance policy 612. Comparing may include ranking the alternative insurance policy offerings according to cost, plotting the cost versus an aggregate score calculated for the alternative insurance policy, ranking the alternative insurance policy offerings according to an aspect of the alternative insurance policy offering normalized dataset, ranking the alternative insurance policy offerings according to cost and an aspect of the alternative insurance policy offering normalized dataset, and the like. Insurance policy data may include at least one of policy terms and conditions, policy cost, policy benefits, claims made against existing or recent policies, location of residence, make, model, and age of automobiles, driving records of insured parties, length of stay at current residence and employment or school, desired automobile, preference for future residence, policy features such as towing services property tax information, property value information, a driving record, property tax information, and the like. Insurance policy data may be input manually by the user to the computer implemented facility, may be a predicted future usage, may be automatically collected by the computer implemented facility, may include comprise billing records, may be automatically collected by the computer implemented facility from at least one of an insurer and a government agency, and the like. The billing records may be for a current bill only, historical billing data, a paper bill, and the like. In an embodiment, the program instructions further include analyzing the terms and conditions, calculating an aggregate score for the terms and conditions, and adding the aggregate score to the aggregate score for the normalized usage dataset or alternative insurance policy offering normalized dataset. In an embodiment, the program instructions further include calculating an aggregate score for each of the plurality of alternative insurance policy offering normalized datasets. In an embodiment, the program instructions further include ranking the plurality of alternative insurance policy offering normalized datasets based on the aggregate score. The user may specify which aspects of the alternative insurance policy offering normalized dataset to include in the aggregate score. In an embodiment, the system 100 may repeat the steps of collecting 602, analyzing 604, normalizing 608, applying 610 and comparing 612 periodically to determine on an updated basis which alternative insurance policy is better than the user's current insurance policy. The user may be alerted when an alternative insurance policy that is better than the user's current insurance policy is available, such as by email, phone, SMS, MMS, and the like. The repetition interval may be set by the user or may be a pre-determined system 100 interval. The user may also be alerted that the repetition is occurring. In an embodiment, the user may be a business entity. After the program instructions have been completed, the user may have the option to purchase a selected insurance policy offering, contact a current insurance policy provider in order to modify their current insurance policy, and the like. In an embodiment, an advertisement may be presented to the user, wherein the advertisement is selected based on an alternative insurance policy offering.

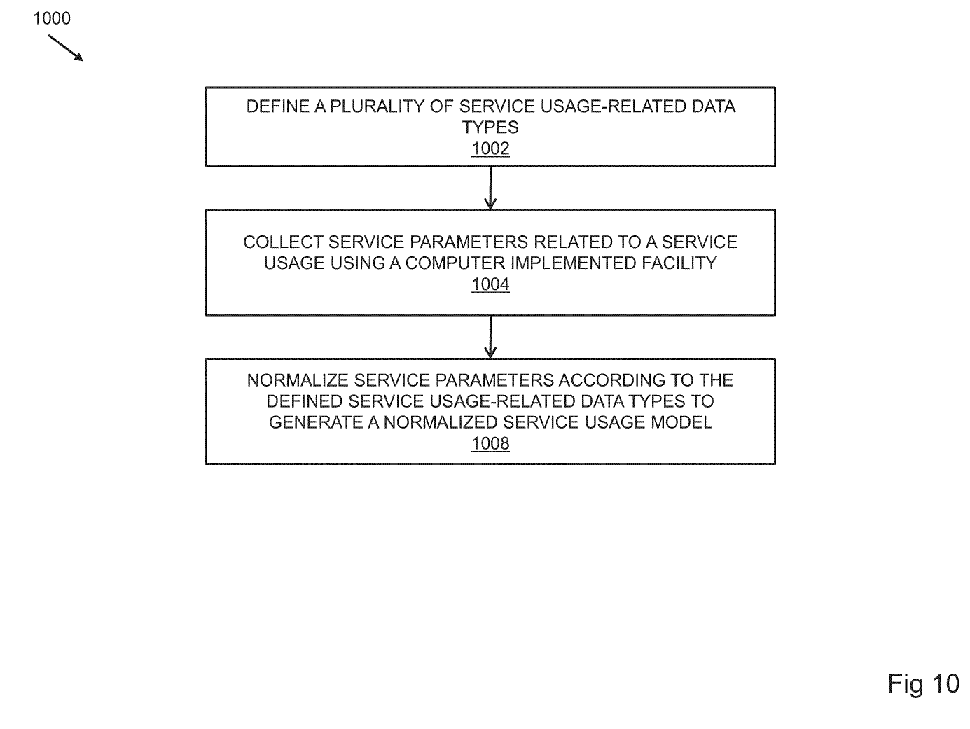

In an embodiment, a data normalization platform 118 for generating a normalized service usage model may include a business rules server 122 for storing the definitions of a plurality of service usage-related data types, a data engine 120 for collecting service parameters related to a service usage using a computer implemented facility, and a data normalization engine 124 for normalizing the service parameters according to the defined service usage-related data types to generate a normalized service usage model. In FIG. 10, a flow diagram of a process for generating the normalized service usage model is shown. In the process, a plurality of service usage-related data types are defined 1002. Then, service parameters related to a service usage are collected using a computer implemented facility 1004. The service parameters are then normalized according to the defined service usage-related data types to generate a normalized service usage model 1008. The entire process may be repeated periodically to update the normalized service usage model. The data engine 120 and the data normalization engine 124 may repeat said collecting and normalizing periodically to determine the normalized service usage model on an updated basis. The parameters related to a service usage may be obtained from public information sources. The public information source may be a data feed file. The public information source may be a web crawl. The parameters related to a service usage may be obtained through direct connections to utility service providers, may be supplied, may be extracted, may be input manually by the user to the computer implemented facility, and the like. The business rules server 122 may prioritize the service usage-related data types prior to normalizing. The service parameter may be a user review. The service parameter may be an adoption rate.

In an embodiment, estimating the cost of an alternative service may include a decision engine 108 for applying a normalized alternative service offering model to a normalized service usage dataset to produce a plurality of alternative service offering normalized datasets, and a ranking facility 128 for comparing the alternative service offering normalized datasets to the normalized usage dataset to determine if an alternative service offering is better than the user's current service. In embodiments, the ranking facility 128 may be an integral part of the decision engine 108. The ranking facility 128 may optionally consider weights of certain dataset factors in comparing datasets. The ranking facility 128 may compare datasets based on cost. The cost may be the cost of the service offering. The cost may be a monthly savings over an existing service. The cost may be an annual savings over an existing service. The ranking facility 128 may compare datasets based on cost plus another factor. The factors may be weighted by a user. The factors may be assigned a score. The score may be based on relevance to personal usage. The ranking facility 128 may compare datasets based on a calculated score. The score may be based on relevance to personal usage. The ranking facility 128 may compare datasets based on rewards associated with a credit card offering.

In an embodiment, the system may include a user-interface 102 for performing a comparison of services, receiving input from a user regarding a user's current service usage, wherein the service usage data may be analyzed to obtain a normalized usage dataset, and enabling the user to review a plurality of alternative service offering normalized datasets generated by application of a normalized alternative service offering model to a normalized service usage dataset. The input may be a usage history provided by a user manually. The input may be login information required to automatically acquire a billing record from a service provider or third-party billing agent.

In an embodiment, comparing service offerings may include a business rules server 122 for storing the definitions of a plurality of service usage-related data types, a data engine 120 for collecting service parameters related to a service usage using a computer implemented facility, a data normalization engine 124 for normalizing the service parameters according to the defined service usage-related data types to generate a normalized service usage model for alternative service offerings and a normalized service usage dataset for a user's current service, a decision engine 108 for applying a normalized service usage model to the normalized service usage dataset to produce a plurality of alternative service offering normalized datasets, and a ranking facility 128 for comparing the alternative service offering normalized datasets to the normalized usage dataset to determine if an alternative service offering is better than the user's current service. A monitoring engine 104 may cause the system 100 to periodically compare service offerings to determine on an updated basis which alternative service offering is better than the user's current service. The normalized service usage model may be stored in a product database 110. The normalized service usage dataset may be stored in a user profile database 112. The results from comparing may be stored in a tracking database 114.

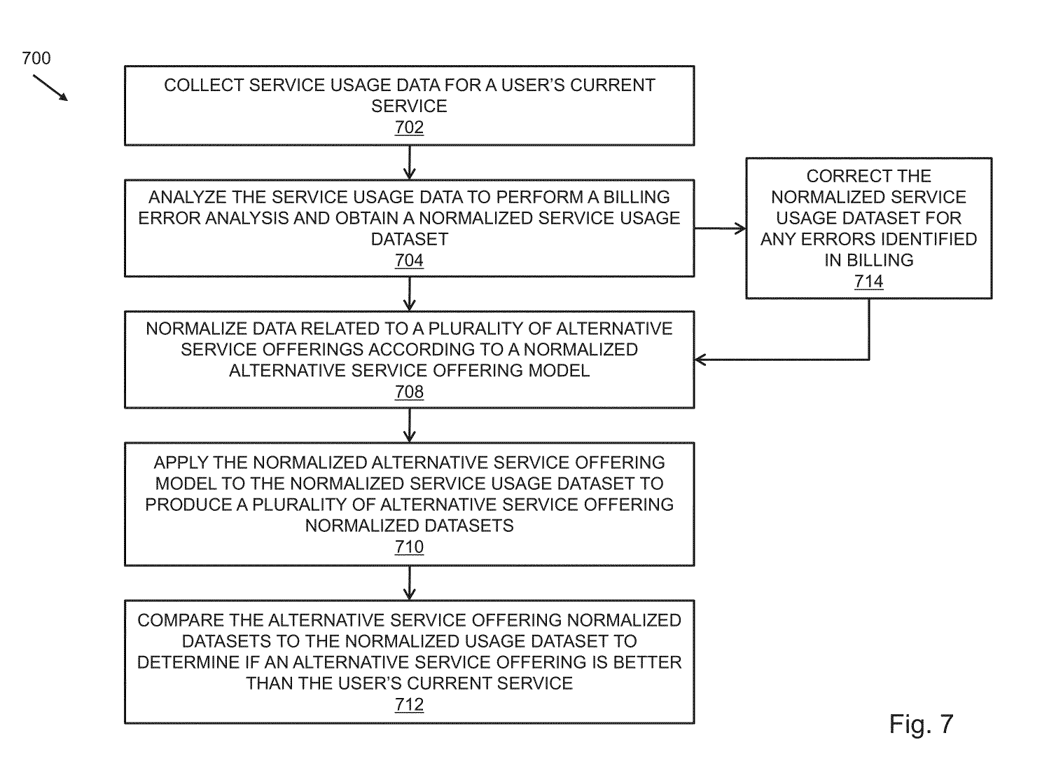

In an embodiment, referring to FIG. 7, the system 100 may collect service usage data for a user's current service using a computer implemented facility 702, analyze the service usage data to perform a billing error analysis and obtain a normalized service usage dataset 704, wherein the normalized service usage dataset may be optionally corrected for any errors identified in billing 714, normalize data related to a plurality of alternative service offerings according to a normalized alternative service offering model 708, apply the normalized alternative service offering model to the normalized service usage dataset to produce a plurality of alternative service offering normalized datasets 710, and compare the alternative service offering normalized datasets to the normalized usage dataset to determine if an alternative service offering is better than the user's current service 712. A service provider may be notified of an error in billing if an error is identified in analyzing the service usage data.

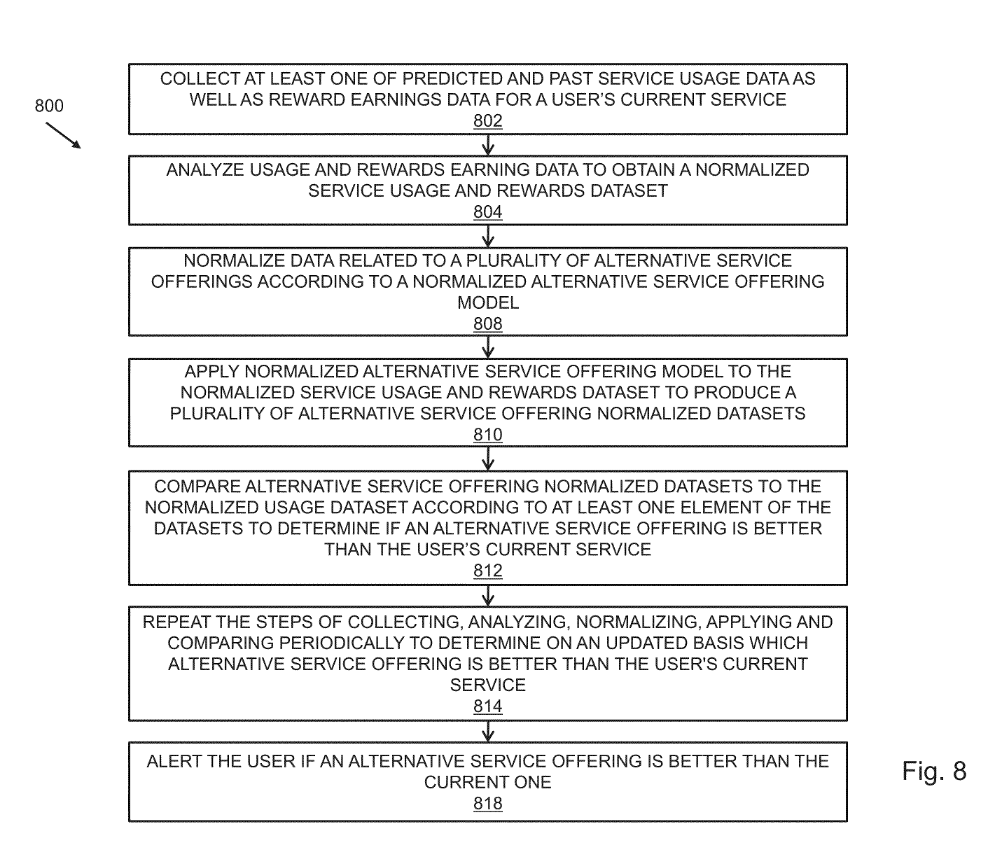

Referring to FIG. 8, the system 100 may provide a system, method, and medium of determining a personalized true cost of service offerings. A personalized cost of a service offering may be calculated for an individual based on your past and/or predicted usage data. The true cost, or impact, of ownership, such as the net cost including rewards and the like, may be quantifiable and unique to each offering. The system 100 may repeat the quantification periodically to alert users of a changed cost/impact when a new offer becomes available or when usage data changes. The system 100 may collect at least one of predicted and past service usage data as well as reward earnings data for a user's current service 802. The usage and rewards earning data may be analyzed to obtain a normalized service usage and rewards dataset 804. Optionally, data related to a plurality of alternative service offerings may be normalized according to a normalized alternative service offering model 808. Alternatively, the data normalized according to a normalized alternative service offering model may be purchased from a third party data provider. The normalized alternative service offering model may be applied to the normalized service usage and rewards dataset to produce a plurality of alternative service offering normalized datasets 810. Finally, the alternative service offering normalized datasets may be compared to the normalized usage dataset according to at least one element of the datasets to determine if an alternative service offering is better than the user's current service 812. The system 100 may repeat the steps of collecting, analyzing, normalizing, applying and comparing periodically to determine on an updated basis which alternative service offering is better than the user's current service 814. Additionally, if the system 100 determines that an alternative service offering is better than the current one, the user may be alerted 818.

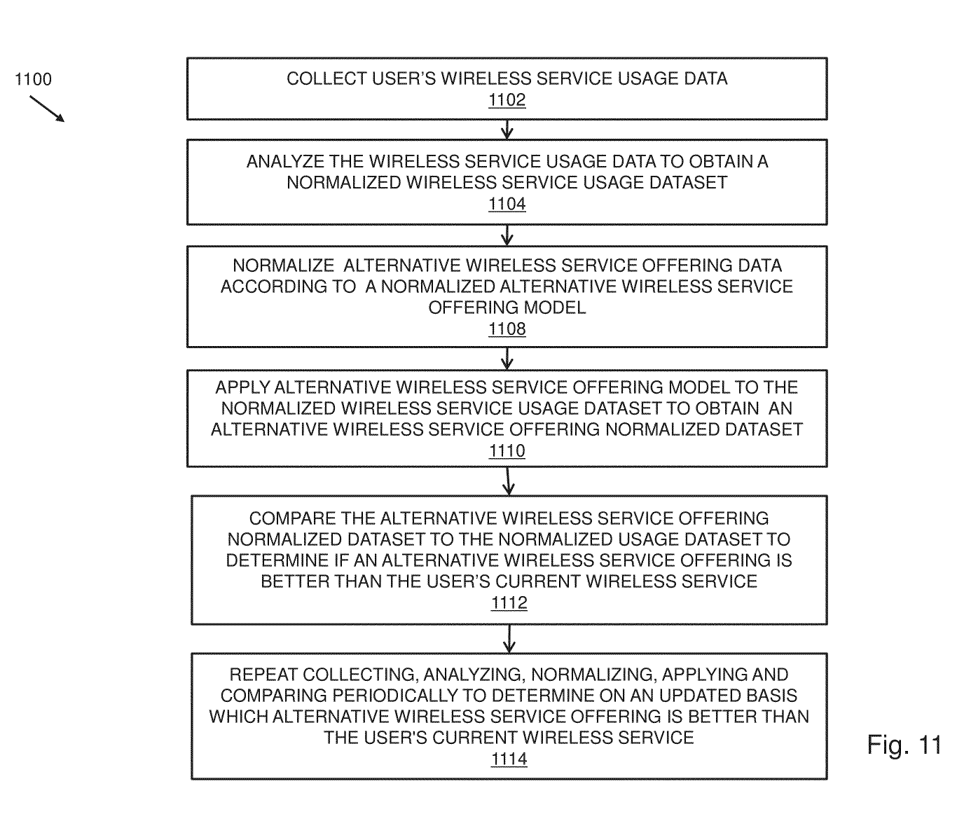

Referring now to FIG. 11, a method of comparing wireless service plans based on a user's wireless service usage data may include the steps of collecting wireless service usage data for a user's current wireless service using a computer implemented facility 1102, analyzing the wireless service usage data to obtain a normalized wireless service usage dataset 1104, optionally, normalizing data related to a plurality of alternative wireless service offerings according to a normalized alternative wireless service offering model 1108, applying the normalized alternative wireless service offering model to the normalized wireless service usage dataset to produce a plurality of alternative wireless service offering normalized datasets, wherein the dataset comprises at least the cost for the alternative service offering 1110, comparing the alternative wireless service offering normalized datasets to the normalized usage dataset to determine if an alternative wireless service offering is better than the user's current wireless service 1112, and optionally, repeating said collecting, analyzing, normalizing, applying and comparing periodically to determine on an updated basis which alternative wireless service offering is better than the user's current wireless service 1114.

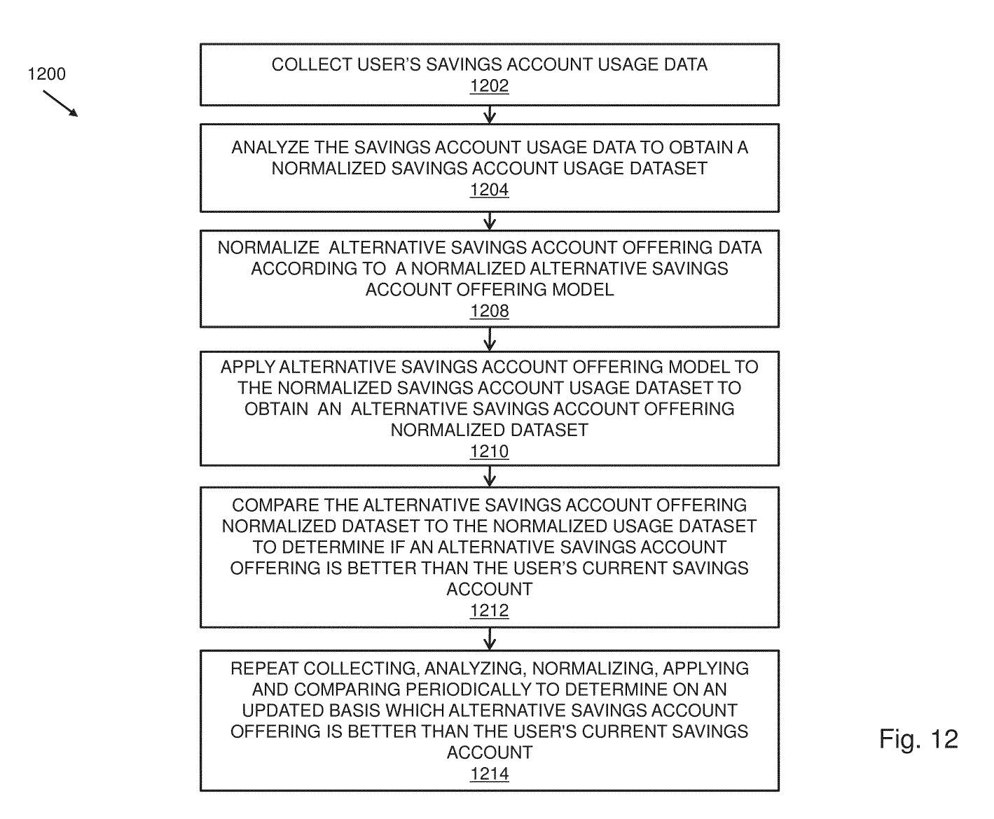

Referring now to FIG. 12, a method of comparing savings account offerings based on a user's savings account usage data may include the steps of collecting savings account usage data for a user's current savings account using a computer implemented facility 1202, analyzing the savings account usage data to obtain a normalized savings account usage dataset 1204, optionally, normalizing data related to a plurality of alternative savings account offerings according to a normalized alternative savings account offering model 1208, applying the normalized alternative savings account offering model to the normalized savings account usage dataset to produce a plurality of alternative savings account offering normalized datasets, wherein the dataset comprises at least the cost for the alternative savings account offering 1210, comparing the alternative savings account offering normalized datasets to the normalized usage dataset to determine if an alternative savings account offering is better than the user's current savings account 1212, and optionally, repeating said collecting, analyzing, normalizing, applying and comparing periodically to determine on an updated basis which alternative savings account offering is better than the user's current savings account 1214.

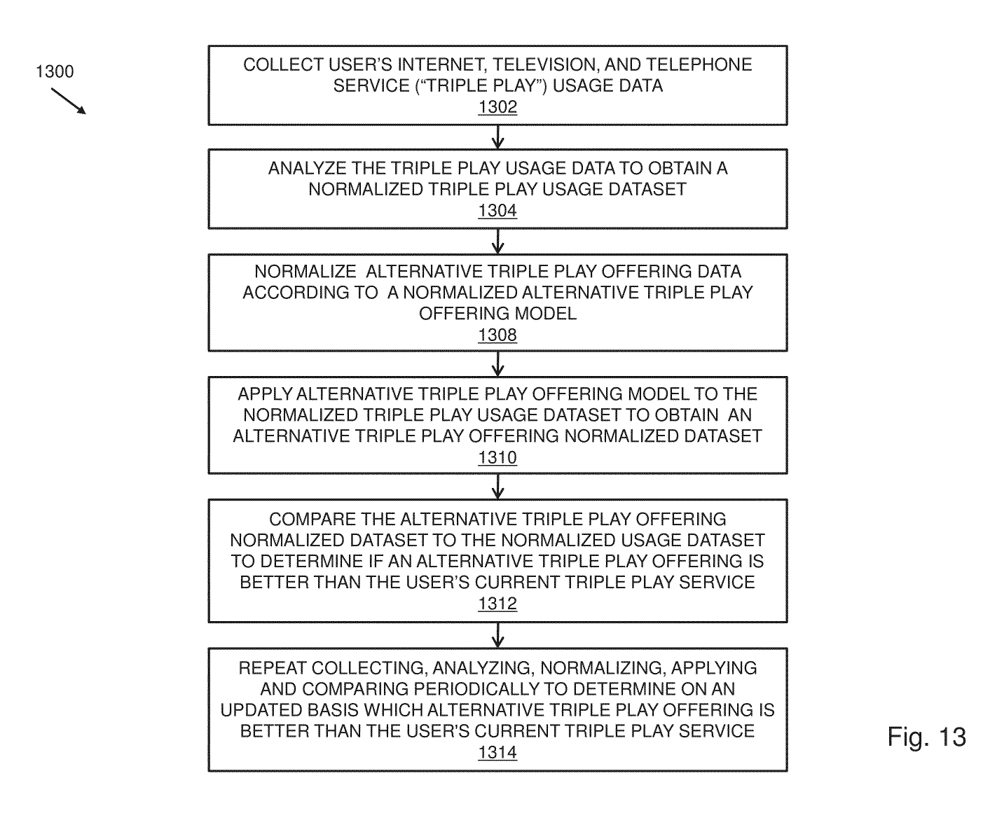

Referring now to FIG. 13, a method of comparing internet, television, and telephone (“triple play”) service plans based on a user's triple play service usage data may include the steps of collecting service usage data for a user's current triple play service using a computer implemented facility 1302, analyzing the triple play service usage data to obtain a normalized triple play service usage dataset 1304, optionally, normalizing data related to a plurality of alternative triple play service offerings according to a normalized alternative triple play service offering model 1308, applying the normalized alternative triple play service offering model to the normalized triple play service usage dataset to produce a plurality of alternative triple play service offering normalized datasets, wherein the dataset comprises at least the cost for the alternative triple play service offering 1310, comparing the alternative triple play service offering normalized datasets to the normalized usage dataset to determine if an alternative triple play service offering is better than the user's current triple play service 1312, and optionally, repeating said collecting, analyzing, normalizing, applying and comparing periodically to determine on an updated basis which alternative triple play service offering is better than the user's current triple play service 1314.

In an embodiment, the system may be a search engine that may compare a plurality of product and service options according to the needs of the users. On the basis of past and predicted service usage of the user, the system may suggest a service plan to the user that may be appropriate for the user's requirements. In an example, the system may suggest a service plan by comparing the costs of the service plans. The costs may be the cost of the service offering. The costs may be a monthly savings over an existing service. The costs may be an annual savings over an existing service. Also, the system may periodically compare service offerings to determine on an updated basis which alternative service offering is better than the user's current service.

A user reviewing their online financial account presents an opportunity for delivery of offers, sales opportunities, and various other opportunities based on the platform 100 of this disclosure or third party applications. An executable script running on a client used to view a user financial account may enable analysis of transaction data, including bill pay entries, from the user financial account in order to provide offers or sales opportunities based on the transaction data. The executable program may be called via a single line of JavaScript embedded in the user financial account webpage. The single line of JavaScript may also be used to call, or integrate, 3rd party or other related applications. For example, a mapping interface may leverage the capability of the executable program to analyze transaction data, match offers from an offer database, and present the locations of the offers on a map. Analyzing the transaction data may include automatically extracting merchant data, such as merchant name, merchant category, transaction category, store name, zip code, spending amounts, purchase frequency, product category, or the like. Transaction entries may be analyzed and matched against a database of offers and sales opportunities to interweave a related offer or sales opportunity. For example, in the case of a transaction description, matching to an offer may be done using natural language processing (NLP). If the transaction entry relates to a service, the analysis may indicate that an alternative offering may be available upon a more detailed analysis. A link to an alternative offering assessment interface may be provided. Alternatively, the executable program may integrate the functionality of the alternative offering assessment interface and provide an indication of an improved offering interweaved with the transaction. Analysis of the transaction data may be limited to individual transactions or may encompass all transactions on a statement, transactions from a particular period of time, transactions from a particular merchant or merchant(s), transactions of a particular nature, and the like. By analyzing transactions from a particular merchant, for example, that merchant may be able to provide offers to the user during a subsequent transaction based on past transactions. In effect, merchants can provide a merchant loyalty program implemented through the use of a transaction card associated with the financial account. Merchants may be able to track various indicia associated with this new kind of loyalty program, as well as make, update track or fulfill offers and sales opportunities through use of a merchant dashboard.

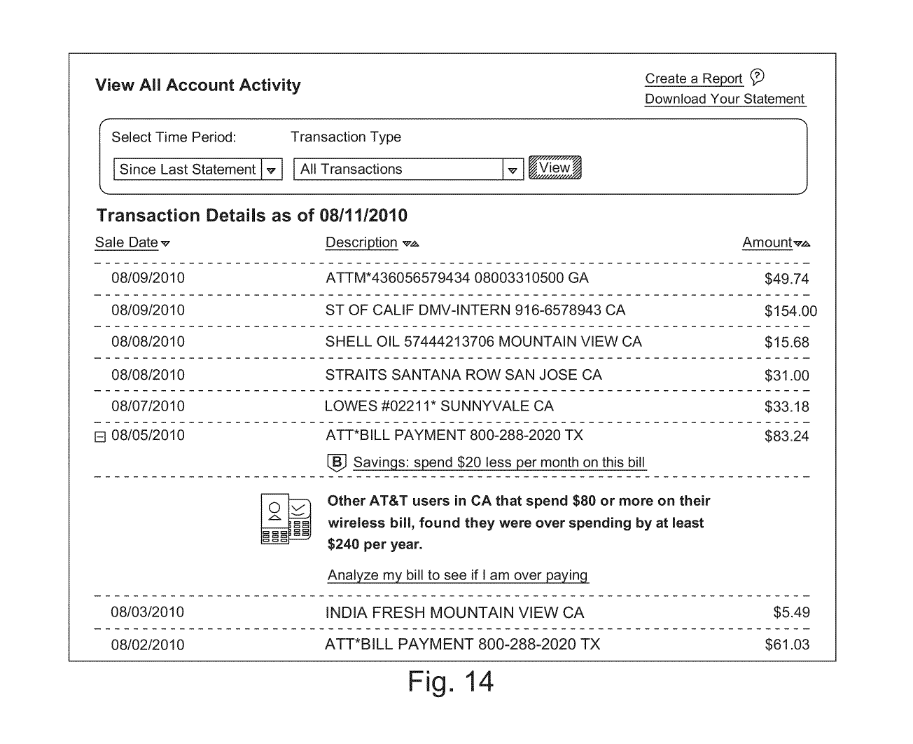

In embodiments, the platform 100 may be enabled to specifically target current customers or competitor customers as they review their recent transactions via an online or paper account statement. The account statement may be a bank statement, a credit card statement, a debit card statement, a stored value card statement, a bill payment system, and any other system for managing transactions on an account like a personal financial management system. Referring to FIG. 14, an account statement of the user is illustrated in accordance with an embodiment of integrated bill analysis. The account statement may include details and information about various transactions done by the user. In examples, the transactions may be provided for a specific period such as one month, three months, and the like. The transactions may relate to purchases done by a user at different locations such as at a departmental store, electronic store, gas station, and the like. The system of the present disclosure may assign and categorize transactions done by the users. For example, the system may categorize the stores which the user visits frequently, the minimum amount spent by the user, and the like. Further, the system may analyze the transactions done by the user.

In an embodiment, the account statements may facilitate the system to identify various merchants listed in the account statements. Thereafter, the identified merchants may be matched with their appropriate business type or category. For example, the merchant may be automatically categorized as a telephone service provider, gas station owner, a coffeehouse owner, and the like. In an embodiment, the system may notify the user of a potential savings with an alternative service plan or item. For example, the system may recommend alternative services such as wireless plans, oil and gas services, and the like to the users as per their past and predicted usage. In the statement, the user may be invited to interact with the consumer service comparison shopping system 100 to investigate whether there are indeed savings to be had with an alternative service plan or item.

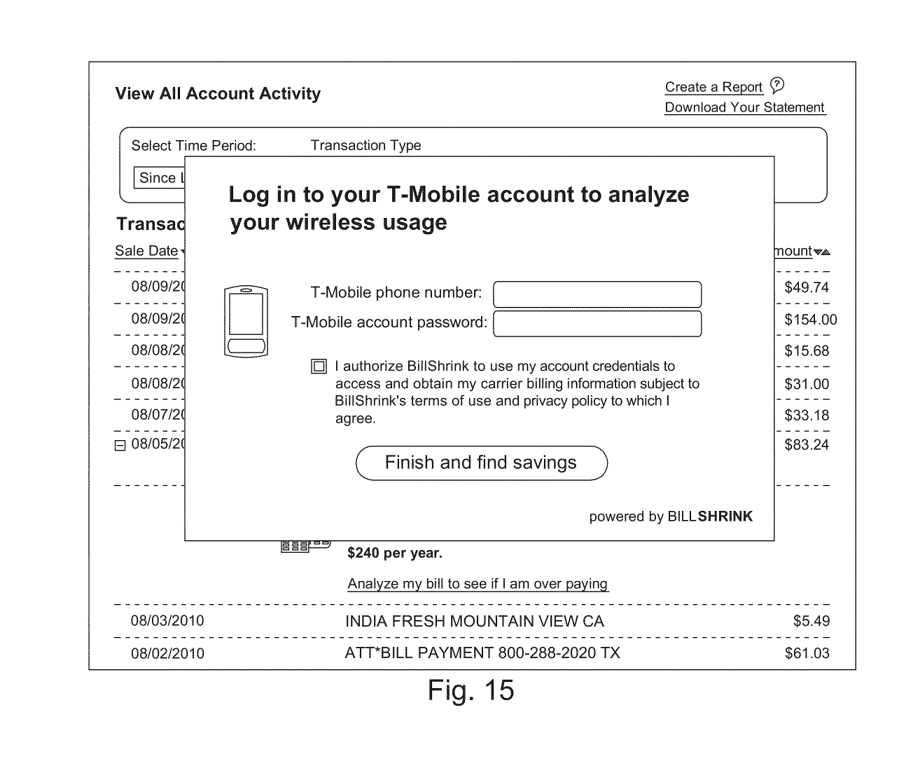

FIGS. 15-17 provide an overview of the recommendations provided by the system, in accordance with an embodiment of the present disclosure. In the example shown here, the user is attempting to determine if there are better cell phone plans available in terms of coverage, cost, quality, and any other desired factors. It should be understood that the system may be enable the user to log into any number of service plans to determine if there are better service plans available, such as television services bundled services, and the like. Continuing with this example, the system may request some information such as a mobile phone number, password of the cell phone account of the user, and the like, from the user. This information may be used for analyzing the account summary of the user. In an example, the user may provide the required information after logging into the system. Thereafter, the system may import the account summary of the user. Further, the system may analyze the cell phone bill of the user based on various aspects such as service plan currently in use by the user, calls made by the user, roaming charges paid, text messages charges, MMS charges, and the like. The system may also generate reports based on the analysis. Accordingly, in other examples, the system may collect internet, television, and telephone service usage data from the user for suggesting alternative service plans for optimizing usage by the user.

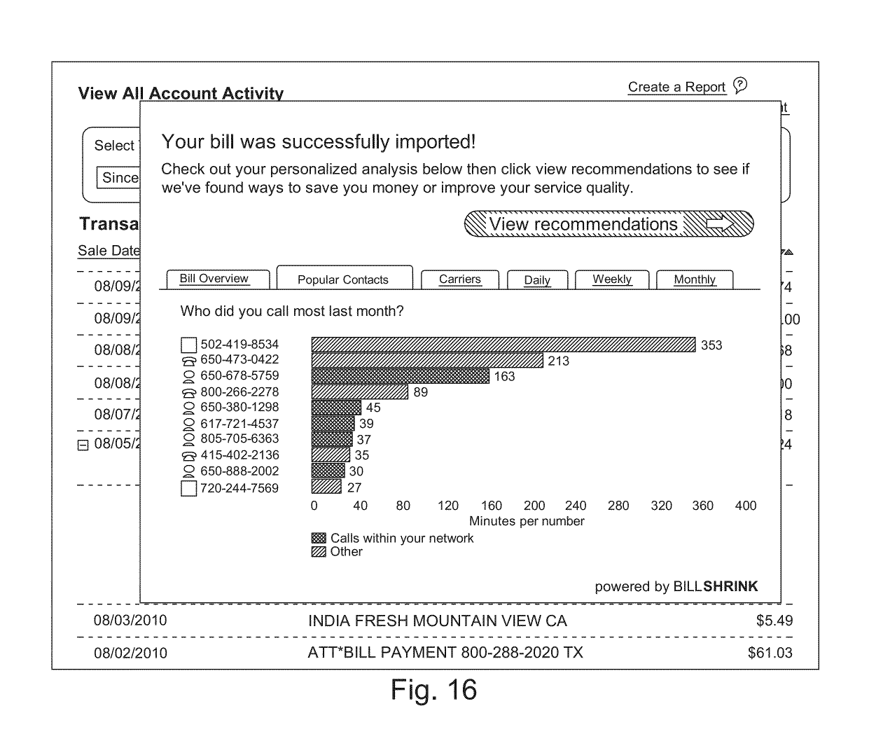

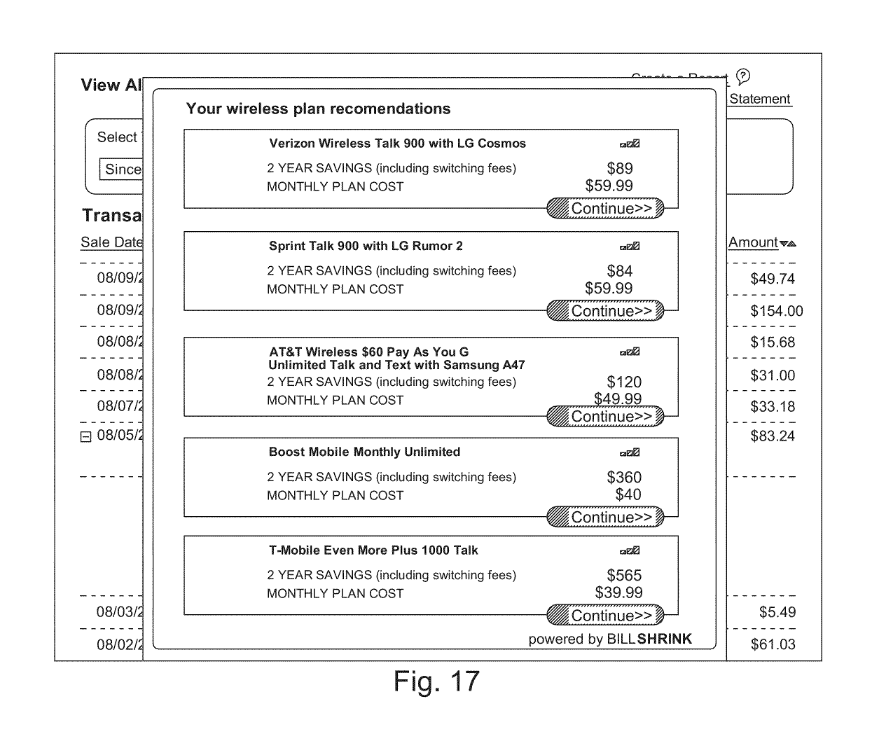

In an embodiment, the system may provide offers/recommendations based on analysis and identification of transactions made in a single account. Again referring to FIG. 16, the system may analyze a telephone bill of a user. The analysis may include a list of contacts that may be frequently contacted by the user, number of calls made, number of international calls made, number of text messages sent, and the like. In an embodiment, the system may provide recommendations to the user after analyzing the transaction details of the user. The recommendations may include different ways that may be suggested to the users for saving money. Further, FIG. 17 illustrates various recommendations suggested by the system, in accordance with an embodiment of the present disclosure. The recommendations may include the various monthly costs of the service plans suggested by the system along with the annual savings that the user may receive. In an embodiment, the recommendations may be directed to reduce the expenses incurred by the user, improve the coverage, improve the signal strength, and the like. The account statement may include an entry for a cell phone bill. The system 100 may recommend a cheaper cell phone plan that may be provided by another service provider. The offers may include discounts that may be offered by the service providers. The discount may include unlimited talk time, some minutes of free talk time, and the like. The system may also provide an estimate of average wireless savings that may be done by the user over a period of time.

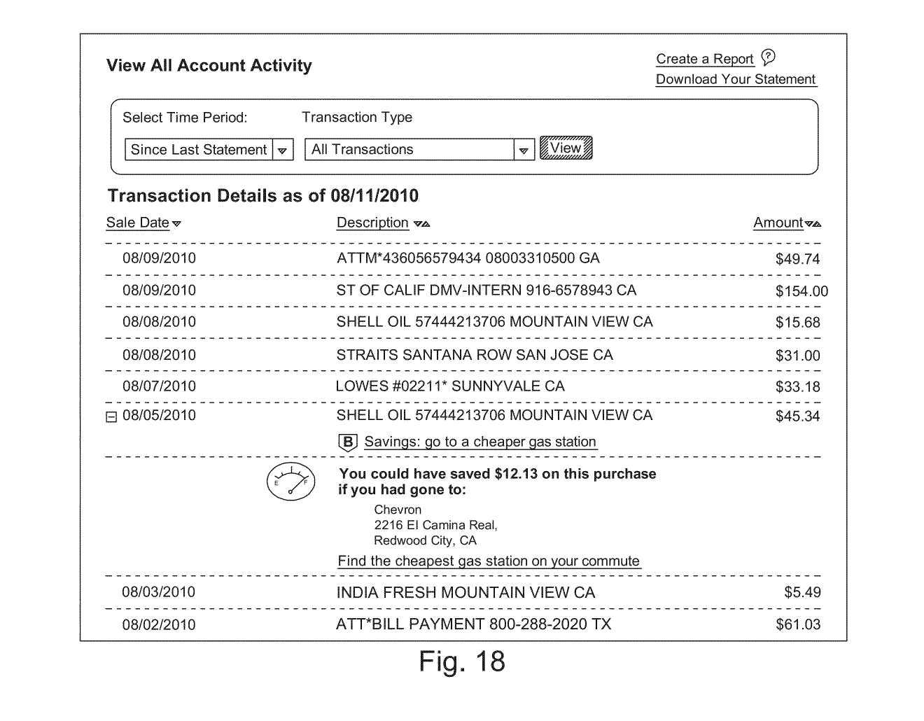

FIG. 18 illustrates an account statement of a user, in accordance with an embodiment of the present disclosure. The account statement of the user may include an entry for a gasoline refill. The system may analyze the costs incurred by the user for gasoline refilling and may provide an offer for recommending a cheaper gasoline refilling station to the user along with the total savings that may done by the user. The offer may be integrated in the account statement of the user.

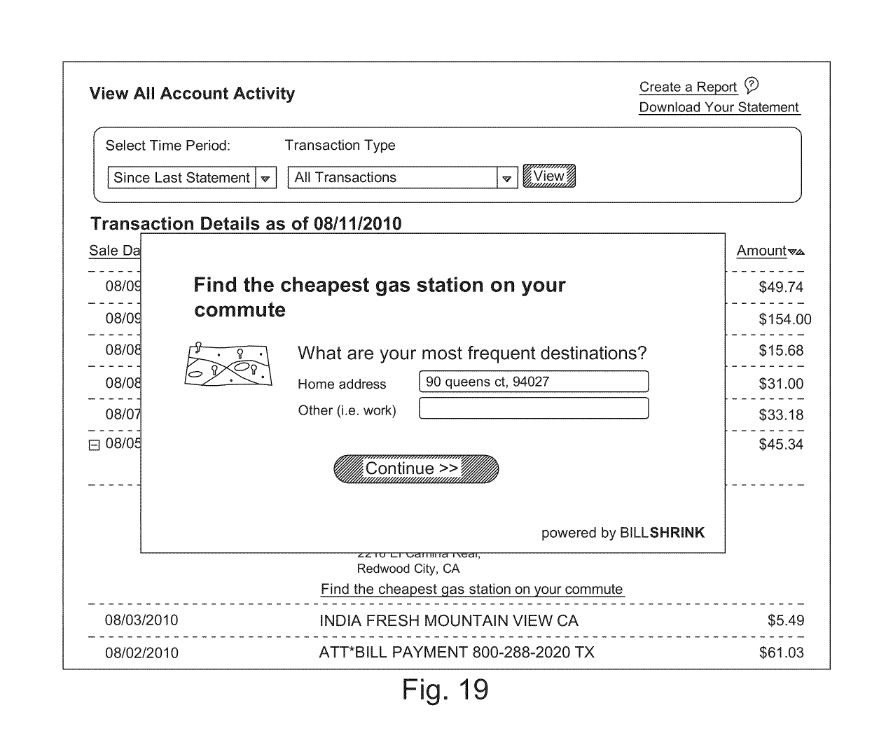

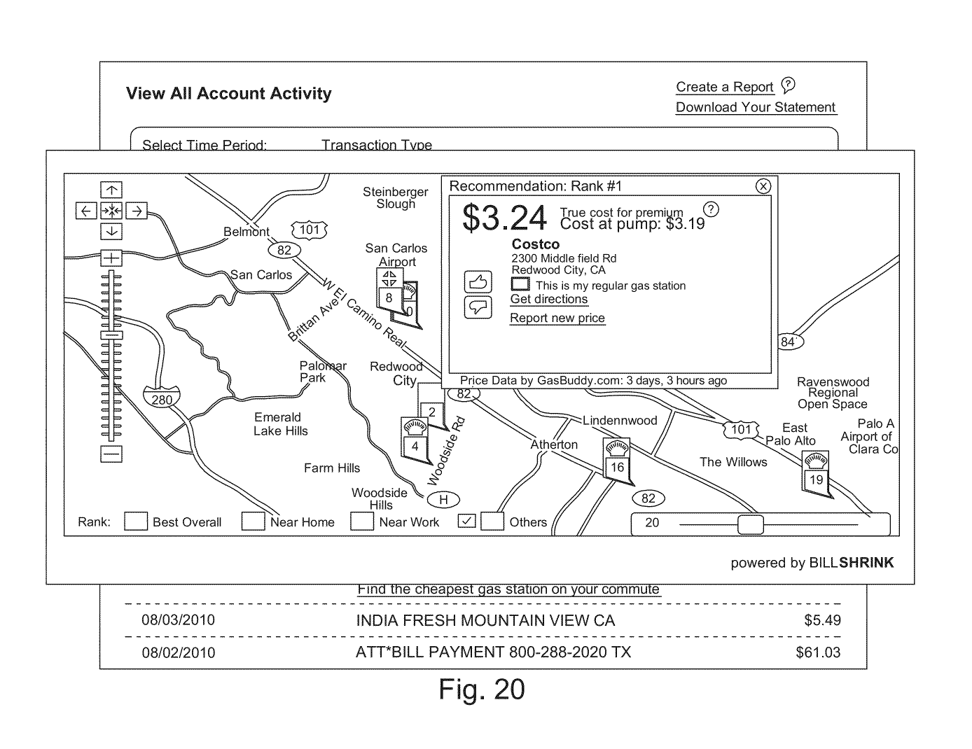

FIGS. 19 and 20 illustrate a recommendation option that may be selected by the user, in accordance with an embodiment of the present disclosure. The user may click on the suggested recommendation to activate them. The system may require some information such as home address, frequent destinations, and the like, from the user. When the user enters the required information, a list of recommendations may be provided to the user. Further, the recommendations may include various gas stations that come on the way to the frequent destinations of the users. The user may also view details of the recommendations by clicking on them. The details may include the address of the gas station, cost of gasoline per gallon, directions to the gas station, and the like.

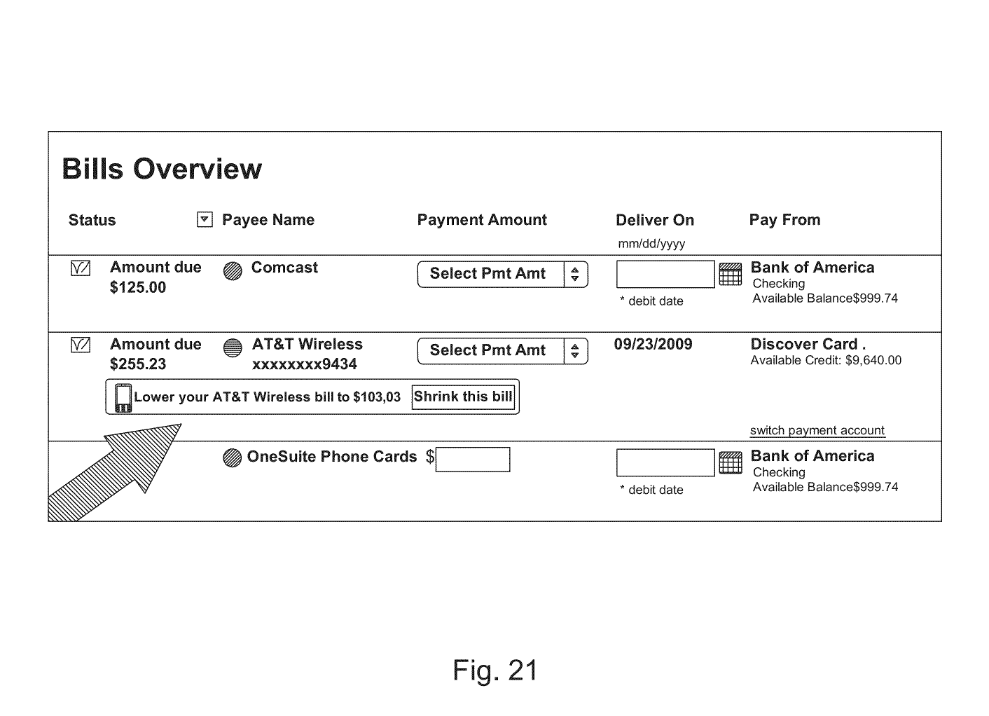

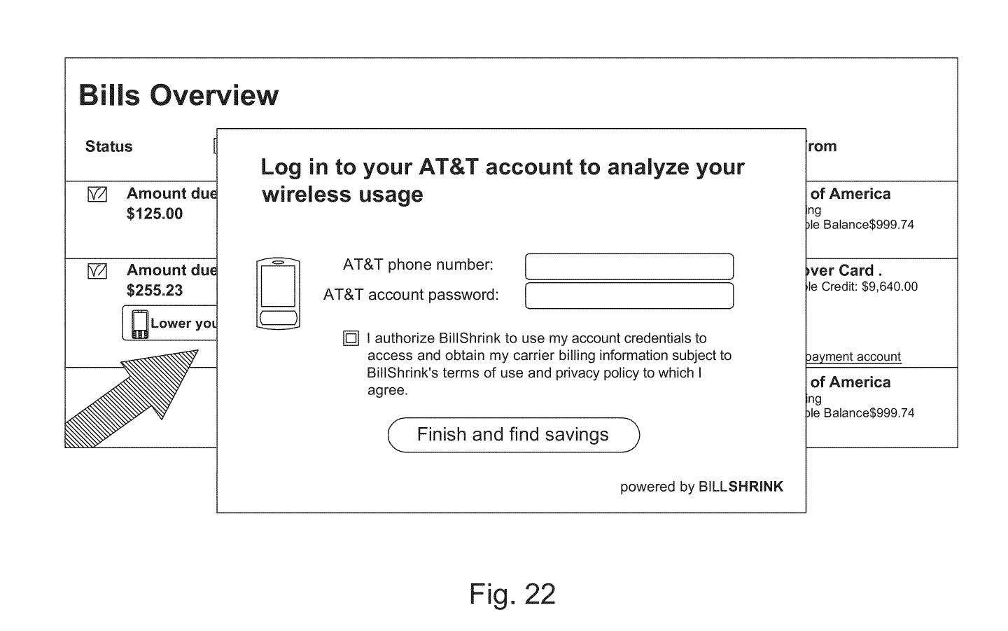

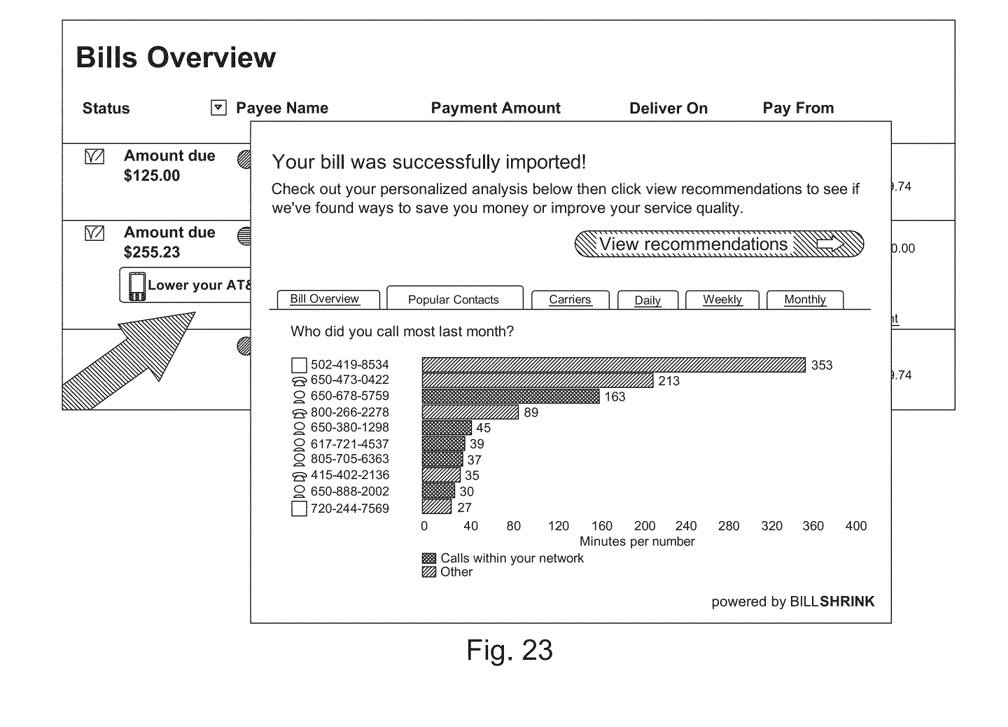

Further, FIGS. 21-23 illustrate saving recommendations provided by the system, in accordance with an embodiment of the present disclosure. In this example, the system is integrated with a Bill Pay screen, such as in FIG. 21. The system may provide saving options to the users such as how much the user may save, which bank may offer reward points to the users, and the like alongside the Bill Pay options. In FIG. 22, the user has activated the option to ‘Shrink this bill’. This may launch a dialog box for logging into their wireless account to obtain the usage data needed for analysis by the platform 100. FIG. 23 depicts a screen indicating successful import of the usage data to the platform 100 and a graph showing analysis of the bill for most popular contacts.

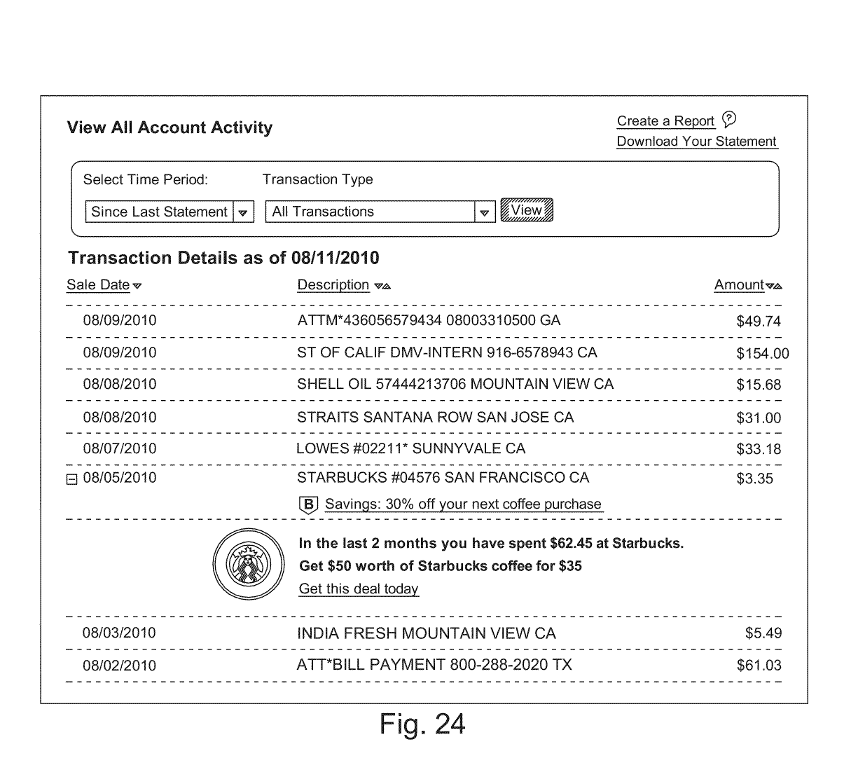

FIG. 24 illustrates a reward being offered to the user, in accordance with an embodiment of the present disclosure. The system may offer rewards to the users based on the loyalty of the users. As shown in FIG. 24, an account statement of the user may reveal that the user have done multiple purchases from a particular store. In such cases, the store may make a loyalty-based offer to the user. For example, if a user shops frequently from a store such as Starbucks, the system may automatically enroll the user in a loyalty program. Thus, every time the users use their regular transaction card such as a credit card, a debit card, and the like, at Starbucks, the user may automatically earn loyalty points. The user may redeem the loyalty points for free products or services from that store. For example, the store may offer some discount to the user on a next purchase of the user. The system may not require loyalty cards to redeem the loyalty offers. In another example, the system 2700 may track the purchases at a particular retailer, such as STARBUCKS. Instead of having a punch card to track coffee purchases, the system 2700 may analyze a user's transactions to keep track of the purchases. The loyalty reward may be a free 12^{th} coffee after 11 coffee purchases. When the user makes the 12^{th} coffee purchase, the system 2700 may credit back the cost of the 12^{th} coffee to the user. Thus, the 12^{th} coffee is free and the user needed only to swipe a single financial account card to effect payment and receive the loyalty reward.

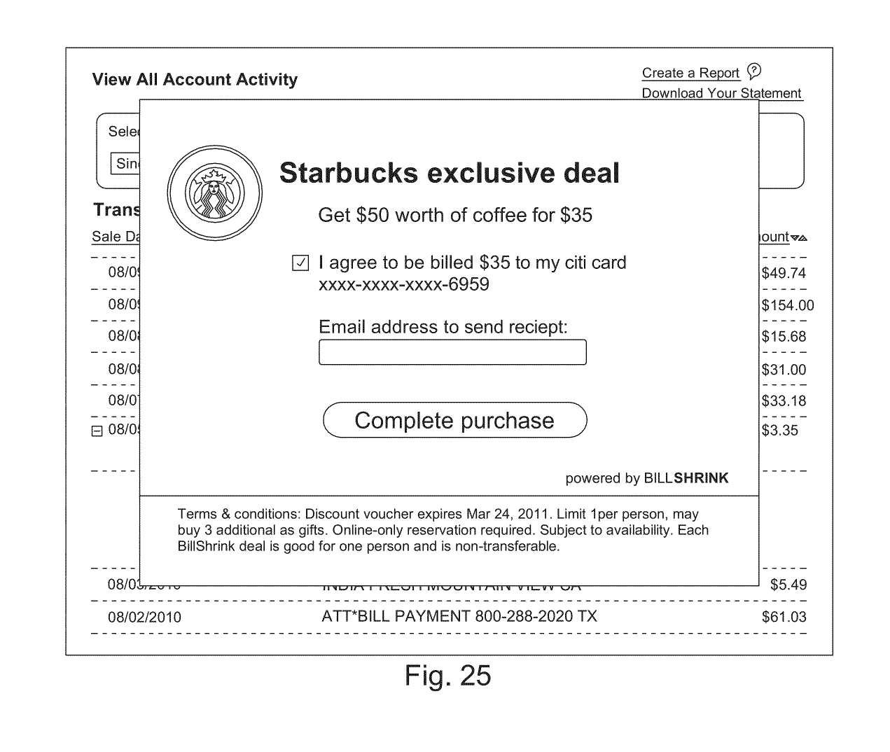

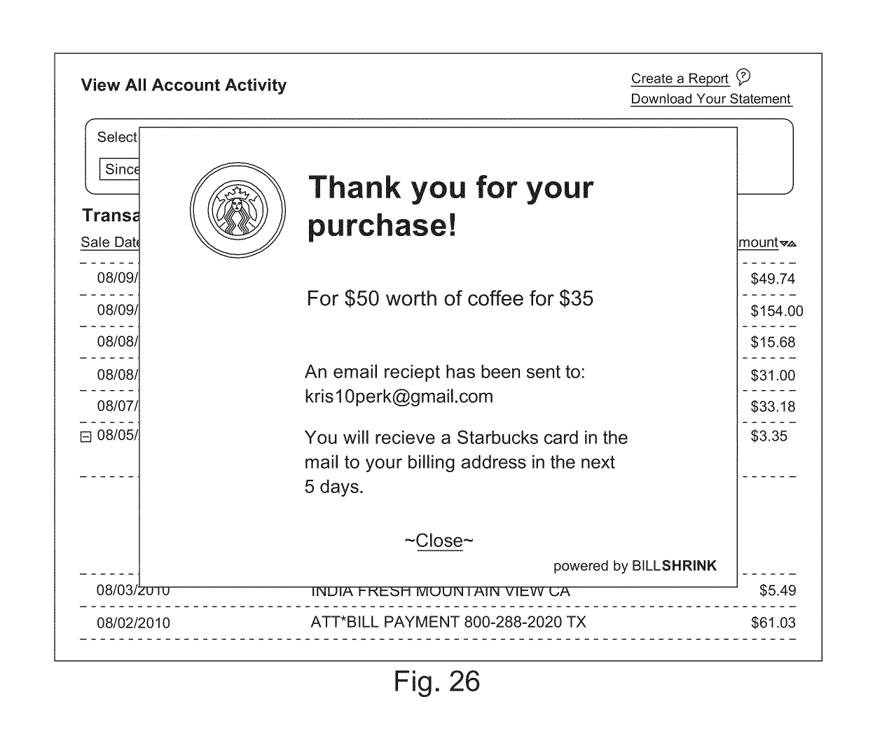

FIG. 25 illustrates a loyalty based offer made to the user, in accordance with an embodiment of the present disclosure. The loyalty based offer may include a coupon with validity for a limited time period such as one month, three months, six months and the like. The user may receive a confirmation receipt on accepting the offer. The offer may be available on a stored value or loyalty card, the items of the offer may be delivered or may be available for pickup at a location, such as upon presenting a receipt, and the like. In this embodiment, the loyalty-based offer is a deep discount on subsequent purchases if the user pre-pays. FIG. 26 illustrates a confirmation receipt that may be provided to the user, in accordance with an embodiment of the present disclosure. The user may receive the coupon through mail and a corresponding receipt may be sent to the e-mail address of the user.

The system may match an offer based on identification and analysis of the transactions made across multiple accounts. The offer shown to the customer may be driven by a combination of three different rules: what the merchant wants to show the customer, what the financial institutions want to show the customer, and what the customer chooses to see. These rules may be stored in a rules database of the system.

Further, the system may provide an account aggregation and other online financial services. Account aggregation may include compilation of information from different accounts, which may include bank accounts, credit card accounts, investment accounts, and other user or business accounts, into a single place. The account aggregation may be provided by online banking solution providers. The account aggregators may analyze the transaction summary of a user and may categorize merchants from it. The merchants may be categorized such as Oil & Gas, Grocery, Retail, and the like. In few cases, the merchants may not fall under any of the pre-defined categories. In such cases, the account aggregators may assign codes to such merchants.

Further, the account statements of the different accounts may be analyzed by the system. The account aggregators may analyze the transactions across all the accounts. For example, a user may charge their Starbucks purchases to a plurality of banks such as Citibank, Bank of America, and the like. The activity at Starbucks across all accounts held by the user may be identified by the account aggregator. Therefore, if a user makes a payment through any of the banks associated with the account aggregator, the user may get loyalty-based offers from Starbucks through the system. In an embodiment, the system may include a natural language processing (NLP) technology. The NLP technology is a form of human-to-computer interaction where the elements of human language, spoken or written, may be formalized so that a computer may perform value-adding tasks based on that interaction. The NLP technology may match offers with relevant and targeted transactions. For example, if a transaction statement is not clear, the system may get details about the purchases using the NLP technology. The details may include, but are not limited to, merchant, location of the store, and amount spent.

In an embodiment, the system may provide anonymity of the users. The identity of the user may not be provided to the system and the merchant. The bank may be the only one that may know the identity, however, the bank may not be provided with the information of the various offers that may be provided/redeemed to the users.

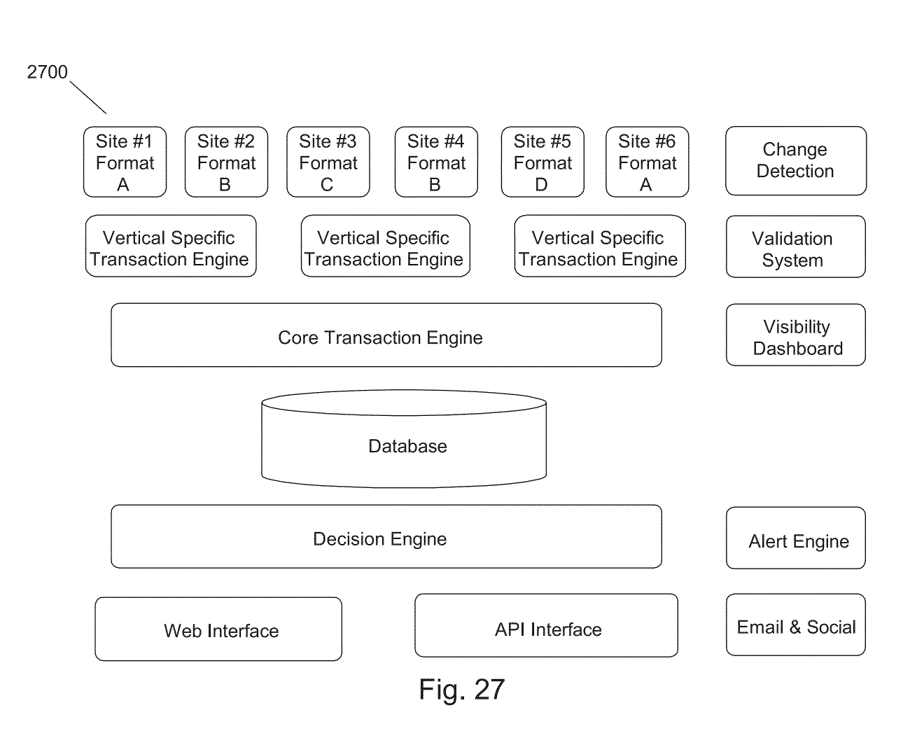

FIG. 27 illustrates a block diagram of the system, in accordance with an embodiment of the present disclosure. The system may include a user interface that may enable the users to access the system. The user interface may be embodied in a website. For example, the system may be associated with a bank having a user account. The bank may provide transaction cards such as a debit card, a credit card, a pre-paid card, and the like. In such a scenario, the user interface may be a web interface that may enable the users to access the system through the bank's website. In another scenario, the system may be a standalone program that may be used for enhancing an existing rewards system. In this scenario, the users may access the system through the user interface.

Once the users access the system, the users may enter their service usage data and preference data through the user interface. The data may include a current service provider, a current service cost, a current service usage, and the like. In an alternative embodiment, the data may be gathered automatically from the user's service provider by a transaction engine when the user logs into the user's service account. Either a core transaction engine or one of a plurality of transaction engines, such as one per merchant, may be used to gather a user's data. The service usage data provided by the user may be compared with other service usage plans that may be stored in a database of the system. Thereafter, a decision engine may suggest the service usage plan to the user that may fit as per the preferences of the user.

The service usage plan may be suggested to the user by an alert engine by sending an e-mail, a text message, an alert, and the like. Further, a dashboard of the system may also include information about the present and suggested service plans of the user. In an embodiment, if the user changes his/her preferences about the service usage plan, the system may reflect those changes and may suggest other plans as per the new preferences of the user. The system may analyze the transactions carried out by a user and may verify the details of the transactions.

The system may include an API interface. This API interface may enable users to interact with the raw and analyzed data stored in the system through any number of applications.

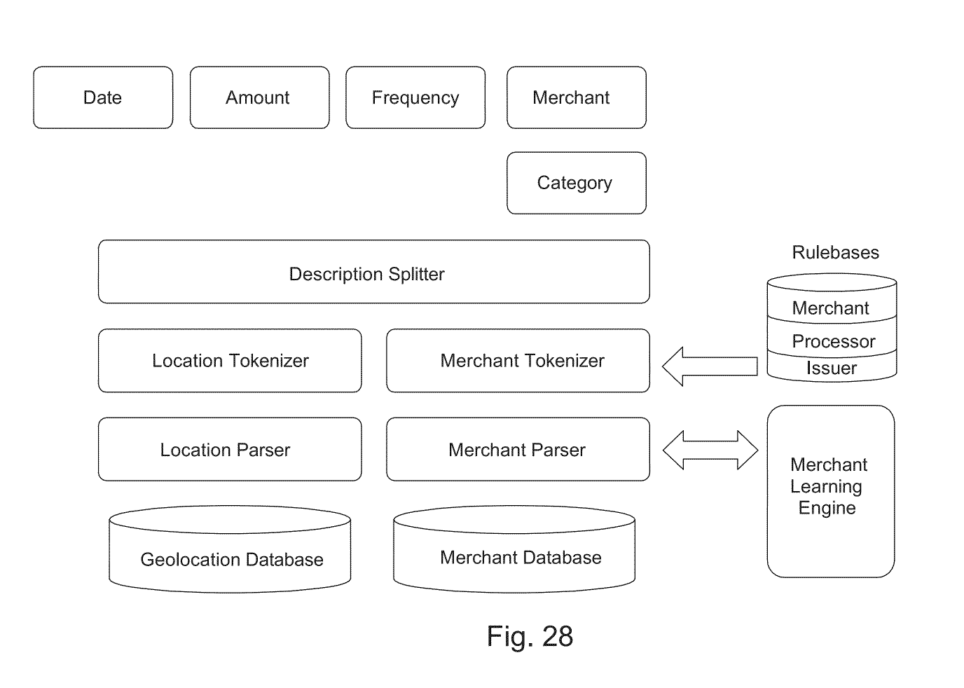

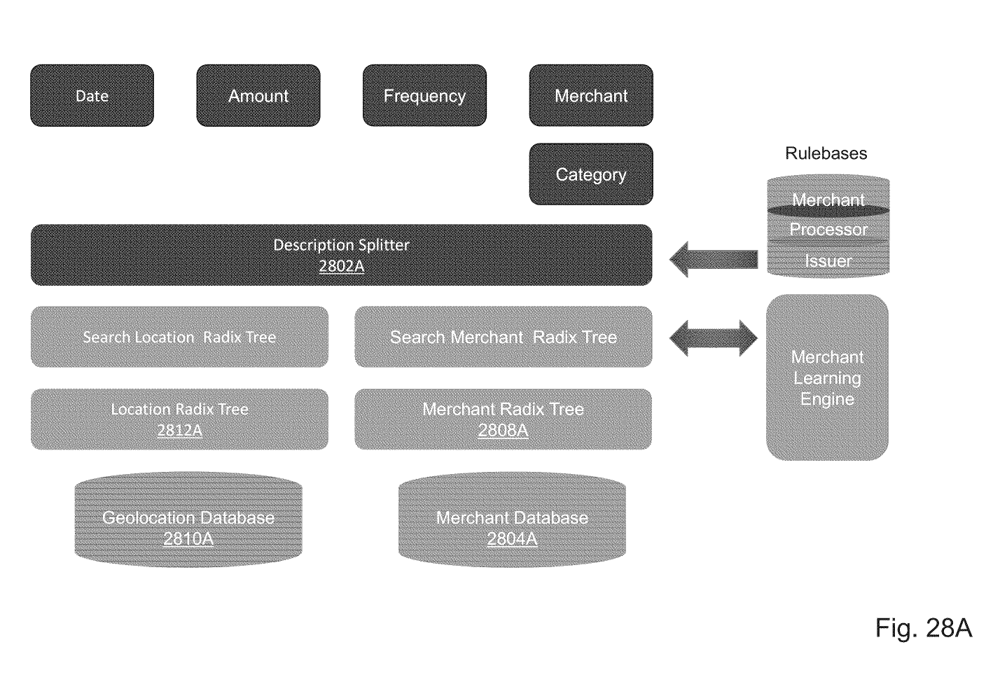

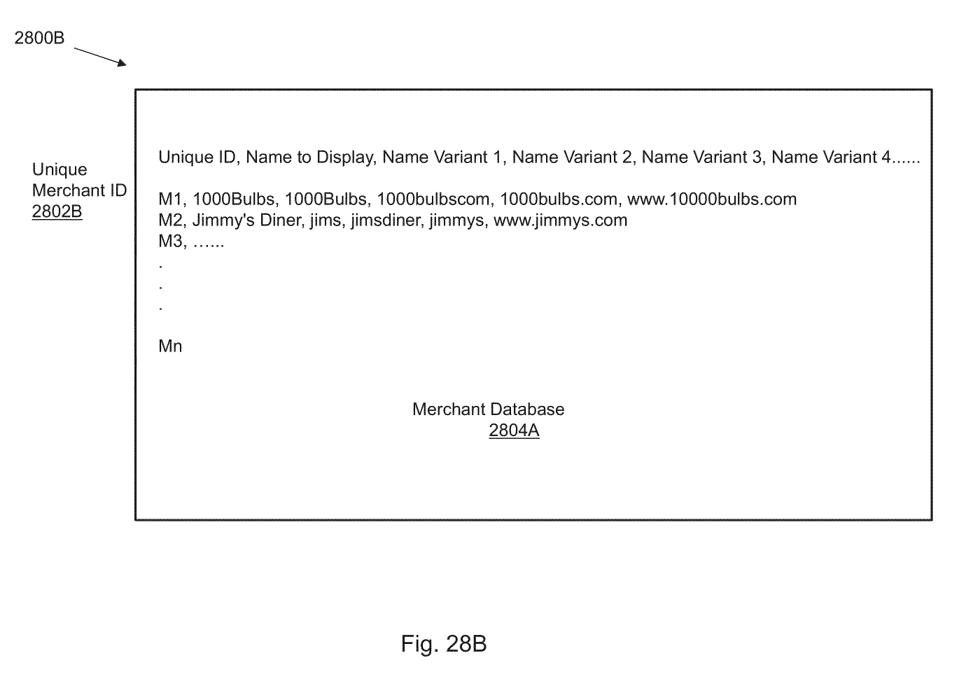

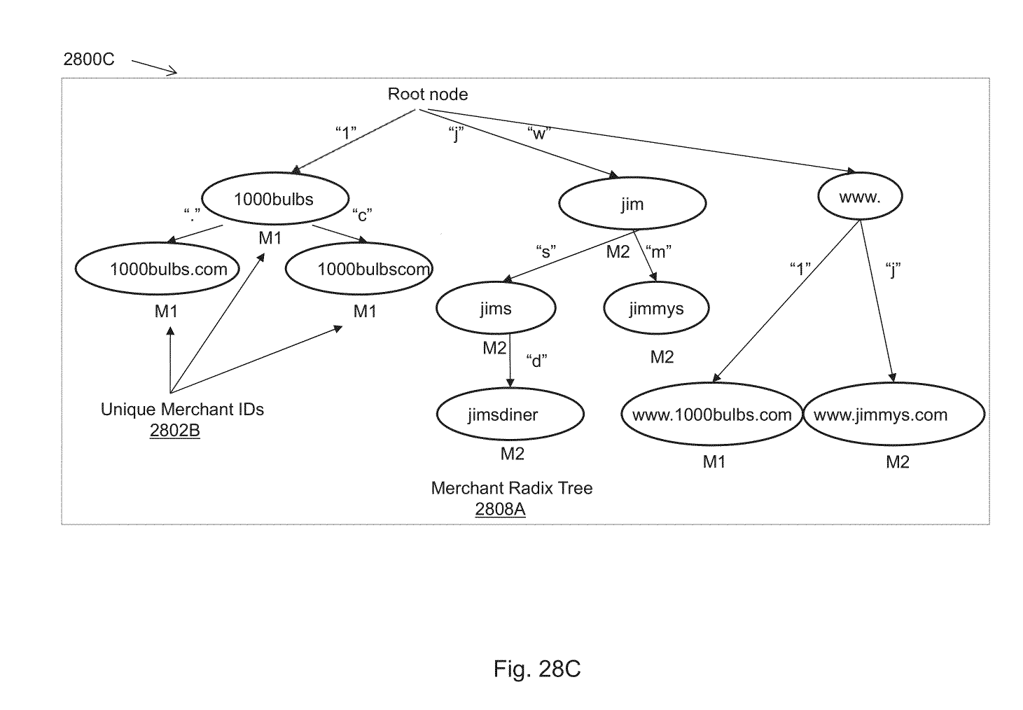

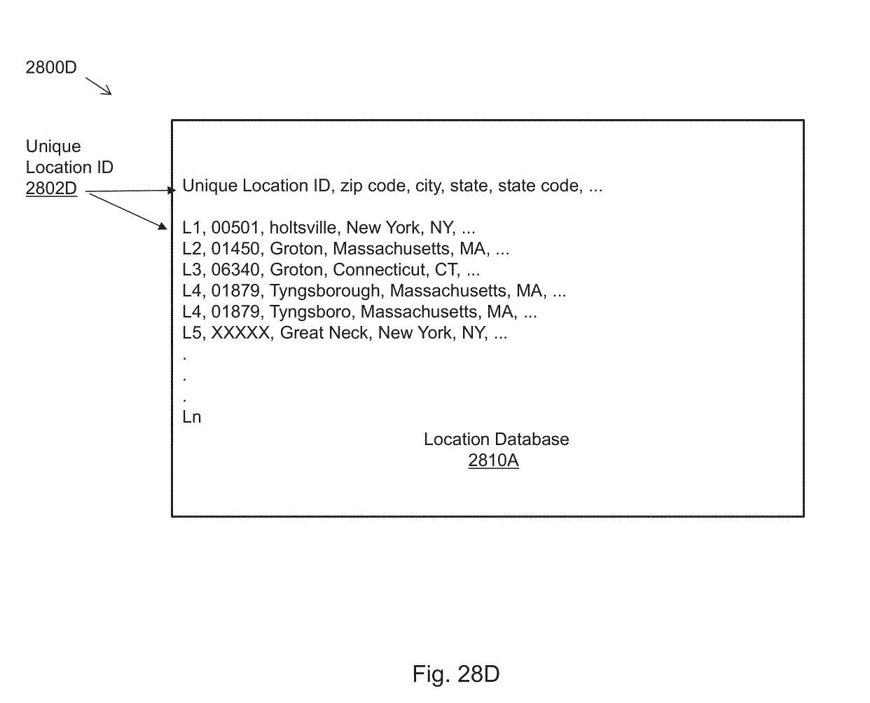

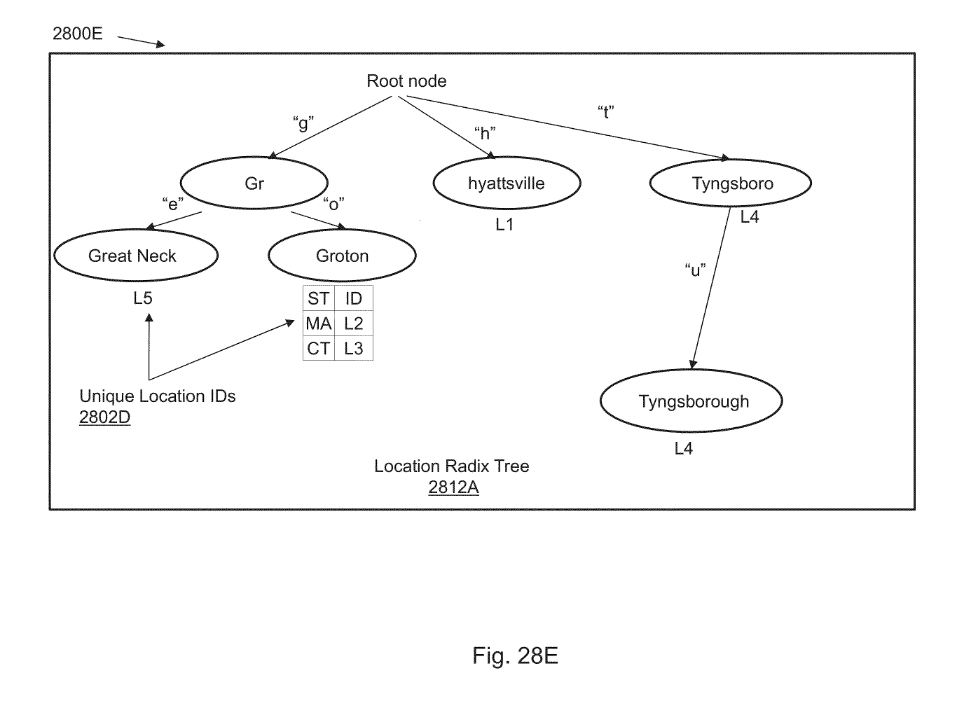

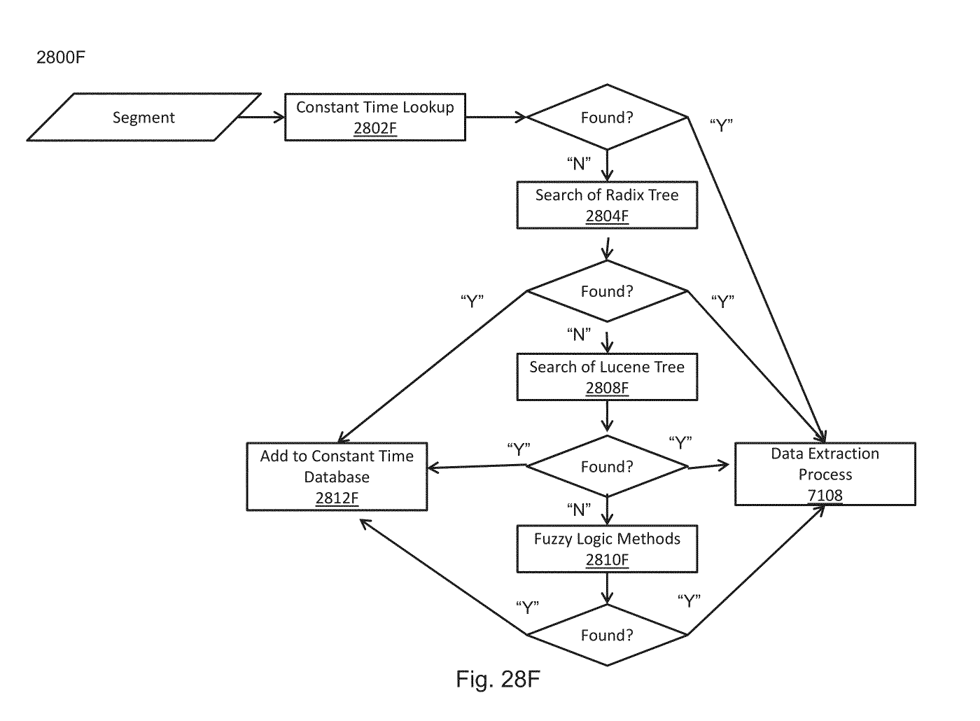

FIG. 28 illustrates a block diagram for matching the transactions carried out by a user, in accordance with an embodiment of the present disclosure. The system may match the transactions that may be carried out by the users. The system may include a description splitter that may segregate the information about the transactions carried out. The information may include the date of purchase, amount spent, merchant from which a product has been bought, and the like. The description splitter may include a location tokenize that may generate a sequence of tokens that may relate to a location of the merchant. The sequence of tokens may be generated by a merchant learning engine that may suggest similar locations. The location of the merchant may be searched in a geolocation database of the system. Thereafter, a location parser of the system may parse through the geolocation database. If the location of the merchant is stored in the geolocation database, the system may match the location in the transaction. However, if the location of the merchant is new, the geolocation database may store that location for future reference.

Further, the description splitter may include a merchant tokenize that may generate a sequence of tokens that may relate to a merchant. The sequence of tokens may be generated by a merchant learning engine that may suggest similar merchant names. The merchant may be searched in a merchant database of the system. Thereafter, a merchant parser of the system may parse through the merchant database. If the merchant is already stored in the merchant database, the system may match the merchant in the transaction. However, if the merchant is new, the merchant database may store that merchant for future reference. Further, the system may include architecture for offering rewards to the users.

FIG. 28A illustrates an alternative block diagram for matching the transactions carried out by a user, in accordance with an embodiment of the present disclosure. The system may include a description splitter 2802A that may segregate the information about the transactions carried out. The segregated information may include the date of purchase, amount spent, merchant, geographic location and the like. A variety of preprocessing techniques may be used to clean the transaction description and parse it into distinct meta data such as merchant, city, state and the like. Preprocessing techniques may include a set of processing rules focused on text transition between character types such as letter to number, delimiting characters and the like.

The description splitter 2802A may extract merchant meta data, such as a representative text string or the like, for a given financial transaction. However, the textual information contained in the meta data identifying the merchant may include a partial name, typographical errors, variations on the merchant's name, truncated names and the like. It is important to correctly identify the merchant over multiple transactions to develop an accurate model of customer preferences with respect to merchants. While associating a unique merchant ID 2804C with a merchant name and its variants might be done with a large look-up table, pattern matching techniques and the like there are other data processing techniques including hash-tags, radix indices, and the like to reduce the processing time required. FIG. 28B depicts an example of a merchant database 2804A which includes a merchant unique ID 2802B for each merchant, merchant name as it is to be displayed, variations on the merchant name, and the like. From this merchant database 2804A a search tree may be created such as the radix tree illustrated in FIG. 28C. A merchant name in a transaction record will be searched upon in the Radix tree 2808A and the value, a corresponding merchant unique ID 2802B, will be obtained. Using a unique merchant ID 2802B for each merchant, regardless of the name variant in the transaction record will allow for more accurate recording of which merchants are frequented regularly by the customer.

The search of the merchant radix tree 2808A may result in a partial match rather than an exact match between the merchant meta data and a node with an associated merchant unique ID 2802B. When a partial match is identified techniques such as thresholding, probability, confidence limits and the like may be used. The selection of a threshold level may vary depending on type of meta data such as merchant, location, and the like. Additionally, the appropriate level for the threshold may be set or adjusted using machine learning techniques such as k-nearest neighbor, any generalized linear and non-linear regression techniques, SVM, and the like. In one embodiment, the percent to which the merchant meta data text matches one of the nodes in the merchant radix tree is compared to a percent match threshold level. If the percent match exceeds the threshold, the merchant is given the unique merchant ID 2802B associated with the node. If the percent match falls below the threshold a variety of actions may occur including the creation of a new merchant unique ID 2802B and entry into the merchant database, the assignment of the transaction to a “miscellaneous” merchant, and the like. Additionally, the machine learning techniques may be augmented with manual feedback and corrections as needed.

As illustrated in FIG. 28A the description splitter 2802A may extract the geographic location of the transaction. However, the information identifying the geographic location may include city, state, country, address, postal code (e.g., zip code), geographically-referenced network address (e.g., mapped IP address), GPS coordinates, latitude and longitude, and the like. As with the merchant information there may be partial names, duplicate city names, typographical errors, variations on place name, and the like. Different transactions may contain the geographic information to a varying degree of specificity. However, the degree to which the geographic location of a transaction may be consistently identified enhances the ability to fine tune offers based on geographic location. FIG. 28D depicts an example of a location database 2810A including a location unique ID 2802D, zip code, city, state name, state code and the like. From the location database 2810A a location search tree may be created such as the radix tree illustrated in FIG. 28E. A city name in a transaction record may be searched upon in the Radix tree 2802E. Once an adequate match for the city name is found it may be necessary, where there are duplicate city names, to utilize additional geographic information including state name, state or zip code to reduce location ambiguity and identify the corresponding location unique ID 2802D. Using a unique location ID 2802D for each location, regardless of the name variant in the transaction record will allow for more accurate recording of which locations are frequented regularly by the customer.

This document discloses a scalable process for extracting customer transaction data. It is known in the art that processing time may increase as the size of the data set to be processed increases. An example of this may be the increase in time required by typical classification algorithms to classify data as the classification set increases. Given the very large sets of financial transaction data contemplated it is desirable to use algorithms that do not vary in time with size of data set such as those using constant-time lookup data structures, and the like. However, these constant-time lookup data structures require classified data as input to their construction. A method of generating the constant-time lookup data structures may include using one or more training sets of transaction data together with a Radix classification method, or the like to create constant-time lookup data structures.

FIG. 28F illustrates a workflow for minimizing overall elapsed time required by data extraction processes 7108. Once the financial transaction data has been split or segmented, a segment may be sent through a corresponding constant-time lookup data structure 2802F to assign a unique ID. If there is no match for the segment in the constant-time lookup data structure 2802F, the data extraction process 7108 may return an unknown or miscellaneous ID. Additionally, the segment may then be processed by conducting a search of a corresponding Radix tree 2804F, or the like. If a match is found, a unique ID may be assigned to the transaction, the data extraction process 7108 may continue, and the match may also be processed for addition to the constant-time lookup data structure 2812F. If a match is not located using the Radix tree search 2804F the segment may then be processed using an inverted index strategy such as a Lucene classifier 2808F, or the like. If a match is still not found, additional fuzzy text search methods 2810F including techniques such as fuzzy distance measures to get a closeness measure of the transaction string and appropriately chosen cutoff values for the closeness measure may be used. The more robust data classification techniques described including Radix tree search 2804F, Lucene classifier search 2808F, fuzzy text search methods 2810F, and the like may be done asynchronously to the data extraction process 7108 to enhance the time-constant database by adding new constant-time lookup data structures.

FIG. 29 illustrates a block diagram for delivering rewards to users, in accordance with an embodiment of the present disclosure. As mentioned herein, the system may be accessed directly through an Application Programming Interface (API) or may be accessed through a financial institution's website. For example, a consumer may receive online account statement that may include some offers suggested to the user. These offers may be integrated in the account statement, such as through a JavaScript™ code. Alternatively, the offers may be linked to the account statement of the user by using a bookmarklet, a browser plug-in, and the like. The user may click on the offers to activate them. In another embodiment, the user may access the system through a user interface. The user may enter information about service plans being used by the user. The system may, in turn, provide offers based on the information entered by the user. An account server of the financial institution where the user may have an account may be unable to determine some transaction details. The account server may send such information to the system such as the amount spent during that transaction, date on which the transaction was done, and the like. The NLP technology of the system may enable the system to get details of the transaction carried out by the user and may be sent back to the account server.

The system of the present disclosure may provide automatic offer redemption to the users. The users may be informed about the various offers that may be applicable as per their account statements. Once the users have subscribed to the services offered by the system, the system may automatically provide various saving offers to the users. Further, the system may provide various offers to the users through multiple channels such as through short message service (SMS), e-mails, and the like. The banks may offer some rewards for the users for using their transaction cards while shopping. Therefore, when a user purchases some items using a transaction card, rewards may be automatically applied to the account associated with the transaction card.

In an embodiment, an offer may be redeemed by clicking on a link that takes the user to a special page that includes a discount for an online purchase. In another embodiment of redemption, a user may use a coupon code, either one-time or multiple use, at an online or offline location to gain discount. In another embodiment of redemption, a user may receive a prepaid instrument of some kind, such as a prepaid debit card, prepaid credit card, gift card, and the like, that can be used to redeem the discount. In another embodiment of redemption, the user may receive a credit on the statement automatically post purchase. In this embodiment, the user may receive an automated discount when a purchase is made or a discount that is applied off of a prior pre-purchased amount.

In an exemplary embodiment, the offers may be included in the account statements of the users. For example, if a user receives the account summary of a bank as a paper statement, the paper statement may include offers that may be printed below the expenses mentioned in the bank statement. In this example, if a user has spent some amount for paying internet bills, the system may provide information about other internet plans as per the requirement of the user.

Further, the system may provide offers/suggestions integrated in an electronic account statement of the user. The system may include a bookmarklet that enables displaying offers/rewards in-line with the transaction history of the user. The bookmarklet may be an applet that may be integrated with the browser to show in-line offers when a bank website, that may have the user's account, may be accessed. The applet may be a uniform resource locator (URL) of a bookmark in a web browser or the applet may be a hyperlink on a web page. The bookmarklet may enable the system to provide real-time analysis of the expenses incurred by the user. In an example, a user may wish to compare other product and service options against the analysis of the user's expenses. The real-time analysis may enable the user to find whether the user is over spending on various expenses or not.

Financial institutions including banks, credit unions, credit card companies, and the like may have an interest in providing their customers with value added services. The specifics of the value added services, which may vary among financial institutions, may include some of the systems described herein including user dashboards, customer offers, purchase insights, statement insights, fraud detection, and the like. These value added services may require access to customer anonymized financial data, while at the same time, the financial institutions may have an interest in controlling access to customer financial information due to security concerns, privacy concerns and the like. Described herein is a system where a single point or limited access is made available at the financial institution. This point of access may provide the financial institution with access to a centralized platform, similar to an app store, which may host select financial applications and the like. A financial institute or individual customers may be able to easily select and configure a plurality of desired value added services while access to the financial institute by the plurality of applications is limited. Additionally, this single point or limited access point may act as a conduit for outgoing anonymized customer financial data and incoming insights provided by the value added services. The use of single point or limited access enables greater ease including in the configuration and incorporation mechanisms to verify, validate, filter, execute and the like the value added services. Access to the centralized platform of applications may be on the financial institute dashboard, the user dashboard, the financial web site, a separate application, and the like.

The centralized platform, or application store, may be hosted by a provider of financial service analytics. The provider of the centralized platform may receive the customer financial data from the financial institution. The provider of the centralized platform may allow 3rd party applications on the centralized platform. The provider of the centralized platform may act as a gate-keeper between one or more 3rd party applications and one or more financial institutes to limit the exposure of customer financial information to that needed by the 3rd party service provider. The provider of the centralized platform may vet the service results to assure high quality financial service applications for the financial institutions and their customers.

In an embodiment, the services offered by the system of the present disclosure may be accessed through a JavaScript code. The financial institutions that may be associated with the system may include a single line of the JavaScript that may be added as per their requirement into the account statement page of the user's account. For example, the system may allow advertiser's to create targeted offers that may be delivered through the user's online account statements. The advertiser's may target the users based on many criteria such as zip code, store name, store category, transaction description, purchase frequency, spending amount, and the like.

In embodiments, there may be multiple possibilities for delivery of the rewards. For example, as mentioned herein, JavaScript integration may occur via a financial institution, aka partner, adding JavaScript to online account pages targeted for display of rewards. The system or the partner may host the JavaScript. In another example, push API integration may be used. Here, the system exposes its API to a partner that pushes transaction data to the system, keyed to specific user IDs. This allows the option to push transactions at fixed intervals (batch mode) or preferably upon event (real-time mode). In another example, pull API integration may be used. In pull API integration, a partner may expose its API to the system. The system may request transaction data associated with specific user IDs. The frequency of requests per-user may be done at agreed-upon intervals. In another example, batch transfer, where a partner pushes transaction files to a secure FTP area (hosted by the partner or the system) may be used. The frequency of updates may occur at agreed-upon intervals, such as hourly, daily, and the like. In yet another example, processor integration may be used, where the system integrates directly via an issuer processor to get real-time transactions via authorizations at the merchant processor. In any of the integration methods, integration may provide just the user interface, just the transaction data, or a combination thereof.

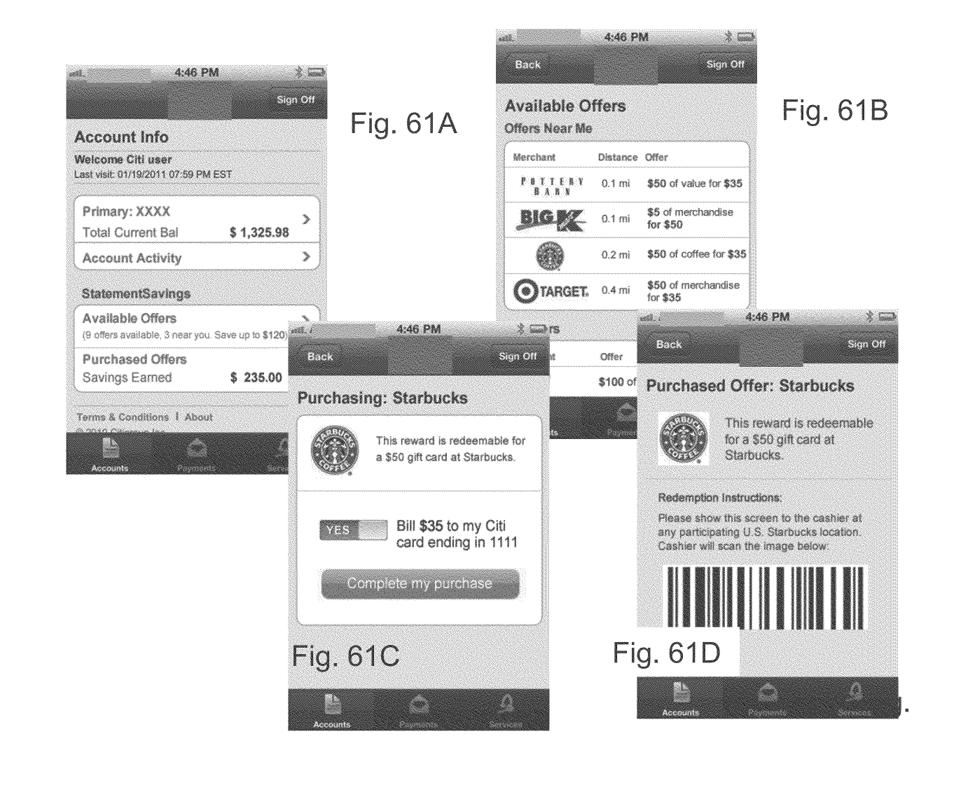

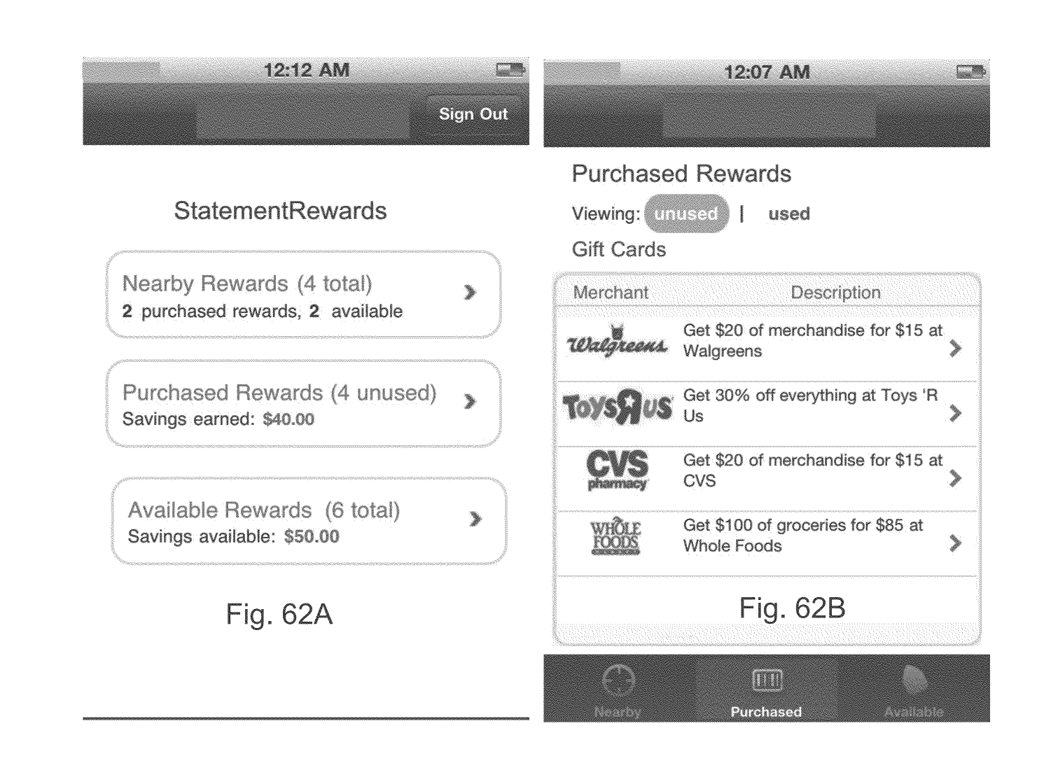

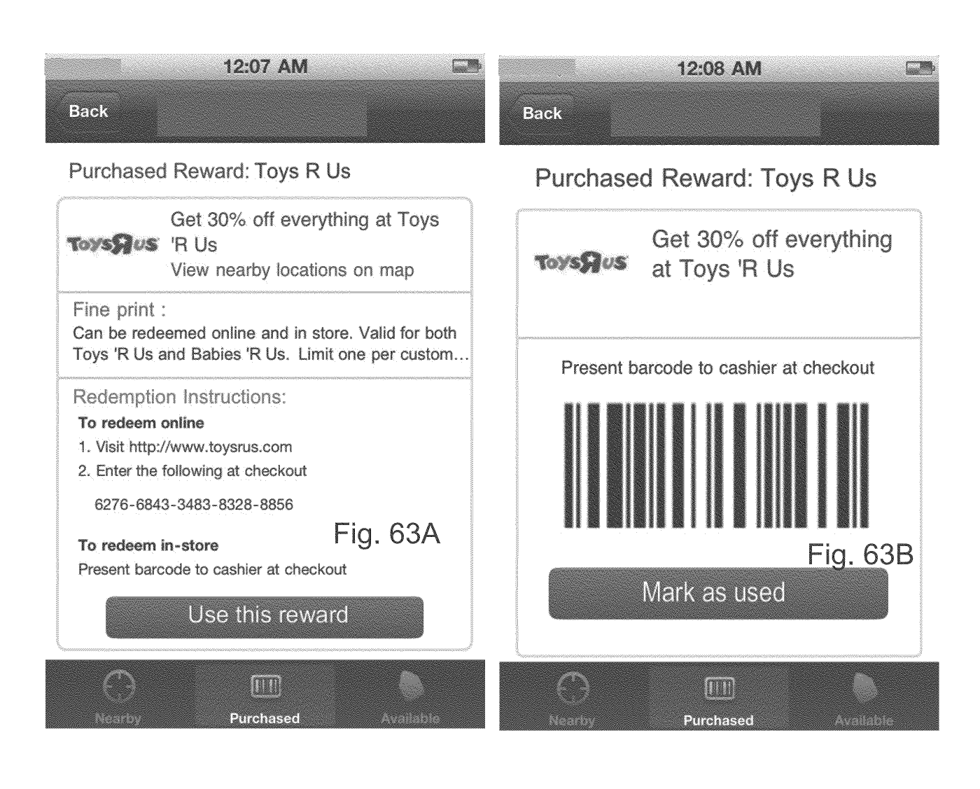

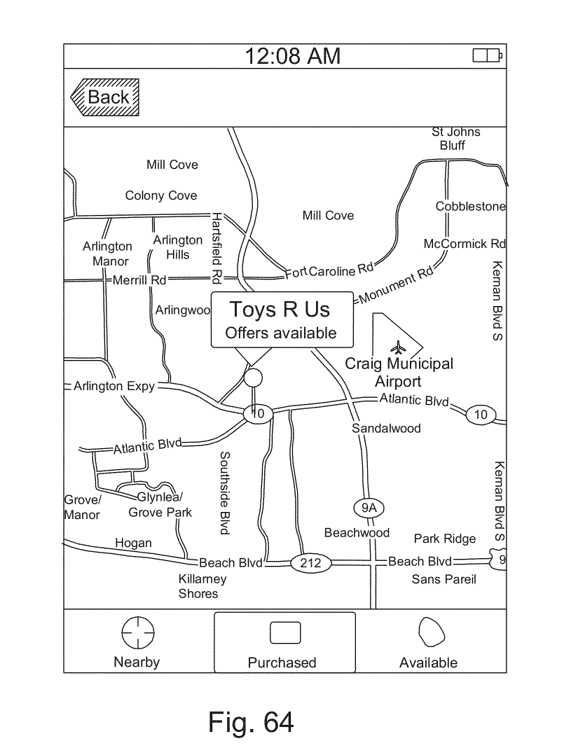

In embodiments, there may be categories based on which the advertisers target the users, in accordance with an embodiment of the present disclosure. In an example, the advertiser's may send selected offers that may target users who may spend around $500 on internet and cell phone bills. The advertiser's may send offers that may provide more features within the limited budget. In another example, the system may enable the advertiser's to track the users based on the category of stores frequently visited by the users. The stores may be categorized as grocery, retail, oil & gas, and the like. The advertisers may give offers to existing users of a store to increase loyalty and spending of the user. The users may click on the offers made by the advertisers to activate the offers. In an embodiment, the system may enable the advertiser's to track both online and in-store purchases for measuring the results and optimizing the offers. The system tracks online and offline redemptions and may report them to advertisers. The system may also send offers through e-mails to various users. In an embodiment, in addition to the online account statement, the system may include mobile abilities and may facilitate SMS notifications to the users. For example, the system may be embodied as a mobile application, such as in FIGS. 61-65. FIGS. 61A-D show an exemplary embodiment of a mobile application. In FIG. 61A, a summary of a user financial account is displayed showing current balance, an indication of account activity available, available savings opportunities, potential savings, purchased offers, savings earned, and the like. FIG. 61B depicts available savings opportunities which can be filtered by which opportunities are in geographic proximity to the mobile device. Thus, certain savings opportunities may be geo-enabled, that is, targeted by the financial history of the user but filtered for presentation to the user by geographic location. Other savings opportunities may be geo-targeted, that is, the savings opportunity is targeted to the user via their location. Other savings opportunities may be geo-enhanced, that is, if a user does not use the savings opportunity online, the merchant can choose to add an incentive when the user is within geographic proximity to the merchant. The merchant may determine the incentive, such as an additional percentage off, a dollar amount discount, an additional savings opportunity, the opportunity to share the savings opportunity, a related opportunity (such as meeting a personality at the merchant location, etc.), and the like. The merchant can set the geographic area in which to trigger the incentive. In any event, the mobile device may be used to accept the offer, which may include auto-billing to a financial account associated with the merchant or the system. FIG. 62C depicts selection of one of the savings opportunities and FIG. 62D depicts redemption instructions, including a bar code for scanning, for the purchased savings opportunity. Instead of a bar code, a QR code, a numeric or alpha-numeric code, or a pin can be used. FIGS. 62A-B shows another exemplary embodiment of a mobile application. In FIG. 62A, a summary of savings opportunities is displayed showing nearby savings opportunities, purchased savings opportunities, and all available savings opportunities. In FIG. 62B, the purchased savings opportunities are viewed. The user can switch the view between the unused savings opportunities, shown here, and the used savings opportunities. In FIG. 63A, one of the unused savings opportunities from FIG. 62B is shown in greater detail. The user may indicate the intent to use the savings opportunity. In response, and referring to FIG. 63B, the user may receive a code, such as a bar code, QR code, alphanumeric code, PIN, or the like, to redeem in-store or online. FIG. 64 depicts the merchant on a map.

Further, the system may offer a “deal-of-the-day”, such as a discount on a single type of product for 24 hours, wherein the product is chosen based on a user's past transactions. In an embodiment, the various offers/suggestions provided by the system may be available in the form of printed coupons that may be used at a retail point of sale (POS) terminal. The offers may be delivered to the users through mails, e-mails, gift vouchers, and the like. The users may take a print of the offers sent through e-mails and may show at the POS terminal for redeeming the offer.

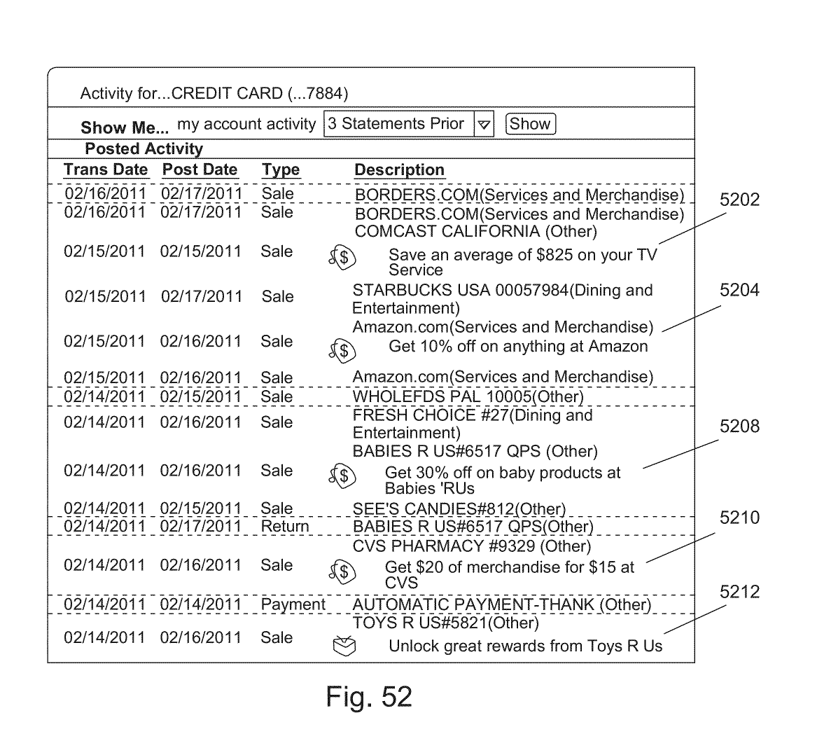

Referring to FIG. 52, a user's statement is displayed with various rewards indicated in association with particular transactions. It should be understood that this example uses an online credit card statement, but the statement could any one of an online statement, an online graphical user interface associated with a user's financial institution account, an online bill pay area, a dialog box associated with the user's financial account, an ATM receipt, a teller receipt, a mobile statement, a paper statement, and the like. The statement rewards indicated in FIG. 52 include a bill analysis opportunity 5202, a savings opportunity 5204, 5208, 5210 and a future reward 5212. A user may click on the various opportunities and rewards to expand the description.

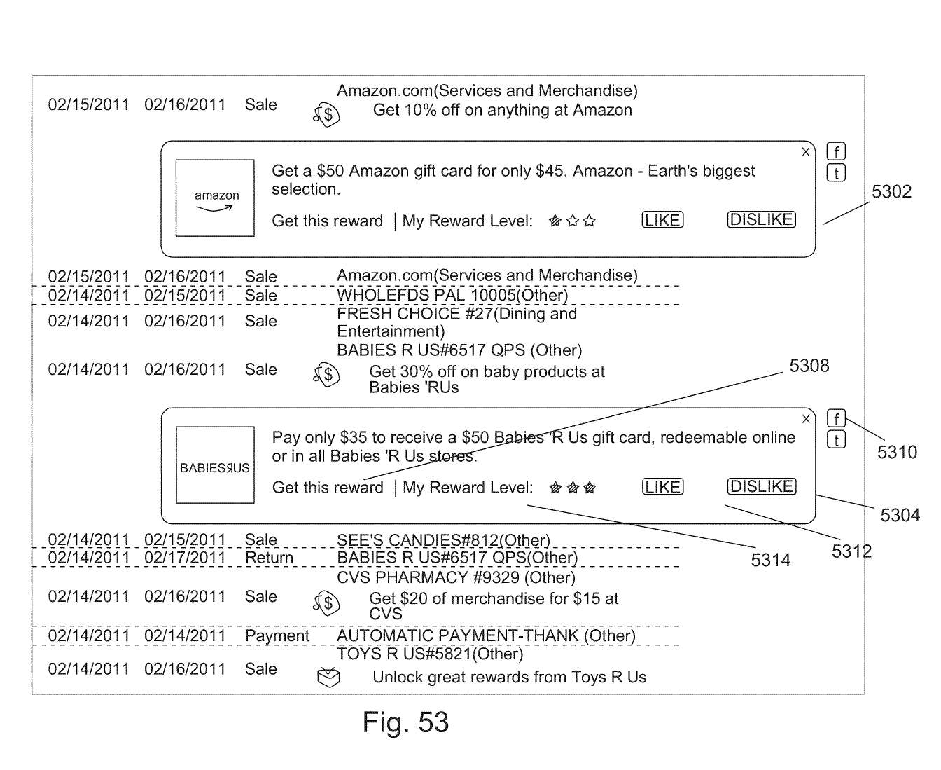

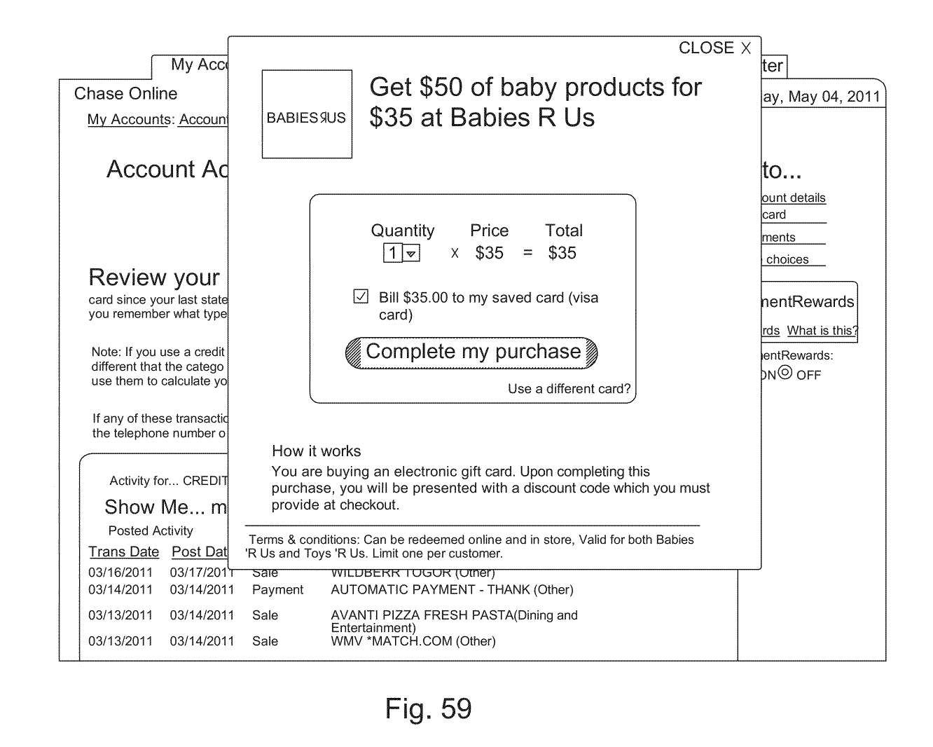

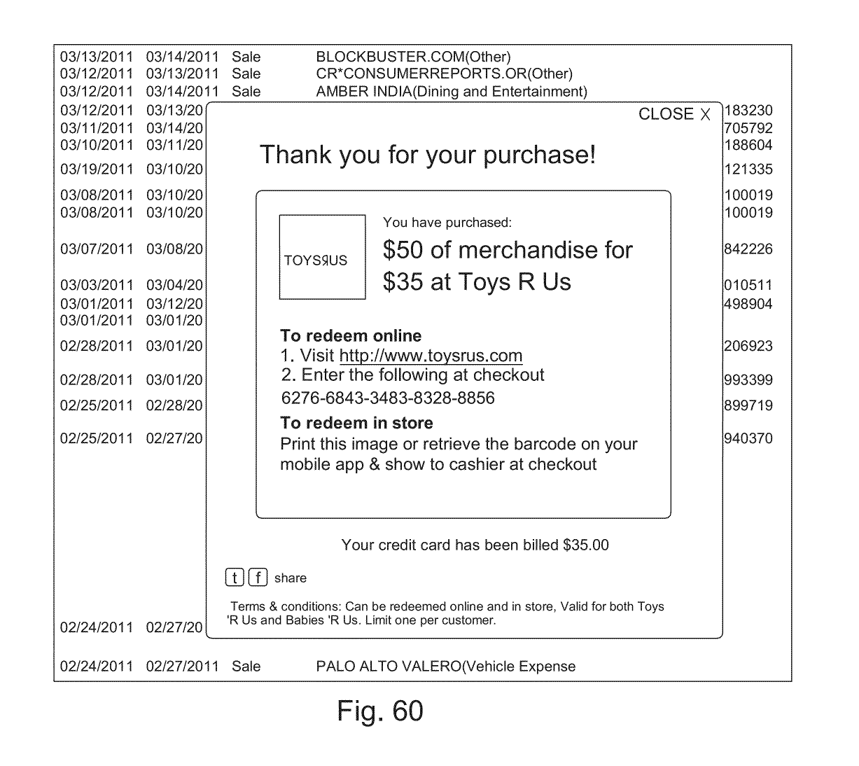

Referring to FIG. 53, the savings opportunity 5204, 5208 elements are shown in expanded form 5302, 5304, respectively. In this opportunity, a user's prior transaction at Babies R Us triggered a savings opportunity to the store to be offered. The opportunity is a $50 electronic gift card for only $35. The user can indicate that they want that savings opportunity via clicking on a link 5308 and obtaining the purchase screen in FIG. 59, can indicate that they like or dislike the opportunity by clicking a sentiment button 5312, can share the opportunity with a social network by clicking a share button 5310, and the like. Once the purchase of the electronic gift card is complete, confirmation of the purchase may be given, such as that shown in FIG. 60, along with redemption instructions.

There is an indication of reward level 5314 in the savings opportunity. Actions, such as sharing the opportunity, liking the savings opportunity, accepting the savings opportunity and the like may improve the reward level 5314. The savings opportunity may improve with reward level.

The reward levels may be tiered. A merchant or the financial institution may set the reward level tiers. For example, one merchant may set reward levels based on number of visits, another may set them on total spend, while yet another may set levels based on a combination of the two. Via auditing and analyzing transactions, the system 2700 can keep track of reward level status.

In some embodiments, in order for a user to share the savings opportunity, such as by using the share button 5310, the savings opportunity must first be social-enabled by the merchant. When the merchant social-enables a savings opportunity, a shared savings opportunity is created. The shared savings opportunity is designed for the user to share, and may not be subject to the same criteria that may have triggered the offering of the original savings opportunity to the user. The system may track redemption of the shared savings opportunity by individual user or in aggregate. The system may track redemption of various shared savings opportunities to determine which user might have broad influence. The system may then target the influencer with improved, more frequent, or more exclusive savings opportunities.

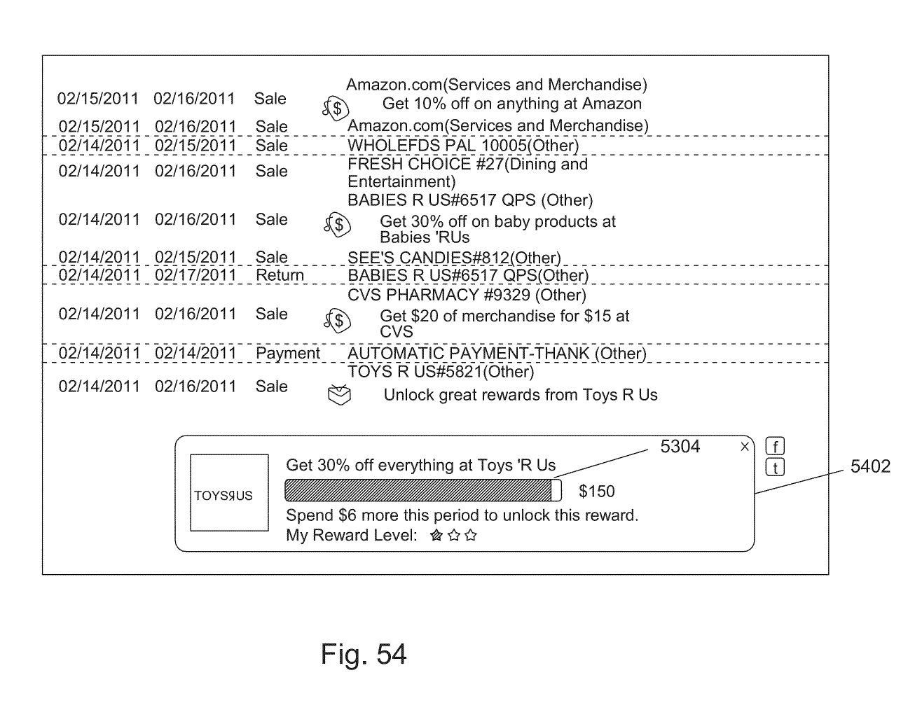

Referring to FIG. 54, a savings opportunity is shown in expanded form. The savings opportunity depicted here is a future reward 5402. A future reward may be given to a user if the user meets certain goals. For example, to receive a 30% discount at the toy store in the example of FIG. 54, the user would have to spend $150 during a particular time period at the store. The system automatically tracks progress towards meeting the goal with a progress bar 5404 or some other depiction, along with an indication of the actions needed to complete the goal. The progress bar 5404 may be updated as new transactions at the toy store are made. As with the other rewards, the future reward 5402 may improve as reward level improves. The future reward 5402 may be shared with other users or a social network. The future reward 5402 may be liked or disliked. The future reward 5402 may be based on at least one of a past transaction and some future transaction behavior.

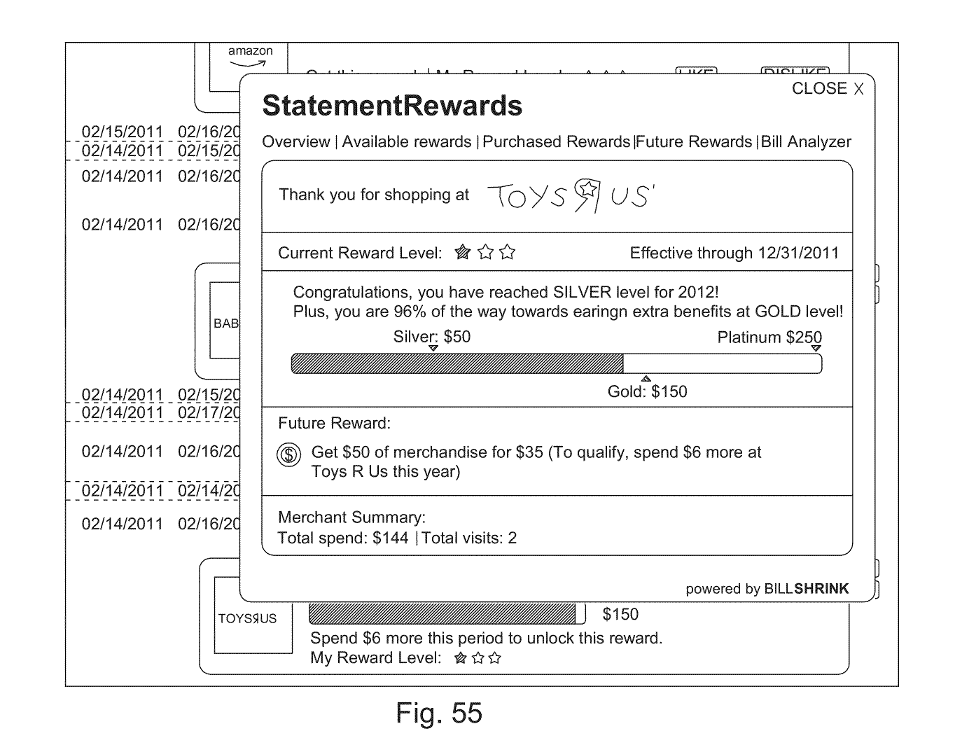

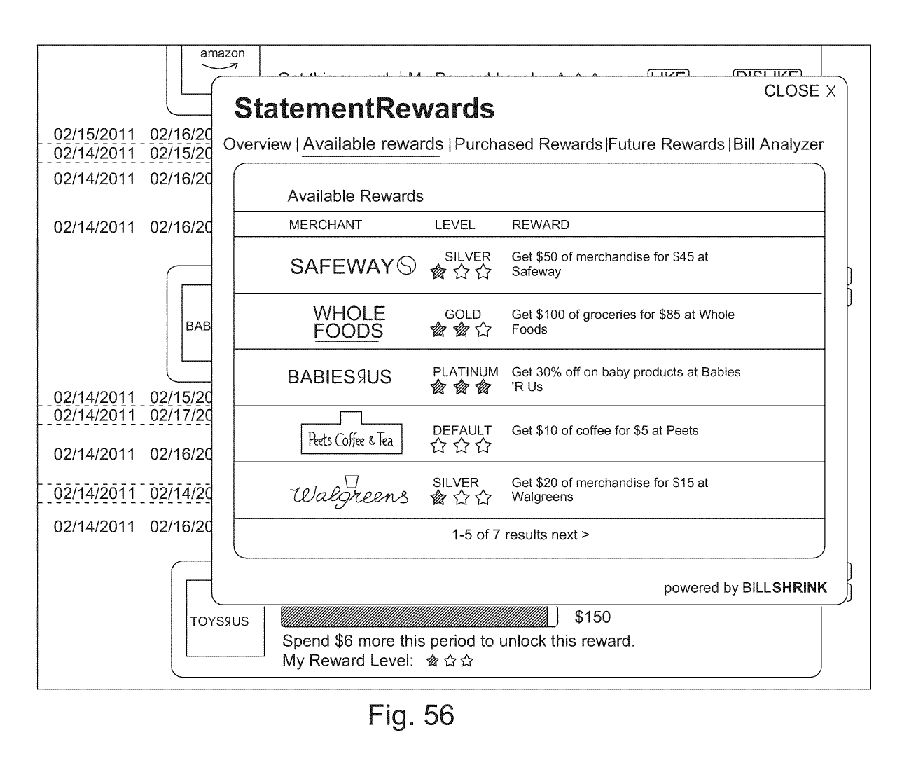

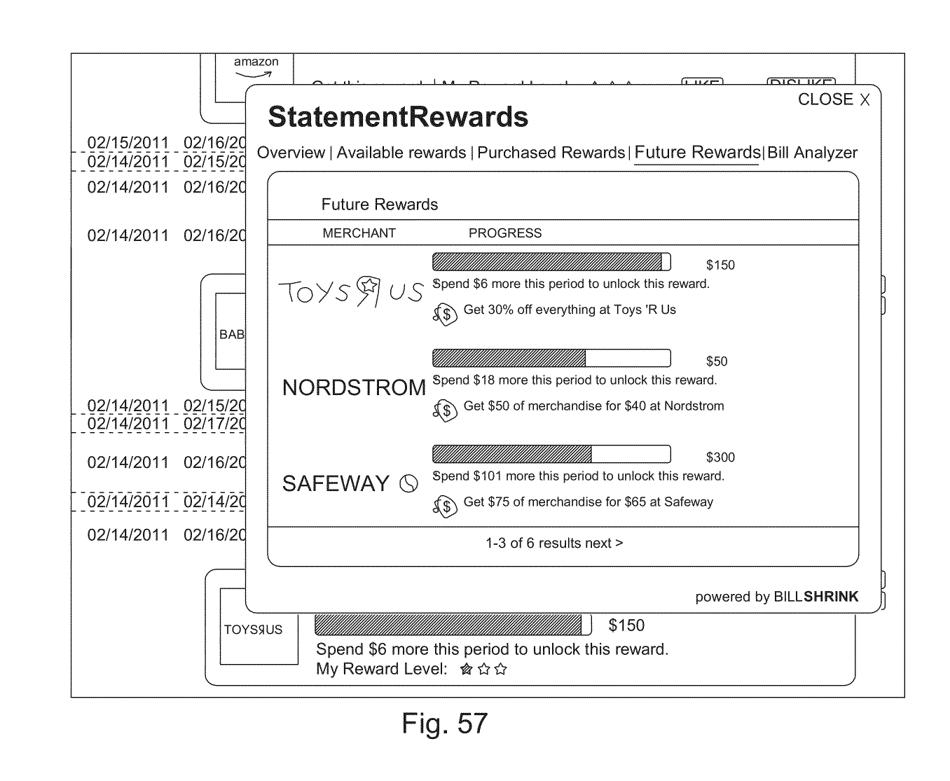

Using a user dashboard, the user may be able to view all of their reward level statuses with each merchant, view all current rewards, view all future rewards, and the like. Referring to FIG. 55, an embodiment of a user dashboard is shown with additional detail regarding the future reward 5402, including the merchant, the future reward, the current reward level, the effective date, progress towards an improved reward level, a total spend summary, and a total visit summary. Other information available in the user dashboard includes an overview, available rewards listing, purchased rewards listing, future rewards listing, a bill analyzer, past rewards, and the like. Referring to FIG. 56, an exemplary user dashboard is shown with the Available Rewards tab displayed. Information on the tab may include merchant, reward level, reward, and the like. Referring to FIG. 57, an exemplary user dashboard is shown with the Future Rewards tab displayed. Information on the tab may include merchant, future reward, progress towards future reward, and the like.

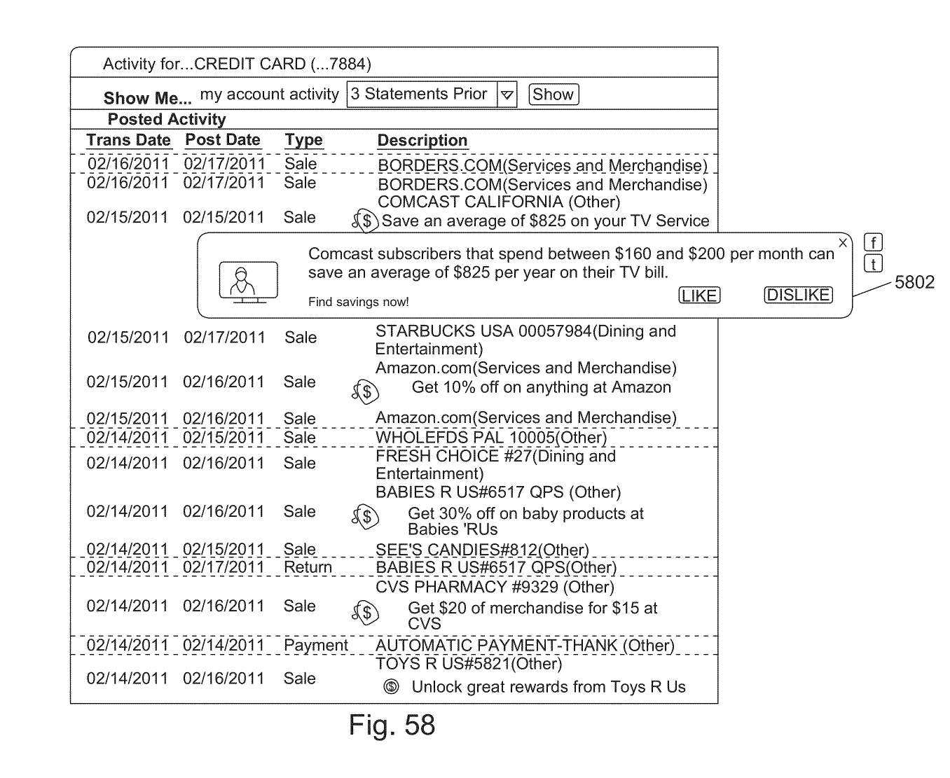

Referring to FIG. 58, the bill analysis opportunity 5202 is shown in expanded form 5802. It too can be shared and liked or disliked.

The system of the present disclosure may include dashboards, such as a merchant dashboard, financial institution dashboard, user dashboard, and the like. Each dashboard may show the appropriate audience how users are doing with all the offers being shown to them, such as opens, clicks, and purchases, as well as enable them to edit and manage the rules governing offer presentation by interfacing to the rules database.

In an embodiment, a user dashboard that may be used for hosting various mini-applications. Users may click on a dashboard icon to activate the dashboard. The dashboard may enable the users to edit the various mini-applications of the dashboard. For example, the users may move the mini-application icons, rearrange the icons on the dashboard, delete some of the mini-applications, recreate the mini-applications so that more than one of the same mini-application is open at the same time, and the like.

In an embodiment, the system may include a merchant dashboard, a financial institution dashboard, and a user dashboard. The merchant dashboard may be used by the various merchants and advertisers for displaying various offers that are being made by them. The various offers may be listed under a tab on the dashboard. The users may click on the tab to view all the offers provided to them. Further, the merchant dashboard may enable a merchant to display the offers in different categories. For example, few offers may be in the form of discount coupons that may be redeemed if a user spends a pre-defined amount. The system may track the activities of the users and may inform the merchants about the user activities. For example, the dashboard may provide information about the number of users who have viewed the offers listed by the merchants. The merchants may also get information about the offers that may be redeemed by the users, and the like. Further, the merchant dashboard may include a merchant re-categorization tool that may facilitate the merchants to categorize themselves as per their business. For example, some merchants may categorize themselves as a retail merchant, oil and gas merchants, and the like.

A multi-merchant loyalty platform is a “universal” program where points apply across the entire financial life of the individual (e.g. points for all their spending, rewards in every area they spend on), as has been described previously herein with respect a loyalty program, loyalty-based offers, and FIGS. 24 and 25. FIGS. 53, 55, and 56 also illustrates a reward level aspect of a loyalty program, wherein the loyalty-based offers are filtered or modified by reward level. In effect, the financial institution card becomes a loyalty card at multiple merchants with no separate card to sign up for or swipe at every purchase.

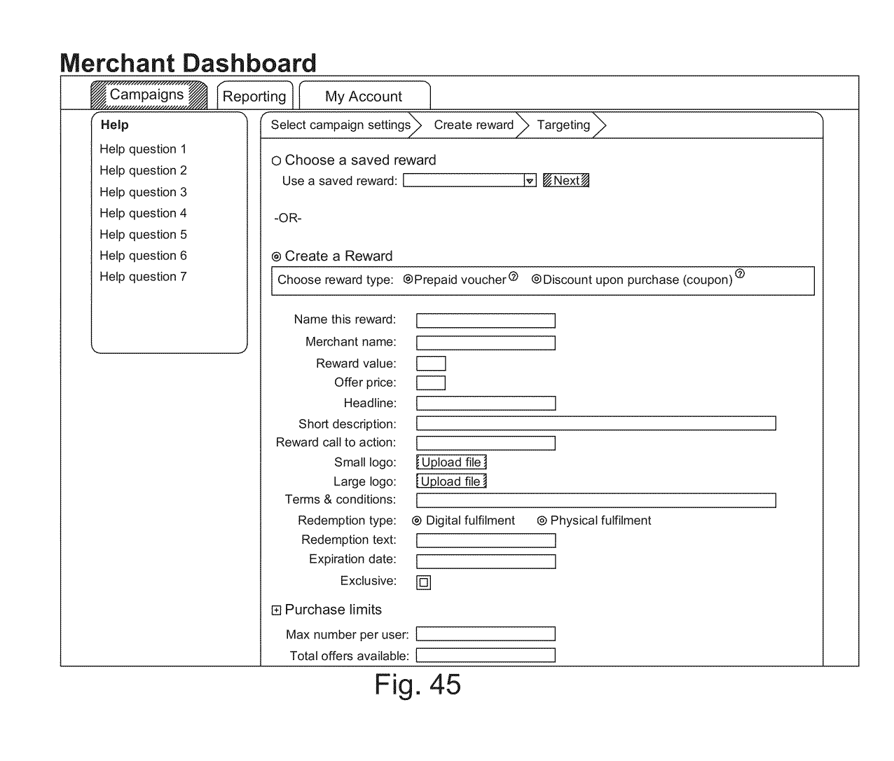

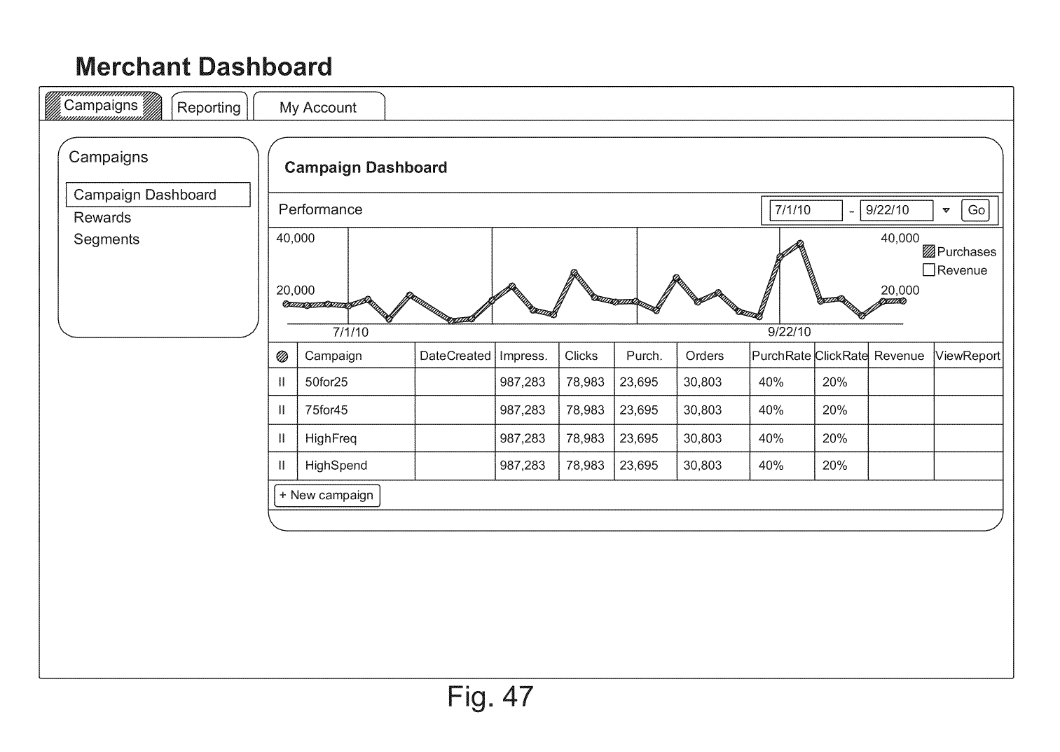

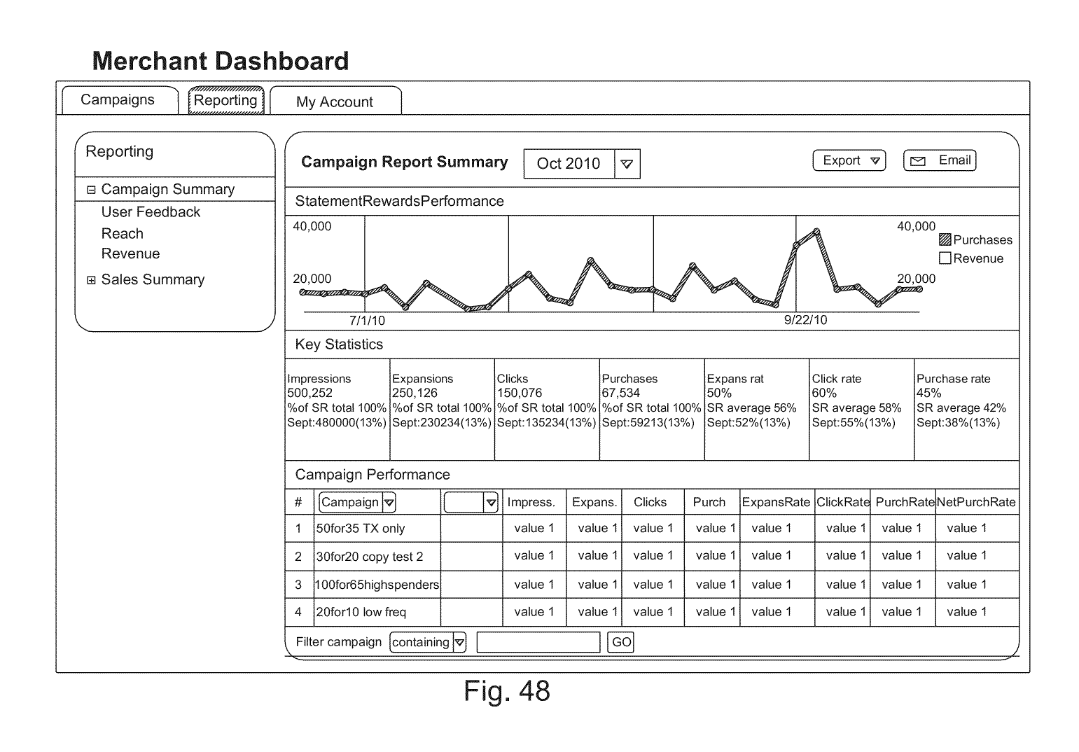

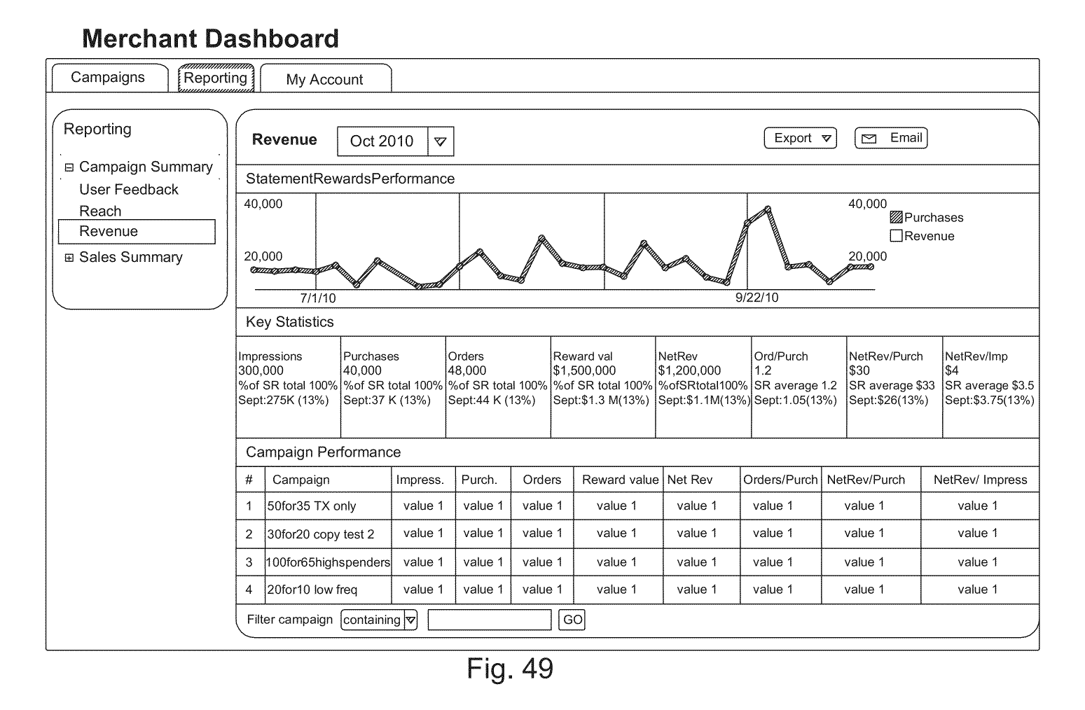

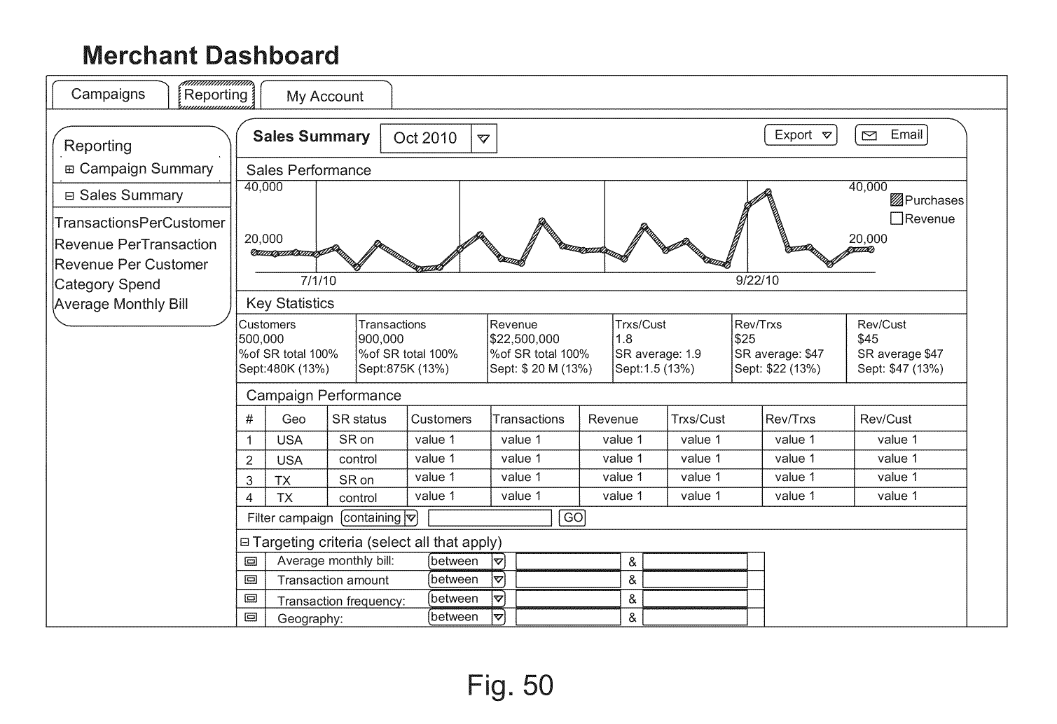

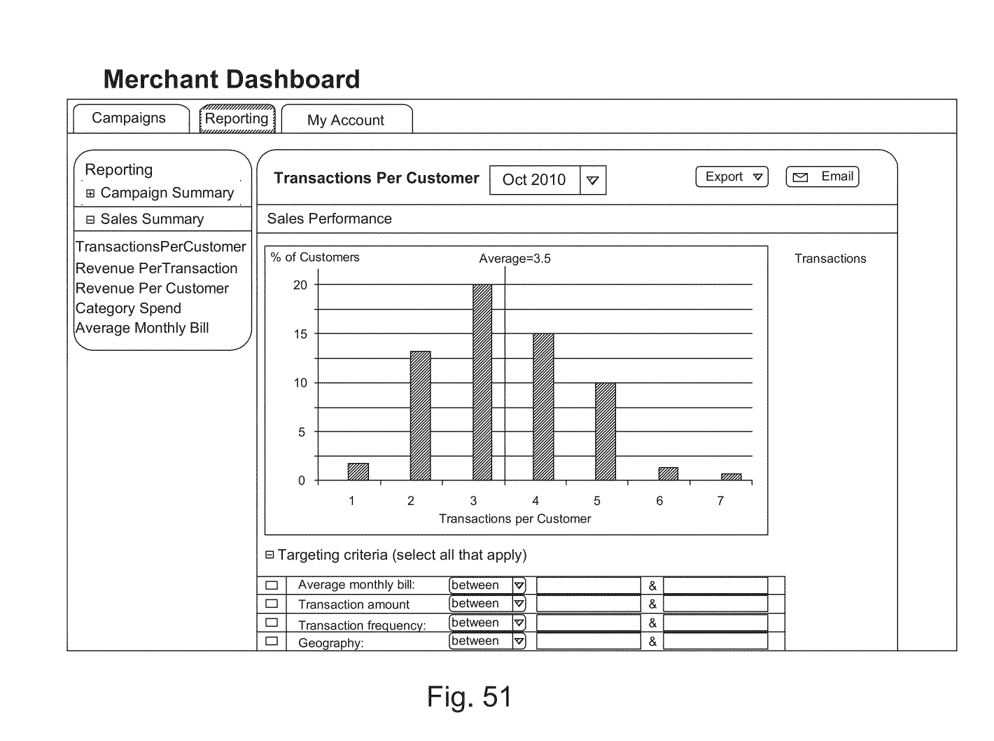

To facilitate receiving feedback regarding campaign effectiveness, adjusting campaign parameters mid-campaign, and the like, merchants may use a self-service platform, or dashboard, which may be financial institution co-branded, to oversee various aspects of the multi-merchant loyalty platform, such as in FIGS. 45-51. The merchant dashboard may allow merchants to review data for all of their customers, not just those with a particular financial institution. The merchant dashboard may include one or more campaign tabs, reporting tabs, a “My Account” tab, and the like as illustrated in FIGS. 45-51.

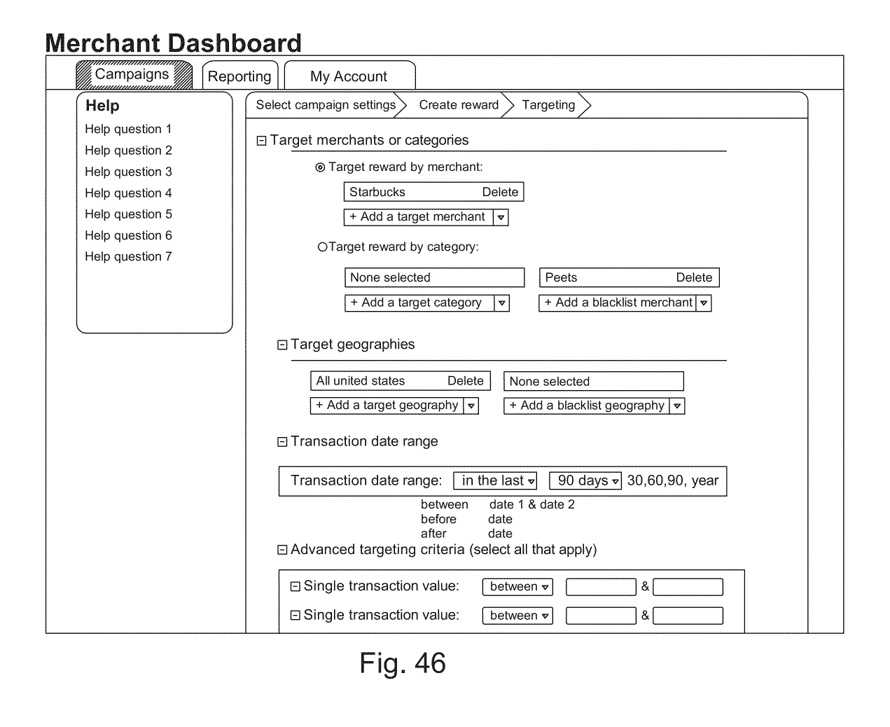

The campaign tabs may include ongoing, real time monitoring of campaign performance and enable the merchant to directly modify the offer targeting algorithm to update targeting criteria and impose constraints on an individual campaign basis. The dashboard may further enable merchants in choosing a saved reward, creating a reward, setting reward matching criteria, purchase limits, targeting merchants or categories, targeting rewards by merchant, targeting geographies, date range, the ability to configure and view performance metrics and graphics specific to individual or multiple campaigns, the ability to group different campaigns under a common theme such as new customer acquisition, the ability to reconfigure multiple campaigns, current and future, to be subject to common sets of constraints that can drive similar/dissimilar targeting approaches, and the like. Data viewable on the merchant dashboard may include: category performance such as % shoppers in a category, % dollar spend in a category, % store visits in a category; customer profiles such as spend distribution and visit frequency distribution; regional insights such as same store analysis and a geographic spend profile. A campaign builder, as depicted in FIGS. 45 and 46 may be included in the dashboard and may be used to set reward specifications, provide reward text, determine if the reward is eligible for social sharing. A performance review may give statistics on impressions, engagement rate, purchases, purchase rate, engagement metrics (e.g. expansions, likes, social network shares, change in monthly activity), top active campaigns, and an account profile.

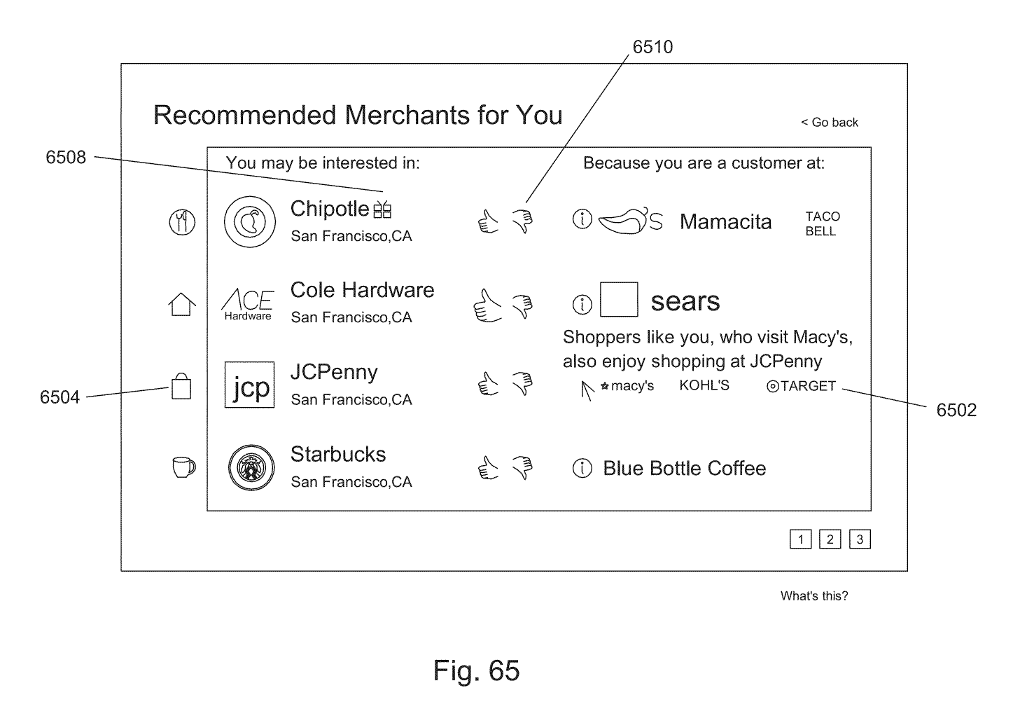

The merchant dashboard may also include a reporting tab including performance graphics, key statistics, business analytics, campaign summaries, user feedback, campaign performance as a function of individual campaign, groups of campaigns or overall, sale performance, transactions per customer, revenue per transaction, revenue per customer, category spend, average monthly bill and the like. The reporting tab may also include purchase insights, or spend pattern metrics, which may be useful for providing recommendations based on a cardholder's transactions and social benchmarking of their spend. Purchase insights can provide analysis to merchants and consumers about purchases, as depicted in FIGS. 65-67. The data reported may include data on current and historic campaigns.

Frequently, the intent of a marketing or advertising campaign is to entice a customer to try a merchant's service or product with the hope that the customer will have a positive experience and purchase from the merchant in the future. In some embodiments, the campaign may be structured in such a way that the merchant gains information about more than just the effectiveness of a specific campaign. This additional information may also include data on how the campaign influences the subsequent buying behavior of different target demographic groups and how the immediate and subsequent buying patterns of different target demographic groups vary depending on whether or not a promotion was offered or the type of incentive offered. Feedback may be obtained on what user-segments reacted the most to the presented offer, what was the lift or increase in merchant revenues as a result of the offer-campaign, and how the offer campaign can be updated to attract more revenues.

Obtaining additional insight may be facilitated by an embodiment that enables a merchant to identify target characteristics of interest including demographics such as gender, age, ethnicity, location, income, marital status, family size, job status, educational levels or status, shopping habits, interests and the like. Then two or more groups or cohorts are created from users whose transaction data are known, where all the members of the plurality of cohorts exhibit the target characteristics of interest. One group, the control group, may include those who did not enroll or opted out of receiving offers and thus did not or will not receive offers. One or more additional groups or cohorts, who did or will receive offers, are also created. Although the customers in the different groups all feature the target characteristics of interest, other characteristics may be randomly distributed among the groups. These additional characteristic data are kept and may be used in subsequent analyses. Offers are presented to the one or more non-control groups or cohorts. The type or size of offer may vary among the non-control groups.

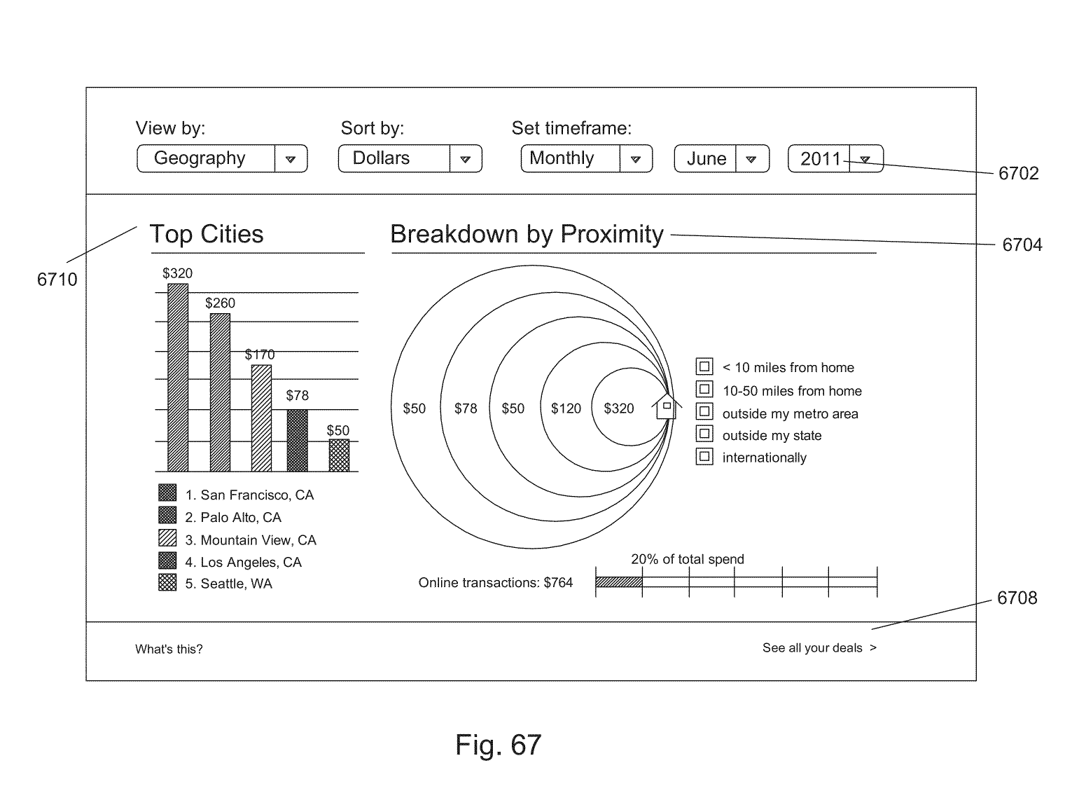

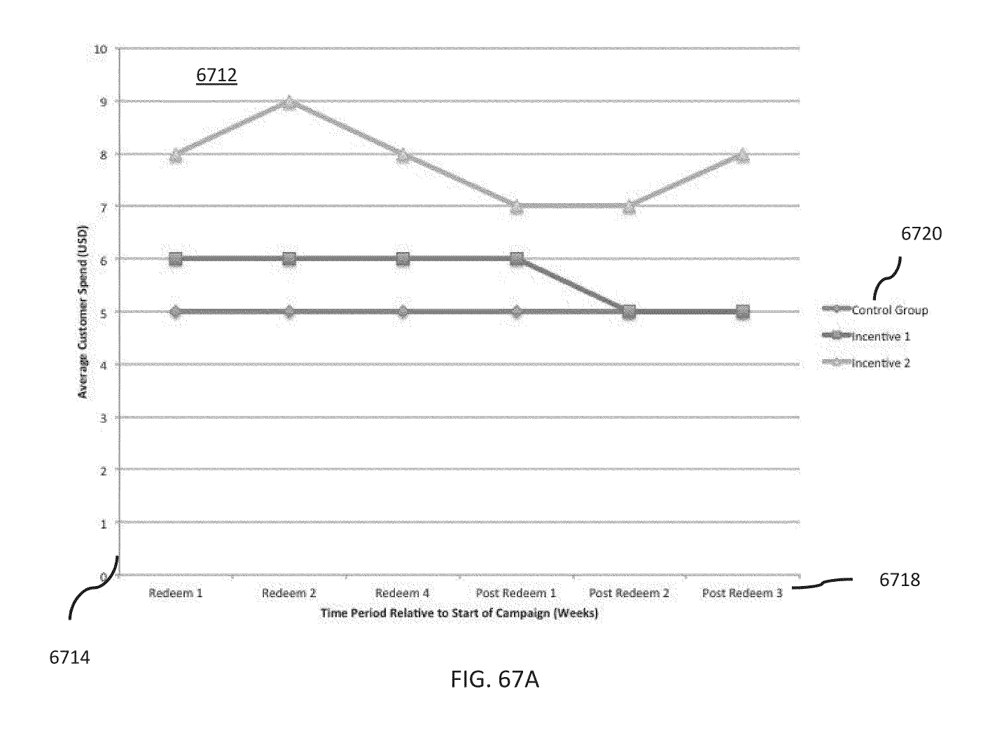

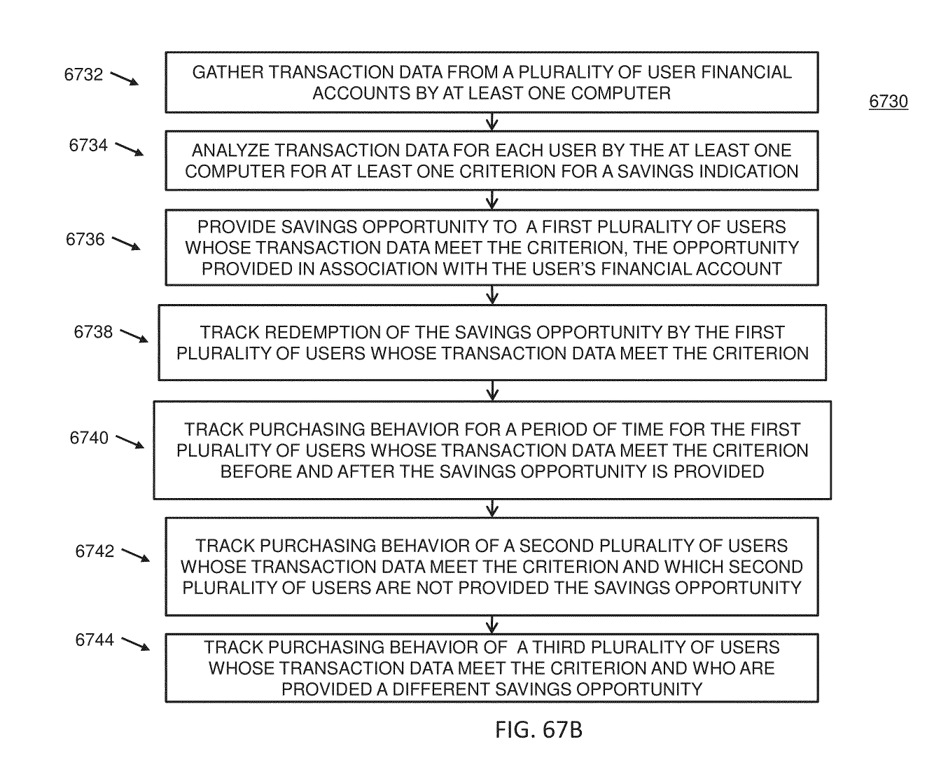

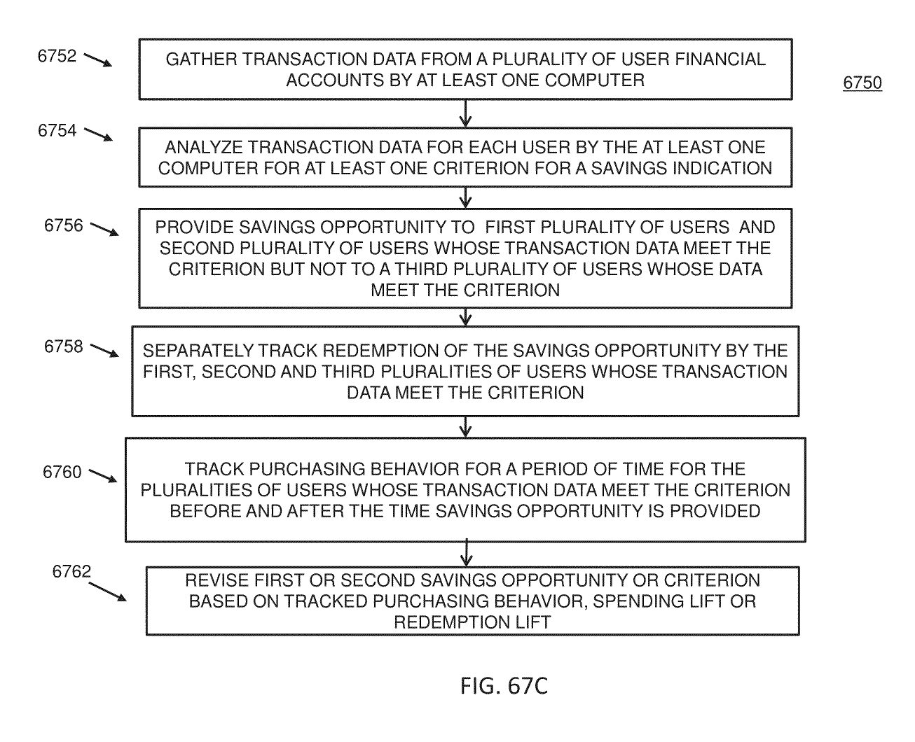

Tracking the purchasing behavior of the two or more groups, including those who received an offer and those who received alternate offers and no offers, allows the system to calculate and compare data, such as average total spend by group, average ticket size, and user spending below an offer dollar threshold for the different cohorts or groups. However, the presence of multiple data sets featuring the same customer target characteristics, but differing in whether or not one or more offers was presented, enables more in-depth analysis of the effectiveness of the offers. Analysis of the data may be done with respect to incremental redemption lift between the groups, incremental revenue to the merchant based on the offers, incremental spend lift, and the like. Additionally, the data may be used to fine-tune future offers based on the response to different variations on the offer such as type of offer, size of offer, variations in long term impact of offer based on demographic characteristics and the like. In addition to tracking the immediate purchasing behavior, the purchasing habits of the two or more groups may be tracked over time as shown in FIG. 67A to identify any lasting change in customer behavior, new customer acquisition and the like between the plurality of groups. FIG. 67A shows an effectiveness graph 6712 plotting average customer spend 6714 over time of campaign and beyond 6718 for different cohorts or groups 6720. This information may then be used to evaluate the long term effectiveness of a particular campaign, not just with respect to participation in a single offer or transaction, but across time and potentially involving numerous transactions. This facilitates the merchant's understanding the impact of the offer on merchant revenues and allows the merchant to manipulate the various campaigns to optimize its marketing budget.

Methods of implementing these marketing campaigns are depicted in the flowcharts of FIGS. 67B and 67C. In a first embodiment, depicted in FIG. 67B, method 6730 includes a first step 6732 of gathering transaction data by at least one computer from a plurality of user financial accounts, the financial accounts held at financial institutions. Financial institutions may include banks, savings and loan associations, credit card companies and the like, as opposed to accounts held by the merchants themselves. The transaction data for each user is analyzed 6734 to see whether the transaction data meets a particular criterion set by the merchant. The criterion may be any qualification or quality desired by the merchant, such as, without limitation, identifying users who have purchased a particular item or category of merchandise, a minimum amount of purchases by the user in a given time period, a number of visits to the merchant's store or web site, and so forth. The at least one criterion may also relate to the characteristics or demographics of the user. Such characteristics may include, without limitation, consumer gender, income level, location, marital status, family size, educational level, shopping characteristics or habits, personal interests, age, ethnicity, and the like.

In the next step 6736 of the method, the merchant or a third party marketer acting on behalf of the merchant, provides a savings opportunity to a first group or plurality of users that meet the at least one criterion or criteria. The opportunity may be presented online in association with the user's financial account, such as when the user logs on to the website of the financial institution to review his or her bill, or when the user receives an electronic bill or statement of his or her account. As discussed throughout this disclosure, the user may elect to take advantage of the opportunity or to explore the opportunity further. The opportunity may include a better product or service, or a less expensive product or service. The merchant or the third party then tracks 6738 redemption of the savings opportunity by the first group of users whose transaction data met the at least one criterion. In addition, the purchasing behavior of this first plurality of users may be tracked 6740 for a period of time, and information gathered, on the relevant purchases of the users both before and after the savings opportunity is provided to the first plurality or group of users.

Similarly, behavior may be tracked 6742 for a second group of users or consumers whose transaction data meet the at least one criterion, but who were not provided the savings opportunity. The second group of users may also qualify for tracking by virtue of their demographics or other characteristics desired by the merchant. Alternatively, or in addition, tracking may be conducted 6744 on a third group or plurality of users whose transaction data meet the at least one criterion but who are provided a different savings opportunity. By noting the differences in incentives or savings opportunities, the merchant or the third-party marketer can use more effective marketing techniques. These techniques may be refined so that marketing or advertising campaigns may be more effectively tailored to the groups most likely to respond to a future campaign.

An embodiment is depicted in FIG. 67C. Method 6750 includes several steps for conducting an improved marketing or advertising campaign. The first step, as before, is to gather 6752 transaction data from a plurality of user financial accounts using at least one computer. The transaction data are analyzed 6754 for each user by the at least one computer for at least one criterion for a savings indication. As before, the criterion may be a demographic criterion or may be based on the purchasing behavior of the users. In this method, a savings opportunity is provided 6756 in association with an online statement of the financial institution account of selected users. The selected users may include a first group or first plurality of users and a second group or second plurality of users whose transaction data meet the at least one criterion. The savings opportunity is not undertaken by a third group of users, i.e., a control group of users, whose transaction data also meet the at least one criterion.

During the campaign, the redemption of the savings opportunity is tracked 6758 separately for the three groups of users whose transaction data meet the at least one criterion. In one embodiment, the redemption and the purchasing behavior of the pluralities of users is tracked 6760 for a period of time. The tracking may take place after the start of the campaign; in addition, data of past transactions of the users for the product or service of interest may be gathered and also analyzed or tracked in this manner. The purpose of the tracking and analyzing is to help accomplish the marketing goals of the merchant or the third party marketer. Thus, when the campaign results are tabulated, the parameters of the campaign may be revised 6762. The revision may take the form of altering or changing the savings opportunity provided to the first group or to the second group; the revision may be accomplished by altering the at least one criterion of the transaction data, by revising any application demographic criterion or criteria used, and so forth. The parameters, details and results of each campaign may be stored by the merchant, the third party marketer, or both. The results may be stored in any convenient electronic storage. The storage may take place in a merchant dashboard, described herein.

The merchant dashboard may also include a “My Account” tab including updating or customizing merchant and business information, updating or customizing specific campaign information, linking campaigns together, and the like. The merchant dashboard may be white-labeled. The merchant dashboard may be self-service.

In an embodiment, the financial institution dashboard may allow the financial institution to connect with the system for providing various offers to the users. The financial institution dashboard may facilitate the financial institutions that may be associated with the system to track the users. The financial institution dashboard may allow the financial institutions to track the opted-in accounts by the users. The opted-in accounts may be the accounts that may be majorly used by a user and the account on which the user may wish to receive offers. Further, the financial institution dashboard may accumulate preferences of the user for receiving the offers. For example, the financial institutions may get information about the offers which the user may wish to receive as a part of their account statement, and the like. Further, the financial institution dashboard may enable the associated financial institutions to re-categorize the merchants as per their convenience. The financial institutions may change the categories in which the merchants may have classified themselves; the financial institution dashboard may enable the financial institutions in doing so.

In an embodiment, the user dashboard may include information about all the offers that were redeemed by the users. The user dashboard may also enable the users to view various transactions done by the users over a specific period such as over a week, over a month, and the like. Further, the user dashboard may include information about the various rewards that may be received by the user. For example, the information may include the minimum amount that the user may need to spend in a day for being eligible for a reward, the number of the times the user may need to shop in a specific category of stores for being eligible for the reward, and the like. Further the user dashboard may also include a merchant re-categorization tool that may enable the users to categorize the merchants as per their convenience.

As mentioned earlier, the users may be provided offers through their account statements and may also get rewarded on using the transaction cards such as a credit card, a debit card, and a pre-paid card. In an embodiment of the present disclosure, the financial institutions associated with the system may get paid when a user redeems an offer provided by the financial institution. For example, if the account statement of the user suggests a cheaper cell phone plan, the user may compare his/her present plan and the suggested plan. If the user activates the suggested plan, the financial institution may get revenues from the redemption. However, if the user decides to continue with the earlier plan, the financial institution may not get any revenue. In a similar scenario, the system may also generate revenues if a user redeems an offer suggested by the system. The offer suggested by the system may be sent to the user in the form of a text message, an e-mail, and the like.

The rapid growth of highly specialized applications may be overwhelming for customers as there may be multiple passwords to remember, multiple user interfaces to learn, difficulty in locating desired information and the like. An example of this may be the many disparate individual offer-distribution mechanisms provided by the different offer-providers including financial institutions such as banks, credit unions and the like, credit cards, merchants and the like. In this environment a customer may have to visit multiple applications to interact with their offers, such as to view, generate, access, redeem, and the like. In an embodiment of this system, a digital wallet mechanism, as is known in the art, may be enhanced with an ability for the customer to interact with their offers, such as to view, generate, manage, select, organize, redeem and the like without having to log-in individual financial institution websites or applications. FIG. 62B illustrates an example of these interactions. Such enhancement may be embodied in a dashboard. Another feature may include the ability to utilize the geographical awareness functionality available on many mobile devices to make new offers available to the user as a function of their geographic location. Another feature may include the ability to alert the customer regarding their offers including newly available offers, goals to reach new offer levels, actions required to obtain new offers and the like.

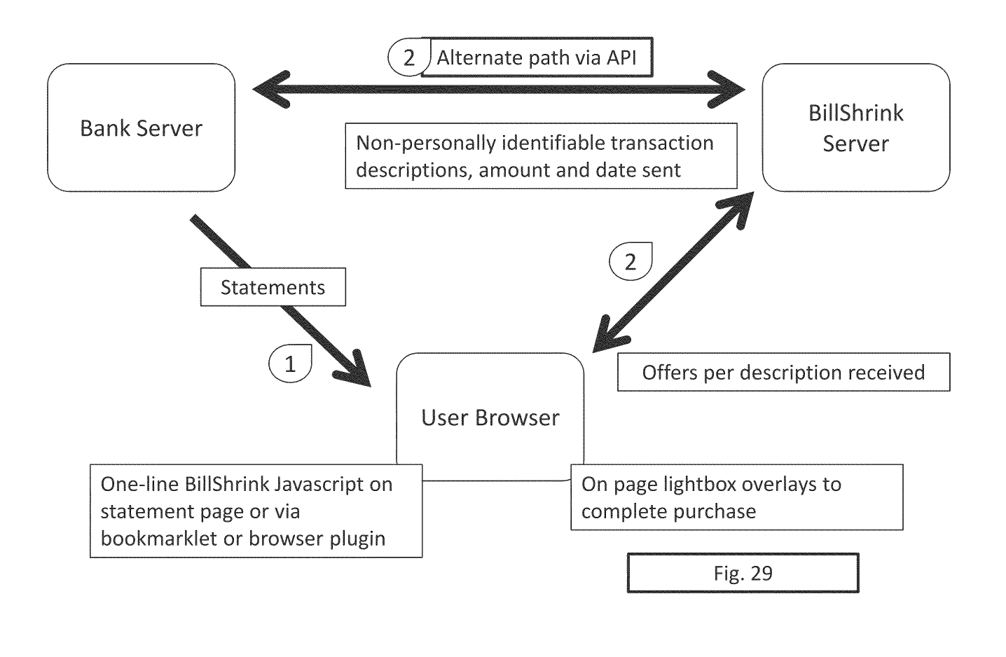

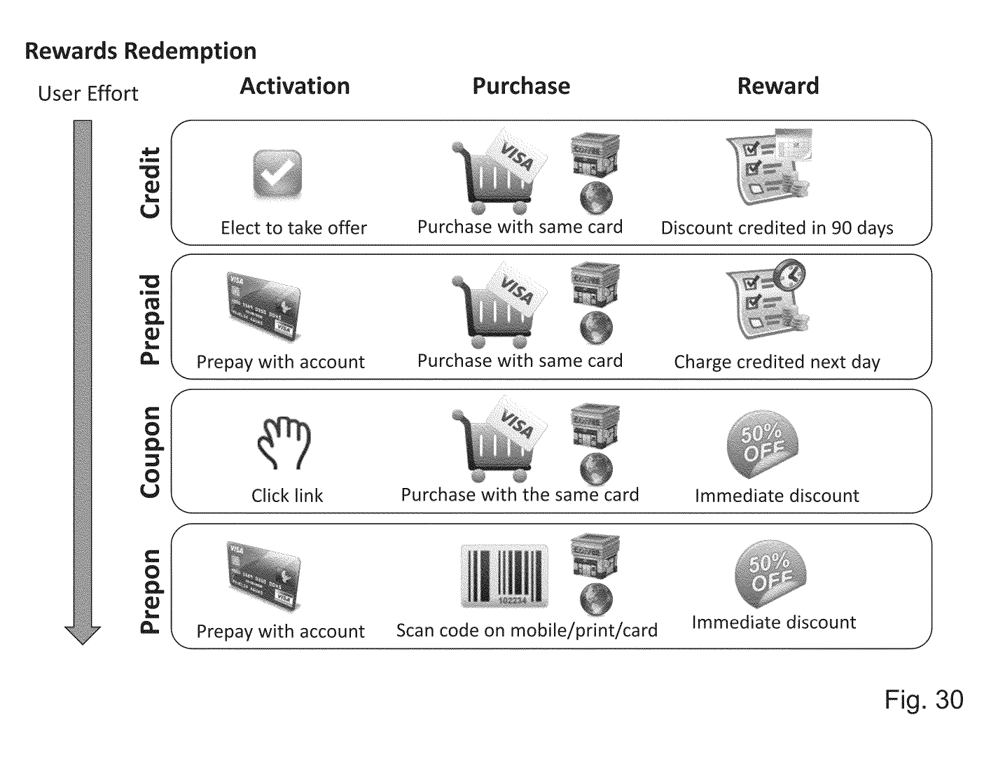

FIG. 30 illustrates an example of rewards redemption, including the steps of activation, purchase, reward, and the like. In embodiments, some rewards may be provided to the user after some period of time (e.g. credited in 90 days), the next day, immediately, and the like. For example, a user may elect to take a credit offer, make a purchase with the same card, and have a discount credited in 90 days. In this example, when the user elects to take a credit, they must swipe the same card at the store when they make their purchase and the credit is given automatically. In another example, a user may prepay with an account, purchase with the same card, and have the charge credited the next day. For example, if the pre-paid offer is $50 worth of merchandise for $40, the next time that the user goes to the merchant and pays at least $50, the entire $50 will get credited back to them automatically. In another example, the user may click on the coupon, and receive an immediate discount. The coupon may be online only or a physical coupon that could be printed or added to their mobile device for display or scan at a point of sale. In another example, the user may prepay with an account for a “prepon”, receive a code that can be stored on a mobile, print, card, and the like indicating that they have pre-paid, and receive an immediate discount when the code is scanned.

The decision engine 108 may apply factors in matching a savings opportunity to the user. For example, a financial institution may blacklist certain merchants, merchant types, transactions, transaction types, and the like from being used to match a purchase reward to the user. In another example, the financial institution or the merchant may use a spend pattern to match an offer to the user. In some embodiments, the offer may be made in conjunction with a display of spend pattern metrics. The spend pattern may be used to send alerts to the user regarding spend with a merchant, in a category, of a total amount, in a time period, and the like. In another example, a merchant may use past spend, past spend in a category, past purchase frequency, and the like to match a purchase reward to the user. In another example, the user's likes/dislikes, expand/collapse behavior regarding obtaining more information about an offer after seeing the offer headline, past purchase behavior, and the like may be used to match a purchase reward to the user. In yet another example, the system may use geographic proximity, location, inferences, seasonal adjustments, and the like to match a purchase reward to the user. For example, with respect to inferences, consumer traits may be identified by inference via transactional data, such as merchants, transactions, transaction types, merchant types, spend total, spend at a particular merchant, and the like. For example, based on transactional data, any of gender, credit rating, age group, life events, income level, psychographic state, demographics, and the like may be inferred. For example, a user suddenly spending more during multiple transactions at a high-end baby store may be inferred to be a high income, pregnant woman.

The spend pattern may be used to predict a store, restaurant, transaction, service, good, or the like that the user might like based on transactions, merchant, goods, services, and the like that appear on a user's statement. The prediction may be based on what other people like the user did in terms of transactions, merchant, goods, services, and the like. For example, referring to FIG. 65, a dialog box displaying purchase insights is shown. In embodiments, this dialog box may be associated with a user's financial account. In this example, because the user's prior merchant history 6502 indicates that the user is a customer of MACY'S, JC PENNEY is the predicted merchant 6504 the user might enjoy because other users who were customers of MACY'S also were customers of JC PENNEY. In embodiments, the decision engine 108 may be used to predict the predicted merchant 6504. In embodiments, the merchant may present an offer 6508 to the user to entice the user to shop.

In some embodiments, the prediction may be based on a single transaction, merchant, good, or service or may be based on a collection of such. For example, soon-to-be moms may make purchases at a collection of merchants, such as a baby store, maternity store, and bookstore. Past expectant mothers may have frequented the collection of merchants as well as a spa. In this example, the spa would likely not have been the predicted merchant based on only one of the common merchants, such as the bookstore for example, but based on the collection of merchants, the prediction of a spa may be made.

Users may indicate whether they like or dislike the predicted merchant 6504. These ratings may be used in subsequent predictions. For example, if the user does not like the predicted merchant, it will be put on a blacklist and not used in future predictions.

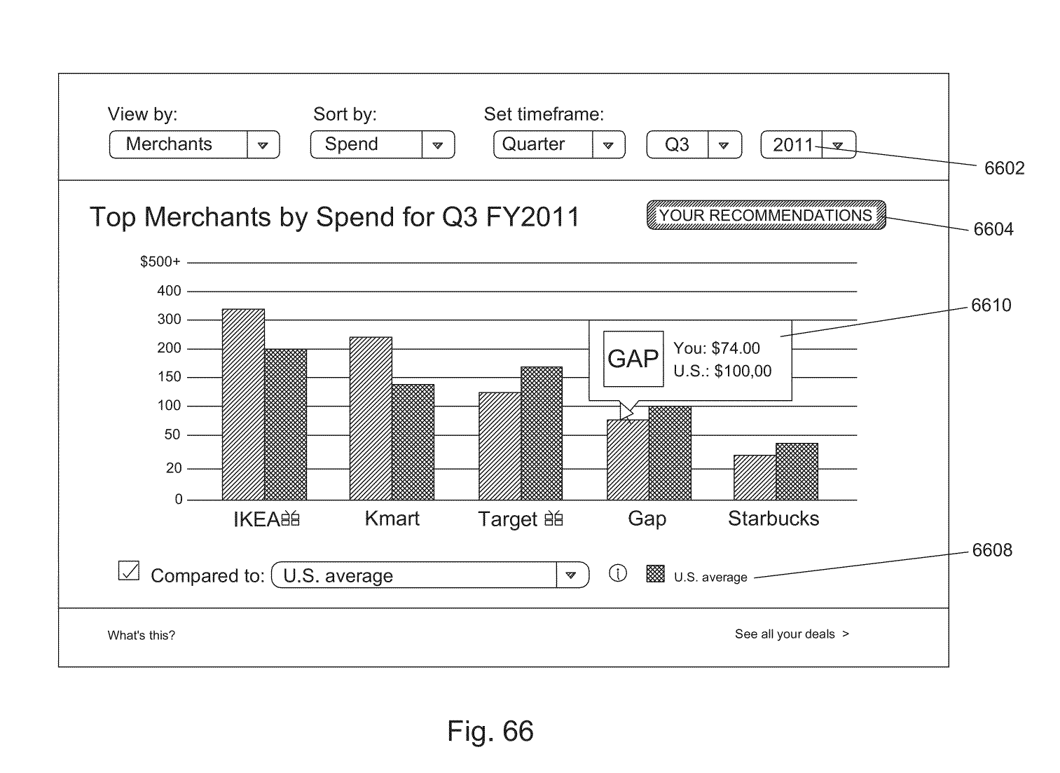

Financial institutions including banks, credit unions, and the like may have an interest in providing their customers with value added services. Currently some financial institutions such as banks, credit unions, credit card companies, and the like may provide the customer with summary information, analytics, and the like in addition to the specifics of individual transactions. An example of this may be a summary of spending by category over a time period, trends in spending in category, and the like. As part of providing the customer with different offers, significant analysis of the customer spending patterns may be done. The customer may benefit from additional insight into their spending profile including some of those generated in the development of a customer model. In one embodiment, the customer may be able to get detailed insights including spend as a function of time, time of day, geography, merchant-visits, category visits, and so on as illustrated in FIGS. 66 and 67. Additionally, the customer may be able to look at their spending relative to spending profiles of relevant peer groups which might include peers in a geographic location, age bracket, earnings bracket, and the like. Further, the customer can configure this information in a form that makes the most sense to the customer. This information may be provided on a financial institute's website, an application associated with a financial institute, a user dashboard, and the like.

One of the spend pattern metrics may be a spending chart, such as the merchant level spending chart shown in FIG. 66. The merchant level spending chart shows which merchants a user is spending at, as opposed to category-level spending. A menu 6602 may be used to set various parameters for the spending chart. For example, users may be able to set the view such as by merchant, by category, by week, by month, by amount, by geographical location, and the like. Users may be able to sort the data, such as by spend. Users may be able to set a time frame for the spending chart. In this example, spending amounts for the third quarter are presented for five merchants. Each of the bars may be interactive. That is, clicking on the bar may pull up the underlying data. Recommendations 6604 for various merchants, transactions, goods, services, offers or the like may be indicated by an icon presented with the spending chart.

Referring to FIG. 67, another example of a spending chart is shown with the parameters 6702 set to show a geographical view, a sort by dollars, and a timeframe of one month. The ‘Breakdown by Proximity’ chart 6704 shows spending at merchants within 10 miles of the user's home, between 10 and 50 miles, outside the user's metro area, outside the state, internationally, and online 6708. For each geographical category, a dollar amount is indicated. In other embodiments, a percentage may be indicated. A ‘Top Cities’ chart 6710 may show the level of spend for particular geographical locations, such as cities in this case.

Referring back to FIG. 66, the spending amounts presented for each merchant may be benchmarked against other users or known data. For example, a benchmark menu 6608 is presented for the user to select a desired benchmark for their data. In this case, the US average is selected. The benchmark data for the given merchant may be presented alongside the merchant data in the spending chart. By hovering or clicking on the data, a dialog box 6610 may pop up showing the user's spend at the merchant and the spend for the benchmark category, which is the US average in this case. In other embodiments, benchmarking may be done against a national average, a city average, a state average, similar people as defined by either: a) similar spend patterns, or b) similar demographics, and a private group.

To determine similar demographics, users may indicate certain characteristics in a profile, such as gender, age range, household type, number of children, household income, geographic location, and the like. In doing the benchmarking against similar people, the user may choose to weight particular characteristics over others, such as by assigning a relative priority to each characteristic or a weighting factor. The user may choose to benchmark against those with similar demographics but with one or more restrictions, such as users only in the same state. In embodiments, the user's geographic location may be obtained by a mobile device viewing the user's statement.

In benchmarking against a private group, a user can create a group of individuals, such as high school friends, family, neighbors, and the like to get feedback on how the user compares in spending against that group without sharing any personal information across the group. Likewise, users may accept invitations to be part of other private groups. Certain security features may be built in to creating and joining private groups. For example, users may be required to provide a password in order to join a private group. In any event, users may be members of multiple private groups and may select any of them to benchmark against. Additionally, social features may allow users to share information with the private group. For example, users may be able to share information with private group members by email, a social network, and the like.

Transaction data may be augmented with third party data in order to improve the matches. In an embodiment, census data may be used in addition to the transaction data to make a match of a savings opportunity. Since the system works with anonymized transaction data, the system knows only what it can infer about the user or what is provided by the user. Based on the user's location, possibly inferred by the system or manually input by the user, census data for the location, such as ethnic makeup, population educational level, income levels, and the like, may be used to provide a substitute demographic profile for the user. One or more of the substitute demographic profile, transaction data, and inferred traits may be used to match a savings opportunity to the user. In another embodiment, merchant data may be accessed using a third party data source and used to improve targeting to the user. For example, a restaurant may be searched on YELP.COM to obtain information about the type of cuisine offered, type of atmosphere, price range and the like. These data may be used as factors in the system's match of a savings opportunity to a user. The 3rd party data may or may not be displayed to the user along with the savings opportunity. Continuing with the example, if the restaurant was determined to be a family-friendly place, a savings opportunity at the restaurant may not be matched to a person who has been inferred to be single/dating based on transactions for flowers and higher-end restaurants. In yet another embodiment, the savings opportunity may be analyzed and 3rd party data may be obtained to improve matching it. For example, 3rd party information about a product that is the subject of the savings opportunity may be used to improve the match.

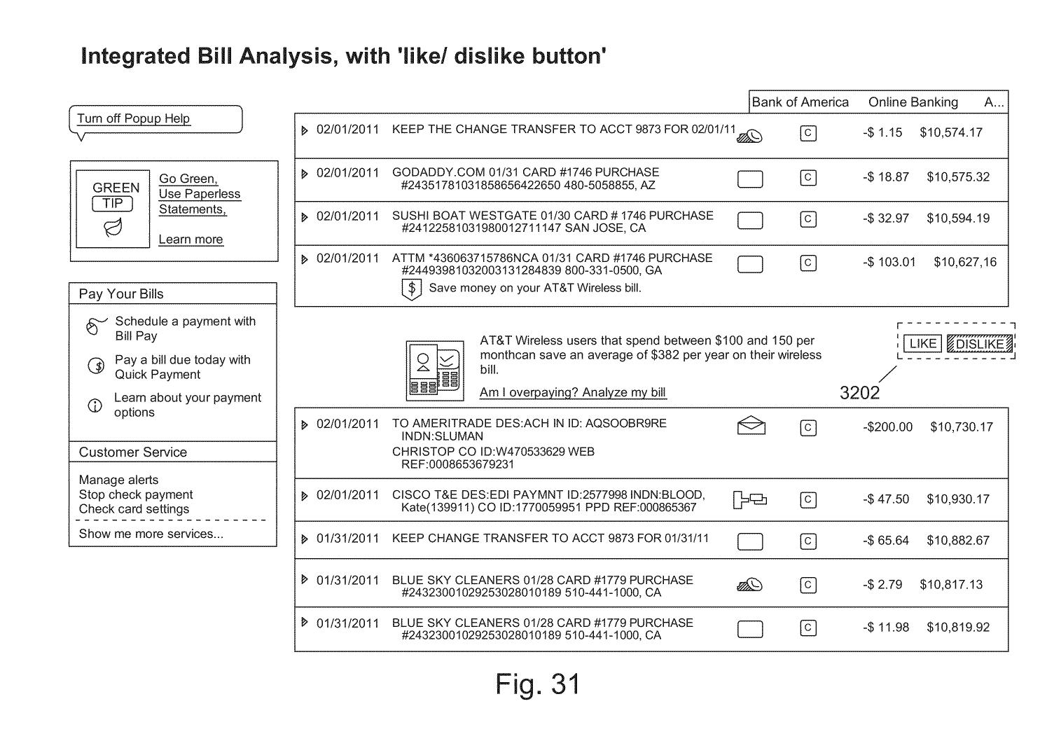

FIG. 31 illustrates an example of an integrated bill analysis, such as with a like-dislike button′ 3202. In embodiments, the like-dislike button may provide the user with the option to select an offer or not, that is, to accept as liking the offer, or to decline as disliking the offer. In embodiments, a selection of dislike may remove the offer, change some physical attribute of the offer (e.g. changing color, hiding, minimizing, deleting). In embodiments, a selection of liking the offer may send the user to a website managed by the present disclosure, performed automatically, sent to a third-party site, and the like, where automatically performed may be implemented through an embedded block of code (e.g. Java code), and the like. In embodiments, the user may be able to share offers, information about offers, and the like, with other individuals, such as through a social network, and as a result improve the value of their offer. Although the like-dislike button has been depicted in an illustrated bill analysis, the like-dislike button may be applied to any user interface disclosed herein where the user has an option to select a service, product, offer, and the like.

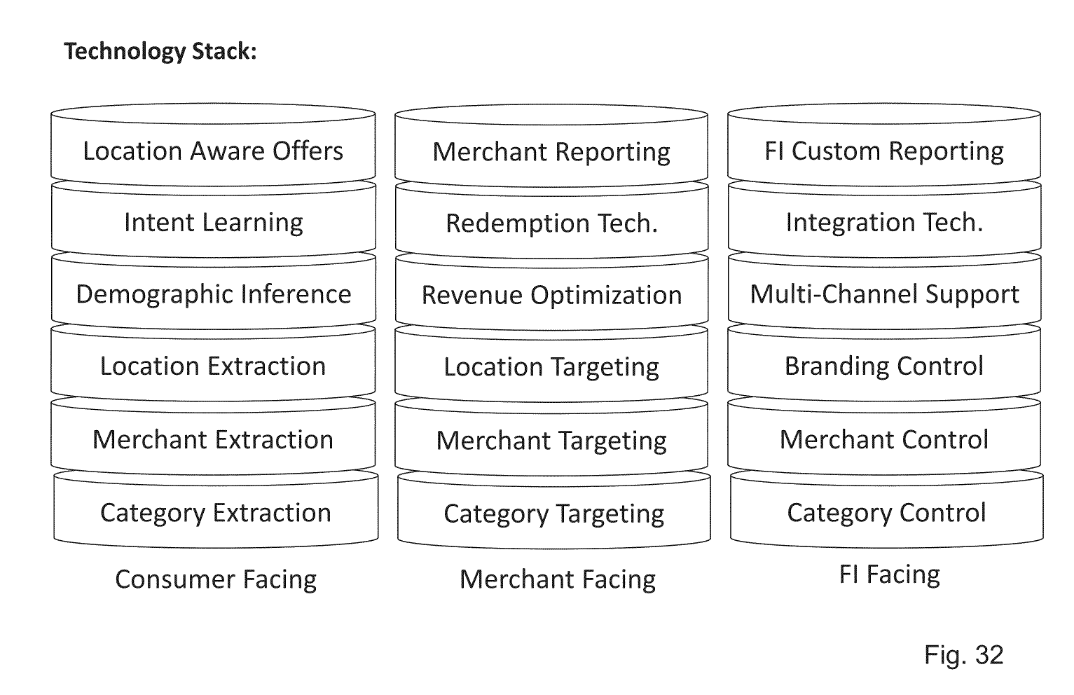

FIG. 32 illustrates embodiment technology stacks, such as for consumer facing, merchant facing and financial institution (FI) facing applications. For instance, a consumer facing stack may include location aware offers, intent learning, demographic interface, location extraction, merchant extraction, category extraction, and the like. Merchant facing may include merchant reporting, redemption techniques, revenue optimization, location targeting merchant targeting, category targeting, and the like. Financial institution facing may include financial institution custom reporting, integration techniques, multi-channel support, branding control, merchant control, category control, and the like.

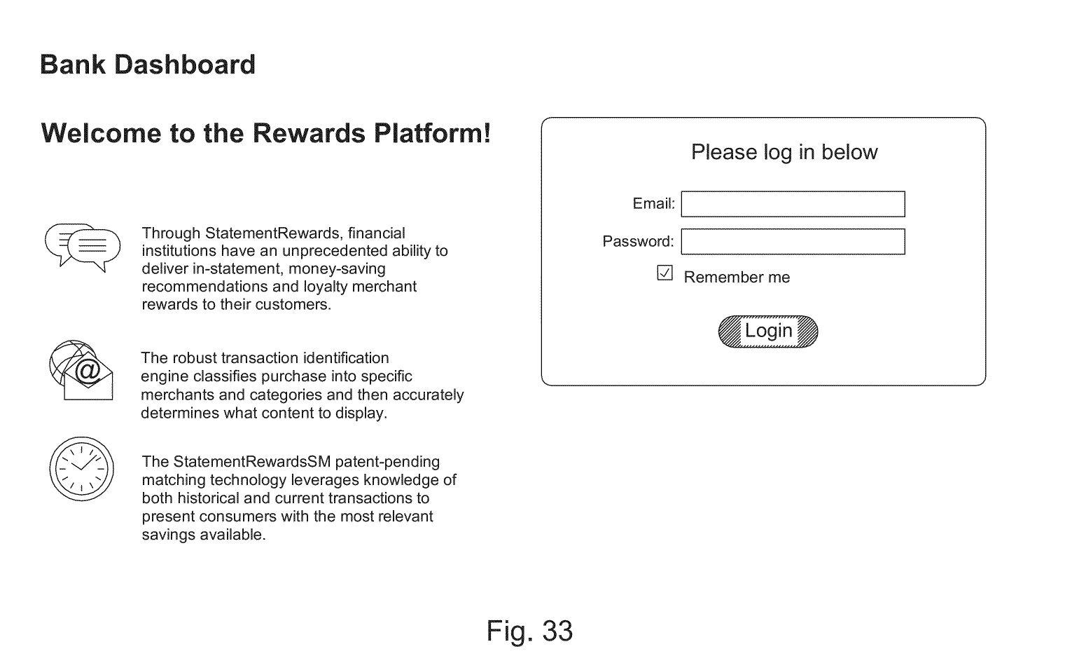

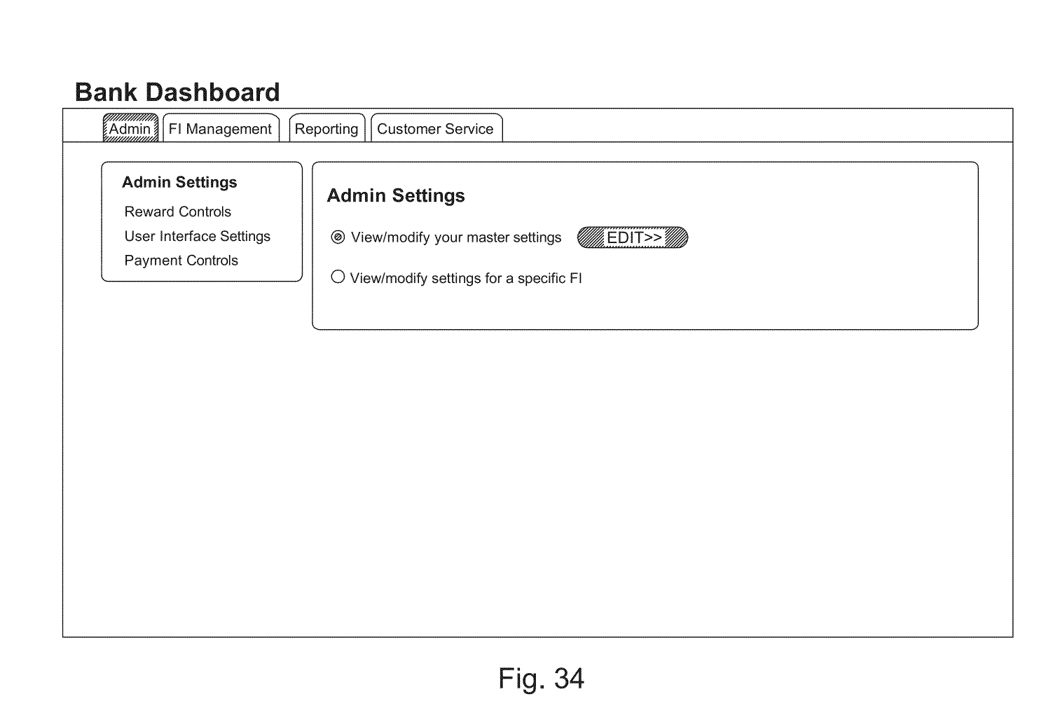

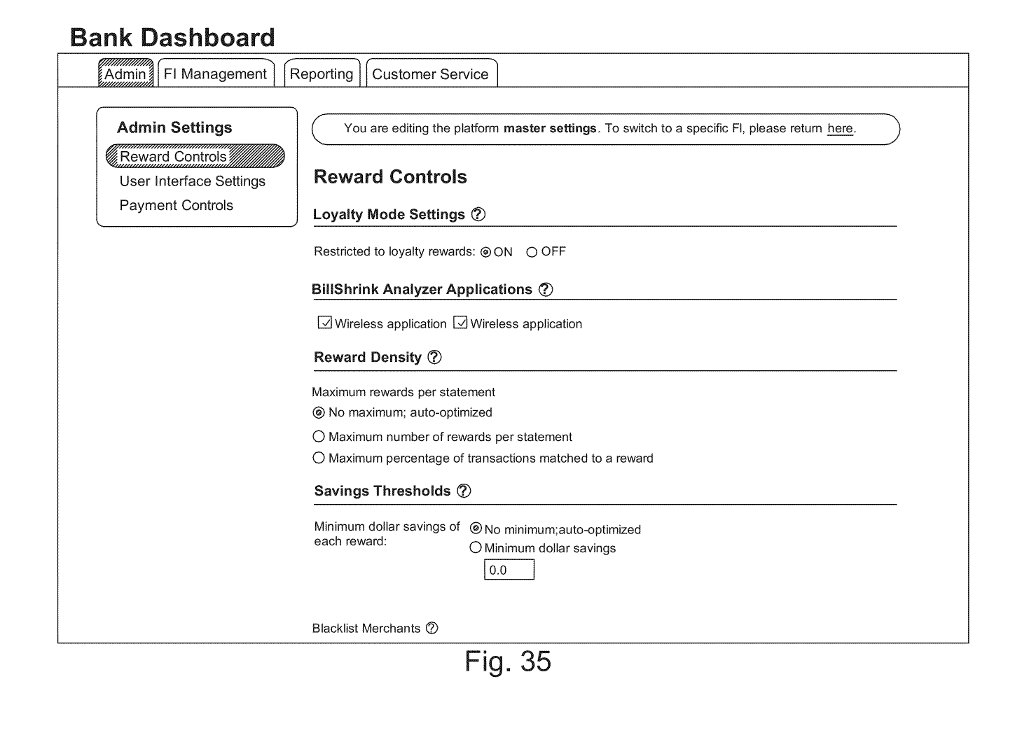

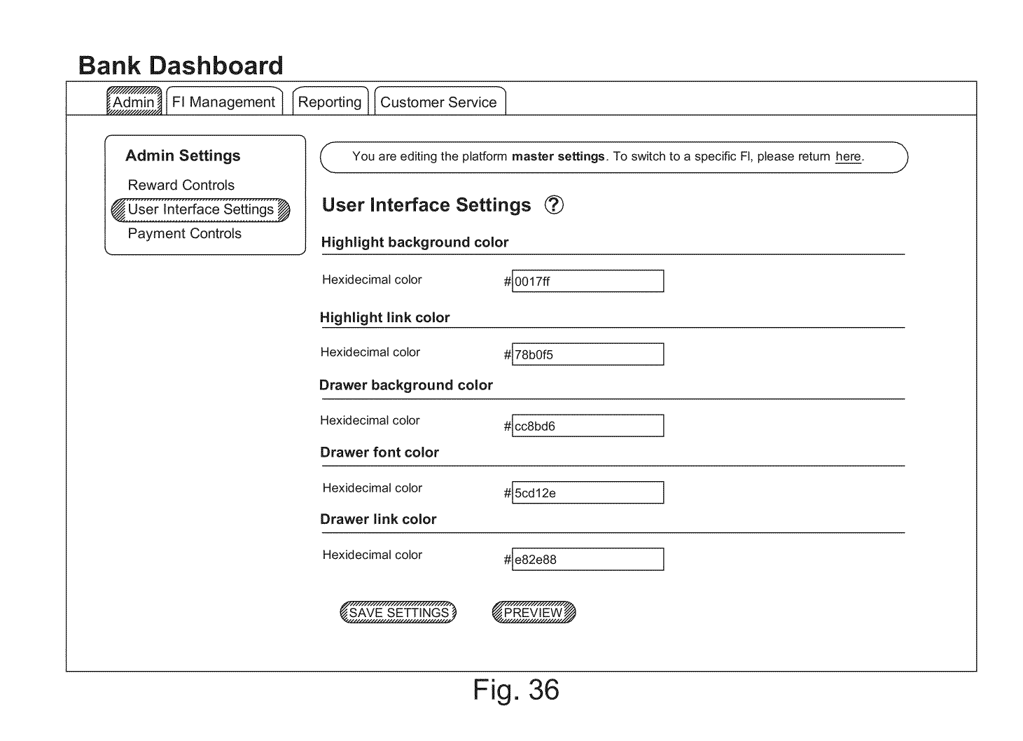

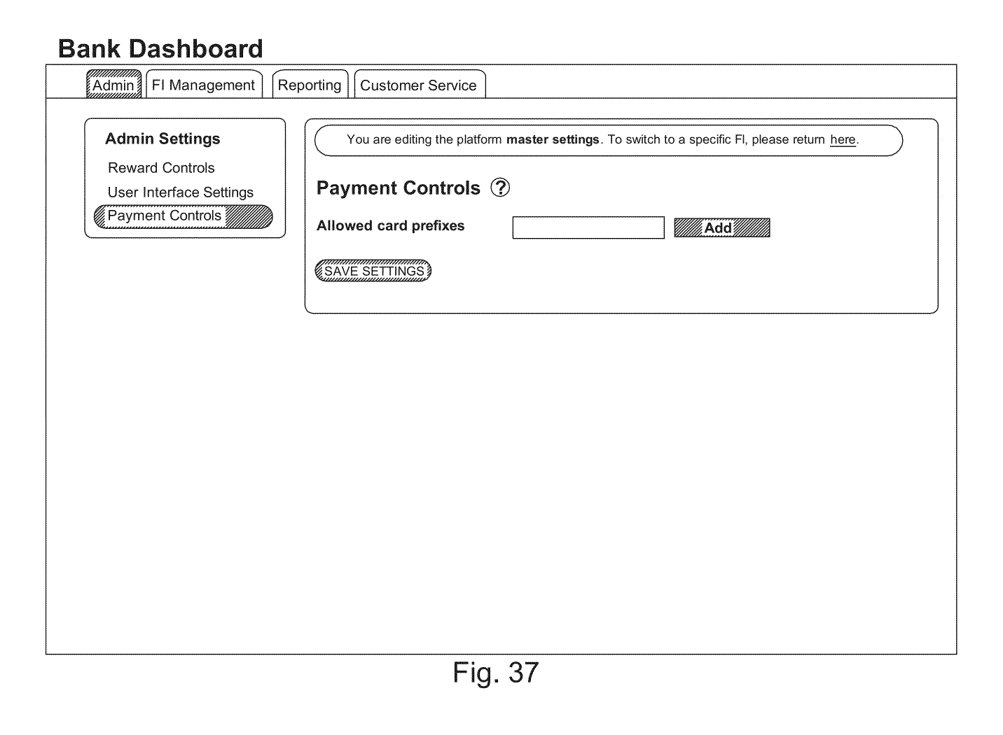

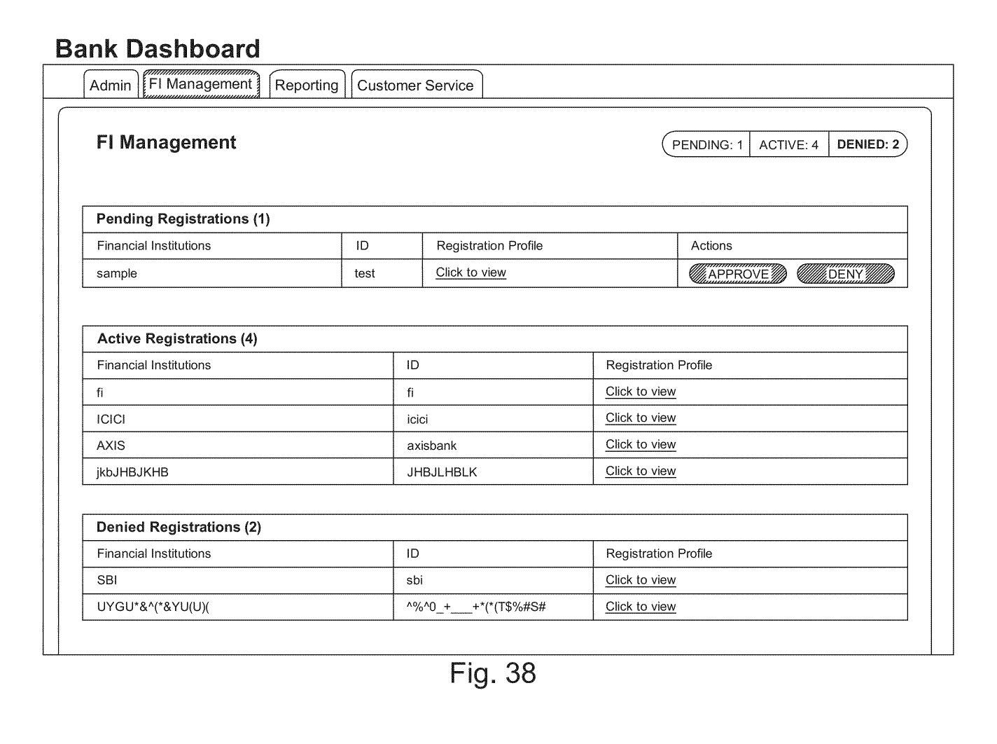

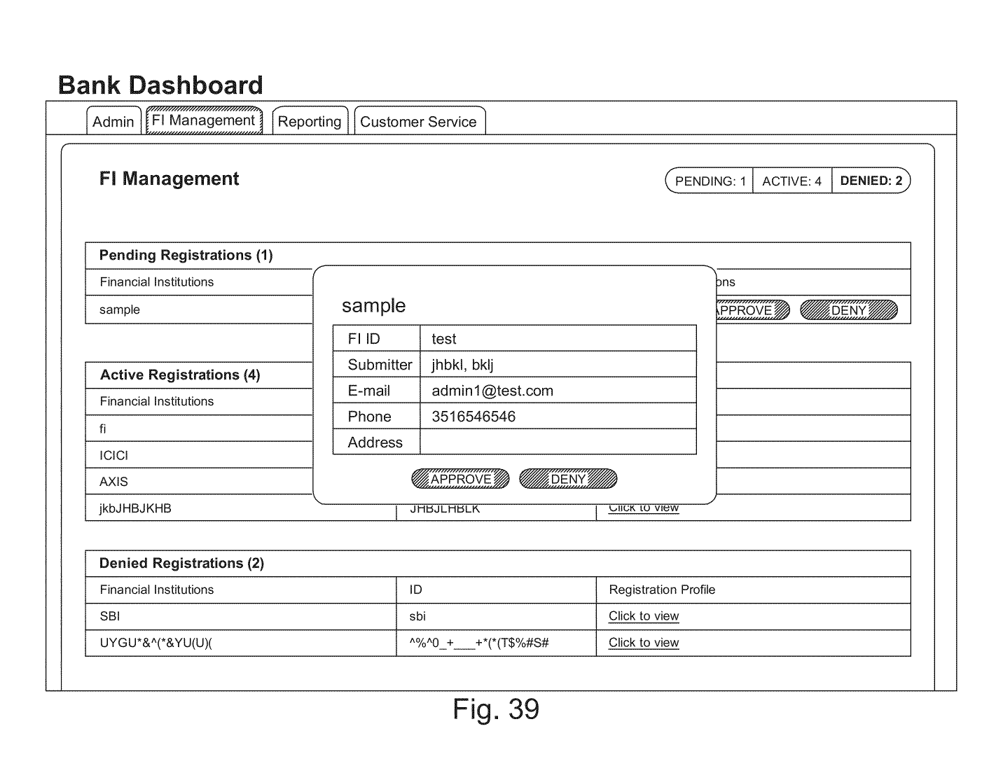

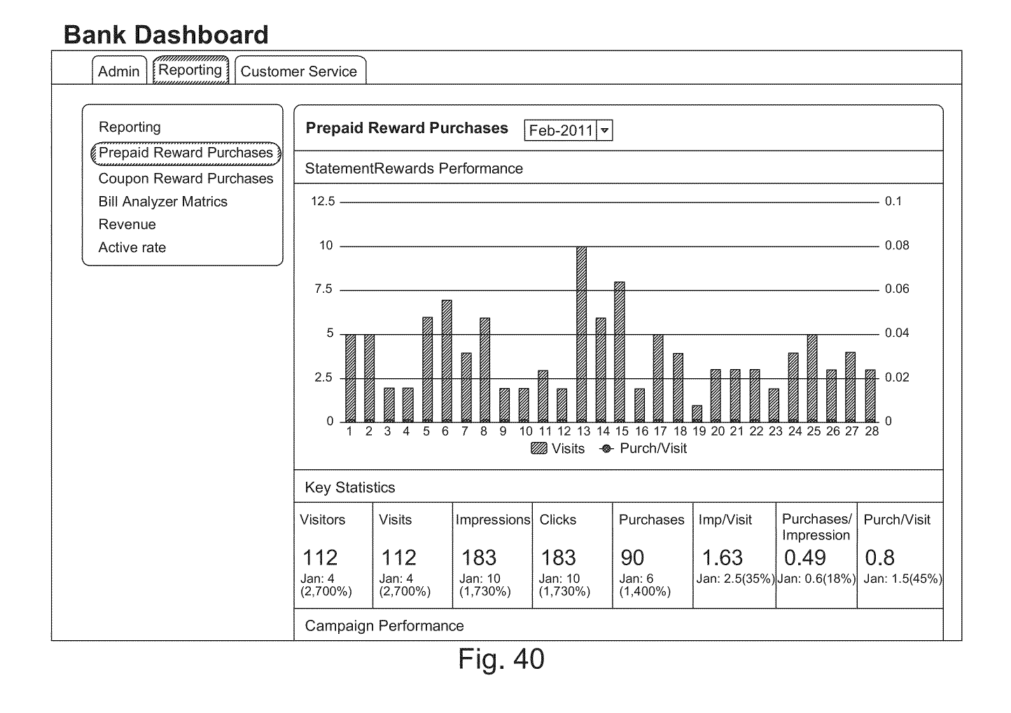

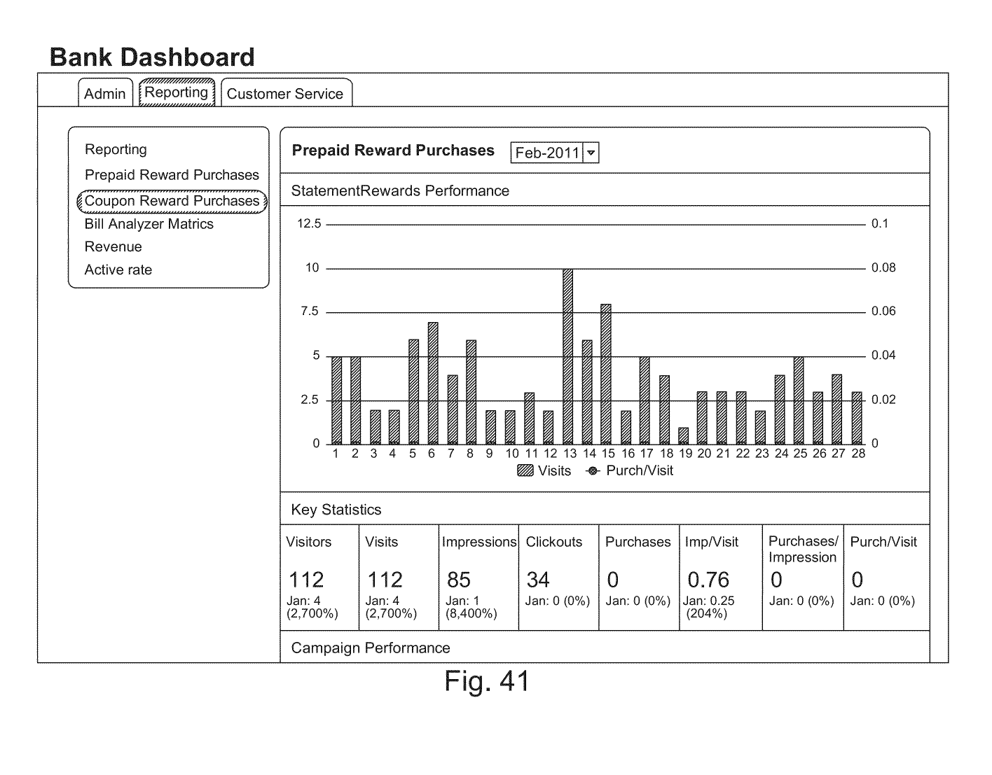

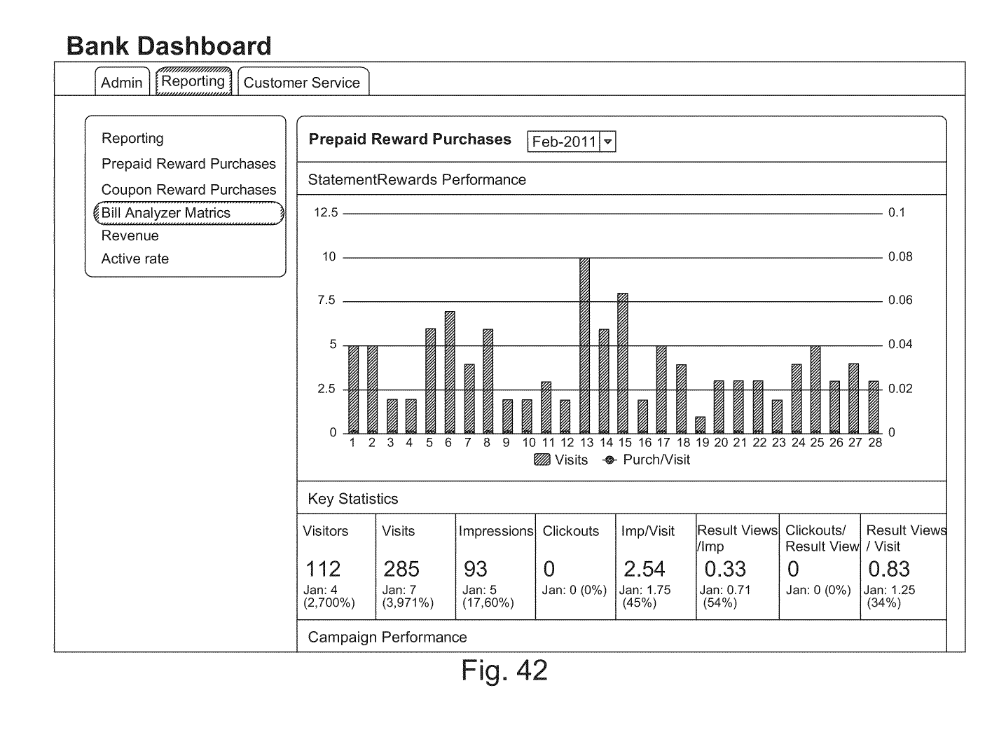

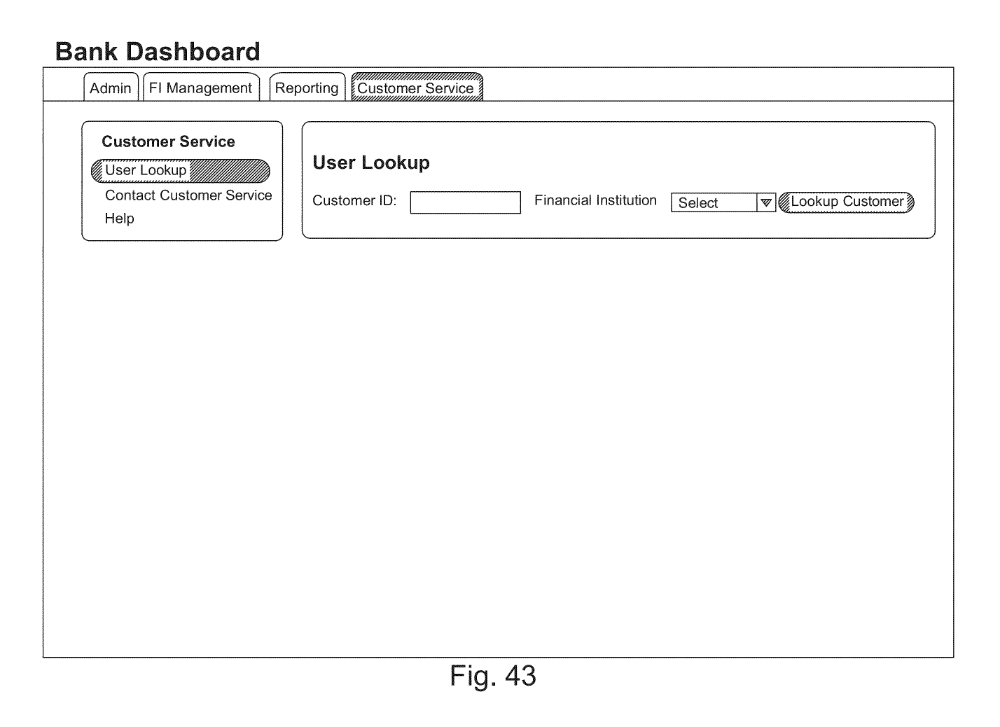

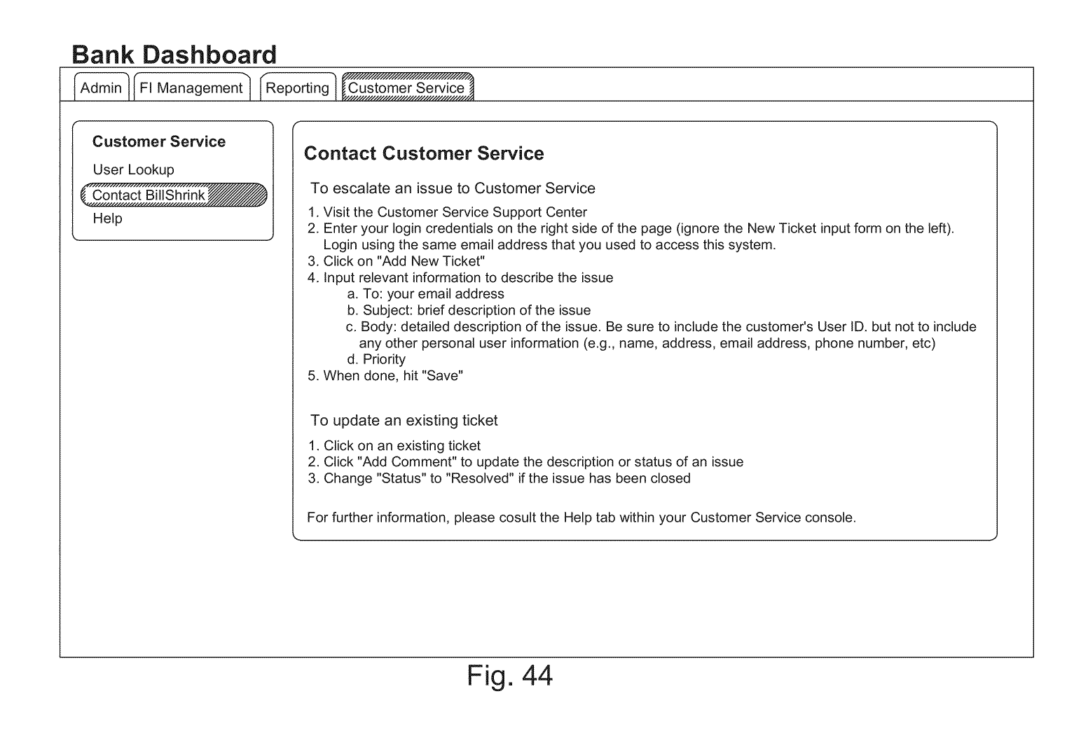

FIGS. 33-44 illustrate embodiment windows for a bank dashboard, including a welcome-login window, an administration tab (e.g. with administration settings, reward controls, user interface settings, payment controls), a financial institution tab (e.g. with pending registrations, active registrations, denied registrations), a reporting tab (e.g. with prepaid reward purchases report in FIG. 40, Coupon Reward Purchases report in FIG. 41, Bill Analyzer Metrics in FIG. 42, revenue, active rates, performance graphics, key statistics, campaign performance), a customer service tab (e.g. with user lookup, contacting customer service), and the like. For example, in the dashboard shown in FIG. 35, the financial institution can set a reward density by indicating the maximum number of rewards per statement. In this embodiment, three options are given to the financial institution to customize reward density: no maximum and auto-optimized, the maximum number of rewards per statement, and maximum percentage of transactions matched to a reward. Finer adjustments may be available in other embodiments. The financial institution can set the maximum or any other reward density desired manually. Auto-optimization may be run on a per-user basis. For example, the financial institution may offer three savings opportunities per statement. Depending on the user engagement with the savings opportunities, the reward density may be optimized up or down. Additionally, the reward type may also be changed in auto-optimization. Optimization may be restricted to a time period, to a specific BIN/IIN number, and the like. The dashboard may also be used to blacklist merchants, merchant types, transactions, or transaction types from being included in the analysis for a savings opportunity match.

Financial institutions including banks, credit unions, and the like may have an interest in providing their customers with value added services. A financial institute may have a vested interest in monitoring these services and how they are provided including the actual value provided to the financial institute's customers, the flow of revenue from these services to the financial institute, and the like. In a further embodiment of this system the financial institute may be provided with an interface such as a dashboard, website, mobile app, or the like where they may interact with the services. FIGS. 33-44 illustrate embodiment windows for a financial institute dashboard, including one or more of a welcome-login window, an administration tab, a financial institution tab, a reporting tab, a customer service tab, and the like.

Financial institutions including banks, credit unions, and the like may have relationships with various merchants including acting as a supplier of financial services to a merchant, collaborating with a merchant to issue credit products including merchant branded credit cards, debit cards and the like, having a financial stake in the merchant, and the like. The existence of such relationships may cause a financial institution to have a vested interest in guiding its customer to offers that support such merchants or the use of redemption methods that provide a return to the financial institution. The administration tab may include features to enable this such as blacklisting competitor merchants and or merchant types, limiting the transactions, or redemption methods, including competitor financial instruments, which may be used to redeem the offers. The administrative tab may also include administration settings, reward controls, user interface settings, payment controls, and the like.

A reporting tab may include reports on prepaid reward purchases as illustrated in FIG. 40, coupon reward purchases as illustrated in FIG. 41, bill analyzer metrics as illustrated in FIG. 42, revenue, active rates, performance graphics, key statistics, business analytics, campaign summaries, user feedback, campaign performance as a function of individual campaign, groups of campaigns or overall, sale performance, transactions per customer, revenue per transaction, revenue per customer, category spend, average monthly bill, value-addition to the financial institute's customers and the like. The performance graphics and reports may be customized including time frame, metrics to be reported, campaigns to be included, and the like.

The financial institution tab may include pending registrations, active registrations, denied registrations, and the like. A customer service tab may include user lookup, contacting customer service, and the like.

In a further embodiment, as shown in FIG. 35, the financial institution can set a reward density by indicating the maximum number of rewards per statement. In this embodiment, three options are given to the financial institution to customize reward density: no maximum and auto-optimized, the maximum number of rewards per statement, and maximum percentage of transactions matched to a reward. Finer adjustments may be available in other embodiments. The financial institution can set the maximum or any other reward density desired manually. Auto-optimization may be run on a per-user basis. For example, the financial institution may offer three savings opportunities per statement. Depending on the user engagement with the savings opportunities, the reward density may be optimized up or down. Additionally, the reward type may also be changed in auto-optimization. Optimization may be restricted to a time period, to a specific BIN/IIN number, and the like.

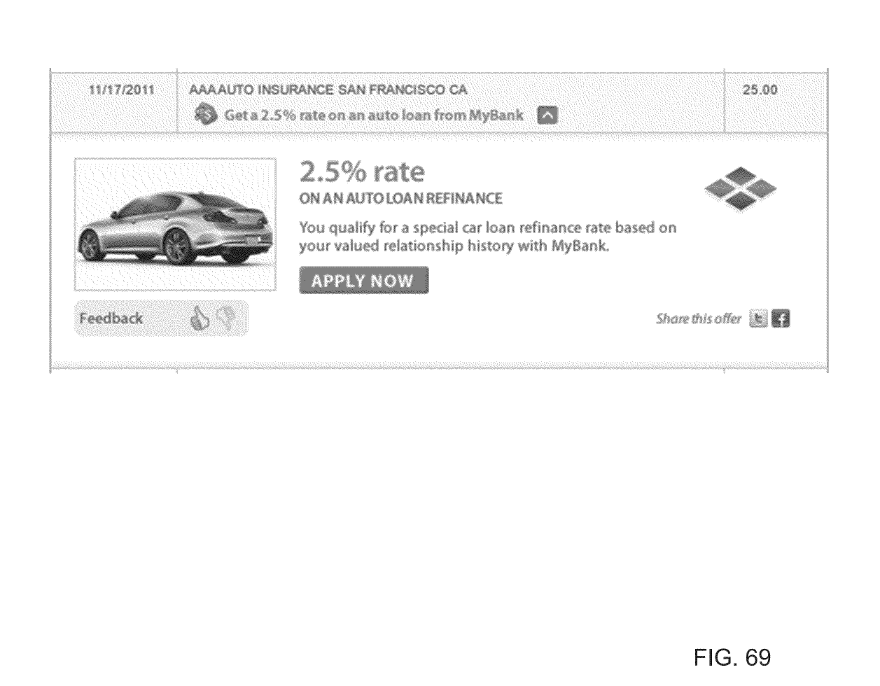

As a component of doing business, financial institutes including banks, credit unions, and the like may use analytic programs to evaluate their customers on one or more criteria including net revenue to the financial institution, spending profile, opportunity to provide additional services, and the like. Identifying net revenue may include classifying customers as revenue-positive, revenue-neutral, revenue-negative and the like. One method of evaluating the customer may involve analyzing spending patterns including merchants, geographic location, category spending, and the like. Future propensity of customer to spend in particular merchant/category buckets and the like may also be computed This analysis may be used to identify potential current and future needs for financial instruments including loans, credit cards, refinancing, and the like. Additionally, analysis may include evaluation of potential profitability to the financial institution based on cross-sell opportunity and customer profitability. These inferences may be leveraged from transactions and data known to the financial institution to deliver timely and perfectly matched cross-sell products. FIG. 69 depicts an example of a cross-sell for an auto-loan refinance based on an auto insurance transaction.

The cross-sell tab on the financial institute dashboard may include identification of cross-sell opportunities, creation of customer offers based on identified opportunities and customer information, performance on offered cross-sell opportunities including financial metrics, acceptance rates and the like.

FIGS. 45-51 illustrate embodiment windows for a merchant dashboard, including a campaign tab (e.g. with choosing a saved reward, creating a reward, setting reward matching criteria, purchase limits, targeting merchants or categories, targeting rewards by merchant, targeting geographies, date range, campaign performance graphics), reporting tab (with performance graphics, key statistics, business analytics, campaign summary, user feedback, campaign performance, sale performance, transactions per customer, revenue per transaction, revenue per customer, category spend, average monthly bill), ‘My Account’ tab, and the like. The merchant dashboard may be white-labeled. The merchant dashboard may be self-service.

In an embodiment, the system of the present disclosure may facilitate a conditional purchase by a user from a merchant of a good or service, wherein the purchase may be conditioned on receiving a discount wherein the discount may be provided based on various bidding offers that may be received from the user. For example, the user may place a bid for a purchase amount and a discount amount that they may wish to get. For example, a user interested in buying merchandise worth $100 from a retail store may ask for a discount of 40% on that merchandise as a pre-condition. In such cases, the merchant may decide whether or not to accept the bid offer from the user. The merchant decision may be based on one or more of an inventory, a production plan, a pricing strategy, and the like. The user may have the opportunity to modify their bid offer. For example, if the merchant does not accept the user's offer to purchase a $100 item at a 40% discount, after being notified of the decline, the user may decrease the discount requested, increase the quantity of items chosen, add additional items, modify the items, and the like and re-submit the offer for consideration by the merchant. This cycle may continue until the bid is accepted or the user stops bidding.

In another embodiment, the bid offer may be automatically incremented up until an amount indicated by the user or according to a rule. For example, the user may offer to purchase a $100 item at a 40% discount but indicate when they set their offer that if it may be declined by the merchant, it may automatically be incremented to a next bid offer. The next bid offer may be explicitly indicated by the user or may be determined by consulting one or more rules. For example, the user may indicate that the offer should be decreased by 5% each time the merchant declines the offer until reaching 20% where no further offers may be made.

In another example, a user may commit to purchasing an item of a particular value if a merchant is willing to sell that item at a lower cost. The merchant may decide whether or not to accept the commitment from the user.

In an exemplary embodiment, the merchant may accept or decline the bid offer through preset rules. These preset rules may include types of bid offers, types of discounts that the user may seek, and the like. These preset rules may be defined by the merchant. Further, the preset rules may facilitate a merchant to select bid offers to be accepted from the total bid offers received by the merchant. The preset rule may also enable the merchant to decide on the volume and kind of users from which the merchant may accept bid offers. In another embodiment, the merchant may accept bid offers dynamically. In this embodiment, the merchant may need to manually approve certain bid offers from a user from among the total bid offers received by the merchant. It will be evident to a person skilled in the art that merchants may accept bid offers through a combination of the preset rules and the dynamic fashion.

In an embodiment, once the user has placed a bid offer for a good or service, an acceptance message of the bid offer may be delivered to the user through one or more of an email, a text message, a message in their account statement, or the like. The account statement may facilitate the system to identify various merchants for which the user has placed a bid offer. Further, the account statement may also provide information about the merchant who may have accepted the bid offer placed by the user. In another embodiment, the user may be approached directly by the merchant who may have accepted the bid offer of the user. In such cases, the merchant may send an e-mail, text message, or the like to the user to inform them about the acceptance of their bid offer.

In an embodiment, when reviewing an account statement, a user may have the opportunity to present an offer for a future purchase to a merchant. The merchant may be identified on the current statement or may be identified by the system as an alternative good or service supplier. In any event, the statement may include an integrated application to make the offer or may include a link to an application for presenting offers. For example, as the user reviews their credit card statement transactions, the application may be integrated to put an instance of an offer window at each transaction line, somewhere on the statement, somewhere on the web page, and the like.

In an embodiment, the application may be a browser plug-in that is active as the user is visiting various websites. For example, as the user visits WALMART.COM and navigates various pages, the browser plug-in may deploy the application in a banner, frame, or the like for the website. When the user sees an item they would like to purchase, they can interact with the application to present an offer to WALMART for the item.

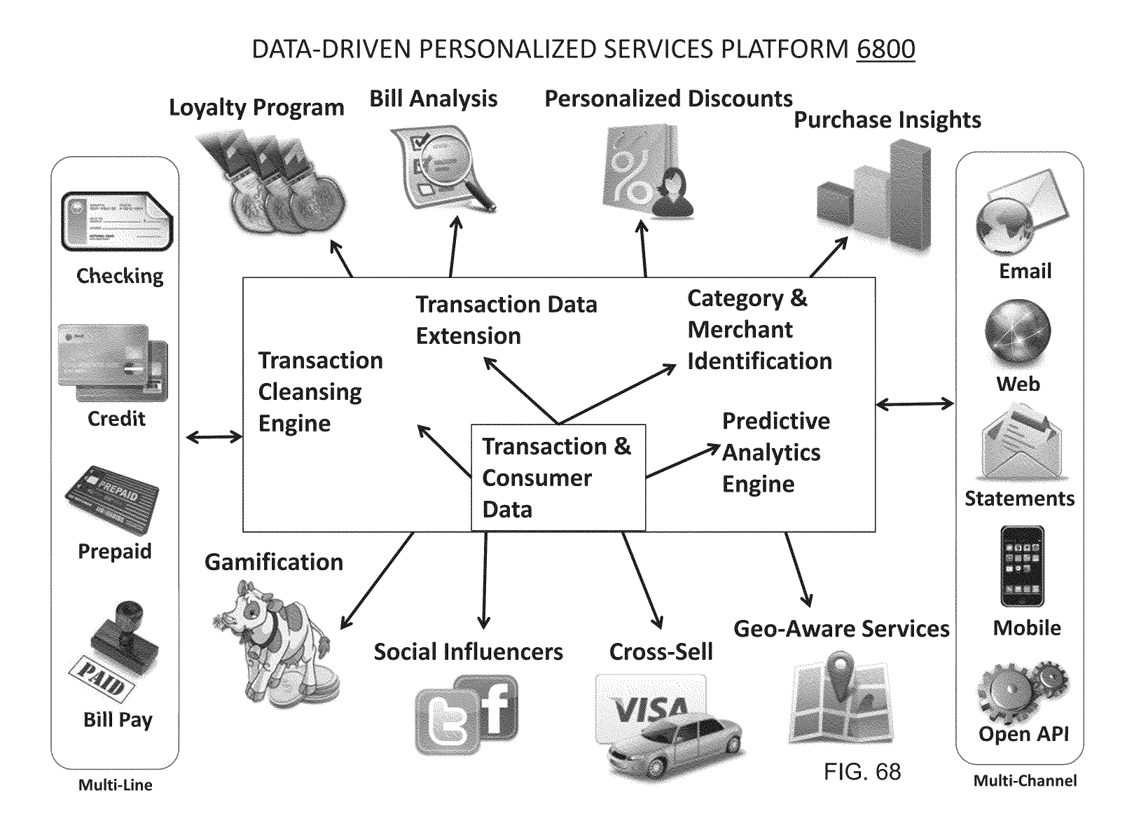

Referring now to FIG. 68, a data-driven personalized services platform is presented. At the heart of the platform is transaction and consumer data that feed into a transaction cleansing engine to, in embodiments, remove personal data or other identifiers; a transaction data extension which feeds into such processes that extend the platform outside of rewards, such as future spend initiatives (e.g. gamification) and cross-selling and others; category and merchant identification which feeds into loyalty programs, etc.; and a predictive analytics engine. The transaction and consumer data can be derived from any one of checking transactions, credit card transactions, prepaid card transactions, and bill pay transactions.

There are many features of the platform 6800 that build off of this core that will be detailed herein. The platform can enable a user to filter transactions on the bill for reviewing such as by a date range, a proximity to a location, a category of transaction, those transactions with associated rewards, and the like. Further features and functionality will be described herein.

Bill analysis can be done on various, typically recurring, transactions that the data-driven personalized services platform accesses to make recommendations for various services, such as changes to a telephone/cellular service, changes to a television/broadband service, changes to a gasoline provider, and the like. Bill analysis has been previously described herein with respect to the consumer service comparison shopping system 100. All of the methods and features described with respect to that system 100 are encompassed by “bill analysis” and may be exemplified in FIGS. 14-17, 21-23, and 31. In this embodiment, the bill analysis functionality is integrated with all of the other functionality of the data-driven personalized services platform.

Personalized discounts, or purchase rewards at merchants that cardholders like to shop at, can be created based on the specific profile of a user, such as based on past transaction history and in particular from conclusions drawn about that customer from that transaction history. The platform 6800 may offer rewards on everyday purchases based on user purchases, such as user's own merchants and category preferences, cluster analytics across users, and predictive analytics within and across users. Purchase rewards have been previously described herein and exemplified in FIGS. 52-56, 59, and 60.

Socially-enabled rewards involve identifying and leveraging social influencers among users and create positive social conversations and visibility for the brand and the financial institution. Seeing social networking activity and transactions of a group of people allows recognition of who is really influencing others to purchase. Then, rewards may be targeted to those people with the expectation that they will influence others to also take advantage of the rewards by sharing them with their social network, such as has been described previously herein with respect to a shared savings opportunity and FIG. 53.

A multi-merchant loyalty platform is a “universal” program where points apply across the entire financial life of the individual (e.g. points for all their spending, rewards in every area they spend on), as has been described previously herein with respect a loyalty program, loyalty-based offers, and FIGS. 24 and 25. FIGS. 53, 55, and 56 also illustrates a reward level aspect of a loyalty program, wherein the loyalty-based offers are filtered or modified by reward level. In effect, the financial institution card becomes a loyalty card at multiple merchants with no separate card to sign up for or swipe at every purchase. Merchants can use a self-service platform, or dashboard, which may be financial institution co-branded, to oversee various aspects of the multi-merchant loyalty platform, such as in FIGS. 45-51. The merchant dashboard may allow merchants to review data for all of their customers, not just those with a particular financial institution. Data viewable on the merchant dashboard may include: category performance such as % shoppers in a category, % dollar spend in a category, % store visits in a category; customer profiles such as spend distribution and visit frequency distribution; regional insights such as same store analysis and a geographic spend profile. A campaign builder, as depicted in FIGS. 45 and 46 may be included in the dashboard and may be used to set reward specifications, provide reward text, determine if the reward is eligible for social sharing. A performance review may give statistics on impressions, engagement rate, purchases, purchase rate, engagement metrics (e.g. expansions, likes, social network shares, and change in monthly activity), top active campaigns, and an account profile.

Future spend incentives, or the gamification of spend, involves the ability of the platform to create game-like dynamics, such as rewarding a customer for accomplishing certain objectives. The objectives may be accumulating points, a total spend at a merchant, a certain number of transactions/visits, a monthly spend at a merchant, a spend in a time period, a total number of items purchased, and the like. These initiatives encourage future customer spend with the financial institution, encourage future spend at a given merchant, and the consumer gets incentives for choosing their future spend patterns. In an embodiment, merchants fund the rewards. FIGS. 54-57 depict various aspects of future spend initiatives.

Geo-enabled rewards deliver value to cardholders on things they love around them. Users can be given offers, points, savings opportunities, etc. based on location, but also based on the users' history and analytics, including spend pattern, as described herein. FIGS. 61A-D depict an embodiment of geo-enabled rewards.

A cross-sell feature of the platform enables cross-sale of related items. The merchant targeting engine can be leveraged by the financial institution for cross-sell. Inferences may be leveraged from transactions and data known to the financial institution to deliver timely and perfectly matched cross-sell products. A real-time dashboard for creation and performance reports on offers may be used for cross-sell. FIG. 69 depicts an example of a cross-sell for an auto-loan refinance based on an auto insurance transaction.

Purchase insights, or spend pattern metrics, may be useful for providing recommendations based on a cardholder's transactions and social benchmarking of their spend. Purchase insights can provide analysis to merchants and consumers about purchases, as depicted in FIGS. 65-67.

The platform may provide a buy on behalf functionality. Users may be able to buy non-network deals (e.g. Groupon™) without leaving the financial institution site. The deal may be charged directly to the financial institution card and the fulfillment certificate may be received inline without signups or link offs. This functionality may be depicted with respect to FIGS. 53, 59, and 60.

As previously described herein, the reward types offered by the platform 6800 may be a pre-paid certificate, an offline coupon, an online coupon, a statement credit, or a future reward. The offers may be delivered via email, web, statements, mobile, ATM receipts, Open API, and the like.

Due to the highly sensitive nature of financial transaction data, security between a financial institute and external companies such as merchants, service providers, customer analytics, and the like must be robust. Additionally, financial institutes may have strict controls on how external companies may interact with their network, customer information and the like. It is an object of this disclosure to provide for an easy mechanism to authenticate a connection and sharing of data between a financial institution and an external company such as a merchant, service provider, customer analytics company, and the like. As part of this security mechanism, the financial institute and the external service provider may define what types of customer information are to be shared and the format in which it will be shared. The shared information can be any random information including strings, numbers, and the like that the financial institution wishes to associate with a financial institution user. The information to be shared may be anonymized (personal identifying information removed) using techniques such as encryption, hash tags, verification of the data, and the like. The information may be further secured by encrypting or hashing the data to be shared using encryption or hash keys which may have been previously established between the two parties. Information shared from the financial institute may be shared in the form of a cookie, java script variable, through a hidden form element, or the like. Where the service provider supports one or more financial institutes, additional information may be shared including identification of the financial institution and the like.

Merchants benefit from the unique capabilities of the platform 6800 by being able to understand their customers or potential customers in terms of a segmentation but without having to rely on personally identifiable information. Merchants enjoy an engaged reach via the platform that also provides payment integration, thus offering a closed loop system. For merchants, the platform may be a full cycle CRM platform that allows merchants to perform competitive analysis, ROI analysis, offer a social aspect to rewards, and offer a seamless loyalty program, all while engaging and acquiring customers. Other benefits may include higher relationship value & card spend, new customer acquisition, additional direct revenues, higher customer satisfaction, and higher online usage.

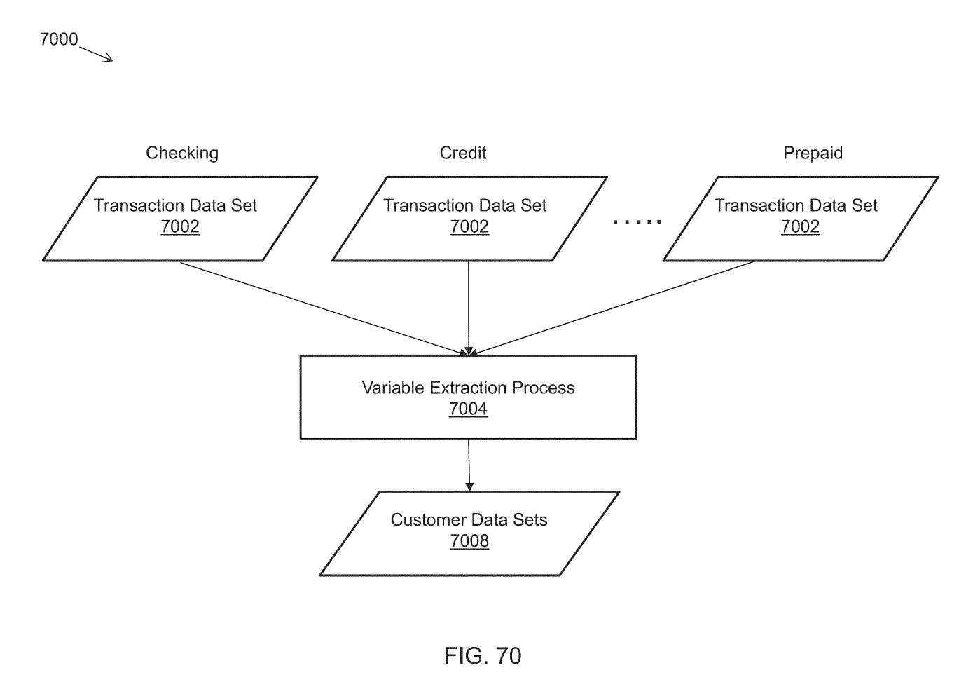

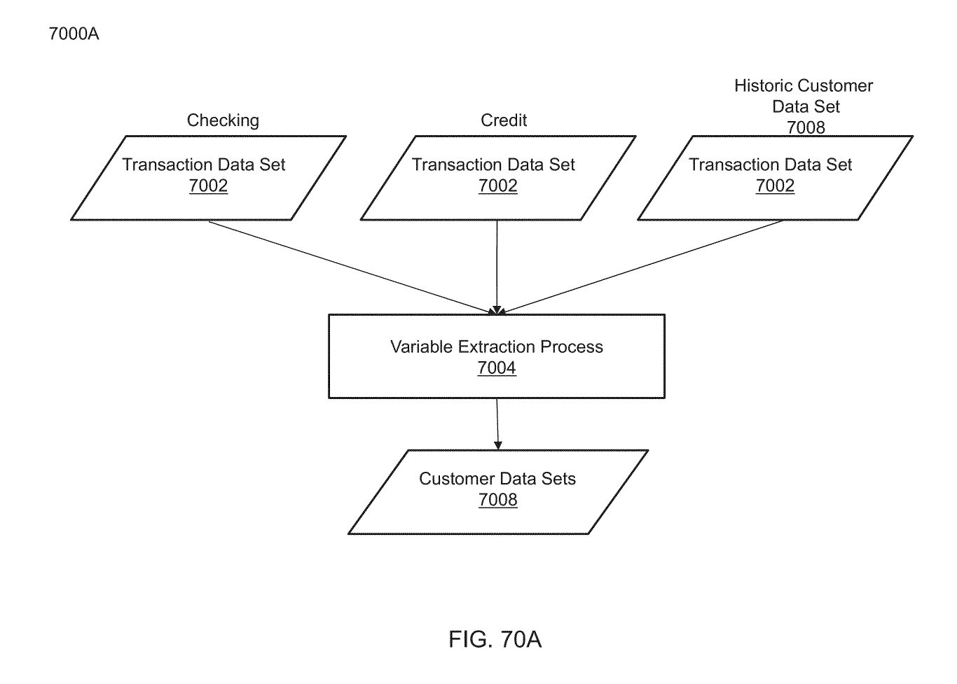

As shown in FIG. 70, customer data sets 7008 may be derived from a plurality of one or more financial transaction data sets 7002 including checking transactions, credit card transactions, prepaid card transactions, bill pay transactions, and the like. Mining financial transaction data from multiple sources enables improved offer selection by providing a more complete view of customer spending including trends across financial instruments, trends in customer purchases including seasonal variety, changes in geography, most recent merchant and category preferences, and the like. The plurality of financial transaction data sets 7002 may be input into the variable extraction process 7004 which extracts and consolidates customer data sets 7008. FIG. 70A illustrates another embodiment, wherein the plurality of financial transaction data sets 7002 also includes historic customer data sets 7008, information on historic customer response to offers and the like.

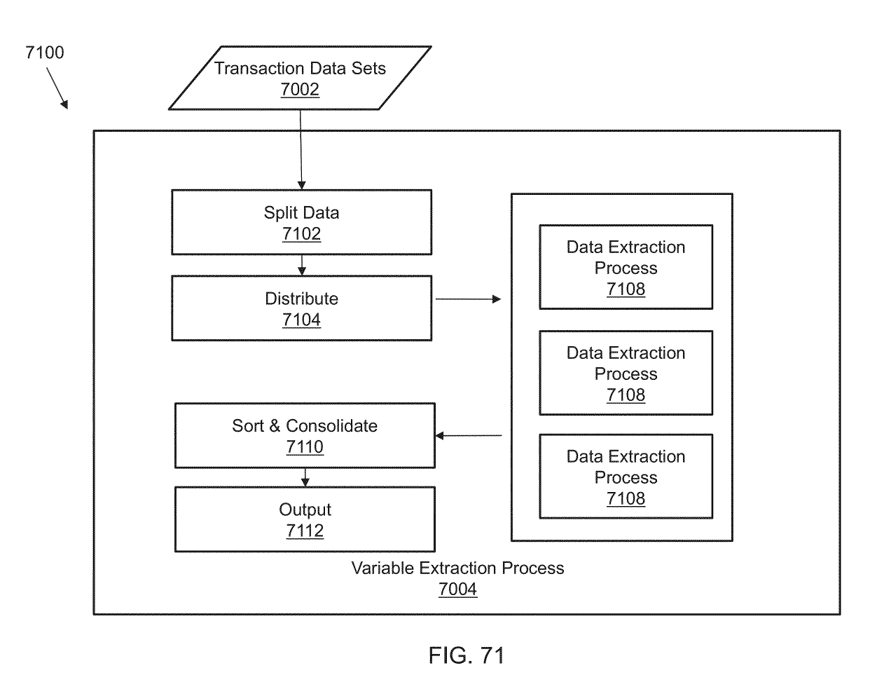

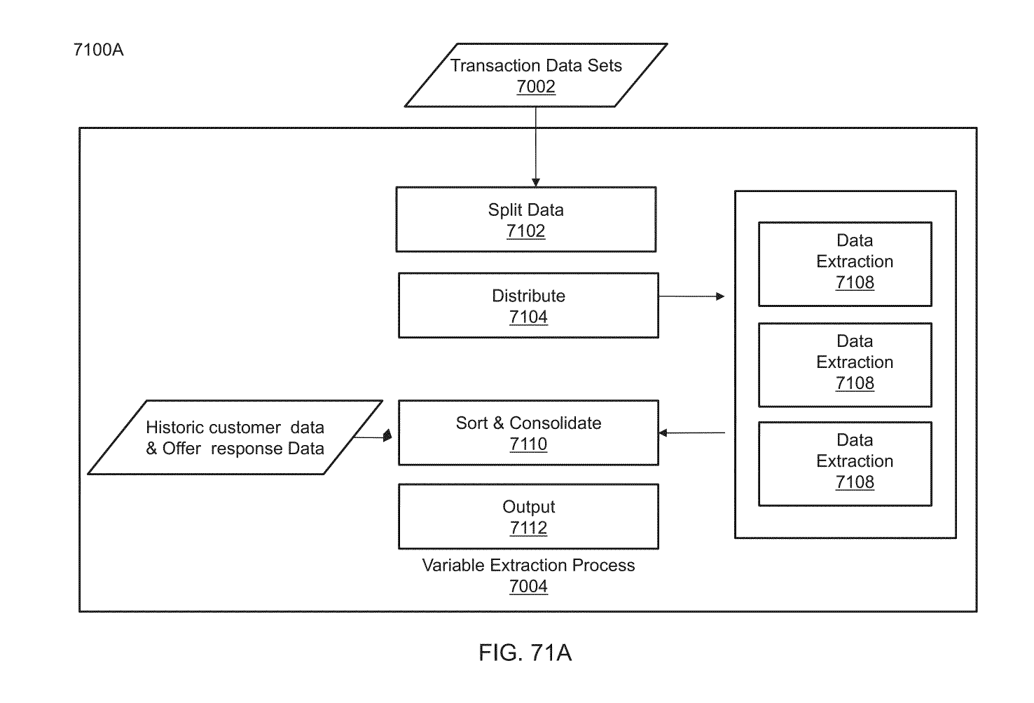

FIG. 71 depicts a variable extraction process 7004 for efficiently mining large amounts of data including those generated by multiple financial transaction data sets 7002, ongoing data collection, and the like wherein this process includes splitting the data 7102 where the combined input of multiple financial transaction data sets 7002 may be separated into smaller data sets of possibly similar size, distributing the smaller data sets 7104, to one or more data extraction processes 7108, sorting and consolidating 7110 the output generated by the data extraction processes 7108 and outputting the processed data 7112. Distributing the data processing across a plurality of data extraction processes 7108 enables a variety of distributed processing schemes including utilizing multiple cores within a single computer, utilizing a group of computers, processing in the cloud, and the like. The potential for widely distributed processing has the potential to significantly reduce the elapsed processing time and capabilities required of individual machines. Sorting and consolidating 7110 consolidates the data output from the plurality of data extraction processes 7108. Sorting of the data may be on the basis of a variety of criteria including user, geographic location, location characteristics, merchant, merchant sales strength during period, category, day of the week, week of the year, periodic purchases by customer, and the like. Consolidation may include the removal of duplicate transactions and the like. The results of sort and consolidate 7110 are then output 7112. Output 7112 may include storing the resulting customer data sets 7008 in a file, database or the like, or passing the customer data sets 7008 to the input of another process. Although the variable extraction method 7004 described herein is representative of a hadoop reduce map, alternative processing methods such as relational databases, elastic map reduce and the like are contemplated.

FIG. 71A illustrates an alternate embodiment of a variable extraction process 7004, wherein previous customer data sets and offer response data may be merged with the results from the data extraction processes 7108 during or following the sorting and reducing process 7110 rather than entering into the data split process 7102 as an additional financial transaction data set 7002 together with new financial transaction data 7002. This may reduce the elapsed processing time as the previous customer data sets 7108 and offer response data are not being reprocessed through the data extraction process 7108.

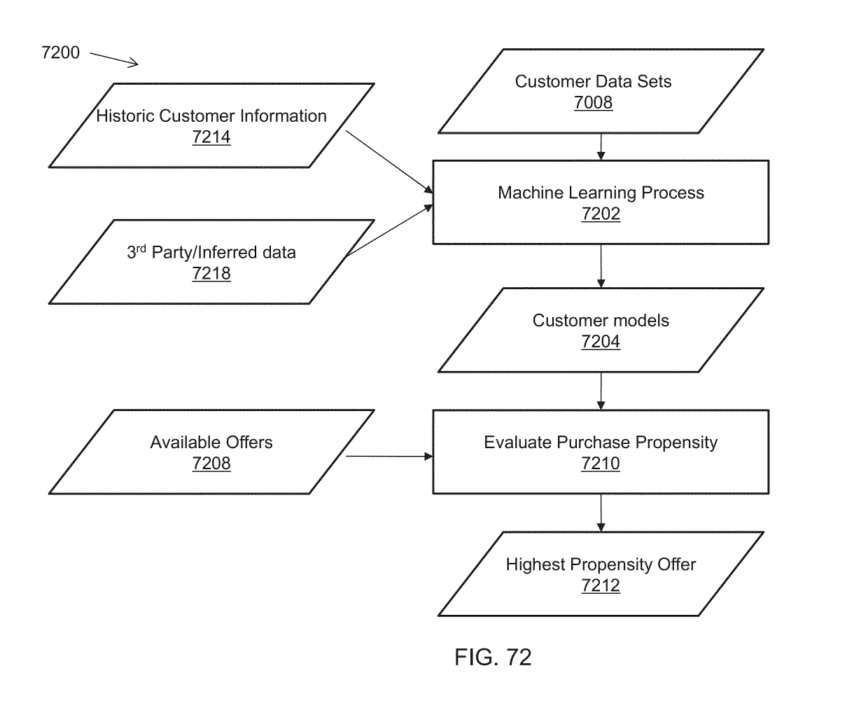

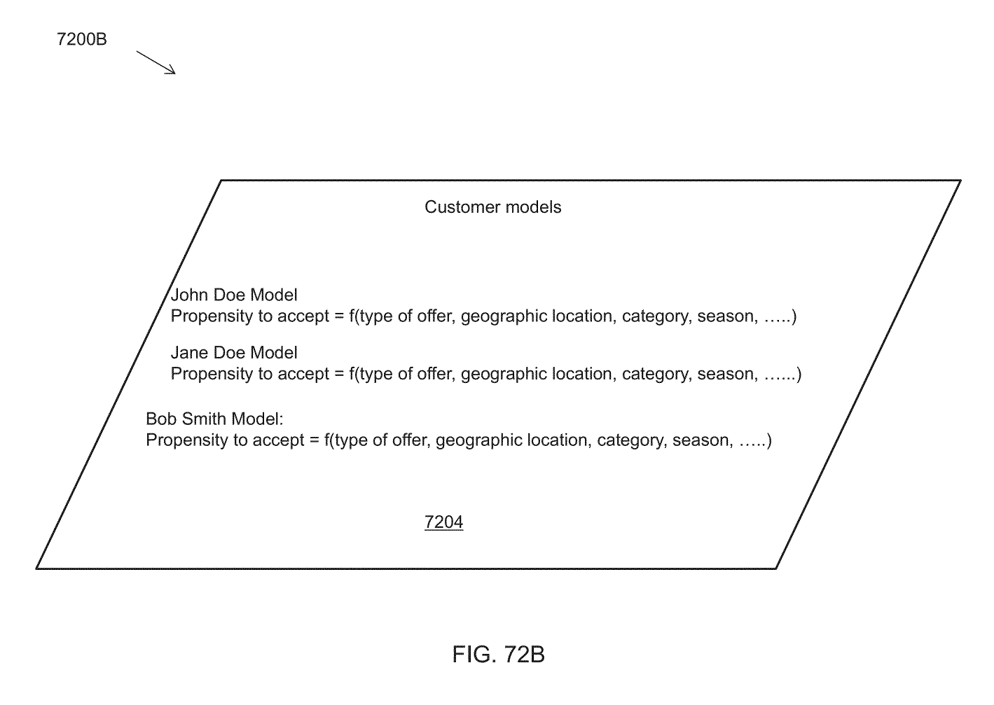

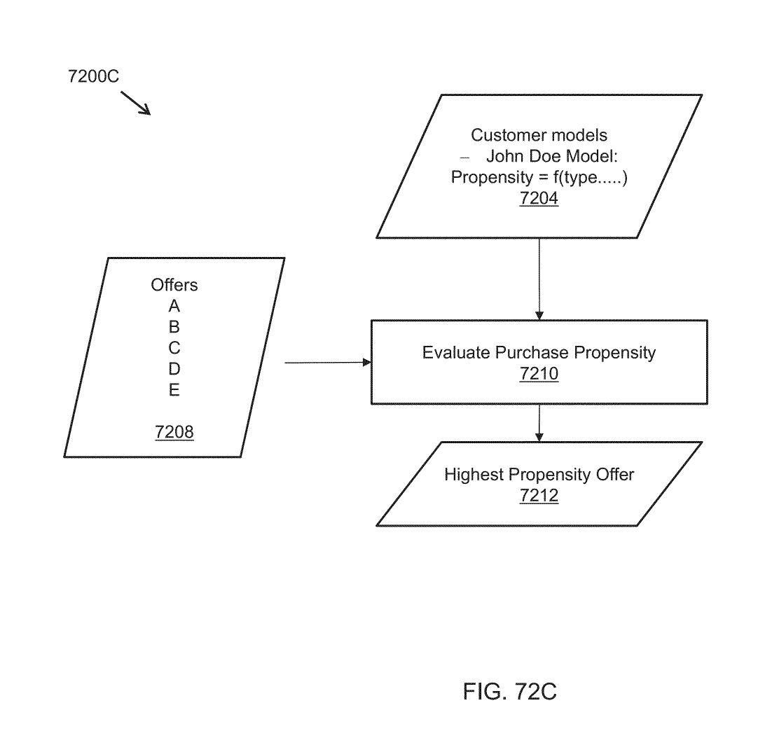

FIG. 72 illustrates a platform 7200 wherein the customer data sets 7008 resulting from the variable extraction 7004 are input into a machine learning process 7202. Additionally, historic customer information 7214, including previous customer models 7204, responses to previous offers, previous customer data sets 7008, and the like may be provided as input to the machine learning process 7202. Additionally, public or inferred data 7218 including customer's location, census data for the location, such as ethnic makeup, population educational level, income levels, and the like, may be used to provide a substitute demographic profile for the user and may be provided as input to the machine learning process 7202. In another embodiment, merchant data may be accessed using a third party data source and used to improve targeting to the user. For example, a restaurant may be searched on YELP.COM by a user to obtain information about the type of cuisine offered, type of atmosphere, price range and the like. These data may be used as factors in the machine learning process.

The machine learning process 7202 develops a model of customer spending habits including category preferences, geographic locations, seasonal variety, periodic purchases, recent changes from historic spending patterns and the like. The machine learning process 7202 may also develop weighting criteria relative to influence on customers spend behavior including a heavier weighting on recent transactions, extended changes in geography, and the like.

The machine learning process may be a form of predictive modeling including techniques such as logistic regression, neural nets, algorithms such as lasso, elastic-net regularized generalized linear and non-linear models, support vector machines (SVM), ensembles of decision trees, “random forests”, and the like. As illustrated in the platform 7200B in FIG. 72B, the customer model 7204 results in a personalized function for each customer that predicts propensity to purchase as a function of a number of variables including type of offer, geographic location, category, merchant, season, and the like. By understanding influences on a particular customer spending behavior the system is better able to accurately predict the relative likelihood or propensity of a customer to act upon a particular offer. As shown in platform 7200C, the customer model 7204 developed is then used to evaluate purchase propensity 7210 for a number of different available offers 7208 as shown in FIG. 72C. Evaluating purchase propensity results in identification of the offer with the highest purchase propensity for presentation to the customer in any of a variety of manners including on a customer's online statement, an online graphical user interface associated with the user's financial account, an online bill pay area, a dialog box associated with the user's financial account, an ATM receipt, a teller receipt, a mobile statement, a paper statement, an email and the like.

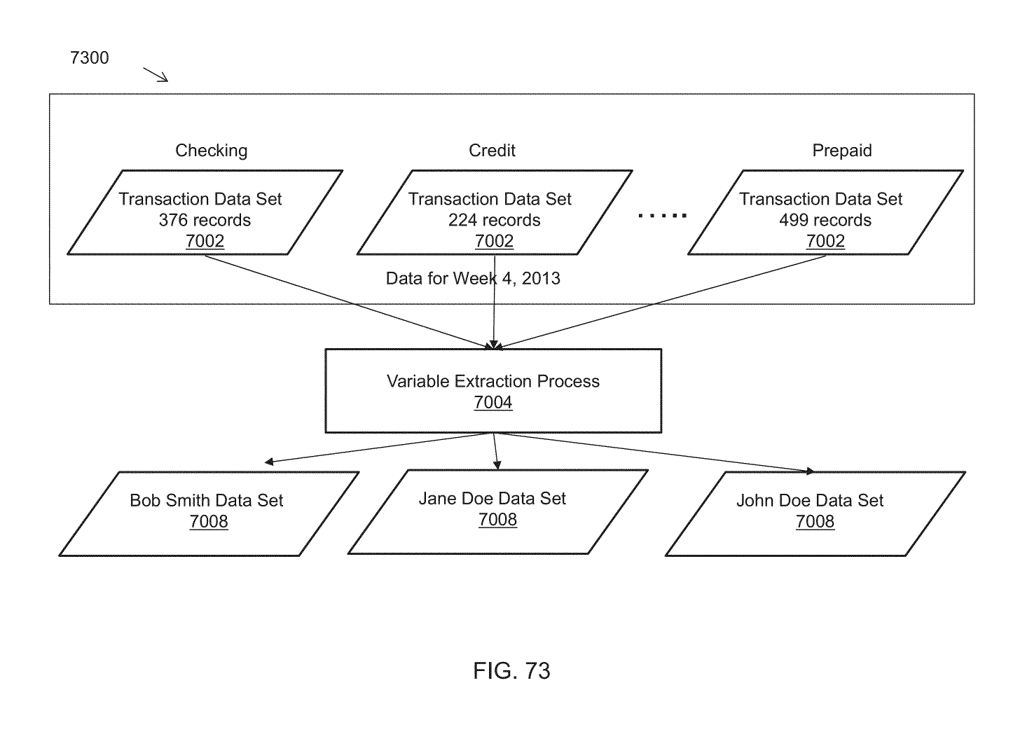

FIG. 73 provides an illustrated example 7300 of how such a system might work. The system receives a plurality of financial transaction data 7002 which encompasses some time period. In this example, the time period is a single week although it is clear that there is wide latitude in the selection of a time interval. The financial transaction data sets 7002 contain a varying number of records encompassing data on a number of individuals. In this example, there are 999 records between the 3 financial transaction data sets 7002 containing financial transactions including those made by Bob Smith, Jane Doe, John Doe, and others. These financial transactional data sets 7002 are sent to the variable extraction process 7004.

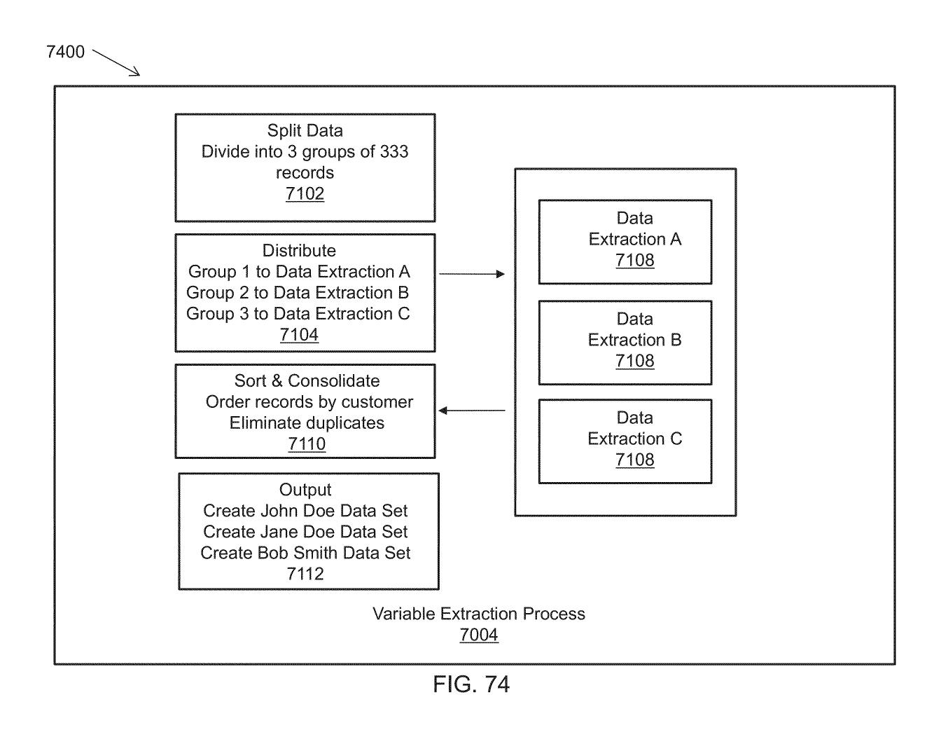

FIG. 74 provides an illustrated example 7400 of how the variable extraction process 7004 might flow. In the data split process 7102, the financial transaction data records are split from 999 records to a number of smaller groups. In this example the 999 records are split into 3 groups of 333 records each. In data distribute 7104 each of the groups is sent to a different instance of the data extraction process 7108. Each data extraction process 7108 returns the process output to the sort and consolidate 7110 process. Here the output is sorted into a number of data sets including a data set of transactions by John Doe, a data set of transactions by Jane Doe, a data of transactions by Bob Smith, and the like. The set of data concerning John Doe is processed to consolidate the data further, remove duplications and the like. The processed data sets are then output 7112 into a file system, database or the like.

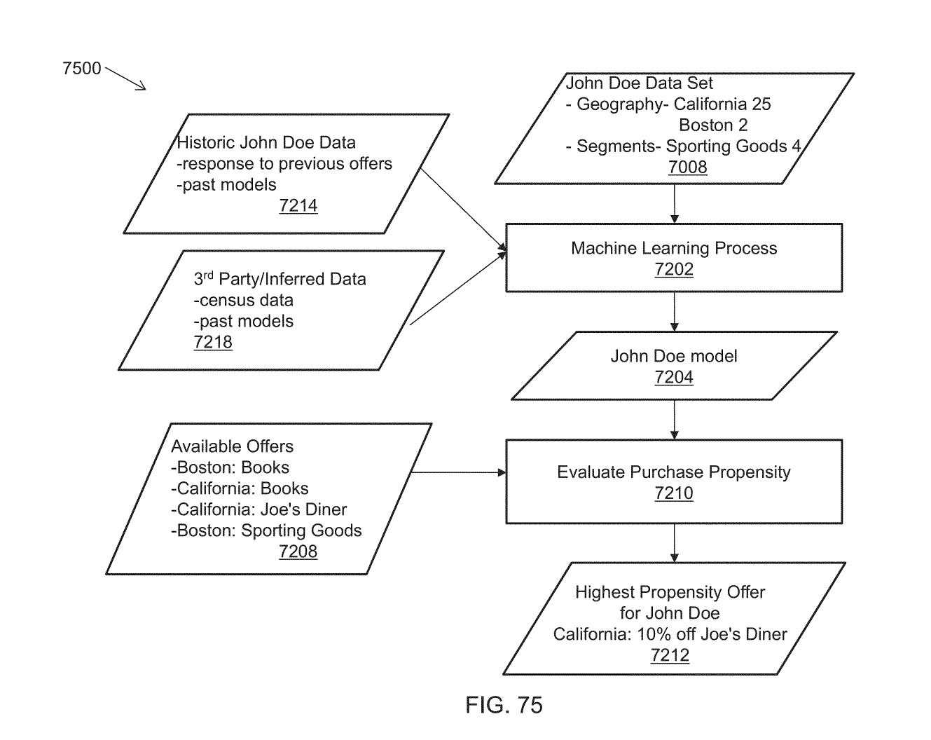

FIG. 75 illustrates the offer scoring process 7500 based on the learned customer models 7204. In this example, the machine learning process creates a propensity to accept model for John Doe based on a variety of inputs including the most recent John Doe data set 7008, historic data on John Doe 7204 including response to previous offers, past models for John Doe and the like, 3rd party and inferred data including substitute demographic profile based on census data, typical preferences for customers in specific geography, and the like. A set of available offers 7208 is evaluated for relative purchase propensity 7210 and then the offer with the highest propensity or likelihood of being accepted is selected and presented to the customer in any of a variety of manners including on a customer's online statement, an online graphical user interface associated with the user's financial account, an online bill pay area, a dialog box associated with the user's financial account, an ATM receipt, a teller receipt, a mobile statement, a paper statement, an email and the like.

In another embodiment the financial transaction data 7002 associated with a particular customer may be gathered in real time to update the relative purchase propensity 7210 model for that particular customer. Additionally, if the customer is accessing the system using a device which provides geographic location that information may also be used to update the purchase propensity model 7204. In this way the purchase propensity model is kept current.

The data extract process 7108 may involve extracting meta data from a customer transaction record such as merchant, category, geographic location, transaction type, spend type, spend profile, and the like. However, the meta data available may not be constant due to truncation by intermediate transaction processers, limits in reporting capabilities of various financial institutions, and the like. Meta data definitions may vary geographically and by category type. It is an object of this disclosure to describe a tool that may enable the viewing, modifying, and reviewing of meta data definitions and rules. The definitions and rules may vary across the plurality of providers of financial transaction data sets. The tool would enable an operator to define rules for the meaning and characteristics of the transaction data to be segmented including what meta data is represented in the transaction, how it may be parsed, and the like. As additional data becomes available in a transaction record it may be possible to define additional meta data types, rules, definitions and the like for search and extraction.

This disclosure provides the customer with a plurality of value adding offers and services. These offers and services may be made available by a plurality of merchants, service providers, and the like to increase customer base, reward loyal customers, increase brand recognition, and the like. Sales teams associated with suppliers of customer analytics, financial applications, and the like, may have the job of approaching different merchants, service providers and the like to solicit deals which may be offered to the customer. Sales teams may be rewarded based on meeting sales targets such as revenue, profitability, number of sales and the like. It is an object of this disclosure to provide a tool to enable the sales team to better achieve such goals. The disclosure enables the sales team to access information about different merchants, categories of merchants and the like to understand individual offer-campaign performances as well as which merchants are currently generating higher levels of offer acceptance and/or spend and the profitability of various merchants and merchant categories across seasons, geography, merchant/merchant category popularity, sales channel, such as online vs. in store, and the like. The sales team may utilize such information to focus their efforts on those merchants, service providers and the like who are most likely to enable the sales team to meet their goals. In another feature of this tool, the performance of a sales person might be evaluated by comparing their recent achievements relative to the analytic data regarding merchant profitability and the like. This functionality may be provided by a sales dashboard, website, application or similar means.

At least part of the attractiveness of the present disclosure is that a plurality of channels and distribution services may be used to communicate these offers and services to the customers. These channels include, as noted herein above, on-line and mobile delivery channels, in-store channels, short-messaging service (SMS) channels, text-messaging channels, printed and on-line coupons and offers, ATM receipts, e-mails, and the like. These communications may take the form of pre-paid certificates, offline coupons (such as those useful in an actual brick-and-mortar store, e.g., a Starbucks® coffee shop), and the like. Channels may also take the form of on-line coupons, financial statement coupons or credits, a future reward, and the like. These rewards or incentives may be delivered by email, on-line or web channels, mobile statements or channels, ATM receipts, Open API, and the like. Mobile channels may include a mobile phone, a smart phone, a personal digital assistant (PDA), or other mobile device, such as a tablet computer, pad computer, or other portable, mobile device capable of communicating digitally or with the Internet.

Thus, while traditional on-line banking has focused on a user at home or in an office using a personal computer, mobile communications are now easily handled by both users and financial institutions. These channels may help the user in his or her daily tasks and may also provide more opportunities for communicating savings opportunities. Merchants and third party service providers also now have additional channels for communicating these savings opportunities to users, customers, and potential customers.

The techniques discussed above make improved use of data that is available to a merchant and to a third party service that assists the marketing efforts of the merchant. These efforts may tend to be more effective if the merchant, and the third party service provider, can more accurately target the desired audience. In general, more accurate targeting will occur if either or both of two things occurs: more persons in the desired audience are reached and/or fewer persons are reached in undesired audiences. As more and more merchants and providers reach out to their targeted audiences, it is preferred that each effort be tailored to just the right audience.

The transaction data used in analyzing the purchasing behavior of individual users, however, is limited. In general, the transaction data furnished to a third party service provider has been anonymized or depersonalized (that is, disassociated with information that identifies a specific individual). The data are typically stripped of all personally identifiable information (“PII”), as described above or by another technique, such as furnishing a copy from which the personally identifiable information has been deleted. Anonymized data thus does not include the personally identifiable information, some of which would likely make it easier to target a marketer's desired audience. Personally identifiable information may include various items, such as name and address, or even just postal code (e.g. ZIP code), which may be sufficient to uniquely identify most users.

Since the transaction data available to third party marketers is limited, another way is needed to help identify users that a merchant or other provider may wish to target. For example, a merchant may wish to target what is known as the “millennial” generation, loosely bearing the characteristics of one or more of: persons with a college degree, an income higher than median income, college students, persons born from about the early 1980s to about the early 2000s, and persons in an age range (such as the 18-34 age range). The age range is optionally converted to a range for date-of-birth of potential customers. This segment of customers may be desirable to any number of merchants, such as niche apparel merchants, which may include Abercrombie & Fitch®, H&M®, J. Crew®, and the like. Other merchants targeting this group may include online retailers, such as Amazon.com® and Zappos®, as well as content download providers, such as iTunes®.

Personal data or personally identifiable information that would be desirable to these merchants or others may include the person's name, address, age, residence and area (e.g., Zip Code or postal code), personal income level, family income, educational level, number and age of children, and the like. This and other information would allow segmentation into a “life stage” for the person, e.g., singles, young marrieds, young family with children, middle age with children in college, empty-nesters, retirees, and the like. Some researchers use what are generally known as core-based statistical areas (CBSAs) or standard metropolitan statistical areas (SMSAs) or micropolitan areas to categorize locations (residences) of persons. Some techniques use what are known as combined statistical areas, metropolitan statistical areas, micropolitan areas and the like. All of these are discussed as statistical areas for purposes of this disclosure except where context indicates otherwise. These may be useful for helping to determine the economic level or potential of an area and persons residing in or associated with the area.

Various information may be gathered by market research firms, such as Nielsen Co. These are generally private firms that conduct surveys and gather information on consumers in various markets. Market research that includes gathering personal data is also conducted by firms that manufacture and market products, such as consumer goods products. Examples include the Proctor & Gamble Mfg. Co. Inc., the Lever Bros. Co. and the Colgate-Palmolive Co. Consumer and demographic information may be gathered in surveys, for home performance tests, and the like. Companies may choose to make some limited portions of this data available to third party marketing companies to assist in marketing their own products.

Market research can be gathered on a desired sample size of consumers, and the market research companies typically focus on achieving representative samples of a desired audience or group. The data is gathered from groups of consumers and may include surveys with questions that identify the persons, as discussed above, and gather demographic data. While actual incomes may not be typically asked or disclosed, the use of income brackets for personal income and for family or household income are common Besides the demographic information mentioned in the previous paragraph, spending habits and shopping habits may also be queried and responses taken. Questions may inquire about the respondent's habits and practices for spending in a particular category or categories. These may include varied areas, and such surveys typically may not be extensive, to avoid respondent fatigue. The areas questioned may include any areas desired by a merchant, retailer, manufacturer, establishment or provider of a good, content, or a service.

A particular survey may question a user's travel purchases, clothing purchases, restaurant expenditures, entertainment expenses, apparel purchases, online purchases, content downloads, and the nature of these purchases. A user's durable goods history or inclinations may also be queried, e.g., for furniture, appliance, housing and automobile expenditure or plans for expenditures. New trends may also be identified, such as which or how many users patronize Uber, Spotify, airbnb.com, iTunes, and so forth. Some of these services may be characterized as on-line based services for connecting buyers and sellers and are a form of “seller” or “merchant.” These services may also be characterized as those, by their nature, primarily base on communications and transactions conducted by mobile devices, e.g., Uber, which is used by persons immediately seeking a local transportation service. Based on responses to market research questions, consumers or potential customers may be clustered or segmented based on their spend behavior for merchants that have been identified as seeking the desired characteristic, e.g., demographic.

For example, a third party marketer with market research data in hand may construct a list of merchants, such as merchants or content providers that may appear desirable to the segment, e.g., millennials. The list may include the niche apparel retailers, as mentioned above, if they appear among merchants mentioned in the market research surveys taken among respondents with the desired demographics, e.g., the millennials. Other groups may also be targeted, e.g., higher income people with significant restaurant expenses, families with young children that rent and may want a home, and so forth. In this manner, users may be segmented or clustered based on their spending behavior with specific merchants, and also with merchandise categories. In the present application, it should be understood that merchandise encompasses both goods (including physical and digital goods) and services (including online services) available for purchase, as well as such goods, content, or services that have been purchased. Throughout this disclosure, the provided examples may focus on shopping at a particular store, but this disclosure is not limited to application of the systems and methods in these scenarios. Indeed, other examples of this disclosure may include shopping for a particular item, as opposed to shopping at a particular store, wherein it is the item that provides a clue as to the demographic of the shopper.

Users may be segmented based on their spending behavior as being indicative of a specific demographic. In the continuing example, “millennial” users may be identified by first constructing a list of “millennial” merchants, such as the apparel retailers, among other merchants and providers. Users may be clustered or segmented based on their purchasing behavior, e.g., spending and number of visits at designated “millennial” merchants or on “millennial” items. These clusters, however, do not automatically mean that the users belong to the desired demographic group or cohort. To verify that the user belongs to the desired demographic group, the clusters should be validated. Validation may occur, for example, by comparing the spending characteristics of the obtained clusters to users that were described by the market research but were not used during clustering or segmentation.

For example, to identify a particular demographic group, a first group of users may be obtained using purchasing behavior, perhaps based mostly on visits to apparel retailers. To validate that the first group of users indeed has the desired demographic, a second group of users may be obtained (members of the second group being different from the first group), where the second group of users is classified as not having or matching the desired characteristic (e.g., a group of Baby Boomers that are, by definition, not “Millenials”). Market research has shown that the first group has more frequent online shopping than the second group. Thus, the online spending behavior of the second group may be compared to that of the first group. If there is a significant difference between the groups, as expected, the first group may be validated. Market research tests may be conducted and the differences may be verified. Additional test groups can be used to verify similar spending behavior between desired groups that appear to fit a demographic category, one group identified from market research and personal information, the other group inferred as having the desired demographics from their spending or purchasing behavior.

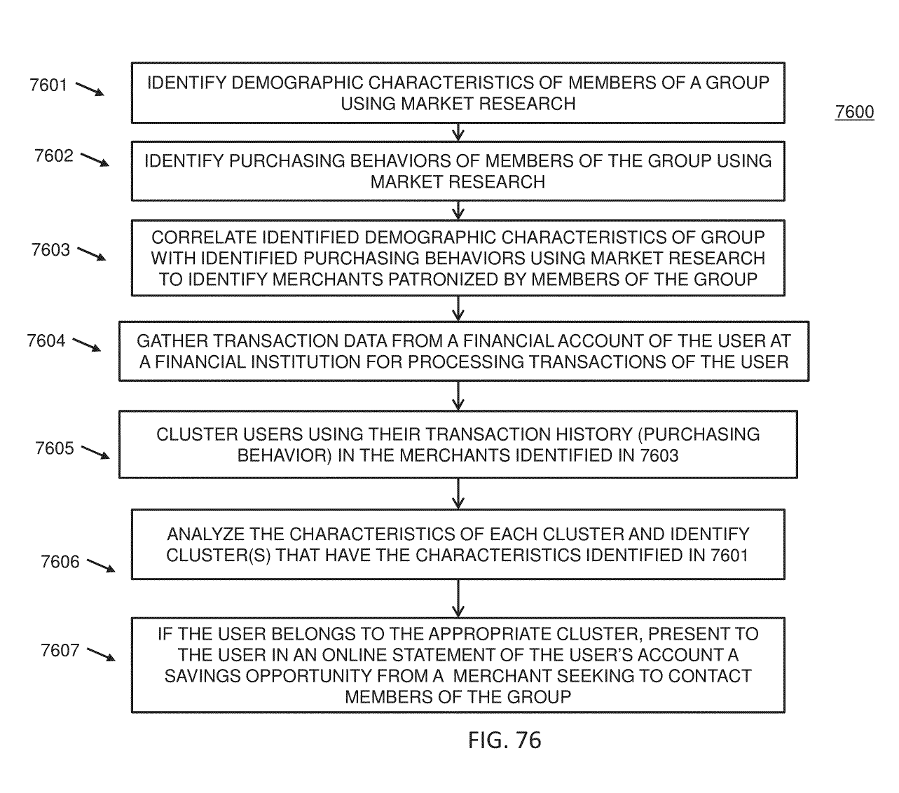

One method of identifying members of a group emphasizes the importance of the merchants themselves, as shown in the flowchart 7600 of FIG. 76. In a first step of method, demographic characteristics of the group are identified at step 7601, using market research. The purchasing behaviors, such as merchants/categories heavily shopped by the group (or exclusively shopped by the group), frequency of shopping, average spend, and many other purchasing-relevant behaviors, of members of the group may also be identified at step 7602 using market research. The identified demographic characteristics of the group may be correlated at the step 7603 using the market research to identify merchants patronized by members of the group. In embodiments, the method may be executed in a very short time, such as under 10 minutes for about one million users.

As discussed in several methods above, transaction data may then be gathered at step 7604 from a financial account of the user at a financial institution that processes transactions of the user from a plurality of merchants and providers. Users' shopping behavior (e.g. number of visits, average spend) with the list of merchants identified in 7603 are collected and used as input to a clustering algorithm 7605. At step 7606, the characteristics of each cluster are examined and compared with those of the demographic group. If the user belongs to the appropriate cluster, the user may then be presented at step 7607 with an offer, such as, for example a savings opportunity in an online statement of the user's account from a merchant seeking to contact members of the group. Thus, in this method, clustering is used to identify demographic labels, not for segmenting users using the labels. For example, if market research indicates that those who shop at comic stores and BestBuy® can be labeled as “twenty-something's”, and clustering of users according to purchasing behavior identifies users who have shopped at both comic stores and BestBuy®, among other stores, the demographic label “twenty-something's” may be assigned to that cluster.

Identifying users by their anonymized financial transaction data enables third party marketers to use the anonymized transaction data in segmenting or clustering potential customers, without the use of the actual personal data that would be difficult to safeguard or prohibited from use. The third party marketer, or the principal, such as a merchant, retailer, manufacturer, establishment or provider of a good or a service, can gather demographic data of exactly the desired segment. While the demographic data is being gathered, the spending behavior or spending history of the potential customer is also gathered. The spending behavior of the desired segment may be used as a proxy to mark the desired segment and to avoid the non-desired segment. In the example for high-end customers, the targeted group may include users who have patronized certain stores or users who have avoided other stores, e.g., discount stores or mass-merchandise retailers.

The data gathered may be used in separate efforts. When the demographics are taken by market research, a more comprehensive spending history is also taken, including purchases in merchants or categories that were not originally targeted. For example, in the effort to identify customers with high-end retailers, the same users who shop at the high-end niche retailers may also patronize restaurants, jewelry stores, airlines, or other completely unrelated establishments. These spending characteristics may help identify the target group, even though they may be completely independent of target lists of merchants in the initially identified area, such as the apparel area in this continuing example. That is, spending in other categories may also be used to identify characteristic behaviors of members of the desired segment. There may thus be separate, independent efforts in several merchandise categories to segment or identify the desired group. The spending in each of the categories may be used to help decide whether a person is a member of the group, the decision then being useful for categorization in connection with targeting efforts that relate to goods and services that are somewhat unrelated to the original spending behavior.

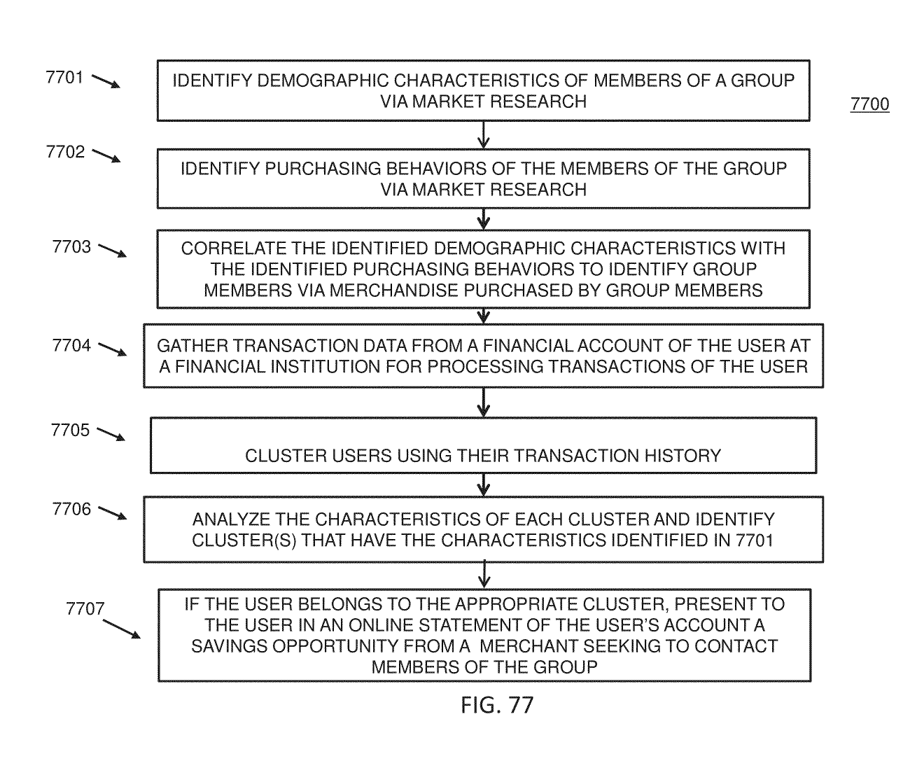

A flowchart 7700 in presented in FIG. 77 to emphasize a method of determining members of a desired demographic group using merchandise purchased by the members. In embodiments, the method may be executed in a very short time, such as under 10 minutes for about one million users. In this method, a first step 7701 may be to conduct market research to identify demographic characteristics of members of the group or to obtain the market research from a third party. The purchasing behaviors of members of the group are then identified 7702 using the market research. The identified demographic characteristics of the group are then correlated 7703 with merchandise purchased by members of the group. At step 7704, transaction data are gathered from a financial account of the user at a financial institution for processing transactions of the user. The transaction data are then analyzed 7705 to cluster users using their transaction history. The characteristics of each cluster are analyzed at step 7706 and cluster(s) that have the characteristics identified at step 7701 are identified. At step 7707, if the user belongs to the appropriate cluster, the user is presented in an online statement of the user's account a savings opportunity from a merchant seeking to contact members of the group.

In addition to the “global” validation or confirmation, additional validation or confirmation may be accomplished on micro-scale, as desired. For example, in identifying potential customers, a third party marketer may have agreements with several financial institutions, such as credit card companies or banks. These financial institutions themselves may not be completely balanced demographically. For example, a given bank or credit card company may have users primarily from a geographic region in which there are no stores of a particular niche apparel company. Accordingly, it may be worthwhile to perform the above validation using only a sub-group from a given financial institution, such as a credit card company or a bank. The list of target companies in the segment may then be updated, since the lack of a store in the area should not detract from membership in the desired demographic group.

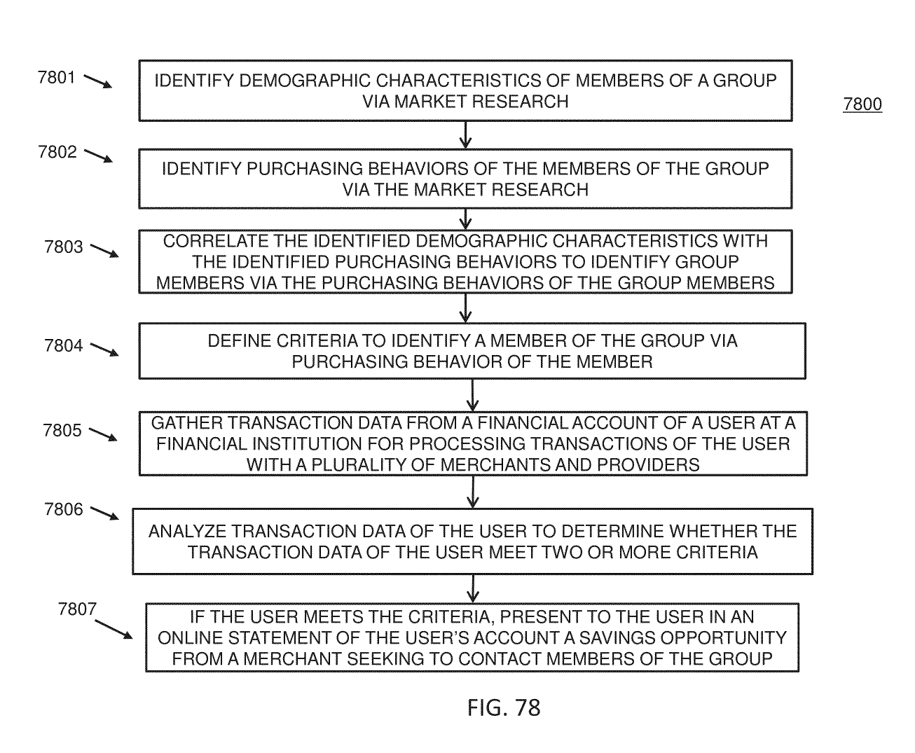

Another way to identify members of a group may be through the purchasing behavior of the members. One method of identifying members of the group emphasizes the importance of the merchants themselves. This method is shown in the flowchart 7800 of FIG. 78. In embodiments, the method may be executed in a very short time, such as under 10 minutes for around one million users. In a first step of method, demographic characteristics of the group are identified at the step 7801 using market research. The purchasing behaviors of members of the group may also be identified at the step 7802 using market research. The identified demographic characteristics of the group are correlated at the step 7803 using the market research to identify purchasing behaviors of members of the group. Using the correlation, criteria are then defined at the step 7804 to identify a member of the group via the purchasing behavior of the member, the criteria not relying on personally identifiable information, since all transaction data is anonymized and may not be traced or tracked to an individual or to a member.

As discussed in several methods above, transaction data is then gathered 7805 from a financial account of the user at financial institution that processes transactions of the user from a plurality of merchants and providers. The gathered transaction data is then analyzed 7806 to determine whether the data meet the criteria for the user to be an individual member of the group, that is, the group that is desired by at least one merchant. If the user meets the criteria, the user is then presented at the step 7807 an opportunity or offer, such as a savings opportunity in an online statement of the user's account from a merchant seeking to contact members of the group. There are many ways to use the market research data and the transaction data to help identify users a merchant wishes to contact.

There are also many ways to assist in ensuring the accuracy of the criteria used to define or segment consumers into the group with the desired demographics. As noted, the criteria for a given consumer or group of consumers may not be valid in all instances. For example, shopping behavior for a group of consumers in a given area may lack purchases from one or more merchants if the merchant does not have a store location in the given area. Therefore, the third party marketer may take account of locations for particular stores or venues and adjust the criteria for spending behavior or purchasing behavior to take account of this circumstance, noting, for example, which stores applicable to a particular segment are actually located in a particular geographic area. The statistical areas discussed above for metropolitan or micropolitan areas may assist in these efforts, by helping researchers pinpoint which retail stores may be absent from purchasing data because of such circumstances (no local store is available, or there are so few stores that purchases are much less frequent than in areas with dense store locations). In such instances, the marketer may adjust the criteria to look for on-line purchases or purchases from alternate merchants or providers.

In a more general sense, once initial criteria for the desired demographic group have been set, the criteria may be tested in many ways to validate and improve the groups or clusters. For example, while merchants target consumers with high incomes and higher value items, these desirable groups also purchase fuel and may shop at general-interest stores, such as mass-merchandise discount stores. Appropriate means may be found using analytical clustering techniques to distinguish patrons of gasoline stations and discount stores with higher spending and income from other patrons of gasoline stations and discount stores with less spending and less-sought-after demographics.

Clustering or cluster analysis aims to group a set of objects, in this case consumers or potential customers, in such a way that persons in the group are more similar to one another than to persons in other groups, in this case in other demographic groups. Tools may include clustering algorithms, such as k-means algorithms, which may give a formal definition to a cluster, e.g., a high income level or an educational level, and then seek to find the most natural clusters along a number of parameters. These parameters may include the ones discussed herein, that is, a cluster may be formed with persons of high income, and then further segregated or clustered with persons who spend a certain minimum amount, persons who shop at certain stores, persons who have a certain number of transactions in a certain category, e.g., high-end restaurants, etc. The parameters may be assigned weights so that more importance is assigned to what are considered the most important criteria or parameters. K-means algorithms may be run several times with varying conditions in order to avoid local minima.

Clustering analysis may also be performed with other techniques, such as agglomerative clustering or hierarchical clustering. In this technique, clusters are formed on the basis of the objects, or consumers, being more related to similar consumers than to dissimilar consumers. In this technique, a similarity or “distance” could be an income range of one group of consumers in comparison to an income range of a second group of consumers. Using a multi-dimensional approach, other similarities or dissimilarities may be constructed using patronage of a certain store or category of store, failure of patronage of a certain store or category of store, and so forth. Weights may be assigned to accord more importance to parameters that are considered to be more important. In one embodiment, a cluster may begin with a single parameter to see how many distinct groups may naturally result. Additional parameters may be added to see whether the multi-parameter groups make sense from a demographic and marketing point of view. The output of clustering may be different demographic parameters, such as age, gender, postal code or zip code, ethnicity, and the like.

The use of market research and clustering analysis may be iterative. With market research completed, there may be a number of “known” clusters of customers based on the personal information that was gathered from the customers participating in the market research. In other embodiments, market research doesn't necessarily provide clusters, but describes the aggregate behavior of users participating in surveys, such as that 200/500 (40%) shoppers in Los Angeles shopped at J.C. Penney®. Purchasing behavior or transactions of a first group of these customers may be available from a financial institution that processes purchasing transactions for these users, e.g., a bank or a credit card company, the key being that the financial institution has access to the purchasing behavior of the user because the financial institution processes transactions of the user with a plurality of merchants and providers. Information from the financial transactions, i.e., purchasing behavior, may be used to form clusters of users with supposed demographics sought by a third party marketing firm on behalf of its clients, such as merchants, retailers, manufacturers, establishments or other providers of a good or a service.

When choosing criteria to use with the transaction data of the consumers, it should be remembered that the depersonalized or anonymized data from the financial institution includes no personal identifiers. One possibility of “personal data” is the identification of the financial institution itself as the source of the transaction data in a particular transmission. That is, the bank or credit card company's identification may be a giveaway of a particular region or area. Other than that, the transaction data itself alone may be used to begin the process of seeking the desired consumers. In general, the financial transactions and selected criteria of the financial transactions alone can be used to form the clusters or groups of customers. One or more iterations or refinements may be made to improve the groups or clusters. At any point along this process, or at every point, the accuracy of the groups may be validated by comparing the anticipated demographics of the group with the actual demographic data from the market research data. In this way, hypotheses may be tested, criteria evaluated, weights tried, and the like, to see which approach yields the most accurate cluster or group of consumers with the desired demographic data.

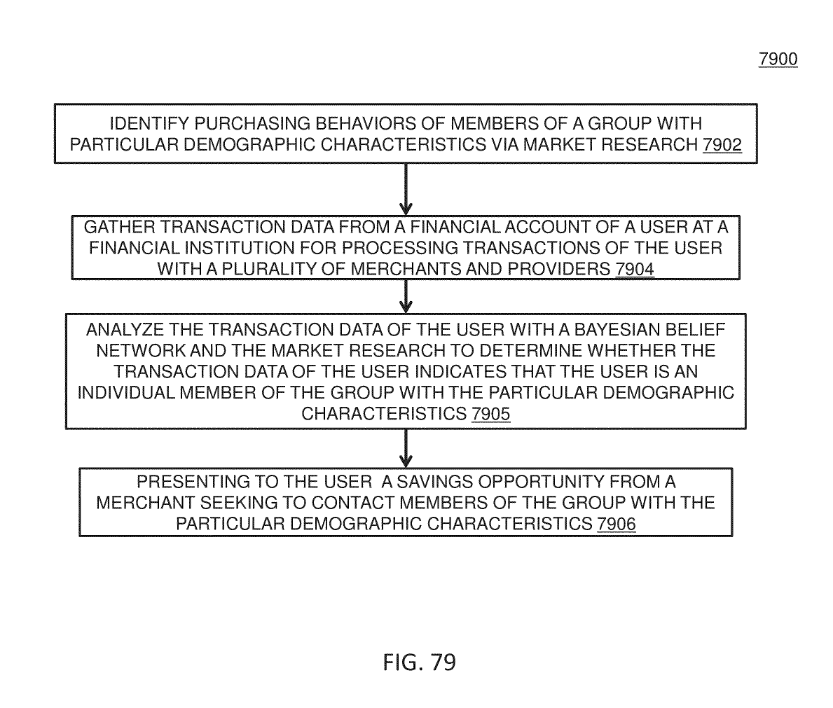

With reference to FIG. 79, in another disclosed non-limiting embodiment, a method 7900 of inferring the demographic characteristics, e.g., gender, age group, new parents, millennials, etc., of a user using a set of transactions and market survey data that does not include any Personal Identifiable Information (PII) can be used to map a user to a given demographic. The method 7900 utilizes heuristics to estimate the demographic information of a particular user or individual, such as a cardholder, based on the user's spending data and external survey data about shopper demographics. In embodiments, the method may be executed in a very short time, such as under 10 minutes for about one million users.

In a first step of the method 7900, purchasing behaviors of members of a group with particular demographic characteristics are identified via market research (step 7902). In one disclosed non-limiting embodiment, the market research may be determined via survey data from a merchant, a group of merchants, service providers, content providers, and the like. That is, merchants often obtain survey data of their customers' (also known as “members”) purchasing behaviors and the particular demographic characteristics thereof. A set of probabilities about shopping behaviors of members and the particular demographic characteristics at various merchants or of various items are obtained, e.g. statistics may indicate that 90% and 30% of shoppers at Victoria's Secret® and BestBuy®, respectively, are women.

In a next step, transaction data from a financial account of a user at a financial institution for processing transactions of the user with the multiple of merchants are gathered (step 7904). It should be appreciated that the transaction data from the financial account, however, may be limited. In general, the transaction data has been anonymized or depersonalized. That is, the data are stripped of all personally identifiable information, as described above or by another technique, such as furnishing a copy from which the personally identifiable information has been deleted. Anonymized data thus does not include the personally identifiable information that would make it easier to target a marketer's desired audience. Deleted or omitted personally identifiable information may include at least name, address, postal code and demographic information such as gender, race, age range, etc., which can be sufficient to uniquely identify most users.

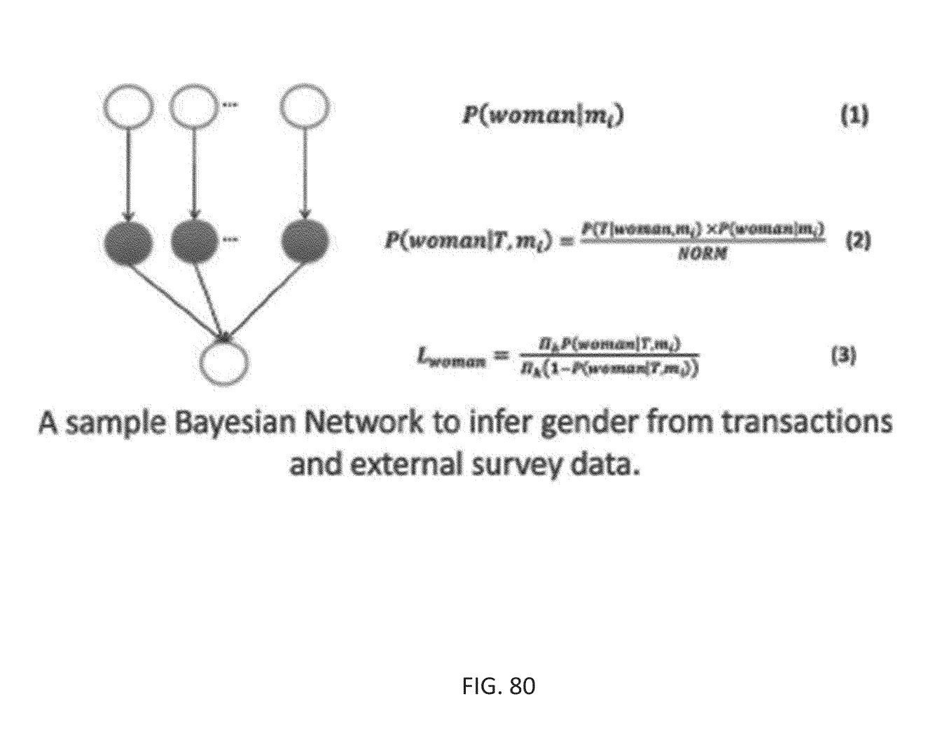

In a next step 7905, the transaction data of the user is analyzed via a Bayesian belief network (FIG. 80) and the market research to determine whether the transaction data of the user indicates that the user is an individual member of the group with the particular demographic characteristics. At step 7906, the user is presented a savings opportunity from a merchant seeking to contact members of the group with the particular demographic characteristics.

A Bayesian belief network, also known in the alternative as a Bayes network, belief network, Bayes(ian) model or probabilistic directed acyclic graphical model, is a probabilistic graphical model. A directed acyclic graph (DAG) may be used to represent a set of random variables of the model and their conditional dependencies. That is, it is formed by a collection of vertices and directed edges, each edge connecting one vertex to another, such that there is no way to start at some vertex v and follow a sequence of edges that eventually loops back to that same vertex again.

This Bayesian belief network allows the combination of the prior information (market research data) and the evidence (user spend represented by transactions) in a coherent framework. For example, with regard to determining whether the user is a woman, a set of prior probabilities about shopping behaviors of women at various merchants are determined from external market research data e.g. 90% and 30% of shoppers at Victoria's Secret® and BestBuy® are women. That is, estimation of the probability as to whether the user is a woman, defined as P (Woman Spend, Merchants), i.e., the probability that the user is a woman based on market research as to the general probability that a given shopper is a woman based on where and how she has shopped before and the demographic information from market research about the gender of other shoppers that have shopped for similar things at similar locations, is derived from transactions at certain merchants, at certain locations of such merchants, involving certain items, or the like.

In one embodiment of such a method, let:
T={t₁, t₂, . . . , tₙ} be a set of transactions for a user.
M={m₁, . . . , mₖ} be a set of merchants for which external survey data exists.
P(woman|m_{(i,1≦j≦k)}) be an estimation of prior probability of a being a woman if a person shopped at a particular merchant mᵢ (estimated from market research data, such as survey data).

Next, a Bayesian Network for the individual as shown in FIG. 80 is constructed. For example, the prior probability P(woman|m_{(i,1≦i≦k)}), obtained via the market research, is initialized.

Then, the following sub-steps A, B, C may be repeated iteratively for each transaction tᵢεT or a subset T⊂T thereof.

Sub-step A, estimate P(T|woman, mᵢ) from the set of user transactions.

Sub-step B, compute the posterior probability P(woman|T, mᵢ) using equation 2 from FIG. 80:

P(woman|T,mᵢ)=(P(T|woman,mᵢ)×P(woman|mᵢ))/NORM (Equation 2).

Sub-step C, update prior probabilities P(woman|mᵢ) with those in Equation 2, disclosed herein and in FIG. 80.

The main reason to include priors from market research is to ensure fast convergence of posterior probabilities to their true values. This can be important, as only a relatively small number of transactions are typically available for a given individual to train the Bayesian belief network. Without seeding the network with prior probabilities from market research, it could otherwise require a relatively large number of transactions for the true, or most likely, probabilities to emerge, as individual transactions can easily diverge from the norm, and if such “non-normal” transactions predominate in a small data set, incorrect inferences can occur, such that it can take a very long time for the posterior inferences to converge. Thus, this method is an improvement in the technical field of presenting offers to a specific demographic when only anonymized transaction data are available and demographics must be inferred. The above example with just one merchant would be very sensitive to shopping behavior at that merchant. One goal of this system is to be able to combine signals across different merchants and categories in a comprehensive and coherent framework.

Finally, the likelihood ratio L_{woman} may be computed using equation 3 (FIG. 80). If L_woman>1, the conclusion is that the user is most probably a woman.

The user may then be presented with a savings opportunity from a merchant seeking to contact members of the group with the particular demographic characteristics (step 7908).

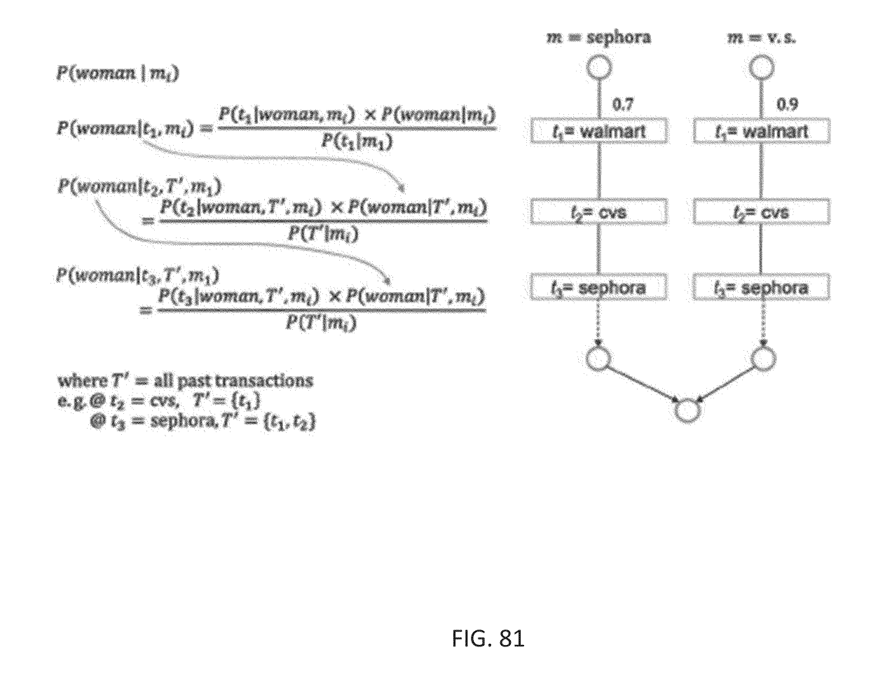

With reference to FIG. 81, suppose there are only two merchants that show strong gender-differentiation among shoppers: Victoria's Secret® and Sephora®. {m₁=victoriassecret, m₂=sephora} In this case, the Bayesian network will have only two branches. Then, assume from prior research that 90% of the shoppers at Victoria's Secret are women, and 70% of the shoppers at Sephora are women. P(woman|sephora)=0.7

Given user A has the following transaction set T: {walmart, cvs, sephora, kfc, walmart, meijer, victoriassecret (vs)}, the transaction set is passed through each branch of the Bayesian network.

For each transaction, estimate P(tⱼ|woman, T′, mᵢ). This step stops after all the transactions have been processed. From each branch, P (woman|T, mᵢ) is calculated. Lastly, the probabilities from different branches are combined to calculate the odds ratio of the user being a woman. Consider a Bayesian network with only two merchants: Victoria's Secret® and Sephora®. Assume the prior probability of a Victoria's Secret® (VS) shopper being a woman is 0.9, and that of a Sephora® (S) shopper is 0.7, i.e. P(woman|VS)=0.9 and P(woman|S)=0.7. Assume a customer shopped at both stores: T={VS, S}. We further estimate that the probability of a woman Victoria's Secret® shopper having such shopping behavior is 0.7, and that of a woman Sephora® shopper is 0.6. Similarly, the probability of a male Victoria's Secret® shopper having such shopping behavior is 0.4, and that for a male Sephora® shopper is 0.3. By formula (2) in FIG. 80, we have

$$\begin{matrix}P ( woman \vert T , VS ) = \frac{P ( T \vert woman , VS ) \times P ( woman \vert VS )}{P ( T \vert woman \vert VS ) \times P ( woman \vert VS ) + P ( T \vert man , VS ) \times P ( man \vert VS )} \\ = \frac{0.7 \times 0.9}{0.7 \times 0.9 + 0.4 \times 0.1} \\ = \frac{0.63}{0.63 + 0.04}\end{matrix} \\ \begin{matrix}P ( woman \vert T , S ) = \frac{P ( T \vert woman , S ) \times P ( woman \vert S )}{P ( T \vert woman \vert S ) \times P ( woman \vert S ) + P ( T \vert man , S ) \times P ( man \vert S )} \\ = \frac{0.6 \times 0.7}{0.6 \times 0.7 + 0.3 \times 0.3} \\ = \frac{0.42}{0.42 + 0.09}\end{matrix}$$

We can now calculate the likelihood of this customer being a woman may now be calculated using Formula (3) of FIG. 80:

$${L}_{woman} = \frac{( 0.63 / 0.67 ) \times ( 0.42 / 0.51 )}{( 1 - 0.63 / 0.67 ) \times ( 1 - 0.42 / 0.51 )} >> 1$$

Since L_{woman}>1 it may be concluded that this customer is most likely to be a woman. These simple examples show the power of Bayes theorem and how it may be useful in predicting consumer preference based on past purchasing data.

This method of estimating demographics information without actually relying on PII from the cardholder data via Bayesian belief network need only rely on the consumer's past spend history and external retail, consumer survey data, and combining both sets of signals through a probabilistic framework in a principled and novel way. Thus, a method and system is provided wherein an individual may be classified, such as into a demographic, psychographic, or similar category or otherwise into a group, based on a very small number of transactions (e.g., fewer than 1000, fewer than 500, fewer than 100, fewer than 10, fewer than 5, or one) entered into by that individual (such as reflected in that individual's credit card, debit card, or other financial transaction records). Such a method and system may be based in part on a prior estimate of the probability of the member being part of a group, such as based on market research.

In embodiments, the methods and systems disclosed herein employ a multi-fold targeting process to generate targeted offers, involving, for example: 1) merchant-defined targeting and segmentation criteria; 2) financial institution targeting; and 3) platform-defined criteria to maximize the likelihood a user will accept a reward, offer, or incentive using transaction metrics that the platform pre-computes. Merchant-defined targeting and segmentation criteria may involve applying rules or filters dictated by a merchant when targeting offers to a user or a segment of users. For example, merchant-defined targeting may involve only providing an offer to consumers who have not shopped with the merchant in the last 90 days. Similarly, financial-institution targeting may involve applying rules, restrictions, blacklists, filters, or the like (collectively referred to herein as “rules” except where context indicates otherwise) that are dictated by a financial institution when targeting offers to users. An example may be that users should not be provided any offers that involve products from other financial institutions. The platform-defined criteria may be applied to the targeting as well. Here, only the offers with a high likelihood of being accepted, or offers for which the return to the merchant is very high upon acceptance, as examples, may be presented to the user. An example scenario of applying acceptance likelihood targeting is as follows: During a period of time, financial transaction information available to the targeting process may indicate that User A spent $500 in the Health & Beauty category but only $50 at Merchant A, whereas User B spent $75 at Merchant A but only $90 total in Health & Beauty. While both users may satisfy a typical criterion of Merchant A that requires a minimum spending of at least $50 with Merchant A during the period of time, User A is more likely to accept a Health & Beauty offer based on the overall spending of User A in the relevant category as indicated by the transaction metrics. The methods and systems disclosed herein may include analyzing shopping behavior in general, and identifying and storing which offers the user is most likely to redeem based on the targeting described herein. Since shopping behavior in general is used in the analysis, the targeted offers may not be linked to any specific transaction or set of transactions. When the consumer logs on to their financial institution account, a contextual filtering of the targeted offers may be performed in real-time, which is based on the currently displayed transactions along with session behavior, which may result in re-ranking which offers to possibly display to the user. The offer information may then be sent to the browser, including where it should be placed in the browser. In real-time or near real-time, the platform may use contextual information based on whatever page of transaction(s) the user is viewing to identify offers from a set of offers that may have been pre-targeted to the user based on various criteria. It should be understood that throughout this specification, the term offer may include rewards, offers and incentives, except where context indicates otherwise.

In addition, the platform may perform offline offer matching in the multi-fold manner described herein, but need not necessarily handle the offline presentation. The platform may assemble offers the consumer is likely to accept based on prior shopping behavior, but the offers need not be matched to any existing specific trans action.

In embodiments, the particular discount presented in an offer that is based on a discount may be the percentage of a total spending amount or an absolute amount that a user receives in points, cash, or other remuneration in exchange for successfully redeeming a reward.

When the term “personalized offers” is used in the rewards space, what is typically meant is selecting one or more merchant-defined rewards or offers (e.g. cash, points, goods, discounts, etc.) from an inventory and giving it to a given user based on the user's past spending pattern, spending behavior, characteristics or history associated with the merchant, or characteristics or history in general. For example, if both hypothetical “User 1” and “User 2” get “Offer 1”, the parameters of the offer, such as without limitation minimum spending threshold to trigger the applicability of the offer, discount amount, and duration or length of the campaign, might typically all be the same for a given Offer 1. This may not be true personalization, and it may be inefficient at driving incremental spending and/or maximizing redemption, or maximizing return on investment, when compared to results in control groups for a variety of reasons, such as that some users may require less or more discount to act, some users would ordinarily spend over or perhaps far below the set spending threshold, some users may respond to short offer periods while others may require a longer time to make decisions, and the like. How to personalize offers, rewards, and incentives at the time of presentation of the offer, reward, or incentive in order to maximize redemption and drive incremental spend is a problem specifically arising in the realm of computer networks and requires a solution necessarily rooted in computer technology in order to overcome the problem.

Dynamic personalization method and systems are described herein wherein depending on which user or users are to receive a reward, offer or incentive, the parameters of the reward, offer, or incentive, such as the amount of any applicable discount, campaign length or duration, minimum spending threshold(s) (e.g. with a retailer, in a category, or the like) required to receive the reward, or trigger the offer or incentive, or any other parameter may be dynamically personalized to a specific user. In embodiments, methods and systems to dynamically adjust reward, offer, or incentive spending threshold(s) and personalize the criteria specific to individual users are disclosed herein. Combining user propensity models (e.g., whether a given consumer is likely to spend), spending trajectory data (e.g., what a likely future spending pattern might be), and user profile information with campaign goals, such as attracting new customers, winning back lapsed customers, or rewarding loyal users, campaign parameters may be defined on a per user basis or for a group of users to offer truly personalized rewards, offers, and incentives.

If we assume that future spending behavior will differ from past spending behavior, a new estimation of a user's spending pattern, i.e., the user's spending trajectory, may be made. For example, a user's monthly spending may typically vary. If the user's spending pattern shows a trend, one may calculate a new monthly average. If the new average differs from the old average by a given amount, a new monthly spending estimate, or trajectory may be calculated. One may perform a calculation based on a difference of 5%, 10%, or other observed difference in spending behavior. In embodiments, other observed differences may be used for calculating a spending trajectory of a user. These differences may include different merchants or providers, different types of expenditures, different periods of time between expenditures, and so forth. For example, a user may make fewer purchases from gasoline stations and more purchases on airline fares. These differences may suggest a spending trajectory with greater travel and entertainment purchases, and fewer expenditures on automobiles, gasoline and related products. In this example, a user's spending trajectory or future spending pattern may be quite different from the user's past spending behavior.

In an embodiment, spending trajectory data may be used to personalize rewards, offers, or incentives. For example, “User 1” may spend on average $50 at “Merchant 1” and “User 2” may spend on average $100 at “Merchant 1.” If the users' spending trajectory is assumed to mirror past spending, presenting both users with a reward, offer, or incentive with the same minimum spend threshold of $60 would likely be less effective at driving incremental revenue for the merchant than giving “User 1” a minimum spending threshold of $60 and “User 2” a minimum spending threshold of $110. The dynamic parameter of spending threshold may give each user a threshold spending amount higher than the particular user's average, to encourage the particular user to spend more than the user ordinarily would. In embodiments, the amount of discount for an offer may also be adjusted based on one or more of spending trajectory data, user propensity, user profile, and the like.

In an embodiment, user profile information may be used to personalize rewards, offers, or incentives. For example, if “User 1” is labeled or categorized as a “thoughtful spender” according to merchant-defined targeting and segmentation criteria, and “User 2” is labeled or categorized as an “impulsive spender,” then giving User 1 a longer deal period, and User 2 a shorter deal period may be more effective at driving incremental revenue than giving them both the same time period to redeem a given reward, offer, or incentive.

In an embodiment, user propensity models may be used to personalize offers. As described herein, and in reference to FIG. 71, variable extraction processes 7004, such as a hadoop reduce map process, a relational database extraction process, an elastic map reduce process, or the like are contemplated for obtaining the data to develop user propensity models. The processes 7004 may be executed on a single computer or by using distributed processing schemes utilizing multiple cores within a single computer, utilizing a group of computers, processing in the cloud, and the like. A machine learning process 7202 can be applied to the obtained data, which may be a form of predictive modeling, optionally using or including techniques, or combinations of techniques, such as logistic regression, neural nets, algorithms such as lasso algorithms, models, such as elastic-net regularized, generalized linear and non-linear models, support vector machines (SVM), ensembles of decision trees, “random forests,” and the like. The machine learning process 7202 may use such techniques to learn, and predict, user behavior based on past data, such as transaction data, data characterizing user responses to offers, and the like. As illustrated in FIG. 72B, the customer model 7204 may be a personalized function for each customer that predicts the relative likelihood or propensity to purchase as a function of a number of variables including type of offer, geographic location, category, merchant, season, and the like, wherein the customer model 7204 is used to evaluate purchase propensity 7210 for a number of different available offers 7208 as shown in FIG. 72C. For example, if a merchant wants to provide users a single offer to drive traffic to the merchant's site, but “User 1” is determined to have a high propensity to redeem a health & beauty offer, and “User 2” is determined to have a high propensity to redeem a baby items offer, then giving “User 1” the health & beauty offer and “User 2” a baby items offer will be more effective at driving incremental revenue than giving them both the same offer.

In embodiments, any combination of at least one of user propensity models, spending trajectory data, and user profile information may be used to dynamically change a reward, offer, or incentive. Further, the same all or fewer than all of user propensity models, spending trajectory data, and user profile information may be used to dynamically change a reward, offer, or incentive, or different combinations of user propensity models, spending trajectory data, and user profile information may be used to dynamically change a reward, offer, or incentive on a per user basis. For example, and continuing with the example of User 1 and User 2, User 1 may be determined to be a thoughtful spender who spends $60 on average on health & beauty items at Merchant 1, while User 2 is determined to be an impulsive spender who spends $100 on average on baby items at Merchant 1.

In one example, where all of user propensity models, spend trajectory data, and user profile information are used to dynamically change a reward, offer, or incentive, if the merchant wants to present a single reward, offer, or incentive to each user that is dynamically targeted to the user, using the methods and systems herein to dynamically modify the offer, the offer presented to User 1 by the merchant may be for health & beauty items with a long redemption period and a minimum spend threshold of $60, while the offer presented to User 2 by the merchant may be for baby items with a short redemption period and a minimum spend threshold of $110.

In another example, where fewer than all of user propensity models, spending trajectory data, and user profile information are used to dynamically change a reward, offer, or incentive, the offer presented to User 1 by the merchant may be for health & beauty items and a minimum spending threshold of $60, while the offer presented to User 2 by the merchant may be for baby items and a minimum spending threshold of $110.

In another example, where different combinations of user propensity models, spending trajectory data, and user profile information are used to dynamically change a reward, offer, or incentive on a per user basis, the offer presented to User 1 by the merchant may be for health & beauty items and a minimum spending threshold of $60, while the offer presented to User 2 by the merchant may be for baby items and a short redemption period.

While the method may be employed on a per user basis, it can also be applied to cohorts of users. For example, all users with an average spend between $40 and $50 may have the same minimum spend threshold applied to offers, rewards, or incentives, say $60, while users with an average spend between $20 and $30 may have a $40 minimum spend threshold for the same offer, reward, or incentive. A cohort implementation model can make reporting simpler for merchants, but may come at the expense of incremental revenue and personal relevance.

In an embodiment, an algorithm may be used to change the offer, reward, or incentive based on one or more inputs, such as user propensity models, spend pattern/spend trajectory data, user profile information, campaign goals, and the like. For each input, one or more rules may be applied to how the input affects the output. For example, the rules may limit which inputs to select in dynamically changing the offer, reward, or incentive. The rules may involve applying a weight to the one or more inputs in dynamically personalizing the offer, reward, or incentive. Merchants may make the rules and select rules to apply, such as through an interface to a rules database or rules server.

The system of the present disclosure may include dashboards, such as a merchant dashboard or a financial institution dashboard. Each dashboard may show the appropriate audience interaction of the users with reward, offers, and incentives being shown to them, such as opens, clicks, redemptions, shares, and purchases. The dashboard may also enable merchants and financial institutions to edit and manage the rules governing dynamic personalization by interfacing to a rules database.

In embodiments, rewards, offers, or incentives may be dynamically changed via a dynamic personalization method in real-time or near real-time when a user accesses an account with a financial institution. In embodiments, the process of dynamically changing a reward, offer, or incentive may occur automatically, under computer control, or in a time span shorter than a browser refresh or webpage load such that a dynamically personalized reward, offer, or incentive is displayed when a new reward, offer, or incentive is requested from the offer database or server. This time span may be less than about 10 sec, less than about 5 sec, less than about 1 second, or substantially instantaneously.

In other embodiments, rewards, offers, or incentives may be dynamically changed via a dynamic personalization method in advance and stored for presentation to the user when the user accesses a site, such as a site hosted by or for the financial institution. In this embodiment, at the time of presentation, additional targeting may be done before the reward, offer, or incentive is presented to the user, such as further applying a filter or rule from the financial institution, using one or more modeled or inferred demographic criteria for targeting, and the like. In embodiments, the process of additional targeting may occur automatically, under computer control, or in a time span shorter than a browser refresh or webpage load such that a dynamically personalized reward, offer, or incentive with additional targeting is displayed when a new reward, offer, or incentive is requested from the offer database or server. This time span may less than about 10 sec, less than about 5 sec, less than about 1 second, or substantially instantaneously. The display may be made on a physical device of the user, of the merchant, or on both. The physical device of the user may be a personal computer, a mobile computer, tablet computer, smart phone or other mobile device. The physical device of the merchant may be a point-of-purchase or point-of-sale (POS) terminal or computer. Alternatively, the merchant may also use a mobile device, such as a smart phone or other terminal or device.

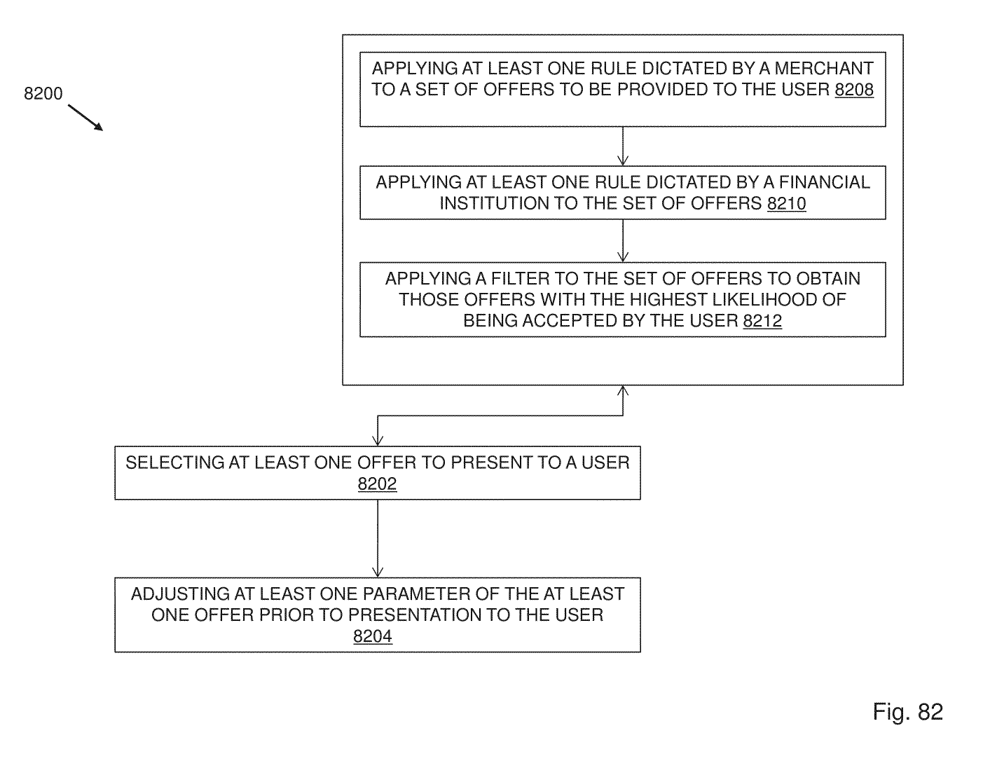

Referring to FIG. 82, a method of targeting users with a reward, offer, or incentive 8200 may include selecting at least one reward, offer, or incentive to present to a user or a segment of users 8202 and adjusting at least one parameter of the at least one reward, offer, or incentive prior to presentation to the user or segment of users 8204. Selecting may be done by: applying at least one rule, restriction, or filter dictated by a merchant to a set of rewards, offers, or incentives to be provided to the user or the segment of users 8208, applying at least one rule, restriction, or filter dictated by a financial institution to the set of rewards, offers, or incentives 8210, and applying a criterion to determine the set of rewards, offers, or incentives with the highest likelihood of being accepted by the user or segment of users 8212. The at least one adjusted parameter may be at least one of a minimum spending threshold, a discount amount, a duration of a campaign, and a category of reward, offer, or incentive. The filter to obtain rewards, offers, or incentives with the highest likelihood of being accepted may be based on a prediction of user behavior, such as purchase behavior, developed using at least one of: data on one or more past user responses to one or more savings opportunities, public or inferred data relevant to the user, preferences (including merchant category preferences, transaction category preferences, product category preferences, and merchant preferences), a geographic location, a seasonal variety, a spending level, and any recent changes from historic spending patterns. The geographic location may be the geographic location of the user, the geographic location of the merchant, or both. The geographic location of the user may be determined separately from a determination of the geographic location of the merchant. For example, a geographic location of the user may be determined by a global positioning system or sensor (GPS), while a location of the vendor or merchant may be known previously. In embodiments, the merchant may have a mobile location, e.g., at special events, fairs, festivals and the like. In these embodiments, a location of the merchant may be determined via global positioning technology or by self-reporting of the merchant.

Adjusting the parameter may include calculating a spending trajectory based on a historical spending pattern and adjusting the parameter in accordance with the spend trajectory. Adjusting the parameter may be done in accordance with at least one segmentation criterion applied to the user. Adjusting may be completed in a time span selected from the group consisting of: less than about 10 sec, less than about 5 sec, less than about 1 second, or substantially instantaneously. Adjusting may be done in accordance with at least one input selected from the group consisting of: a spend trajectory, a user propensity model, user profile information or segmentation criteria, and a campaign goal. A rule may be applied to determine which of the inputs are used in adjusting. A weight may be applied to each of the selected inputs in adjusting.

The parameters may be adjusted, in one embodiment, with a spending trajectory adapted for the user and including spending via one or more geographical locations. For example, the merchant or vendor may wish to encourage spending in certain categories when the user is away from his or her usual location. These categories may include restaurants, travel and leisure, e.g., spending categories associated with being away-from-home. A geographic location of the user may be determined by a global positioning system or sensor. Alternatively, a location of the user may be inferred by his or her patronage at shops or vendors with a known location at a given distance from a normal geographical location of the user. The distance may be used as a criterion or parameter. For example, a distance of 500 miles implies that the user is away from home for at least one night. Other physical distances, such as 1000 miles or more, may also be used. Shorter distance, to help determine branch or store areas, may also be used, e.g., 5 km, 10 km, 15 km, 50 km, 100 km, 5 miles, 10 miles, 15 miles, 50 miles or 100 miles may also be used. These shorter distances may aid merchants or third party markers to distinguish and determine likely areas for participation by users, their propensity to travel, their traveling propensity to spend, and the like. Data determined by studies such as these may be used to adjust a spending trajectory of a user and how the spending trajectory of the user or other users may depend on physical distance of the user from a merchant.

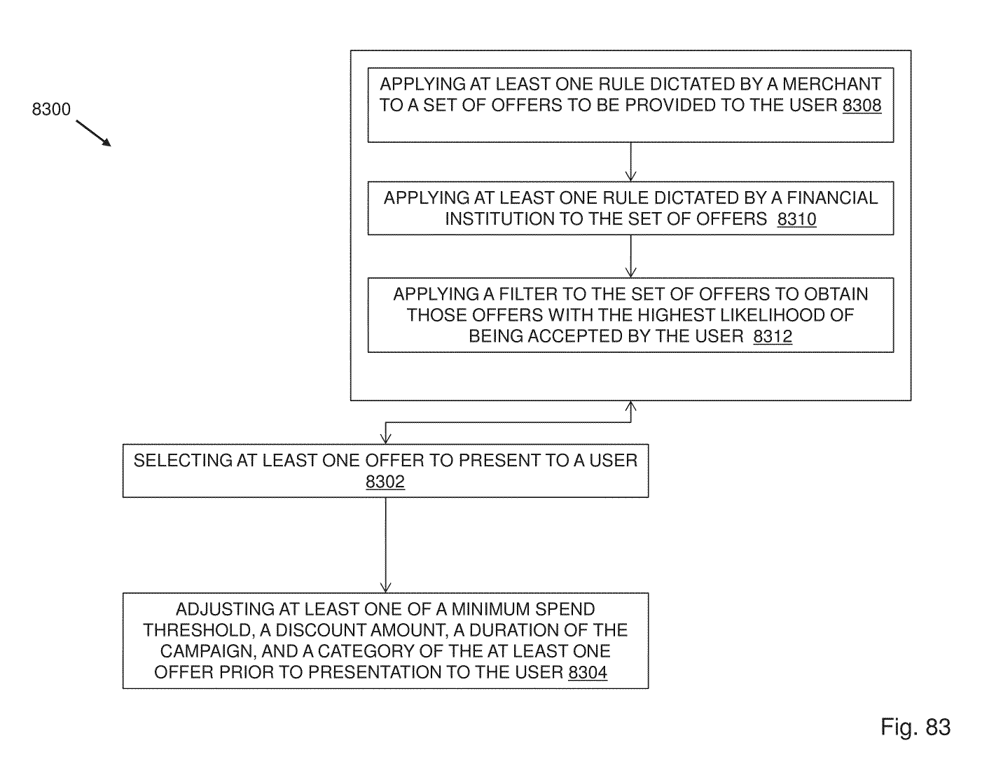

Referring to FIG. 83, a method of targeting users with a reward, offer, or incentive 8300 may include selecting at least one reward, offer, or incentive to present to a user or a segment of users 8302 and adjusting at least one of a minimum spending threshold, a discount amount, a duration of the campaign, and a category of the at least one reward, offer, or incentive prior to presentation to the user or segment of users 8304. Selecting may be done by: applying at least one rule, restriction, or filter dictated by a merchant to a set of rewards, offers, or incentives to be provided to the user or the segment of users 8308, applying at least one rule, restriction, or filter dictated by a financial institution to the set of rewards, offers, or incentives 8310, and applying a filter to the set of rewards, offers, or incentives to obtain those rewards, offers, or incentives with the highest likelihood of being accepted by the user or segment of users 8312. The filter to obtain rewards, offers, or incentives with the highest likelihood of being accepted may be based on a predictive model of user purchase behavior developed using at least one of: data on one or more past user responses to one or more savings opportunities, public or inferred data relevant to the user, preferences (including merchant category preferences, transaction category preferences, product category preferences, and merchant preferences), a geographic location, a seasonal variety, a spending level, and any recent changes from historic spending patterns.

The geographic location for the method pictured in FIG. 83, may have an importance similar to the geographic location discussed above. In particular, the step of adjusting at least one of a minimum spend threshold, a discount amount, a duration of the campaign and a category of the at least one offer may be made contingent or dependent on a geographic location of the user, or one or more locations of the vendor merchant, or both. In addition, the presentation to the user may be understood to be a physical presentation, such as via a mobile device of the user or an in-place or mobile device of the merchant. The presentation may also be made via presentation of a printed offer or coupon from the merchant or third party marketing company to the user. The location of the user or the merchant, or both, may be determined via a GPS sensor, using a GPS system. Alternatively, the location of either, or both, may be inferred from other known facts, e.g., the store has always been located in Mexico City; or the user, in one example, has recently made another purchase in a Mexico City location or has requested peso-denominated foreign exchange from an ATM located in Mexico City.

Adjusting may include calculating a spending trajectory based on a historical spending pattern and adjusting the at least one minimum spend threshold, discount amount, duration of the campaign, and category of the at least one reward, offer, or incentive in accordance with the spend trajectory. Adjusting may be done in accordance with at least one segmentation criterion applied to the user. Adjusting may be completed in a time span selected from the group consisting of: less than about 10 sec, less than about 5 sec, less than about 1 second, or substantially instantaneously. Adjusting may be done in accordance with at least one input selected from the group consisting of: a spend trajectory, a user propensity model, user profile information or segmentation criteria, and a campaign goal. A rule may be applied to determine which of the inputs is used in adjusting. A weight may be applied to each of the selected inputs in adjusting.

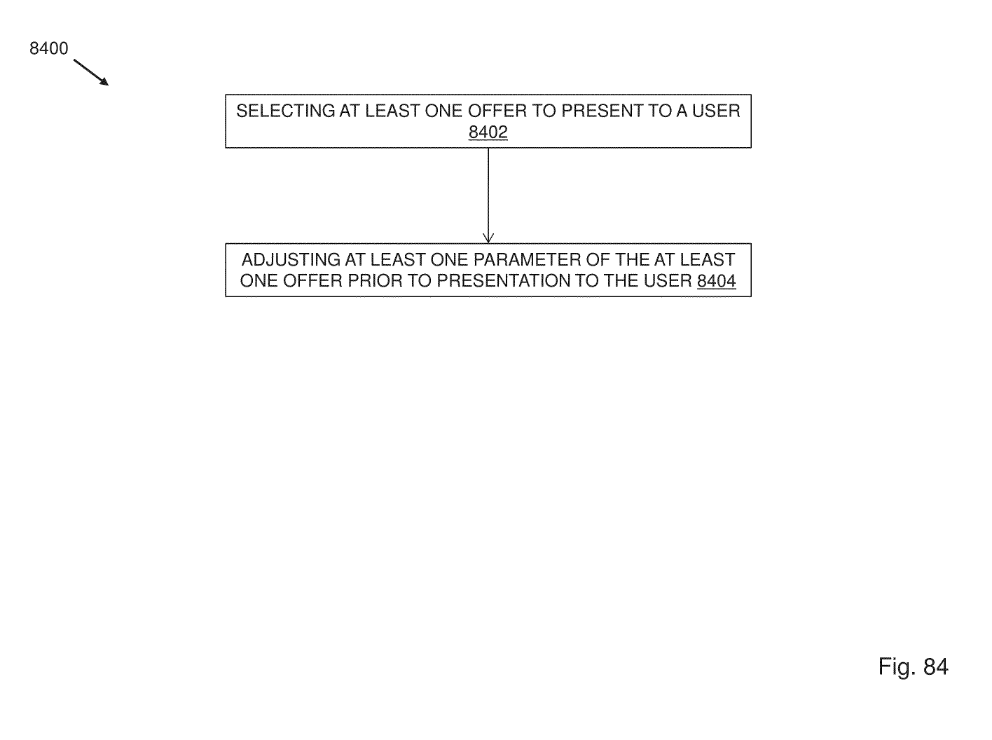

Referring to FIG. 84, a method of dynamically personalizing a reward, offer, or incentive 8400 may include selecting at least one reward, offer, or incentive to present to a user or a segment of users 8402, and adjusting at least one parameter of the at least one reward, offer, or incentive prior to presentation to the user or segment of users 304, wherein adjusting is done in accordance with at least one input selected from the group consisting of: a spending trajectory, a user propensity model, user profile information, a segmentation criterion, and a campaign goal. The user propensity model may be a predictive model of user purchase behavior developed using at least one of: data on one or more past user responses to one or more savings opportunities, public or inferred data relevant to the user, preferences (including merchant category preferences, transaction category preferences, product category preferences, and merchant preferences), a geographic location, a seasonal variety, a spending level, and any recent changes from historic spending patterns.

Adjusting may be completed in a time span selected from the group consisting of: less than about 10 sec, less than about 5 sec, less than about 1 second, or substantially instantaneously. A rule may be applied to determine which of the inputs is used in adjusting. A weight may be applied to each of the selected inputs in adjusting. The location of the user or the merchant may be determined as discussed above, e.g., via GPS or by other techniques inferring location using recent facts about the user, the merchant, or both. These techniques typically require physical devices, such as a mobile device of a user and its GPS-determined location. The location of the merchant or other sales place may also be determined by physical devices, such as a mobile device of the user, a mobile POS terminal of the merchant, or the known physical location of the merchant.

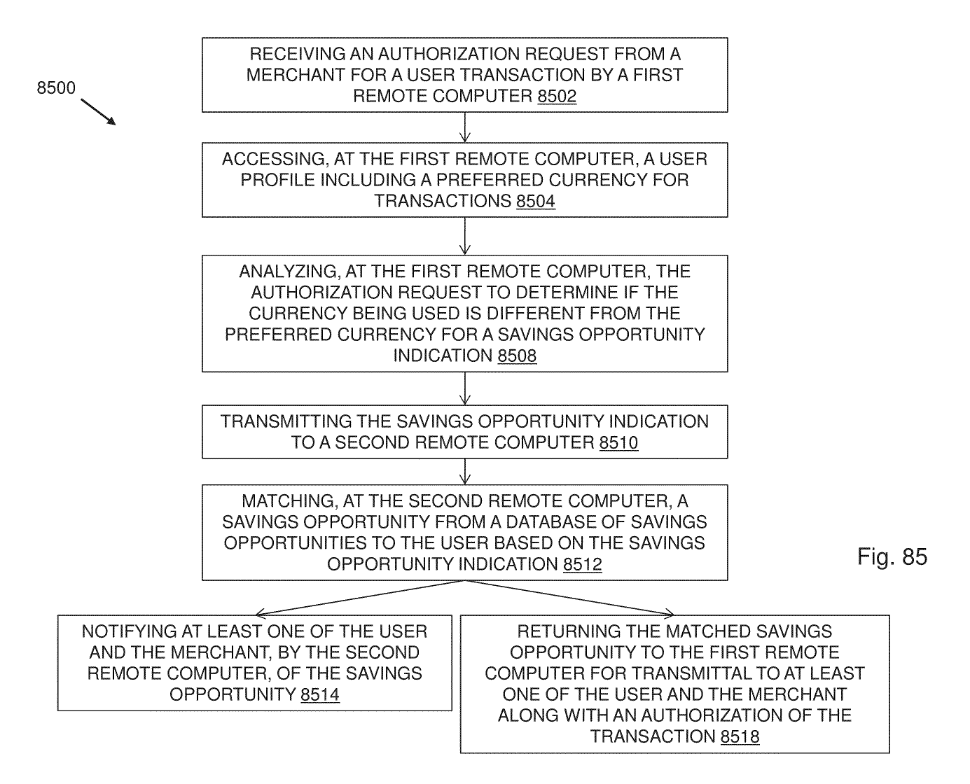

Referring now to FIG. 85, in an embodiment, systems, methods and processes to identify cross-border transactions and reward relevant cardholders with offers are described herein. Loyalty programs help issuers reward their consumers for using the issuer-provided payment instrument (credit, debit) when spending outside their home country. A platform can be used to identify if a payment transaction made by a consumer is a foreign payment transaction outside their home country, thus enabling consumers to earn rewards based on their future foreign payment transactions. The platform can be used to identify when a foreign payment transaction is made, match the foreign payment transaction to an existing set of rewards available for the consumer, and finally credit the consumer's account at the issuer with the reward. Using the platform, cardholders outside of their ‘home’ country are targeted for rewards and unique value is brought to retailers with respect to foreign visitors traveling from their home country.

When the system detects a cardholder's swipe of a payment instrument at a target merchant in a target country while making a foreign payment transaction, and the payment is made in a specified currency, the system is able to match that person/transaction with a relevant merchant-funded offer. This type of targeting does not necessarily require knowledge of past transaction information to target cardholders, and yet is able to match cardholders to offers at the right time and right place. The merchant-funded offers themselves may already be targeted, assigned, offered, presented, or otherwise available to the user prior to the foreign payment transaction, but the user would not be eligible to receive the offer until the foreign payment transaction actually occurs. In embodiments, merchant-funded offers/rewards may be in multiple countries at the same time. Offer qualification criteria may be different for each currency/country in which an offer is made. Certain details of the offer, such as a discount amount, may also be different for each currency/country in which an offer is made. The system may detect a location of the user via a plurality of methods. The system may already know the location of the target merchant in the target country, e.g., a particular Carrefour store in Paris or Beijing. The system may associate the currency of the transaction with the country in which the user is located. Alternatively, the system may detect a location of the user via a mobile device of the user and its GPS position at a time of the transaction by the user.

Upon detection that a foreign payment transaction has occurred (e.g. availability of authorization data, user reporting of a receipt, detection of a specific currency used, etc.), the user may be notified that an eligible transaction has occurred that may qualify them for rewards. For example, the platform host, which may be the provider of the payment instrument, may detect a foreign payment transaction made in the currency of the peso and determine that the user is traveling, e.g., in Mexico. At this point, the system may match the transaction in Mexico between the cardholder and a merchant with an offer available for users making transactions in the currency of the peso, who are generally traveling in Mexico, who are generally traveling, and the like. When the match is made, the user may be eligible for one or more offers, either retroactively based on the transaction or for future transactions, such as future transactions in the currency (e.g. the peso in this example) or future transactions in the country (e.g. Mexico in this example).

The now-eligible offers may be presented to the user. The offer may be physically presented to the user, e.g., in a printed receipt for the qualifying purchase, or on a merchant screen. In this embodiment, cooperation may be needed between the provider of the payment instrument and the merchant or payment network to allow offers to be printed on the receipt or presented on a merchant screen. Alternatively, the offer may be transmitted to the user. The transmission may be to a mobile device of the user, e.g., instant notification via a push notification, SMS or MMS. Alternatively, the user may view the transmitted offer when the user logs in to his or her computer to view a cardholder statement. Other ways to notify the user may be used. In addition, the offers may be contingent, e.g., require, a presence of the user in a certain location. Continuing with this example, the offer may only be valid for a certain time period and for a certain location, e.g., while a user is present in a city, or a region or a country, the location known to the system via a currency used in a transaction being associated with a country, a location of the merchant, or a location of the user. The location of the user may be determined via a GPS system or other means, such as a known location of a mobile device of the user. For example, it is known to determine a location of a cell phone or a smart phone, or a device with a telecommunications capability, via the telecommunications network itself. This information may be available to the system described herein and shared with the merchant. This location of a mobile device of a user, or an additional user, may also be used in embodiments of the present disclosure.

In embodiments, presentation of eligible offers to the user for the qualifying purchase, such as on a receipt, in a mobile notification, or in a user interface, involves a number of steps. At the place of the foreign transaction, an authorization request for the transaction is requested by the merchant from the provider of the payment instrument. The authorization request may include information about the cardholder, the items being purchased, the currency being used, the merchant, the merchant's geographic location, and the like. Alternatively, a location of the transaction may be characterized by a known location of the user, as discussed above. Information from the authorization request is used to determine eligibility of offers for the user. Once the provider of the payment instrument has detected that the transaction is a foreign transaction based on the currency used, the system makes certain offers eligible, such as those that are limited to merchants in the geographic region of the qualifying foreign transaction, those that are in the currency of the qualifying foreign transaction, and the like. Once the offer is made eligible, the system returns information to the merchant, which may include the authorization requested as well as information about the eligible offers. The eligible offers may be available for presentation on a merchant display or may be printed on the user's receipt for the foreign transaction.

Alternatively, the eligible offer may be presented in a mobile notification (e.g. push notification, SMS or MMS, phone call, etc.) or in a cardholder statement (or e-statement). In one example, the notification or the offer is presented virtually on-the-spot, within moments of an occurrence of the transaction. In this example, only the authorization requested is returned to the merchant while the eligible offers are presented directly to the user, such as in the form of an instant mobile notification. Thus, the transaction may give rise to two presentations: the merchant receives an authorization or approval for the transaction to proceed, while the user receives an offer or enticement for an additional purchase. Alternatively, the offer or the presentation to the user or cardholder may take place later, in a statement of the user's financial account, in a user interface, and the like. The mobile notification may occur, for example, immediately upon detection of the foreign transaction by the payment instrument provider. Such rapid notification allows the user to take advantage of merchant-funded offers for which they are now eligible while still at a merchant site with an offer, while generally out shopping, or while still in the qualifying location, city or country.

The process of requesting authorization, making certain offers eligible, and presenting the eligible offers to the user may be completed in a time span selected from the group consisting of: less than about 1 minute, less than about 30 seconds, less than about 10 seconds, less than about 5 seconds, less than about 1 second, or substantially instantaneously. As described above, notification and presentation may be made in a user interface, for example, which may be implemented by software and embodied in a tangible medium, such as a mobile device, smartphone, tablet computer, or the like. The user interface may be a touchscreen embodiment, such that to utilize the user interface, a user is required to touch the screen of the device displaying the user interface. The user interface may be accessible on different computing devices and capable of dynamically accessing user specific data stored on a network server and/or local device, including offers, payment information, receipts, a user profile, and the like. Examples of user interfaces useful for the presentation of eligible offers in accordance with this disclosure are depicted in FIG. 61B, FIG. 62A, and FIG. 64.

In embodiments, zero or more conditions may be associated with making certain offers eligible, such as the currency used in the payment, location of the merchant/payment, type of merchant, amount of the payment (e.g. any amount spent qualifies, only a threshold amount spent qualifies), date and time of the payment, the merchant with whom the payment transaction is made, and the like. For example, a cardholder from Brazil (where the currency is the Brazilian real) may travel to Mexico (where the currency is the Mexican peso) and purchase an item at a Mexican store with his or her credit card. Authorization data is requested by the Mexican merchant by sending a request to the provider of the payment instrument. The provider receives the authorization request including information about the transaction, such as the merchant, amount of the transaction, etc. The provider may determine that the transaction is made in a currency other than the ‘home’ currency of the cardholder. As part of this determination, the transaction may also be determined to be a physical transaction in the country and not online. The determination may be made, for example by noting that the payment instrument is present at the transaction, by previous information that the merchant is not an online retailer, by receiving terminal information from the merchant, by receiving geolocation data from the merchant and/or cardholder, and the like. In certain embodiments, the provider may determine that the cardholder is traveling by identifying the foreign transaction. Based on the information received in the authorization request, certain offers may be made eligible, while others may not be eligible due to conditions imposed by the cardholder system, the merchant, or others.

At this point, offers from merchants in the geographic region of the qualifying foreign transaction or those that are in the currency of the qualifying foreign transaction may be further limited by conditions of the offers. Those conditions of the offer are considered against the information in the authorization request. Continuing with the example, if the Brazilian user makes a purchase in a Mexican sports store of Mex $50, and the offer has a condition of a purchase in the Mexican sports store of Mex $75, the user may not be eligible for the offer. In this example, the user may be notified of the available offer, their failure to qualify for the available offer, the requirement to increase their purchase by Mex $25 in order to qualify, and the like. Notification may take place as described herein. If the Brazilian user makes a purchase in a Mexican sports store of Mex $100, the user may be eligible for the offer and may be notified of such. In embodiments, the offer may be for the current transaction or for a future purchase. Continuing with this example, now that the fictitious Brazilian user has made a Mex $100 purchase in the sports store, one or more offers becomes available to them based on the details of the foreign transaction matching the criteria for certain offers. For example, the offer may be for a free gift upon reaching the Mex $75 threshold. In another example, the offer may be for a percentage or peso amount off. In embodiments, the merchant may immediately implement the offer and give the discount, or the user may be credited the discount amount after the transaction is complete. In another example, the offer may be for a discount on a purchase at a gift shop near the sports store. The user may receive a notification of the offer as described herein and may be able to take advantage of and/or accept offers while still in the foreign country.

Various methods may be described herein to accomplish the disclosure relating to providing offers, generally termed herein as a savings opportunity, to foreign transactors, that is, a foreign person physically located in the country of the transaction that is not the person's home country. Referring to FIG. 85, one computer-implemented method for providing a savings opportunity includes receiving an authorization request from a merchant for a user transaction by a first remote computer 8502. At the first remote computer, a user profile may be accessed that includes a preferred currency for transactions 8504. By analyzing, at the first remote computer, the authorization request, it can be determined if the currency being used during the transaction is different from the preferred currency (as indicated by the user profile), and if there is a difference, a savings opportunity indication for the foreign transaction may be generated 8508. The savings opportunity indication may be transmitted to a second remote computer where a savings opportunity from a database of savings opportunities is matched to the user 8510. Then, at least one of the user and the merchant may be notified by the second remote computer of the savings opportunity 8512. Alternatively, the matched savings opportunity may be returned to the first remote computer for transmittal to at least one of the user and the merchant along with an authorization of the transaction 8514. The savings opportunity may be for use during the current transaction, and in some embodiments, may be automatically applied to the current transaction. For example, the user may be asked to key in a code, scan a barcode, purchase an additional item, or the like in order to avail themselves of the savings opportunity. Alternatively, the savings opportunity may be for a future transaction. The method may include filtering the savings opportunities in the database by one or more merchant-indicated conditions, such as a location of the merchant/payment, a type of merchant, an amount of the payment, a good or service purchased, a date of the transaction, and a time of the transaction.

The method may include receiving an indication from the user by at least one of the first and second remote computers for sharing the matched savings opportunity with at least one additional user, wherein sharing causes at least one of the first and second remote computers to generate a shared savings opportunity. The method may yet further include receiving an indication to redeem the shared savings opportunity, and tracking the sharing and redemption of the shared savings opportunity. In some embodiments, the indication to redeem the shared savings opportunity is presented on a device, such as a mobile phone. In one example, the user mobile device may include a touch-screen and the offer or savings opportunity may include a feedback screen, allowing the user to take advantage of a touch-screen capability. In this example, the offer may include a quick-response menu, e.g., “press the pound or hash key to accept this offer now” or “press the star key to exit this screen.” Other possible responses may include instructions to press a different key for additional information, to remind the user later, and so forth. Alternatively, the user may respond by pressing keys on a physical keyboard of the mobile device. The user may thus respond to the offer by a physical action on a mobile device or a touch screen of the mobile device. If the user is using a non-mobile device, such as a desktop personal computer, responses may be made by pressing keys on the user's physical keyboard. This method and equipment may also be used by additional user, such as those taking advantage of a shared savings opportunity or a shared savings opportunity indication.

In embodiments, certain metrics may be available based on knowing the number of foreign transactors who are outside their home country accepting offers. The platform provider has knowledge of how many cardholders come from a particular country and make a transaction in a foreign country. The platform provider also knows the percentage of those people who accept offers for individual merchants as well as for any other foreign merchant. Such information is not generally available to individual merchants. For example, one metric that is possible is the number of users who travel and do not accept offers versus the number of users who travel and do accept offers. Such metrics may be a measure of the efficacy of the foreign offer program. The platform provider also knows whether each individual user has accepted or failed to accept an offer, allowing the presentation of further inducements to accept the offer to those users who failed to accept the offer initially, as well as analysis of the transaction patterns of users who do and do not accept offers to identify commonalities and/or differences.

In embodiment, as with other offers/rewards described herein, offers may be shared with other users or a social network. Sharing by a user causes a shared savings opportunity to be generated for other users. Sharing and redemption of the shared offer may be possible.

In embodiments, users may be provided with pre-targeted offers in various categories of goods and services, and/or multiple offers within particular categories of goods and services. However, users may forget about the availability of the offer or have not yet considered using it and end up deciding on a different merchant/item than what is on offer. Retailers and merchants may find it worthwhile to give consumers a reminder or nudge that products or services are available and on sale when the consumer makes a purchase in a related category or location.

When an offer for goes unused for a period of time and, in certain cases, there is little time remaining before offer expiry, users may be sent a reminder when a transaction is detected to have occurred with a merchant in a related category of good or service. Thus, based on real-time user behavior detected from transaction data, unexpired eligible offers in categories related to the categories for merchants or items detected in real-time transactions can be highlighted by the system through a generated reminder to the user. For example, if the user eats at an Indian restaurant, but the user has an offer targeted to the user for an Italian restaurant, he or she may be reminded of the offer. In this case, the Italian and Indian restaurants are grouped into two different granular categories of merchants, that of Indian restaurants and Italian restaurants, and it is this granularity that is leveraged in generating reminders. In this example, the granular categories are part of a parent category called “restaurants”. This hierarchical adjacency of the granular sub-categories within the same parent category is what drives generation of the reminder by the system.

Category is a property of a given offer and can vary in specificity. Merchants and items may be assigned one or more categories. For example, the Indian restaurant in the prior example may be assigned the “Indian restaurant” category. In embodiments, when assigned this sub-category, the parent category “restaurant” is automatically assigned by virtue of “Indian restaurant” being hierarchically below “restaurant.” Thus, the Indian restaurant belongs to the “Indian restaurant” category, which is a sub-category of “restaurant.” The Indian restaurant of this example may have other categories and sub-categories assigned to it, such as for example, “Boston restaurant” or “small business.” When the system detected the transaction at the Indian restaurant, the categories for the Indian restaurant were used by the system to traverse a hierarchical category tree. Starting at the level of “Indian restaurant,” the system traverses the category tree up a level to the parent category of “restaurant” and determines if any eligible, unused offers are in the category of “restaurant” or any sub-category below “restaurant” that should be promoted to the user through a reminder. Continuing with this example, it is an eligible, unused offer for an Italian restaurant, which is in a sub-category of “restaurant,” that the user is reminded to use.

Continuing with this example, having just dined at an Indian restaurant, it may not be productive to remind the user of an eligible, unused offer at another Indian restaurant, especially if the offer is close to expiry. Thus, as the system traverses the category tree to determine the parent category and check if there are any eligible, unused offers in other sub-categories, the system may determine if the eligible, unused offer is for a different or the same sub-category. Since the Italian restaurant is in a different sub-category than “Indian restaurant,” the reminder is generated. Of course, there may be scenarios when it is desired that reminders for eligible, unused offers for goods or services in the same sub-category are generated.

Continuing with the example, any of the assigned categories for a merchant or item may be used in determining which eligible, unused offer to promote through a reminder. For the Indian restaurant of the example, the system may likewise start from the assigned sub-category “Boston restaurants” and traverse the category tree up a level to “Massachusetts restaurant” and determine if any eligible, unused offers are in the category of “Massachusetts restaurant” that should be promoted to the user through a reminder. In this example, the user may be reminded of an eligible, unused offer for a pub in Winchester, Mass., which may have the sub-category label of “Winchester, Mass. restaurants” and “pub,” for example. In embodiments, there may be multiple eligible, unused offers for goods and services in adjacent or related sub-categories for which reminders may be sent to the user.

Continuing with the example, the user may be reminded of multiple eligible, unused offers. Continuing with the example, using both the sub-categories of “Boston restaurants” and “Indian restaurants,” the system may traverse the category tree and find eligible, unused offers that fall under the parent category for each of the sub-categories. After optionally determining that the eligible, unused offers are not for merchants in the same sub-category as the merchant in the original transaction, reminders for eligible, unused offers for the Italian restaurant and the pub in Winchester, Mass. may be generated since both offers are for merchants in sub-categories adjacent to the sub-category for the merchant in the original transaction at the Indian restaurant. In embodiments, all of the reminders may be sent to the user for the multiple, unused offers or one or more of the offers may be selected for reminding.

Users, merchants, or platform operators may be able to set preferences related to how to determine which eligible, unused offer should be promoted in a reminder to the user. For example, the user may set a preference that they never want to receive reminders about “East Asian restaurants.” In another example, merchants may set a preference that they want reminders to be sent for their offers even if they are in the same sub-category. In another example, platform operators may set a preference that only one offer reminder per transaction may be generated. In another example, a user may be reminded of an unused, eligible offer only if the user typically or on average spends a minimum or threshold amount in a given category of purchases per billing period, perhaps monthly or annually, and has recently completed a purchase in that category or in a related category. In embodiments, offer providers may pay for priority in having a reminder sent regarding their offer in the case where multiple unused offers are eligible for reminding. In some embodiments, an auction may be used to determine which offer is promoted to the user.

Determining which eligible unused offer to remind users of may be determined based on multiple variables, such as propensity for the user to accept the offer, time since a transaction was made in the sub-category, the amount of money spent in the sub-category, the geographical distance from the merchant in the offer, and the like. Reminders may also be generated based on users satisfying more than one criterion. For example, a user may be reminded about an eligible, unused offer from an East Asian restaurant that is located in a geographical area convenient to the user, e.g., only East Asian restaurants located in Boston, Mass. or within a given radius of a location of the user. Another multiple-criteria reminder may require that the user has purchased a minimum amount in a given related category in a given geographic location, e.g., a retail superstore or a gasoline vendor may try to attract customers within a given radius of a regional shopping mall, business district or other location.

The eligible, unexpired offer(s) in a related sub-category may be presented in a mobile notification (e.g. push notification, SMS or MMS, phone call, etc.) or in a cardholder statement or e-statement. In one example, the notification or the offer may be presented virtually on-the-spot, within moments of an occurrence of the transaction in a related sub-category or entering a geographical area, in certain embodiments, as determined based on a device of the user.

This method will improve retail sales. Vendors don't want reminders to go out to all users, so by utilizing transaction data, reminders are optimized by targeting to those who are already spending in a related category. Vendors can quickly move on to delivering a new offer to users instead of waiting for redemptions to trickle in based on large-scale reminders. Bandwidth use and use of computing resources are improved because not all users are being reminded, just those who are most likely to redeem offers because of purchases made in a related/adjacent category. Further, by using granular categories to search for previous eligible, but unused offers to remind users of, there is an improvement in the database search strategy for matching unused offers to current transactions.

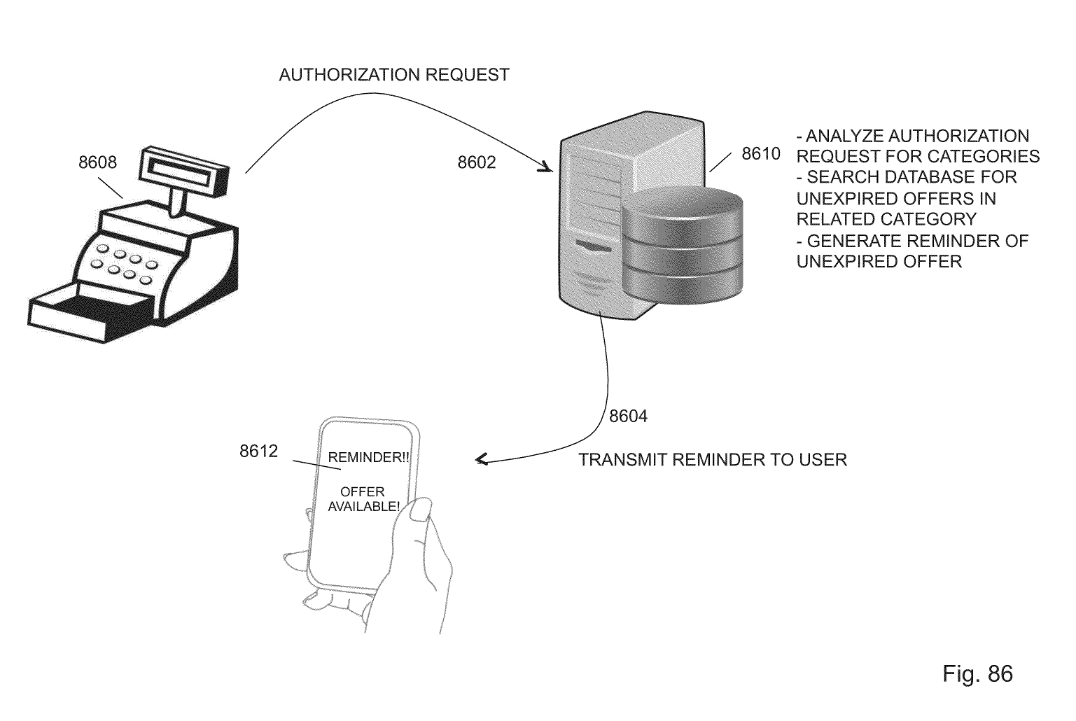

In an aspect and referring to FIG. 86, a computer-implemented method for providing an offer may include selecting at least one offer to present to a user by applying at least one rule dictated by a merchant to a set of offers to be provided to the user, applying at least one rule dictated by a financial institution to the set of offers, and applying a filter to identify offers with the highest likelihood of being accepted by the user. Then, the selected offer may be presented to the user. An authorization request from a merchant 8608 for a user transaction may be received 8602, optionally by a remote computer 8610, and analyzed to determine one or more categories or sub-categories of the merchant or item in the transaction. Then, the system may determine if the selected offer is for a merchant or item in a related but different category from the one for which the authorization request was received. The system generates a reminder for the user of the selected offer if the selected offer is for a merchant or item in a related but different category from the one for which the authorization request was received and then transmits the reminder to the user 8604. Analyzing, determining, generating and transmitting may be done by the same remote computer that received the authorization request or a different one. Presentation to the user may be done in a mobile notification 8612. The method may further include accepting a like or dislike interaction for the selected offer from the user, and sharing the selected offer with at least one user of a social network when a like interaction is accepted, wherein sharing causes the remote computer to generate a shared offer. The method may further include receiving an indication to redeem the shared offer and tracking the sharing and redemption of the shared offer.

In an aspect, a method may include providing an executable script embedded in a graphical user interface of a user's financial account, using the executable script to gather transaction data from a user's financial account, wherein the user's financial account is a financial institution account that is maintained on behalf of the user, and analyzing the transaction data for transactions by the user. Based on the transaction data, selecting at least one offer to present to a user by applying at least one rule dictated by a merchant to a set of offers to be provided to the user, applying at least one rule dictated by a financial institution to the set of offers, and applying a filter to identify offers with the highest likelihood of being accepted by the user given the transaction data. Then, the selected offer may be presented to the user. An authorization request from a merchant for a user transaction may be received 8602, optionally by a remote computer 8610, and analyzed to determine one or more categories or sub-categories of the merchant or item in the transaction. Then, the system may determine if the selected offer is for a merchant or item in a related but different category from the one for which the authorization request was received. The system generates a reminder for the user of the selected offer if the selected offer is for a merchant or item in a related but different category from the one for which the authorization request was received and then transmits the reminder 8604 to the user. Analyzing, determining, generating and transmitting may be done by the same remote computer that received the authorization request or a different one. The step of analyzing may include extracting at least one of a merchant name, a merchant category, a merchant location, a store number, a transaction amount, a transaction frequency, a zip code, a store category, a transaction description, and a total spending amount or analyzing the transaction data for transactions by the user relating to a merchant, a market segment, or a category. The user's financial account may be at least one of a credit card account, a bank account, a checking account, a savings account, a personal finance program account, and a loan account. The step of analyzing may include anonymizing the transaction data. Presentation to the user may be done in a mobile notification 8612. The method may further include accepting a like or dislike interaction for the selected offer from the user, and sharing the selected offer with at least one user of a social network when a like interaction is accepted, wherein sharing causes the remote computer to generate a shared offer. The method may further include receiving an indication to redeem the shared offer and tracking the sharing and redemption of the shared offer.

Illustrative Methods

In some implementations, methods for providing a savings opportunity may be described in the following clauses or otherwise described herein and as illustrated in FIG. 85.

1. A computer-implemented method for providing a savings opportunity, comprising:

receiving an authorization request from a merchant for a user transaction by a first remote computer;

accessing, at the first remote computer, a user profile including a preferred currency for transactions;

analyzing, at the first remote computer, the authorization request to determine if the currency being used is different than the preferred currency for a savings opportunity indication;

transmitting the savings opportunity indication to a second remote computer;

matching, at the second remote computer, a savings opportunity from a database of savings opportunities to the user based on the savings opportunity indication; and

notifying at least one of the user and the merchant, by the second remote computer, of the savings opportunity.

2. The method of clause 1, wherein the savings opportunity is for use during the current transaction.

3. The method of clause 1, wherein the savings opportunity is automatically applied to the current transaction.

4. The method of clause 1, wherein the savings opportunity is for a future transaction.

5. The method of clause 1, wherein the matched savings opportunity is at least one of printed on a receipt, displayed on a merchant user interface, and displayed on a mobile device user interface.

6. The method of clause 1, further comprising filtering the savings opportunities in the database by one or more merchant-indicated conditions.

7. The method of clause 6, wherein the merchant-indicated condition is at least one of a location of the merchant/payment, a type of merchant, an amount of the payment, a good or service purchased, a date of the transaction, and a time of the transaction.

8. The method of clause 1, further comprising receiving an indication from the user by at least one of the first and second remote computers for sharing the matched savings opportunity with at least one additional user, wherein sharing causes at least one of the first and second remote computers to generate a shared savings opportunity.

9. The method of clause 8, further comprising presenting an indication to redeem the shared savings opportunity to the at least one additional user; and tracking the sharing and redemption of the shared savings opportunity.

10. The method of clause 9, wherein the indication to redeem the shared savings opportunity is presented on a mobile device.

11. A computer-implemented method for providing a savings opportunity, comprising:

receiving an authorization request from a merchant for a user transaction by a first remote computer;

accessing, at the first remote computer, a user profile including a preferred currency for transactions;

analyzing, at the first remote computer, the authorization request to determine if the currency being used is different than the preferred currency for a savings opportunity indication;

transmitting the savings opportunity indication to a second remote computer;

matching, at the second remote computer, a savings opportunity from a database of savings opportunities to the user based on the savings opportunity indication; and

returning the matched savings opportunity to the first remote computer for transmittal to at least one of the user and the merchant along with an authorization of the transaction.

12. The method of clause 11, wherein the savings opportunity is for use during the current transaction.

13. The method of clause 11, wherein the savings opportunity is automatically applied to the current transaction.

14. The method of clause 11, wherein the savings opportunity is for a future transaction.

15. The method of clause 11, wherein the matched savings opportunity is at least one of printed on a receipt, displayed on a merchant user interface, and displayed on a mobile device user interface.

16. The method of clause 11, further comprising filtering the savings opportunities in the database by one or more merchant-indicated conditions.

17. The method of clause 16, wherein the merchant-indicated condition is at least one of a location of the merchant/payment, a type of merchant, an amount of the payment, a good or service purchased, a date of the transaction, and a time of the trans action.

18. The method of clause 11, further comprising receiving an indication from the user by at least one of the first and second remote computers for sharing the matched savings opportunity with at least one additional user, wherein sharing causes at least one of the first and second remote computers to generate a shared savings opportunity.

19. The method of clause 18, further comprising presenting an indication to redeem the shared savings opportunity to the at least one additional user; and tracking the sharing and redemption of the shared savings opportunity.

20. The method of clause 19, wherein the indication to redeem the shared savings opportunity is presented on a mobile device.

In some implementations, methods for targeting users with an offer may be described in the following clauses or otherwise described herein and as illustrated in FIGS. 82 through 84.

1. A method of targeting users with an offer, comprising:

selecting at least one offer to present to a user by:
applying at least one rule dictated by a merchant to a set of offers to be provided to the user;
applying at least one rule dictated by a financial institution to the set of offers; and
applying a filter to identify offers with the highest likelihood of being accepted by the user; and

adjusting at least one parameter of the offer prior to presentation to the user based on at least one characteristic of the user.

2. The method of clause 1, wherein the at least one parameter is at least one of a minimum spending threshold, a discount amount, and a duration of a campaign, and a category of offer.

3. The method of clause 1, wherein the filter to identify offers with the highest likelihood of being accepted is based on a predictive model of user purchase behavior developed using at least one of:
data on one or more past user responses to one or more savings opportunities;
public data relevant to the user;
inferred data about the user;
preferences selected from the group consisting of merchant category preferences, transaction category preferences, product category preferences and merchant preferences;
a geographic location;
a seasonal variety;
a spending level; and
a change from an historic spending pattern.

4. The method of clause 1, wherein adjusting the parameter comprises calculating a spending trajectory based on a historical spending pattern and adjusting the parameter in accordance with the spending trajectory.

5. The method of clause 1, wherein adjusting the parameter is done in accordance with at least one segmentation criterion applied to the user.

6. The method of clause 1, wherein the adjusting is completed in a time span selected from the group consisting of: less than about 10 sec, less than about 5 sec, less than about 1 second, or substantially instantaneously.

7. The method of clause 1, wherein adjusting is done in accordance with at least one input selected from the group consisting of: a spend trajectory, a user propensity model, user profile information or segmentation criteria, and a campaign goal.

8. The method of clause 7, wherein a rule is applied to determine which of the inputs are used in adjusting.

9. The method of clause 7, wherein a weight is applied to each of the selected inputs in adjusting.

10. A method of targeting users with an offer, comprising:

selecting at least one offer to present to a user by:
applying at least one rule dictated by a merchant to a set of offers to be provided to a user;

applying at least one rule dictated by a financial institution to the set of offers; and
applying a filter to identify offers with the highest likelihood of being accepted by the user; and
adjusting at least one of a minimum spending threshold, a discount amount, a duration of the campaign and a category of the offer prior to presentation to the user based on at least one characteristic of the user.

11. The method of clause 10, wherein the filter to identify offers with the highest likelihood of being accepted is based on a predictive model of user purchase behavior developed using at least one of:

data on one or more past user responses to one or more savings opportunities;

public data relevant to the user;

inferred data about the user;

preferences selected from the group consisting of merchant category preferences, transaction category preferences, product category preferences, and merchant preferences;

a geographic location,

a seasonal variety,

a spending level; and

a change from a historic spending pattern.

12. The method of clause 10, wherein adjusting comprises calculating a spending trajectory based on a historic spending pattern and adjusting the at least one minimum spending threshold, discount amount, duration of the campaign, and category of offer in accordance with the spending trajectory.

13. The method of clause 10, wherein adjusting is done in accordance with at least one segmentation criterion applied to the user.

14. The method of clause 10, wherein adjusting is completed in a time span selected from the group consisting of: less than about 10 sec, less than about 5 sec, less than about 1 second, or substantially instantaneously.

15. The method of clause 10, wherein adjusting is done in accordance with at least one input selected from the group consisting of: a spend trajectory, a user propensity model, user profile information or segmentation criteria, and a campaign goal.

16. The method of clause 15, wherein a rule is applied to determine which of the inputs is used in adjusting.

17. The method of clause 15, wherein a weight is applied to each of the selected inputs in adjusting.

18. A method of dynamically personalizing an offer, comprising:

selecting at least one offer to present to a user; and

adjusting at least one parameter of the at least one offer prior to presentation to the user;

wherein adjusting is done in accordance with at least one input selected from the group consisting of: a spending trajectory, a user propensity model, user profile information, a segmentation criterion, and a campaign goal.

19. The method of clause 18, wherein the user propensity model is a predictive model of user purchase behavior developed using at least one of:

data on one or more past user responses to one or more savings opportunities;

public data relevant to the user;

inferred data about the user;

preferences selected from the group consisting of merchant category preferences, transaction category preferences, product category preferences, and merchant preferences;

a geographic location,

a seasonal variety,

a spending level; and

a change from a historic spending patterns.

20. The method of clause 18, wherein adjusting is completed in a time span selected from the group consisting of: less than about 10 sec, less than about 5 sec, less than about 1 second, or substantially instantaneously.

21. The method of clause 18, wherein a rule is applied to determine which of the inputs are used in adjusting.

22. The method of clause 18, wherein a weight is applied to each of the selected inputs in adjusting.

In some implementations, methods for identifying group members may be described in the following clauses or otherwise described herein and as illustrated in FIGS. 76-78.

1. A method for identifying group members, comprising:

identifying demographic characteristics of members of a group via market research;

identifying purchasing behaviors of the members of the group via market research;

correlating the identified demographic characteristics with the identified purchasing behaviors to identify merchants whom the members of the group tend to patronize;

gathering transaction data from a financial account of a user at a financial institution for processing transactions between the user and a plurality of merchants and providers;

clustering users using their transaction data with the identified merchants to from a plurality of clusters;

analyzing the characteristics of each cluster and identifying at least one cluster that has the identified demographic characteristics; and

presenting to the user in an online statement of the user's account a savings opportunity from a merchant seeking to contact members of the group when the characteristics suggest that the user belongs to the at least one cluster.

2. The method of Clause 1, wherein the demographic characteristics of the members of a group comprise at least one of gender; ethnicity; age or birthdate; family income; personal income; educational level; shopping preference; and a personal interest.

3. The method of Clause 1, wherein the market research comprises an organized effort to contact individual members of the group to gather information concerning at least one of: economic data; habits and practices of individual members of the group.

4. The method of Clause 1, wherein identifying merchants comprises identifying sellers, retailers, manufacturers, establishments, on-line services for connecting buyers and sellers, on-line services using primarily mobile devices to connect buyers and sellers, and providers of goods and services patronized by members of the group.

5. The method of Clause 1, wherein the identified merchants include at least one of sellers, retailers, manufacturers, establishments, providers of goods and services, and completed transactions with selected merchants or providers.

6. The method of Clause 1, wherein analyzing comprises analyzing transaction data for at least one of: an amount spent in a time period; an amount spent in a product or service category; one or more transactions with a particular merchant or provider of a good or a service; and an average amount spent per time periods over several time periods.

7. The method of Clause 1, further comprising eliminating from the step of presenting, savings opportunities from merchants not patronized by the members of the group.

8. The method of Clause 1, wherein the savings opportunity is an invitation to an alternative provider of a good or a service previously purchased by the user and further comprising accepting a response from the user to the presentation of the savings opportunity by redirecting the user to information about the alternative provider.

9. The method of Clause 1, further comprising identifying the purchasing behaviors of the members of the group from third party sources and verifying the purchasing behaviors of the members of the group via market research.

10. The method of Clause 1, further comprising identifying merchants patronized by the members of the group from third party sources and verifying the purchasing behaviors of the members of the group via the analyzed transaction data.

11. A method for identifying group members, comprising:

identifying demographic characteristics of members of a group via market research;

identifying purchasing behaviors of the members of the group via market research;

correlating the identified demographic characteristics with the identified purchasing behaviors to identify merchandise categories typically purchased by the members of the group;

gathering transaction data from a financial account of a user at a financial institution for processing transactions between the user and a plurality of merchants and providers;

clustering users using their transaction data in the identified merchant categories;

analyzing the characteristics of each cluster and identifying at least one cluster that has the identified demographic characteristics; and

presenting to the user in an online statement of the user's account a savings opportunity from a merchant seeking to contact members of the group when the characteristics suggest that the user belongs to the cluster.

12. The method of Clause 11, wherein at least one of the merchandise categories is selected from the group consisting of restaurants, jewelry, airline travel, travel-related merchandise, clothing, high-end apparel, entertainment, furniture, appliances, general merchandise, mass-market discount merchandise, housing, automobiles, education, continuing education and online-purchased merchandise and services.

13. The method of Clause 11, wherein the identified purchasing behaviors of the members include a list of merchants or providers patronized by the members of the group.

14. The method of Clause 11, wherein identifying purchasing behaviors of the members of the group comprises identifying merchants, retailers, manufacturers, establishments and providers of goods and services patronized by members of the group, and further comprising categorizing the identified merchants, retailers, manufacturers, establishments and providers into a plurality of merchandise categories.

15. The method of Clause 11, wherein the savings opportunity is an invitation to an alternative provider of a good or a service in a merchandise category previously purchased by the user and further comprising accepting a response from the user to the presentation of the savings opportunity by redirecting the user to information about the alternative provider in the merchandise category.

16. The method of Clause 11, further comprising presenting the user with an opportunity to view detailed billing records from a current provider to the user in the merchandise category, the detailed billing records including information additional to the transaction data.

17. The method of clause 11, further comprising, correlating the identified demographic characteristics with the identified purchasing behavior to identify merchandise categories not typically purchased by the members of the group.

18. A method for identifying group members, comprising:

identifying demographic characteristics of members of a group via market research;

identifying purchasing behaviors of the members of the group via market research;

correlating the identified demographic characteristics with the identified purchasing behaviors to identify purchasing behaviors of the members of the group;

defining criteria to identify a member of the group via a purchasing behavior of the member;

gathering transaction data from a financial account of a user at a financial institution for processing transactions of the user with a plurality of merchants and providers;

analyzing the transaction data of the user to determine whether the transaction data of the user meet two or more of the criteria for the user to be an individual member of the group; and

presenting to the user in an online statement of the financial account of the user a savings opportunity from a merchant seeking to contact members of the group having the identified purchasing behaviors when the user meets the two or more of the criteria for the user to be an individual member of the group.

19. The method of Clause 18, wherein at least two purchasing behaviors are selected from the group consisting of: at least one merchandise category; an amount spent in a time period; an amount spent in a product or service category; one or more transactions with a particular merchant or provider of a good or a service; purchases made online; purchases made from a mobile device; transactions conducted outside a person's zip code or statistical area; and an average amount spent per time periods over several time periods.

20. The method of Clause 18, further comprising identifying purchasing behaviors not practiced by the members of the group and in the step of analyzing, eliminating the user if the transaction data of the user reveal a purchasing behavior inconsistent with membership in the group.

21. The method of Clause 18, wherein the merchant participates in a merchandise category selected from the group consisting of a niche apparel category, an online retailer category, an educational category, a continuing education category and a travel category.

22. The method of Clause 18, wherein the merchant seeking to contact members of the group is identified in the step of identifying purchasing behaviors of the members of the group.

23. The method of Clause 18, further comprising comparing a list of the members of the group from the step of correlating with a list of users identified by the step of analyzing and modifying the criteria to identify a member of the group.

In some implementations, methods for tracking financial transactions may be described in the following clauses or otherwise described herein and as illustrated in FIGS. 67A, 67B, and 67C.

1. A method for tracking financial transactions, comprising:

gathering transaction data from a plurality of user accounts by at least one computer, each user account a financial institution account at a financial institution;

analyzing the transaction data for each user by the at least one computer for at least one criterion;

providing a first savings opportunity to a first plurality of users whose transaction data meet the at least one criterion, the first savings opportunity provided in association with an online statement of the user's financial account;

tracking a redemption of the savings opportunity by the first plurality of users whose transaction data met the at least one criterion; and

tracking purchasing behavior for a period of time for the first plurality of users whose transaction data met the at least one criterion before and after the savings opportunity was provided.

2. The method of Clause 1, wherein the transaction data comprises at least one of a merchant name, a merchant location, a transaction amount, a date of a transaction, a time of a transaction, a merchant category, a product category and a number of transactions.

3. The method of Clause 1, further comprising tracking purchasing behavior of a second plurality of users whose transaction data met the at least one criterion, said second plurality of users not undertaking the savings opportunity.

4. The method of Clause 1, further comprising tracking purchasing behavior of a second plurality of users whose transaction data met the at least one criterion, said second plurality of users provided with a second savings opportunity, said second savings opportunity different from said first savings opportunity.

5. The method of Clause 1, further comprising gathering demographic data concerning each of the plurality of users, the demographic data including at least one of gender, age, ethnicity, an income level, an educational level, a shopping habit and a personal interest.

6. The method of Clause 1, wherein the criterion is selected from the group consisting of a previous purchase of an item, an amount of one or more purchases of an item, a number of transactions, a frequency of transactions and a transaction category.

7. The method of Clause 1, further comprising comparing tracking information about purchasing behavior of the first plurality of users and a second plurality of users whose transaction data met the at least one criterion but who were not provided the savings opportunity for a category of product or service related to a category of the savings opportunity indication.

8. The method of Clause 1, further comprising comparing tracking information about the purchasing behavior of a second plurality of users whose transaction data met the at least one criterion and who were not provided the savings opportunity and a third plurality of users whose transaction data met the at least one criterion and who were provided with a second savings opportunity different from the first savings opportunity.

9. The method of Clause 1, further comprising revising at least one of the first savings opportunity and the at least one criterion based on at least one of the tracked purchasing behavior, the spending lift and the redemption lift.

10. A method for tracking financial transactions, comprising:

gathering transaction data from a plurality of user accounts by at least one computer, each user account a financial institution account at a financial institution;

analyzing the transaction data for each user by the at least one computer for at least one criterion for a savings opportunity indication;

providing a first savings opportunity to a first plurality of users whose transaction data meet the at least one criterion;

providing a second savings opportunity to a second plurality of users whose transaction data meet the at least one criterion;

tracking a redemption of the savings opportunity by the first plurality of users and the second plurality of users; and

tracking purchasing behavior of the first plurality of users and the second plurality of users for a period of time before and after the savings opportunity was provided.

11. The method of Clause 10, further comprising comparing spending on a good or a service in a category of the first and second savings opportunity by the first plurality of users and the second plurality of users.

12. The method of Clause 10, further comprising tracking purchasing behavior of a third plurality of users whose transaction data met the at least one criterion, said third plurality of users not being provided the savings opportunity.

13. The method of Clause 10, further comprising presenting the first savings opportunity or the second savings opportunity to a user in association with an on-line statement of the user's financial institution account.

14. The method of Clause 13, further comprising presenting the user with an opportunity to view detailed billing records of the user's transactions with a merchant associated with the first savings opportunity or the second savings opportunity.

15. The method of Clause 10, further comprising revising at least one of the first savings opportunity, the second savings opportunity and the criterion based on at least one of the tracked purchasing behavior, the spending lift and the redemption lift.

16. The method of Clause 10, further comprising storing data related to the transaction data, demographics of the first and second pluralities of users and a propensity of the first and second users to accept a savings opportunity.

17. A method for tracking financial transactions, comprising:

gathering transaction data from a plurality of user financial accounts by at least one computer, each user account a financial institution account at a financial institution;

analyzing the transaction data for each user by the at least one computer for at least one criterion for a savings opportunity indication;

providing a first savings opportunity to a first plurality of users whose transaction data meet the at least one criterion;

providing a second savings opportunity to a second plurality of users whose transaction data meet the at least one criterion;

tracking a redemption of the savings opportunity by the first plurality of users and the second plurality of users;

tracking purchasing behavior of the first plurality of users and the second plurality of users for a time period before and after the savings opportunity was provided; and

tracking purchasing behavior in a same time period for a third plurality of users whose transaction data met the at least one criterion and for whom a savings opportunity was not provided.

18. The method of Clause 17, wherein the first savings opportunity differs from the second savings opportunity in at least one of: an amount of spending required to realize the first or second opportunity; a number of transactions required to realize the first or second opportunity; and a time period in which to realize the first or second opportunity.

19. The method of Clause 17, wherein the third plurality of users is selected based on a previous purchasing behavior of at least one of: not accepting savings opportunities; opting out of receiving opportunities or offers; and not enrolling in a program or plan to receive offers.

20. The method of Clause 17, wherein the purchasing behavior is tracked for differences among the pluralities of users in at least one of: average total spending; average purchase amount; and number of transactions.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A computer-implemented method for providing an offer, comprising:
receiving an authorization request from a first merchant for a user transaction for an item;
analyzing, using a programmed processor, the authorization request to determine a category of the first merchant or a category of a good or a service of the item for which authorization is requested;
searching in a remote database for at least one offer previously sent to the user from a provider in a related but different category from the category of the good or the service of at least one of the first merchant and the item for which authorization is requested;
generating a reminder to transmit to the user of the offer previously sent to the user for the merchant or the good or the service in the related but different category for which the authorization request was received; and
transmitting the reminder for presentation to the user.

2. The method of claim 1, wherein presentation to the user is done via a mobile notification.

3. The method of claim 1, further comprising:
applying at least one rule dictated by at least one of the first merchant and a second merchant to a set of offers to be provided to the user;
applying at least one rule dictated by a financial institution to the set of offers;
applying a filter to identify offers with a highest likelihood of being accepted by the user; and
selecting at least one offer previously sent to the user in accordance with the filter, the at least one rule dictated by at least one of the first merchant and the second merchant and the at least one rule dictated by a financial institution to the set of offers.

4. The method of claim 1, wherein the first merchant is the provider.

5. The method of claim 1, wherein the category of the first merchant comprises both a geographic location of the first merchant and a type of product available from the first merchant.

6. The method of claim 3, further comprising:
accepting a like or dislike interaction for the at least one selected offer from the user; and
sharing the at least one selected offer with at least one user of a social network when a like interaction is accepted, wherein sharing causes the remote computer to generate a shared offer.

7. The method of claim 6, further comprising receiving an indication to redeem the shared offer and tracking the sharing and redemption of the shared offer.

8. The method of claim 1, wherein when multiple offers are identified in the step of searching, applying at least one of a user preference, a merchant preference or a platform operator preference to determine for which offer of the multiple offers the reminder should be generated.

9. The method of claim 1, wherein when multiple offers are identified in the step of searching, applying at least one criterion to determine for which offer the reminder should be generated.

10. A method, comprising:
providing an executable script embedded in a graphical user interface of a user's financial account;
using the executable script to gather transaction data from a user's financial account, wherein the user's financial account is a financial institution account that is maintained on behalf of the user;
analyzing the transaction data for transactions by the user;
selecting at least one offer to present to a user by:
applying at least one rule dictated by a merchant to a set of offers to be provided to the user;
applying at least one rule dictated by a financial institution to the set of offers; and
applying a filter to identify offers with a highest likelihood of being accepted by the user given the transaction data;
presenting the at least one selected offer to the user;
receiving an authorization request from a merchant for a user transaction for an item by a remote computer;
analyzing, using a programmed processor of the remote computer, the authorization request to determine a category of the merchant or a category of the item and determining if the at least one selected offer is for a merchant or an item in a related but different category from the merchant or the item for which the authorization request was received;
generating a reminder to transmit to the user of the at least one selected offer if the at least one selected offer is for a merchant or an item in a related but different category from the merchant or the item for which the authorization request was received; and
transmitting the reminder for presentation to the user.

11. The method of claim 10, wherein presentation to the user is done in a mobile notification.

12. The method of claim 10, wherein the step of analyzing comprises analyzing the transaction data for at least one of a merchant name, a merchant category, a merchant location, a store number, a transaction amount, a transaction frequency, a zip code, a store category, a transaction description, and a total spending amount.

13. The method of claim 10, wherein the step of analyzing comprises analyzing the transaction data for transactions by the user relating to a market segment.

14. The method of claim 10, wherein the step of analyzing comprises analyzing the transaction data for transactions by the user relating to a category.

15. The method of claim 10, wherein the user's financial account is at least one of a credit card account, a bank account, a checking account, a savings account, a personal finance program account, and a loan account.

16. The method of claim 10, wherein the step of analyzing comprises anonymizing the transaction data.

17. The method of claim 10, further comprising accepting a like or a dislike interaction for the selected offer from the user; and
sharing the selected offer with at least one member of a social network of the user when a like interaction is accepted, wherein sharing causes the remote computer to generate a shared offer.

18. The method of claim 17, further comprising receiving an indication to redeem the shared offer and tracking the sharing and redemption of the shared offer.

19. The method of claim 10, wherein when there are multiple selected offers, applying at least one of a user, merchant or platform operator preference to determine for which offer the reminder should be generated.

20. The method of claim 1, wherein when there are multiple selected offers, applying at least one criterion to determine for which offer the reminder should be generated.
